(19) United States
(12) Patent Application Publication
(10) Pub. No.: US 2014/0153683 A1
(43) Pub. Date: Jun. 5, 2014

(54) Nuclear Fusion of Common Hydrogen

(71) Applicant: HYDROGEN FUSION SYSTEMS, LLC, (US)

(72) Inventors: Norris Ray Peery, Anacortes, WA (US); Ahmad Attaie, Lynnwood, WA (US)

(73) Assignee: HYDROGEN FUSION SYSTEMS, LLC, Anacortes, WA (US)

(21) Appl. No.: 13/887,268

(22) Filed: May 3, 2013

Related U.S. Application Data
(60) Provisional application No. 61/642,360, filed on May 3, 2012.

(51) Int. Cl. G21G 1/12

(52) U.S. Cl. CPC G21G 1/12
USPC 376/100

(57) ABSTRACT

A process of fusing common hydrogen to: (1) form all of the elements in the Periodic Table of Elements; and, (2) produce excess energy. The process involves controllably initiating the process of electron capture with a hydrogen nucleus, which produces virtual neutrons and a new short-lived negatively charged particle (Negatron).

### CROSS-REFERENCE TO RELATED APPLICATION

This application claims the benefit of U.S. Provisional Application No. 61/642,360 filed May 3, 2012, which is incorporated herein by reference in its entirety.

### FIELD OF THE INVENTION

The present invention is directed to the nuclear fusion of hydrogen to: (1) form helium, along with all of the other chemical elements in the Periodic Table of Elements; and, (2) produce excess energy.

### BACKGROUND OF THE INVENTION

Since at least at early as 1990, the inventors of the present invention have been researching hydrogen fusion.

From examining tables that listed all of the chemical elements and all of their isotopes, the inventors knew that certain unstable isotopes could transform by means of radioactive transmutations, and that many of the transmutations from one isotope to a different chemical element took place as a result of a common process known as electron capture.

Electron capture results when a nucleus is in a certain excited state and is prone to decaying by means of positive beta decay. But, instead of ejecting a positron, the nucleus captures one of its atom's negative orbital electrons, which is absorbed by one of the atom's nuclear protons. This causes the cancellation of both the proton's positive charge and the absorbed electron's negative charge, all resulting in the nuclear protons transforming into a neutron of zero charge, thus decreasing the nuclear atomic number by one unit and becoming a different chemical element.

The inventors understood, with certainty, that if they could discover a process that could controllably initiate the process of electron capture with a hydrogen nucleus, that they could ultimately fuse hydrogen into helium.

The “scientific magic” of initiating controlled electron capture, took the inventors more than two decades and many hundreds of experiments to decode and understand. Yet, the resulting theory of how this process is realized is not complex, but simple, elegant and powerfully predictive of the resulting reactants, all of which are scientifically verifiable and 100% repeatable.

### SUMMARY OF INVENTION

The inventors have discovered a process of fusing common hydrogen into helium, along with the release of excess energy. The process involves controllably initiating the process of electron capture with a hydrogen nucleus, which produces virtual neutrons and a new short-lived negatively charged particle, which the inventors have named Negatron.

When common hydrogen's proton captures an electron, the charges of the two particles are both neutralized, and what was a hydrogen proton becomes, at least for a short time, a virtual neutron. The virtual neutron (having no charge) is not in any way resistant to capturing a second electron, thus becoming a negatively charged Negatron. Negatrons, because of their unique mass and negative charge, are strongly attracted to fuse with any positively charged hydrogen protons in their nearby vicinity. Therefore, a quick and intensely powerful force for fusion of common hydrogen takes place—all produced by the appropriate application of Coulomb's law.

According to Coulomb's law, the force of attraction or repulsion between two point charges is directly proportional to the product of the charges and inversely proportional to the square of the distance between them. Thus, F, the force between two point charges is: F=qq′/r̂2. As is well-known, if the charges of q and q′ are of the same sign, the force exerted is repulsive and increases exponentially as the separation radius between the two charges decreases. However, if the charges q and q′ are of different signs, then the force exerted is attractive and increases exponentially in a force of attraction as the separation radius between the two charges decreases—thus causing an extremely powerful and ever increasing force for the fusion of the two differently charged particles to take place.

### BRIEF DESCRIPTION OF THE DRAWINGS

FIG. 1 is a spectrographic image evidencing that, via the present invention, common hydrogen has been fused to form helium;

FIGS. 2 and 3 are spectrographic images demonstrating that the fusion process of the present invention can be controlled by cycling the RF electromagnetic stimulation on or off;

FIG. 4 is a spectrographic image evidencing that, via the present invention, common hydrogen has been fused to form helium;

FIG. 5 is a spectrographic image evidencing that, via the present invention, common hydrogen has been fused to form helium;

FIG. 6 is a spectrographic image evidencing that, via the present invention, deuterium has been fused to form helium;

FIG. 7 is a spectrographic image evidencing that, via the present invention, common hydrogen has been fused to form helium;

FIG. 8 is a spectrographic image evidencing that, via the present invention, common hydrogen has been fused to form helium;

FIG. 9 is a spectrographic image capturing the helium reference lamp data for the spectral line at 492.193 nanometers in connection with calibrating the spectrometer;

FIG. 10 is a spectrographic image for the calibration of the spectrometer, which shows the full helium lamp spectrum in the range of 200 nanometers through 1100 nanometers;

FIG. 11 is a screen capture of radiation data from a digital Geiger counter while fusing common hydrogen into helium in accordance with the principles of the present invention;

FIGS. 12 and 13(a) illustrate a type of coaxial reactor, which was used to fuse common hydrogen into helium in accordance with the principles of the present invention and from which the data presented in FIGS. 1-3 was gathered;

FIG. 13(b) illustrates a resonant closed system circular waveguide reactor, which was used to fuse common hydrogen into helium in accordance with the principles of the present invention and from which the data presented in FIG. 5 was gathered;

FIG. 13(c) illustrates a closed system resonant rectangular waveguide reactor, which was used to fuse common hydrogen into helium in accordance with the principles of the present invention and from which the data presented in FIG. 4 was gathered;

FIG. 14 illustrates a schematic diagram of an exemplary HVDC power supply for, among other things, supplying power to a source of microwave electromagnetic radiation (in this case, a magnetron);

FIG. 15 illustrates palladium rods charging with common hydrogen in a distilled water and 5% lithium hydroxide (LiOH) electrolytic bath, wherein the anode and cathode sections of the bath are separated by a nylon mesh;

FIGS. 16-127 are spectrographic images evidencing that, via the present invention, common hydrogen has been fused to form all of the elements of the Periodic Table of Elements; and,

FIG. 128 illustrates ten RF wavelengths and the chemical elements which are produced from common hydrogen fusions during each of the ten wavelength periods, so as to demonstrate that all chemical elements of the Periodic Table of Elements are created within approximately 4.909 microseconds.

### DETAILED DESCRIPTION

Nuclear fusion of common hydrogen (to form all of the chemical elements in the Periodic Table of Elements (hereinafter “Periodic Table”) and to produce excess energy) is performed by means of electron capture and resonant particle fusion within a Special Dynamic Material Environment (defined below) that is excited by microwave electromagnetic radiation. The term common hydrogen refers to the most commonly abundant form of hydrogen, which has but one proton in its nucleus and one electron in its atomic orbit.

The theory behind the nuclear fusion reactions and their excess energy is discussed below (the “Peery Theory”).

With respect to the organization of this application, first, the initial nuclear fusion reactions which produce the Virtual Neutron, the Heavy Negatron and Light Negatron are discussed. These unique particles initiate all further reactions from common hydrogen to helium, and continue to form all of the other chemical elements shown within the Periodic Table. Next, the Sequence of Fusion Reactions is discussed. Subsequently, information regarding the Special Dynamic Material Environment is presented. Next, a technique to control the fusion process is discussed. Finally, evidence in support of the nuclear fusion of common hydrogen to form helium, and the heavier chemical elements, is provided.

### Virtual Neutrons

A Virtual Neutron (X) particle can be produced in a Special Dynamic Material Environment when an electron resonating within a resonating electron swarm (plasmon) is momentarily captured (electron capture) by a proton, which is part of a resonating proton swarm resident within the same Special Dynamic Material Environment.

It should be noted that, in the equations that follow “MeV” means millions of electron volts of energy and P=proton, N=neutron, e=electron, except in the rest mass energy equations where ₁₅³¹P represents the phosphorous 31 nucleus and ₇¹⁴N represents the nitrogen 14 nucleus.

A Virtual Neutron (X) can be represented by the following equation: P (938.211 MeV)+e⁻ (0.511 MeV)=X (938.722 MeV). A Virtual Neutron (X) is 0.7831 MeV less in mass than a normal Neutron which is 939.505 MeV. The Virtual Neutron (X) has zero electric charge.

With respect to its decay, the half-life of a Virtual Neutron (X) is very short. When a Virtual Neutron (X) decays, no excess energy is realized. If a Virtual Neutron (X) decays, it does so, by ejecting its captured electron to again become a proton and a free electron.

Although the half-life of a Virtual Neutron (X) might be very short, in the Special Dynamic Material Environment, the Virtual Neutron (X) becomes a very reactive nuclear particle that can fuse with a positively charged nuclear particle to produce heavier nuclei and excess energy. It should be noted that a Virtual Neutron (X) is essentially the same mass as a proton, having increased its mass from that of a proton by adding the mass of one very excited electron.

### Light Negatrons (Y) and Heavy Negatrons (Y#)

A Light Negatron (Y) can be produced in a Special Dynamic Material Environment when a resonating electron is absorbed by a Virtual Neutron (X). A Light Negatron (Y) can also be produced in a Special Dynamic Material Environment when two resonating electrons within an electron swarm (plasmon) are sequentially captured by a resonating proton that is part of a resonating proton swarm also resident within the same Special Dynamic Material Environment. A Heavy Negatron (Y#) can be produced in a Special Dynamic Material Environment when an electron resonating within a resonating electron swarm (plasmon) is momentarily absorbed by a neutron. It must be emphasized that there are two distinct Negatron particles (Y) and (Y#), which are each defined by their unique rest mass energy in MeV and their negative charge.

The equation below represents the first process of forming a Light Negatron (Y), where a resonating electron is absorbed by a Virtual Neutron (X). That is, X (938.722 MeV)+e⁻ (0.511 MeV)=Y (939.233 MeV). It should be noted that a Light Negatron (Y) is not an antiproton, as the difference in rest mass energies distinguishes these two particles.

The equation below represents the second process of forming a Light Negatron (Y). That is, a resonating proton captures a single resonating excited electron to become a Virtual Neutron (X), which immediately or simultaneously absorbs a second excited resonating electron to become a Light Negatron (Y) [a negatively charged Virtual Neutron (X)]. P (938.211 MeV)+2e (1.022 MeV)=(Y) (939.233 MeV).

A Light Negatron (Y) is 0.272 MeV under the mass of a natural Neutron, but is 1.022 MeV heavier in mass than a Proton. The half-life of a Light Negatron (Y) is most likely exceedingly short, probably just a few nanoseconds in duration. It should be noted that the term Negatron is not to be confused with the early physics name for an electron, which is no longer commonly used.

As represented by the equation below, a neutron absorbs a single resonating excited electron to become a Heavy Negatron (Y#), which is identifiable in reactions by its unique mass. That is, N (939.505 MeV)+e⁻ (0.511 MeV)=(Y#) (940.016 MeV).

The decay options of the Light and Heavy Negatrons will now be discussed. A Light Negatron (Y) has two decay modes. Specifically, a Light Negatron (Y) may either eject one of its two absorbed electrons to become a Virtual Neutron (X) or it may eject two of its captured or absorbed electrons to become a proton. A Heavy Negatron (Y#) decays by ejecting its absorbed electron to become a neutron.

Although the half-life of a Light Negatron (Y) or Heavy Negatron (Y#) might be very short, in the proper Special Dynamic Material Environment, Light Negatrons (Y) or Heavy Negatrons (Y#) are very reactive nuclear particles that can fuse with positively charged (other light) nuclear particles to produce heavier nuclei and excess energy.

### Sequence of Fusion Reactions

In the equations that follow, the number in subscript represents the total number of protons, while the number in superscript represents the total number of protons plus neutrons. Accordingly, ₂⁴He represents helium 4. The subscript indicates that there are two protons and the superscript indicates that the total number of protons plus neutrons is 4 (i.e., two protons plus two neutrons).

The sequence of fusion reactions (or sequence of fusions) that leads from 4₁¹H to ₂⁴He is listed below. It should be noted that the energy yields are approximate, as 931.494 MeV was used as the conversion factor from unified atomic mass units (uamu) in Daltons to rest mass energy in MeV. The twelve reactions listed below take place within the later defined Special Dynamic Material Environment, while the environment's reactions are being stimulated and synchronized by electromagnetic radiation.

P(938.211 MeV)+e⁻(0.511 MeV)=X(938.722 MeV), a Virtual Neutron (1)

X(938.722 MeV)+e⁻(0.511 MeV)=Y(939.233 MeV), a Light Negatron (2)

N(939.505 MeV)+e⁻(0.511 MeV)=(Y#)(940.016 MeV), a Heavy Negatron (3)

P(938.211 MeV)+X(938.722 MeV)=₁²H(1876.006 MeV)+0.691 MeV (4)

P(938.211 MeV)+Y(939.233 MeV)=₁²H(1876.006 MeV)+e⁻(0.511 MeV)+0.809 MeV (5)

P(938.211 MeV)+(Y#)(940.016 MeV)=₁²H(1876.006 MeV)+e⁻(0.511 MeV)+1.642 MeV (6)

₁²H(1876.006 MeV)+Y(939.233 MeV)=₁³H(2809.431 MeV)+e⁻(0.511 MeV)+5.297 MeV (7)

₁³H(2809.431 MeV)+X(938.722 MeV)=₂⁴He(3728.401 MeV)+e⁻(0.511 MeV)+19.241 MeV (8)

₁²H(1876.006 MeV)+(Y#)(940.016 MeV)=₂³He(2809.413 MeV)+e⁻(0.511 MeV)+6.098 MeV (9)

₂³He(2809.413 MeV)+X(938.722 MeV)=₂⁴He(3728.401 MeV)+e⁻(0.511 MeV)+19.223 MeV (10)

₂³He(2809.413 MeV)+Y(939.233 MeV)=₂⁴He(3728.401 MeV)+e⁻(0.511 MeV)+19.734 MeV (11)

₂³He(2809.413 MeV)+(Y#)(940.016 MeV)=₂⁴He(3728.401 MeV)+e⁻(0.511 MeV)+20.517 MeV (12)

Under conventional wisdom, the above sequence of fusions would be suspected to stop after the completion of reactions (10), (11), or (12). Because ₂⁴He has a cross-section to thermal neutrons of Zero Barns, the conventional belief would be that the ₂⁴He produced is inactive with respect to further absorbing neutrons or protons. However, to the contrary, the inventors have recognized that when ₂⁴He is formed in this fusion process, it is formed as a bare nucleus, specifically an Alpha particle, and even more specifically a positively charged Alpha particle. Therefore, further reactions with the highly reactive Negatrons surely occur within the Special Dynamic Material Environment.

It should be noted that, in the above sequence of fusions, reactions (6), (9), and (12) are unique because they each involve the fusion of a highly-reactive Heavy Negatron (Y#). Accordingly, reactions (6), (9), and (12) produce energies in excess of what is normally expected from a similar reaction involving a highly-reactive Light Negatron (Y).

Deuterium may exist within the Special Dynamic Material Environment as deuterons. Deuterons exhibit a strong positive charge. Even though a deuteron has a very small nuclear cross-section for thermal neutrons (i.e., 0.00057 Barns), its nuclear cross-section to highly-reactive negatrons (both Light Negatrons (Y) and Heavy Negatrons (Y#)) is undoubtedly many magnitudes greater than that for neutrons or Virtual Neutrons (X).

It should be noted that ₂³He has a very large nuclear cross-section for thermal neutrons. Therefore, it is highly reactive for accepting a Virtual Neutron (X) and both Heavy Negatrons (Y#) or Light Negatrons (Y). Its nuclear cross-section for both Heavy Negatrons (Y#) and Light Negatrons (Y) probably seems something like an infinite capture net.

In addition to the sequence of fusions set forth in reactions (1)-(12), subsequences of fusion reactions take place within a Special Dynamic Material Environment. One such subsequence is described as follows by (A)-(D):

(A) Once a deuteron is formed in the main reaction's sequence, a deuteron's proton may momentarily capture an electron to produce a short-lived dineutron (1876.517 MeV), as two Virtual Neutrons (X) each of (938.2585 MeV).

(B) The two Virtual Neutrons (X) of (A) each capture an electron and are transformed into two Light Negatrons (Y), each of (938.7695 MeV).

(C) The two Light Negatrons (Y) of (B) each fuse with a proton to produce two deuterons (each of (1876.006 MeV)) plus an excess energy of 0.9745 MeV.

(D) The above reactions repeat until all of the deuterons are fused in reactions that finally lead to the formation of helium nuclei.

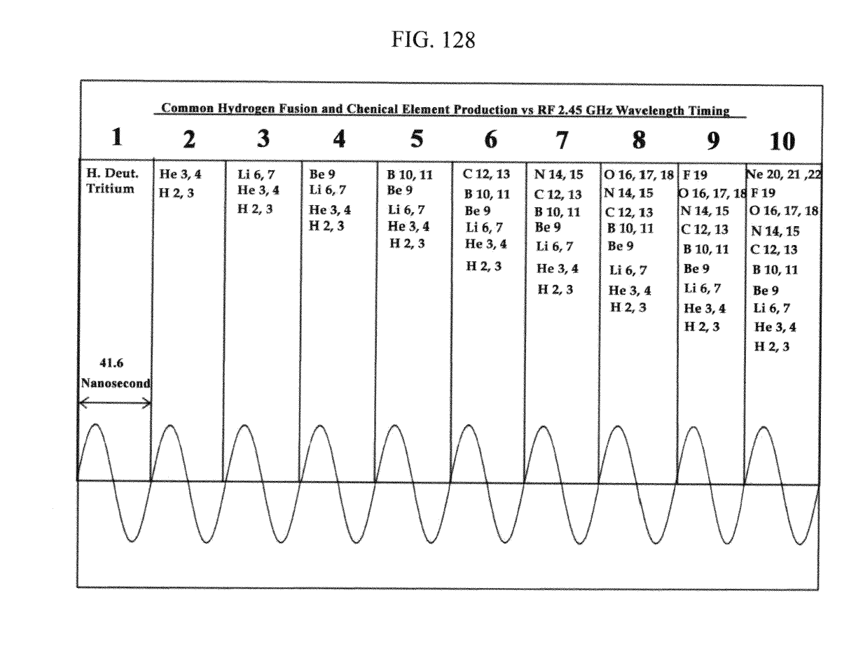

The same resonating particle mechanisms acting within the Special Dynamic Material Environment that cause hydrogen to fuse and form helium (₂⁴He) are the same forces that cause further fusions to even heavier nuclei, including those very intense visible spectrum radiators such as Lithium, Sodium, Chromium and others. Certainly, in the fusion channels, which are made possible by the “Peery Theory,” every element, from Deuterium up to Einsteinium (atomic number 99) and beyond, can have existed at sometime within the Special Dynamic Material Environment. But, each of those 118 chemical elements is subject to being transmuted to a heavier element within picoseconds of their initial formation by the very same physical mechanisms which originally produced them. Because of the extremely high frequency of the electromagnetic radiation which produces the fusion reactions, all fusion possibilities occur within the time encompassed by about 118 wavelengths of the electromagnetic radiation which is irradiating the Special Dynamic Material Environment, or within about 4.908 microseconds from the time of the fusions beginning (see FIG. 128).

### Special Dynamic Material Environment

The sequence of fusions (reactions (1)-(12) above and (13)-(110) below) occurs within a Special Dynamic Material Environment, in which the conditions of highly dynamic particle mechanisms exist, so as to allow common hydrogen to fuse into becoming helium and continuing to fuse to include all of the known chemical elements. The Special Dynamic Material Environment is an electrically conductive molten metal reaction volume that is being irradiated with electromagnetic radiation at 2.45 GHz or radio frequencies that are integer harmonics of 2.45 GHz. The Special Dynamic Material Environment physically consists of metals that can chemically readily form metal hydrides.

The electrically conductive molten metal (or electrically conductive metal alloys) can be brought to a molten state by means of induced heat from a variety of energy sources (such as a chemical energy source, an electrical energy source, a magnetic energy source or a source of powerful fluxing electromagnetic radiation, including combinations thereof) that causes a microscopic melting of a common hydrogen-doped, electrically conductive metal (or metal alloy), originally formed as a rod, bead, pellet, or granule, or a conformation of those forms. The originally formed metal (or metal alloy) or conformation thereof physically approximates the length of one-quarter (or integer multiples thereof) of the physical wavelength of the frequency of electromagnetic radiation of about 2.45 GHz or radio frequencies that are integer harmonics of 2.45 GHz. Of course, other frequency ranges are possible. The molten part of the electromagnetically irradiated electrically conductive metal (or metal alloy) immediately becomes the Special Dynamic Material Environment in which the common hydrogen fusion reactions (sequence of fusions), numbered 1 through 12 above and 13 through 110 below, are catalyzed to create all of the chemical elements along with the release of large amounts of fusion energy in the form of kinetic thermal energy. It should be noted that the fusion (or fusions) takes place at the surface or near-surface of the molten metal.

It is well established in Nuclear Physics that the nuclear fusion of one gram of common hydrogen to form helium yields approximately 55,002.9 kWh of energy, but further fusions forming nuclei heavier than helium also produce excess energy as can be seen in equations 13 through 85. The fusion of common hydrogen to form the nuclei of all of the known chemical elements produces more excess kinetic thermal energy than does any other known process. The process of common hydrogen fusion to produce helium (along with heavier elements), as reported herein, is scalable for producing energy which may be used in transportation systems of every kind (including spaceships), supplying energy for electrical power generation, and providing energy for heating systems, among other things.

During electromagnetic irradiation of the Special Dynamic Material Environment, alternating electron (plasmon) current nodes are produced within the skin of the molten metal reaction volume of the Special Dynamic Material Environment. The electron currents have a rise time from zero to peak power of approximately 10 nanoseconds. The electromagnetic radiation used to irradiate and excite the molten metal reaction volume may be produced by a magnetron, traveling wave tube (TWT), or a microwave GHz oscillator coupled with an RF amplifier, such as a klystron. The electrons within the molten metal reaction volume that is being irradiated (The Special Dynamic Material Environment) are driven to oscillate in a resonance directly coupled to the fluxing polarity changes of the electromagnetic radiation and oscillate in a harmonic resonance with the cyclic electron oscillations (plasmon) within the magnetron, TWT, or microwave GHz oscillator coupled with an RF amplifier, such as a klystron.

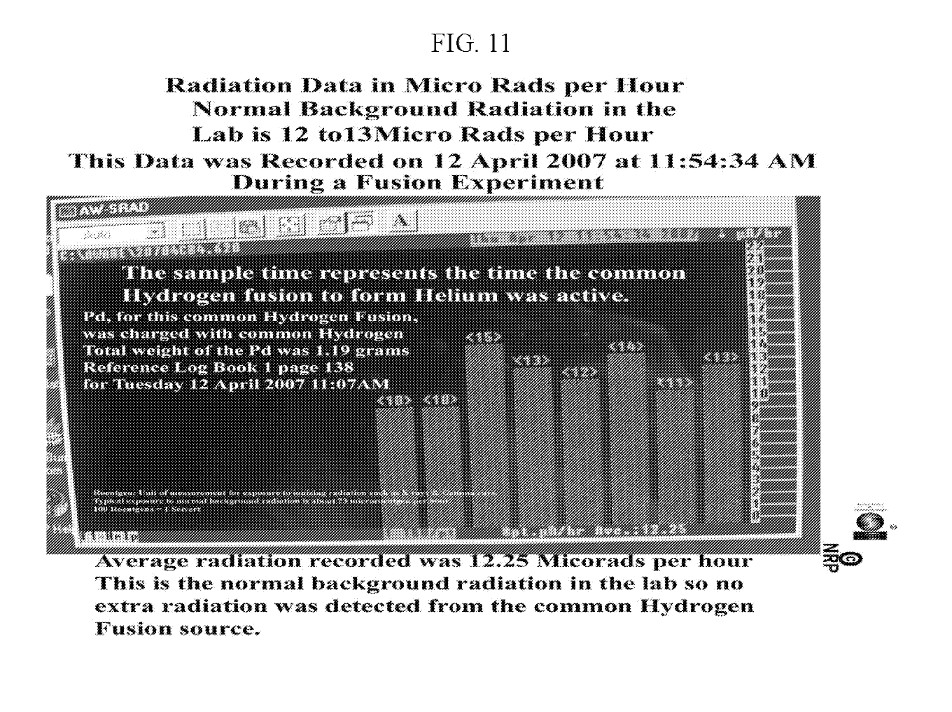

Common hydrogen's protons, driven by the alternating electromagnetic radiation and the fusion's produced heat, migrate into the molten metal reaction volume, or the molten metal reaction volume migrates to those protons trapped within the electrically conductive metal (or metal alloy). The protons within the molten metal reaction volume are much more massive than the electrons. Even though the protons are more massive, they also oscillate with a harmonic resonance linked to, and synchronized with, the electromagnetic source radiation. The proton's oscillations are exactly contrary to the directions of the electron's oscillations; that is, they are 180 degrees out-of-phase with that of the electron's oscillations. These resonant opposing phase differences, and opposite electric charges of the reactants, strongly contribute to the fusion encounters that take place within the Special Dynamic Material Environment. Because the electromagnetic RF Energy which stimulates the Special Dynamic Material Environment to initiate the nuclear fusion of common hydrogen to form helium is thousands of times less than the energy used in any magnetic confinement fusion processes, no radioactive ionizing radiation is produced (see FIG. 11). Accordingly, the products of the fusion process have extremely low energy (i.e., they are relatively unexcited, which reduces the likelihood of radioactive emission).

The electrically conductive metal (discussed above) can be any chemically-active hydrogen-absorbing metal such as, aluminum, gallium, lithium, nickel, palladium, potassium, sodium, titanium, zinc or any electrically conductive metal (or metal alloy) that can actively form a metal hydride (e.g., palladium-boron alloys).

Within the molten metal reaction volume, while being electromagnetically irradiated, exists the Special Dynamic Material Environment including highly mobile electrically conductive molten metal atoms, highly mobile protons and numbers of electrons thousands of times more numerous than are the numbers of free nuclear particles contained in the Special Dynamic Material Environment. Those large numbers of electrons create a powerful resonating current of electrons (plasmon) that is fluxing and oscillating, billions of times each second. Also within this environment are powerful voltages and electron currents that are fluctuating between their positive and negative maximums, billions of times each second. It is within this very “unusual” and “confining” Special Dynamic Material Environment, where the sequence of fusion reactions defined by equations 1 through 12 and 13 through 110 are driven to be catalyzed.

In one embodiment, common hydrogen must be present within the Special Dynamic Material Environment or in the atmosphere that surrounds the Special Dynamic Material Environment for fusions to take place, because it contains the basic particle (i.e., the proton) which can produce the highly active virtual particles (i.e., Virtual Neutron (X), Light Negatron (Y) and Heavy Negatron (Y#)), which are the primary and unique drivers of every fusion reaction that takes place within the Special Dynamic Material Environment. Once the common hydrogen is completely consumed by entering into fusions, or by escaping as gas from the reaction area, all further fusion reactions come to a full stop.

It should be understood that hydrogen's isotope deuterium or its heaviest isotope tritium could be used to form the powerful virtual particles of equations 1, 2, and 3 of the sequence of fusions. However, to use deuterium or tritium would be economically illogical, because common hydrogen is sufficient as the fusion fuel to form the three very active virtual particles for fusion, and because common hydrogen is the most abundant element in the universe.

It should be noted that within this section of the description that provides information regarding the Special Dynamic Material Environment, the “common hydrogen” can be replaced with the phrase, “a mixture of various percentages of common hydrogen with deuterium or with an inert gas,” and the logic will not change.

### Ash as a Product of Common Hydrogen Fusion

The inventors have discovered that the “ash” from the fusion of common hydrogen is a collection of all of the elements of the Periodic Table. Accordingly, the ash is extremely valuable. Chemical elements that are not abundantly available within the earth's crust can be extracted from the ash. Likewise, the ash provides an alternative source of chemical elements that are not economically available.

### Control of the Fusion Process

Due to the immense amount of thermal energy generated by the fusion process, it is important to be able to control the energy being generated, so as to not damage the fusion reactors and to adjust the amount of excess energy being produced. The present fusion process can be controlled within microseconds by cycling on or off the RF microwave energy that irradiates the Special Dynamic Material Environment, where turning on the microwave RF energy begins the fusion process and turning off the RF energy stops the fusion process. This on-off cycling can be precisely applied to control the fusion process' excess energy production. The spectrometer pixel data shown in FIGS. 2, 3, 16, 30, 40, 43, 46, 94, 95 and 96 demonstrates that the actual fusion of common hydrogen to form helium, and heavier elements, can be cycled on and off.

FIG. 14 illustrates a schematic diagram of an exemplary HVDC power supply for, among other things, supplying power to a source of microwave electromagnetic radiation (in this case, a magnetron) and for cycling the fusion process on and off. It should be understood that FIG. 14 illustrates one configuration of the HVDC power supply and that there are many other different ways of designing such a power supply.

With reference to FIG. 14, 120V AC is supplied to the circuit. Transformers T1 and T2 are wired to be 180 degrees out-of-phase with one another. T1, C1, D1a and D1b form a voltage doubler on the positive portion of the cycle. Similarly, T2, C2, D2a, D2b form a voltage doubler on the negative portion of the cycle. The doubled waveforms are aggregated and delivered to R1. Accordingly, T1 and T2 form a full-wave (bridge) rectifier and voltage doubler. Thus, 4 kV full wave rectified is supplied at R1.

Resistors R1, R2, R3 and R4 provide enough resistance for current limiting. Because the capacitors are discharged when the device is turned on (or plugged in), if such resistors were not provided, the in-rush current might cause a fuse to short (or the circuitry to be damaged).

The 4 kV full-wave rectified signal is used to charge up the capacitors C3a and C3b. −4 kV is used to drive the cathode of the magnetron, as the magnetron's chassis acts as the anode.

T3 is a transformer that converts 120V to 3V at 10A, which is used to heat up the filament in the magnetron. It essentially keeps the magnetron filament warm, so there is no delay associated with the magnetron turning on and off, as it is being controlled by the switch (described below). T3 turns on when the system is plugged in.

120V AC is also connected to the cooling fan for cooling the magnetron.

T1 and T2 are switched by a solid state switch that is optically isolated (solid state relay). The solid state relay is controlled by a 9V battery. The 9V battery is used to turn on the LED, which turns on the triac device inside the solid state switch, which turns on T1 and T2. The box at the bottom right depicts the push-button switch, which is used to turn the magnetron on and off. It is a manually controlled system.

The switch could be electronically controlled, instead of being manually controlled. In one embodiment, a timer is provided to turn the switch on and off.

Still referring to FIG. 14, a reactor (coaxial reactor) is shown as being adjacent to the magnetron. In one embodiment, the reactor is tubular in shape and is made of copper. An antenna is shown as extending from the magnetron into the reactor, which transmits the RF signal into the coaxial reactor (which is a resonance box).

There is a fiber optic port at the other end of the coaxial reactor, to which the probe of the spectrometer is connected, so that spectral data can be captured.

As shown on FIG. 14, to obtain 50% duty cycle (or half-power), T2, C2, D2a and D2b may be omitted. Thus, half of the AC waveform would not being rectified and added. Again, FIG. 14 illustrates one of many ways to design the HVDC power supply.

In addition to turning the fusion process on and off, the amount of excess energy being produced by the fusion process can be controlled by adjusting the concentration of common hydrogen within the Special Dynamic Material Environment, and also by controlling the concentration of common hydrogen in the atmosphere that surrounds the Special Dynamic Material Environment.

### Sequence of Fusion Equations 13 Through 110

The sequence of fusion reactions (or sequence of fusions) that leads from the ₂⁴He nucleus (a positively charged alpha particle) to Einsteinium (atomic number 99) is listed below. Because of the uncertainty of the exact value of the mass defect energy (M-A) in MeV, which in some cases can vary by as much as several million electron volts (MeV), it should be noted that the energy yields are approximate. In the calculations below, 931.494 MeV, was used as the conversion factor from unified atomic mass units “uamu” (Daltons) to rest mass energy. For the same reasons, the excess energy yields are also approximate. The reactions listed below take place within the Special Dynamic Material Environment, while that environment is being stimulated by electromagnetic radiation.

Shown below are the equations of rest mass energy in MeV and excess energy in MeV for the hydrogen fusion produced chemical elements that represent the elements' most abundant isotopes. Although all isotopes are being produced, the various isotopes of the same element are not resolvable by the spectrometer, as their wavelengths are too close together to be individually resolved without the use of an interferometer.

It should be noted that a fusion-formed chemical element's spectrographic lines can only be detected by a spectrometer, when the chemical element has escaped from the Special Dynamic Material Environment and has formed its atom's atomic electron structure. For this reason, the quantity of a chemical element fused to the next heavier chemical element has not been determined. Thus, the amount of excess energy actually delivered quantitatively by each step of the fusion reaction has not been determined, but such excess energy certainly exceeds the excess energy produced by the fusion of common hydrogen to form helium. Again, it should be noted that the fusions take place at the surface or near-surface of the molten metal.

Like equations 4 through 12, the following equations show the reactant particles and their rest mass energy in MeV and the yielding of various particle products with their rest mass energy in MeV, along with the total excess energy of the fusion reaction.

₂⁴He(3728.401 MeV)+2Y(939.233 MeV)=₃⁶Li(5603.051 MeV)+3e⁻(0.511 MeV)+2.283 MeV (13)

₃⁶Li(5603.051 MeV)+Y(939.233 MeV)=₃⁷Li(6535.366 MeV)+e⁻(0.511 MeV)+6.407 MeV (14)

₃⁷Li(6535.366 MeV)+2Y(939.233 MeV)=₄⁹Be(8394.794 MeV)+3e⁻(0.511 MeV)+18.016 MeV (15)

₄⁹Be(8394.794 MeV)+2Y(939.233 MeV)=₅¹¹B(10255.102 MeV)+3e⁻(0.511 MeV)+16.625 MeV (16)

₅¹¹B(10255.102 MeV)+Y(939.233 MeV)=₆¹²C(11177.928 MeV)+2e⁻(0.511 MeV)+15.385 MeV (17)

₆¹²C(11177.928 MeV)+2Y(939.233 MeV)=₇¹⁴N(13043.779 MeV)+3e⁻(0.511 MeV)+11.082 MeV (18)

₇¹⁴N(13043.779 MeV)+2Y(939.233 MeV)=₈¹⁶O(14899.167 MeV)+3e⁻(0.511 MeV)+21.545 MeV (19)

₈¹⁶O(14899.167 MeV)+3Y(939.233 MeV)=₉¹⁹F(17696.898 MeV)+4e⁻(0.511 MeV)+17.924 MeV (20)

₉¹⁹F(17696.898 MeV)+Y(939.233 MeV)=₁₀²⁰Ne(18622.838 MeV)+2e⁻(0.511 MeV)+12.271 MeV (21)

₁₀²⁰Ne(18622.838 MeV)+3Y(939.233 MeV)=₁₁²³Na(21414.832 MeV)+4e⁻(0.511)+23.661 MeV (22)

₁₁²³Na(21414.832 MeV)+Y(939.233 MeV)=₁₂²⁴Mg(22341.922 MeV)+2e⁻(0.511 MeV)+11.121 MeV (23)

₁₂²⁴Mg(22341.922 MeV)+3Y(939.233 MeV)=₁₃²⁷Al(25133.141 MeV)+4e⁻(0.511 MeV)+24.436 MeV (24)

₁₃²⁷Al(25133.141 MeV)+Y(939.233 MeV)=₁₄²⁸Si(26060.339 MeV)+2e⁻(0.511 MeV)+11.013 MeV (25)

₁₄²⁸Si(26060.339 MeV)+3Y(939.233 MeV)=₁₅³¹P(28851.873 MeV)+4e⁻(0.511 MeV)+24.121 MeV (26)

₁₅³¹P(28851.873 MeV)+Y(939.233 MeV)=₁₆³²S(29781.792 MeV)+e⁻(0.511 MeV)+8.803 MeV (27)

₁₆³²S(29781.792 MeV)+3Y(939.233 MeV)=₁₇³⁵Cl(32573.276 MeV)+4e⁻(0.511 MeV)+24.171 MeV (28)

₁₇³⁵Cl(32573.276 MeV)+5Y(939.233 MeV)=₁₈⁴⁰Ar(37224.720 MeV)+6e⁻(0.511 MeV)+41.655 MeV (29)

₁₈⁴⁰Ar(37222.41 MeV)+Y(939.233 MeV)=₁₉⁴¹K(38153.2883 MeV)+2e⁻(0.511 MeV)+7.237 MeV (30)

₁₉⁴¹K(38155.694 MeV)+3Y(939.233 MeV)=₂₀⁴⁴Ca(40944.267 MeV)+4e⁻(0.511 MeV)+27.082 MeV (31)

₂₀⁴⁴Ca(40941.6179 MeV)+Y(939.233 MeV)=₂₁⁴⁵Sc(41876.162 MeV)+2e⁻(0.511 MeV+6.316 MeV (32)

₂₁⁴⁵Sc(41876.162 MeV)+3Y(939.233 MeV)=₂₂⁴⁸Ti(44663.224 MeV)+4e⁻(0.511 MeV)+28.593 MeV (33)

₂₂⁴⁸Ti(44663.224 MeV)+3Y(939.233 MeV)=₂₃⁵¹V(47453.992 MeV)+4e⁻(0.511 MeV)+24.887 MeV (34)

₂₃⁵¹V(47453.992 MeV)+Y(939.233 MeV)=₂₄⁵²Cr(48382.271 MeV)+2e⁻(0.511 MeV)+9.932 MeV (35)

₂₄⁵²Cr(48382.271 MeV)+3Y(939.233 MeV)=₂₅⁵⁵Mn(51171.565 MeV)+4e⁻(0.511 MeV)+26.361 MeV (36)

₂₅⁵⁵Mn(51171.565 MeV)+Y(939.233 MeV)=₂₆⁵⁶Fe(52103.059 MeV)+2e⁻(0.511 MeV)+6.717 MeV (37)

₂₆⁵⁶Fe(52103.059 MeV)+3Y(939.233 MeV)=₂₇⁵⁹Co(54895.917 MeV)+4e⁻(0.511 MeV)+22.797 MeV (38)

₂₇⁵⁹Co(54892.519 MeV)+Y(939.233 MeV)=₂₈⁶⁰Ni(55825.168 MeV)+2e⁻(0.511 MeV)+8.960 MeV (39)

₂₈⁶⁰Ni(55825.168 MeV)+3Y(939.233 MeV)=₂₉⁶³Cu(58618.542 MeV)+4e⁻(0.511 MeV)+22.281 MeV (40)

₂₉⁶³Cu(58618.542 MeV)+Y(939.233 MeV)=₃₀⁶⁴Zn(59549.612 MeV)+2e⁻(0.511 MeV)+7.141 MeV (41)

₃₀⁶⁷Zn(59549.612 MeV)+5Y(939.233 MeV)=₃₁⁶⁹Ga(64203.758 MeV)+6e⁻(0.511 MeV)+38.953 MeV (42)

₃₁⁶⁹Ga(64203.758 MeV)+5Y(939.233 MeV)=₃₂⁷⁴Ge(68857.133 MeV)+6e⁻(0.511 MeV)+39.724 MeV (43)

₃₂⁷⁴Ge(68857.133 MeV)+Y(939.233 MeV)=₃₃⁷⁵As(69789.017 MeV)+2e⁻(0.511 MeV)+6.327 MeV (44)

₃₃⁷⁵As(69789.017 MeV)+5Y(939.233 MeV)=₃₄⁸⁰Se(74441.760 MeV)+6e⁻(0.511 MeV)+40.356 MeV (45)

₃₄⁸⁰Se(74441.760 MeV)+Y(939.233 MeV)=₃₅⁸¹Br(75373.039 MeV)+2e⁻(0.511 MeV)+6.932 MeV (46)

₃₅⁸¹Br(75373.039 MeV)+Y(939.233 MeV)=₃₆⁸²Kr(76301.918 MeV)+2e⁻(0.511 MeV)+9.332 MeV (47)

₃₆⁸²Kr(76301.918 MeV)+3Y(939.233 MeV)=₃₇⁸⁵Rb(79090.0857 MeV)+4e⁻(0.511 MeV)+22.751 MeV (48)

₃₇⁸⁵Rb(79094.822 MeV)+3Y(939.233 MeV)=₃₈⁸⁸Sr(81883.550 MeV)+4e⁻(0.511 MeV)+26.927 MeV (49)

₃₈⁸⁸Sr(81883.550 MeV)+Y(939.233 MeV)=₃₉⁸⁹Y(82815.264 MeV)+2e⁻(0.511 MeV)+6.497 MeV (50)

₃₉⁸⁹Y(82810.149 MeV)+Y(939.233 MeV)=₄₀⁹⁰Zr(83745.693 MeV)+2e⁻(0.511 MeV)+7.782 MeV (51)

₄₀⁹⁰Zr(83745.693 MeV)+3Y(939.233 MeV)=₄₁⁹³Nb(86541.734 MeV)+4e⁻(0.511 MeV)+19.614 MeV (52)

₄₁⁹³Nb(86541.734 MeV)+2Y(939.233 MeV)=₄₂⁹⁵Mo(88404.222 MeV)+3e⁻(0.511 MeV)+14.445 MeV (53)

₄₂⁹⁵Mo(88404.222 MeV)+Y(939.233 MeV)=₄₃⁹⁶Tc*(89337.606 MeV)+2e⁻(0.511 MeV)+4.827 MeV(*Note Tc has no stable isotopes) (54)

₄₃⁹⁶Tc(89337.606 MeV)+6Y(393.233 MeV)=₄₄¹⁰²Ru(94923.289 MeV)+7e⁻(0.511 MeV)+46.138 MeV (55)

₄₄¹⁰²Ru(94923.289 MeV)+Y(939.233 MeV)=₄₅¹⁰³Rh(95855.859 MeV)+2e⁻(0.511 MeV)+5.641 MeV (56)

₄₅¹⁰³Rh(95855.859 MeV)+2Y(939.233 MeV)=₄₆¹⁰⁵Pd(97718.457 MeV)+3e⁻(0.551 MeV)+14.335 MeV (57)

₄₆¹⁰⁵Pd(97718.457 MeV)+2Y(939.233 MeV)=₄₇¹⁰⁷Ag(99581.456 MeV)+3e⁻(0.551 MeV)+13.934 MeV (58)

₄₇¹⁰⁷Ag(99581.456 MeV)+7Y(939.233 MeV)=₄₈¹¹⁴Cd(106100.295 MeV)+se(0511 MeV)+51.704 MeV (59)

₄₈¹¹⁴Cd(106100.295 MeV)+Y(939.233 MeV)=₄₉¹¹⁵In(107032.273 MeV)+2e⁻(0.511 MeV)+6.233 MeV (60)

₄₉¹¹⁵In(107032.273 MeV)+3Y(939.233 MeV)=₅₀¹¹⁸Sn(109824.636 MeV)+4e⁻(0.511 MeV)+23.292 MeV (61)

₅₀¹¹⁸Sn(109824.636 MeV)+3Y(939.233 MeV)=₅₁¹²¹Sb(112621.179 MeV)+4e⁻(0.511 MeV)+19.112 MeV (62)

₅₁¹²¹Sb(112621.179 MeV)+5Y(939.233 MeV)=₅₂¹²⁶Te(117278.179 MeV)+6e⁻(0.511 MeV)+36.009 MeV (63)

₅₂¹²⁶Te(117278.179 MeV)+Y(939.233 MeV)=₅₃¹²⁷I(118210.755 MeV)+2e⁻(0.511 MeV)+5.635 MeV (64)

₅₃¹²⁷I(118210.755 MeV)+3Y(939.233 MeV)=₅₄¹³⁰Xe(121004.338 MeV)+4e⁻(0.511 MeV)+22.072 MeV (65)

₅₄¹³⁰Xe(120996.73 MeV)+3Y(939.233 MeV)=₅₅¹³³Cs(123792.553 MeV)+4e⁻(0.511 MeV)+19.362 MeV (66)

₅₅¹³³Cs(123792.553 MeV)+5Y(939.233 MeV)=₅₆¹³⁸Ba(128457.910 MeV)+6e⁻(0.511 MeV)+35.820 MeV (67)

₅₆¹³⁸Ba(128457.910 MeV)+Y(939.233 MeV)=₅₇¹³⁹La(129390.434 MeV)+2e⁻(0.511 MeV)+5.687 MeV (68)

₅₇¹³⁹La(129390.434 MeV)+Y(939.233 MeV)=₅₈¹⁴⁰Ce(130321.077 MeV)+2e⁻(0.511 MeV)+7.568 MeV (69)

₅₈¹⁴⁰Ce(130321.077 MeV)+Y(939.233 MeV)=₅₉¹⁴¹Pr(131254.633 MeV)+2e⁻(0.511 MeV)+4.655 MeV (70)

₅₉¹⁴¹Pr(131254.633 MeV)+Y(939.233 MeV)=₆₀¹⁴²Nd(132186.193 MeV)+2e⁻(0.511 MeV)+6.651 MeV (71)

₆₀¹⁴²Nd(132186.193 MeV)+4Y(939.233 MeV)+₆₁¹⁴⁶Pm(135918.664 MeV)+5e⁻(0.511 MeV)+21.906 MeV(Note: there are no stable isotopes of Promethium) (72)

₆₁¹⁴⁶Pm(135908.386 MeV)+6Y(939.233 MeV)+₆₂¹⁵²Sm(141512.319 MeV)+7e⁻(0.511 MeV)+38.166 MeV (73)

₆₂¹⁵²Sm(141512.319 MeV)+2Y(939.233 MeV)=₆₃¹⁵⁴Eu(143378.332 MeV)+3e⁻(0.511 MeV)+10.920 MeV (74)

₆₃¹⁵⁴Eu(143378.332 MeV)+2Y(939.233 MeV)=₆₄¹⁵⁶Gd(145240.522 MeV)+3e⁻(0.511 MeV)+14.743 MeV (75)

₆₄¹⁵⁶Gd(145240.522 MeV)+3Y(939.233 MeV)=₆₅¹⁵⁹Tb(148038.007 MeV)+4e⁻(0.511 MeV)+18.170 MeV (76)

₆₅¹⁵⁹Tb(148038.007 MeV)+3Y(939.233 MeV)=₆₆¹⁶²Dy(150833.841 MeV)+4e⁻(0.511 MeV)+19.791 MeV (77)

₆₆¹⁶²Dy(150833.841 MeV)+3Y(939.233 MeV)=₆₇¹⁶⁵Ho(153631.605 MeV)+4e⁻(0.511 MeV)+17.861 MeV (78)

₆₇¹⁶⁵Ho(153620.665 MeV)+3Y(939.233 MeV)=₆₈¹⁶⁸Er(156427.995 MeV)+4e⁻(0.511 MeV)+19.235 MeV (79)

₆₈¹⁶⁸Er(156427.995 MeV)+Y(939.233 MeV)=₆₉¹⁶⁹Tm(157361.206 MeV)+2e⁻(0.511 MeV)+5.000 MeV (80)

₆₉¹⁶⁹Tm(157361.206 MeV)+5Y(939.233 MeV)=₇₀¹⁷⁴Yb(162023.006 MeV)+6e⁻(0.511 MeV)+31.299 MeV (81)

₇₀¹⁷⁴Yb(162023.006 MeV)+Y(939.233 MeV)=₇₁¹⁷⁵Lu(162956.279 MeV)+2e⁻(0.511 MeV)+4.938 MeV (82)

₇₁¹⁷⁵Lu(162956.279 MeV)+5Y(939.233 MeV)=₇₂¹⁸⁰Hf(167619.132 MeV)+6e⁻(0.511 MeV)+30.246 MeV (83)

₇₂¹⁸⁰Hf(167619.132 MeV)+Y(939.233 MeV)=₇₃¹⁸¹Ta(168551.972 MeV)+2e⁻(0.511 MeV)+5.371 MeV (84)

₇₃¹⁸¹Ta(168551.972 MeV)+3Y(939.233 MeV)=₇₁¹⁸⁴W(171349.189 MeV)+4e⁻(0.511 MeV)+18.438 MeV (85)

₇₄¹⁸⁴W(171349.189 MeV)+3Y(939.233 MeV)=₇₅¹⁸⁷Re(174148.162 MeV)+4e⁻(0.511 MeV)+16.682 MeV (86)

₇₅¹⁸⁷Re(174148.162 MeV)+3Y(939.233 MeV)=₇₆¹⁹⁰Os(176945.154 MeV)+4e⁻(0.511 MeV)+18.663 MeV (87)

₇₆¹⁹⁰Os(176945.154 MeV)+3Y(939.233 MeV)=₇₇¹⁹³Ir(179743.808 MeV)+4e⁻(0.511 MeV)+17.001 MeV (88)

₇₇¹⁹³Ir(179743.808 MeV)+2Y(939.233 MeV)=₇₈¹⁹⁵Pt(181608.533 MeV)+3e⁻(0.511 MeV)+12.208 MeV (89)

₇₈¹⁹⁵Pt(181608.533 MeV)+2Y(939.233 MeV)=₇₉¹⁹⁷Au(183473.177 MeV)+3e⁻(0.511 MeV)+12.289 MeV (90)

₇₉¹⁹⁷Au(183473.177 MeV)+2Y(939.233 MeV)=₈₀¹⁹⁹Hg(185337.711 MeV)+3e⁻(0.511 MeV)+12.399 MeV (91)

₈₀¹⁹⁹Hg(185337.711 MeV+6Y(939.233 MeV)=₈₁²⁰⁵Tl(190932.449 MeV)+7e⁻(0.511 MeV)+37.033 MeV (92)

₈₁²⁰⁵Tl(190932.449 MeV)+3Y(939.233 MeV)=₈₂²⁰⁸Pb(193729.004 MeV)+4e⁻(0.511 MeV)+19.100 MeV (93)

₈₂²⁰⁸Pb(193729.004 MeV)+Y(939.233 MeV)=₈₃²⁰⁹Bi(194663.988 MeV)+2e⁻(0.511 MeV)+3.227 MeV (94)

₈₃²⁰⁹Bi(194663.988 MeV)+Y(939.233 MeV)=₈₄²¹⁰Po(195597.787 MeV)+2e⁻(0.511 MeV+4.412 MeV (95)

₈₄²¹⁰Po(195597.787 MeV)+2Y(939.233 MeV)=₈₅²¹²At(197468.107 MeV)+3e⁻(0.511 MeV)+6.613 MeV (96)

₈₂²¹²At(197468.107 MeV)+2Y(939.233 MeV)=₈₆²¹⁴Rn(199335.396 MeV)+3e⁻(0.511 MeV)+9.644 MeV (97)

₆₈²¹⁴Rn(199335.396 MeV)+3Y(939.233 MeV)=₈₇²¹⁷Fr(202138.513 MeV)+4e⁻(0.511 MeV)+12.538 MeV (98)

₈₇²¹⁷Fr(202138.513 MeV)+9Y(939.233 MeV)=₈₈²²⁶Ra(210541.313 MeV)+10e⁻(0.511 MeV)+45.197 MeV (99)

₈₈²²⁶Ra(210541.313 MeV)+Y(939.233 MeV)=₅₈₉²²⁴Ac(211474.989 MeV)+2e⁻(0.511 MeV)+4.535 MeV (100)

₈₉²²⁷Ac(211474.989 MeV)+5Y(939.233 MeV)=₉₀²³²Th(216142.056 MeV)+6e⁻(0.511 MeV)+26.032 MeV (101)

₉₀²³²Th(216142.056 MeV)+2Y(939.233 MeV)=₉₁²³⁴Pa(218009.937 MeV)+3e⁻(0.551 MeV)+9.052 MeV (102)

₉₁²³⁴Pa(218009.937 MeV)+Y(939.233 MeV)=₉₂²³⁵U(218942.010 MeV)+2e⁻(0.511 MeV)+6.138 MeV (103)

₉₂²³⁵U(218942.010 MeV)+Y(939.233 MeV)=₉₃²³⁶Np(219875.963 MeV)+2e⁻(0.511 MeV)+4.258 MeV (104)

₉₃²³⁶Np(219875.963 MeV)+5Y(939.233 MeV)=₉₄²⁴¹Pu(224543.011 MeV)+6e⁻(0.511 MeV)+26.051 MeV (105)

₉₄²⁴¹Pu(224543.011 MeV)+2Y(939.233 MeV)=₉₅²⁴³Am(226410.218 MeV)+3e⁻(0.511 MeV)+9.726 MeV (106)

₉₅²⁴³Am(226410.218 MeV)+Y(939.233 MeV)=₉₆²⁴⁴Cm(227342.990 MeV)+2e⁻(0.511 MeV)+5.439 MeV (107)

₉₆²⁴⁴Cm(227342.990 MeV)+3Y(939.233 MeV)=₉₇²⁴⁷Bk(230144.509 MeV)+4e⁻(0.511 MeV)+14.136 MeV (108)

₉₇²⁴⁷Bk(230144.509 MeV)+4Y(939.233 MeV)=₉₈²⁵¹Cf(233879.129 MeV)+5e⁻(0.511 MeV)+19.757 MeV (109)

₉₈²⁵¹Cf(233879.129 MeV)+3Y(939.233 MeV)=₉₉²⁵⁴Es(236681.468 MeV)+4e⁻(0.511 MeV)+13.316 MeV (110)

Although equations 13 through 110 are all derived using the Light Negatron (Y) because of its high reactivity with newly-formed positively-charged nuclei, the equations can also be written using a combination of heavy Negatrons (Y#) and Virtual Neutrons (X) with the results being the same. Only the chemical elements to and including Einsteinium are shown in the above equations. The equations clearly establish the pattern of fusions that take place from common hydrogen to the chemical element, atomic number 99, of the Periodic Table. The Transuranic elements (atomic number 99 and above) do not occur naturally, but can be produced artificially and are certainly produced by fusions, as indicated by the sequence of fusions exhibited in the sequential equations of fusions from atomic number 2 through atomic number 99. Energy required for the fusions that take place beyond iron (atomic number 56) is supplied by the powerful electrostatic attractive field of the newly-formed positively-charged nuclei and the negatively charged Negatrons, along with the resonant energy imparted to those particles by the irradiating electromagnetic forces.

### Evidence

Certain evidence in support of the occurrence of nuclear fusion of common hydrogen will now be presented.

As background, the spectrum of frequencies and wavelengths radiated by each chemical element are as unique to that element as DNA is unique to its biological source. Stated differently, the spectrum of frequencies and their wavelengths are absolutely unique to the chemical element that was their originating source. Thus, by examining the radiated spectrums from any source, the chemical elements within the source can be determined.

When there are helium spectral lines within the spectrums from common hydrogen fusion experiments, one can state with certainty that helium was produced from the common hydrogen fusions, as no helium was present within the source or reactor's atmosphere before the fusions took place. Helium is chemically inert, so it is not found chemically united with any other chemical element.

It should be noted that a fusion-formed chemical element's spectrographic lines can only be detected by a spectrometer, when the chemical element has escaped from the Special Dynamic Material Environment and has formed its atom's atomic electron structure.

Independent of any possible concerns about the accuracy of the theory presented herein, the only consequence of any merit is the absolute scientific fact that the spectrographic evidence shows that the spectral lines from the chemical elements of the Periodic Table are found within the visual spectrums produced by the fusions of common hydrogen. Spectrographic images are shown for all of the chemical elements from hydrogen to and including Einsteinium (atomic number 99), which clearly establishes the pattern of evidence that each of the chemical elements of the Periodic Table is in fact produced by the nuclear fusion of common hydrogen as proposed by the Peery Theory.

The transuranic elements (atomic number 99 and above) do not occur naturally, but can be produced artificially. Those elements are Fermium, Mendelevium, Nobelium, Lawrencium, Rutherfordium, Dubnium, Seaborgium, Bohrium, Hassium, Meitnerium, Darmstadtium, Roentgenium, Copernicium, Ununtrium, Ununquadium, Ununpentium, Ununhexium, Ununseptium and Ununoctium. There are no spectrographic spectrums available for these transuranic elements, so spectrographic proof of their production cannot be provided. Nevertheless, the previously-presented evidence of the Peery Theory would strongly indicate that even the transuranic elements are produced by the common hydrogen fusion process. It is speculated that some elements heavier than atomic number 118 may be produced. One or more of these elements may be stable and, therefore, detectable.

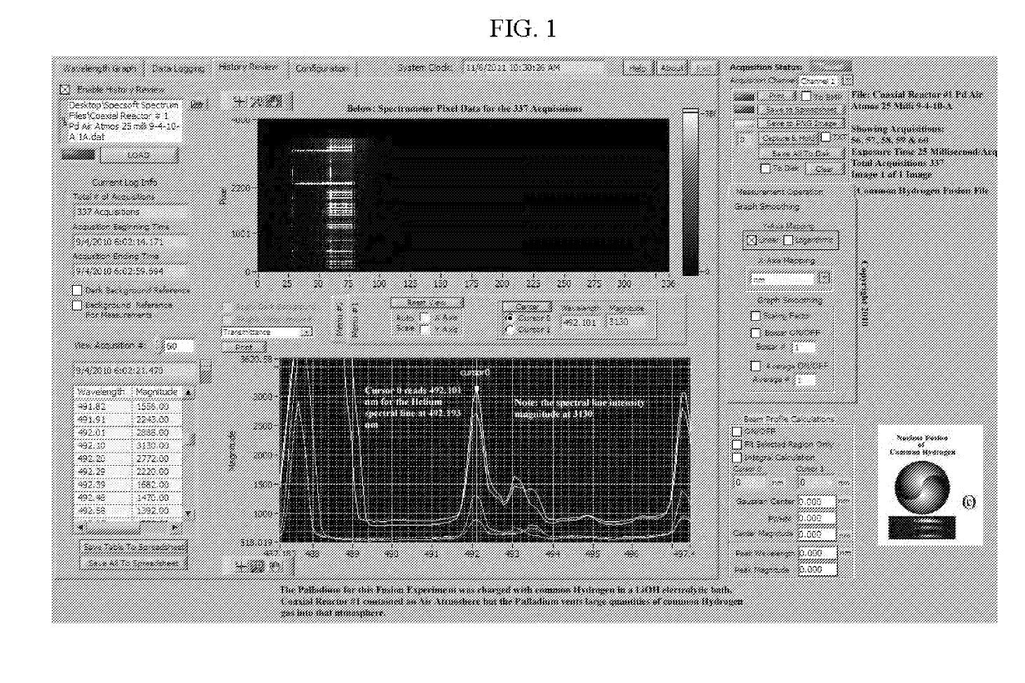

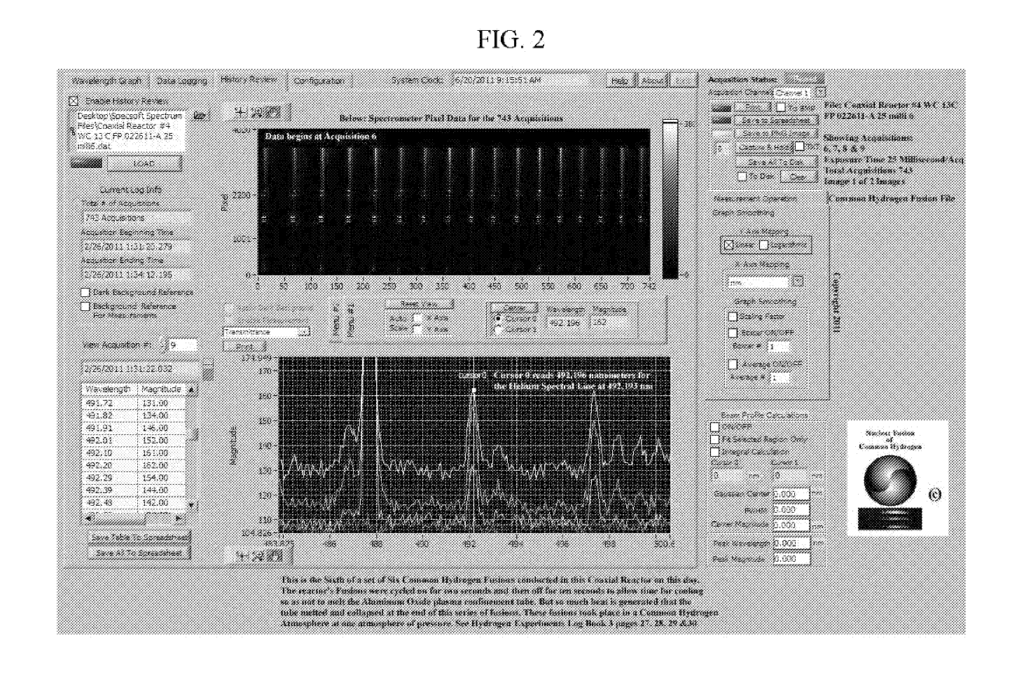

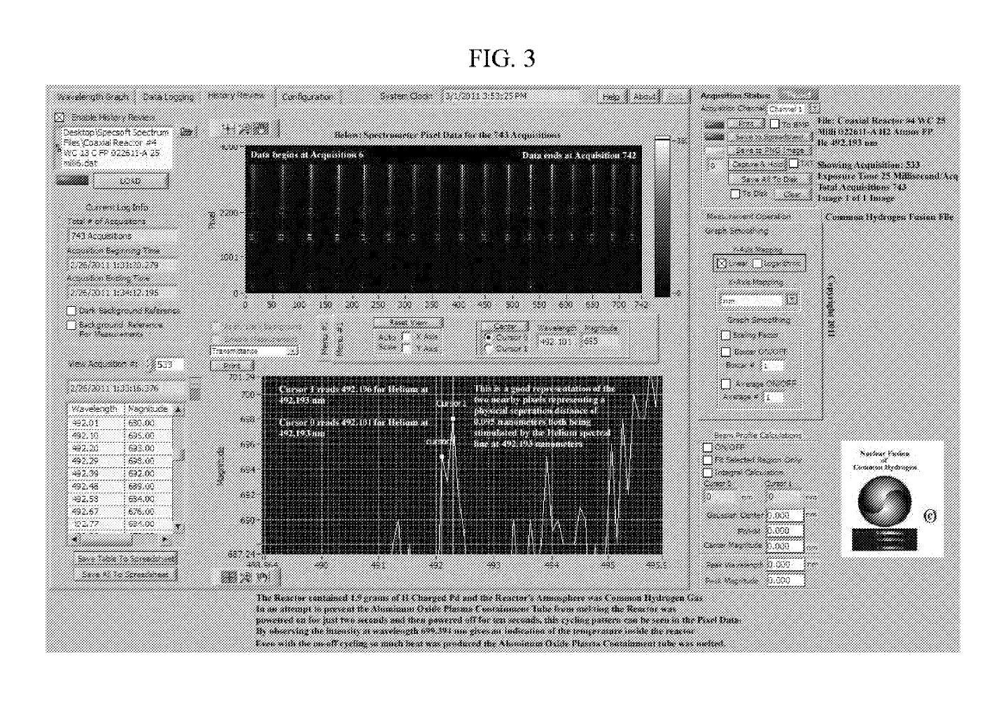

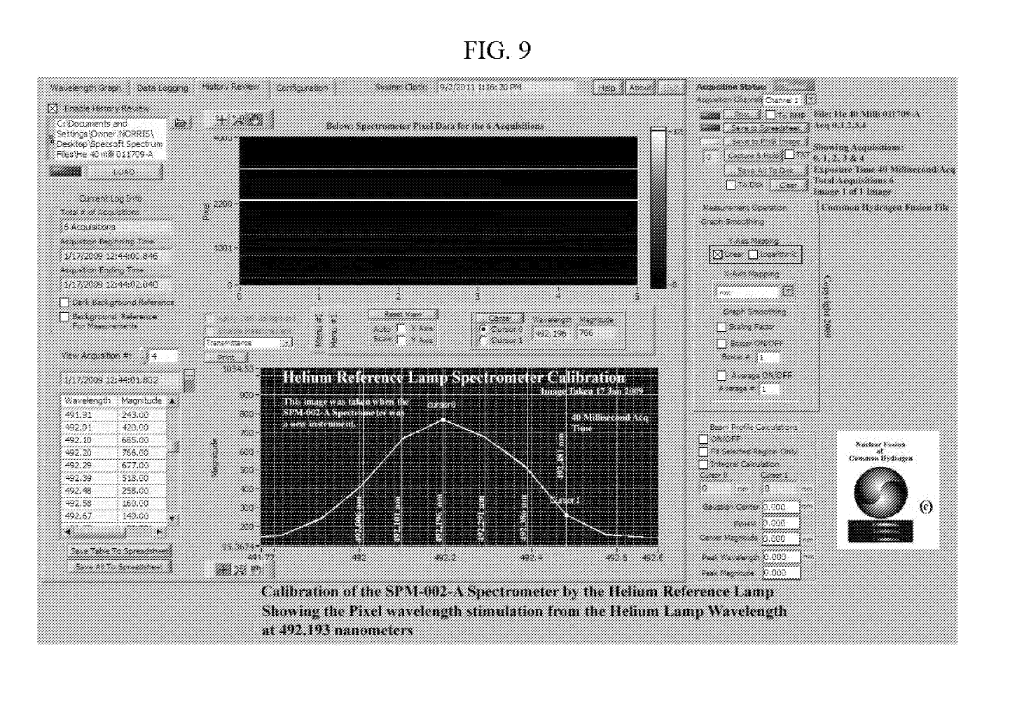

FIG. 1 is a spectrographic image (internal file name: Coaxial Reactor #1 Pd Air Atmos 25 Milli 9-4-10-A 1A 6) and shows fusion acquisitions 56, 57, 58, 59 and 60. The spectrometer (SPM-002-A) exposure time was set at 25 milliseconds per acquisition. Cursor 0 reads 492.101 nanometers at a magnitude of 3130, which is the helium spectral line at 492.193 nanometers. The common hydrogen fusions to form helium predominantly stimulate the production of the helium spectral line at 492.193 nanometers, although other helium spectral lines are stimulated to a lesser degree. Reference should be made to FIG. 9 for calibration data of the SPM-002-A spectrometer.

FIG. 2 is a spectrographic image (internal file name: Coaxial Reactor #4 WC 13C FP 022611-A 25 Milli) and shows acquisitions 6, 7, 8 and 9. The spectrometer (SPM-002-A) exposure time was set at 25 milliseconds per acquisition. Cursor 0 reads 492.196 nanometers at a magnitude of 162.

As can be seen in the spectrometer pixel data, the actual fusion of common hydrogen was cycled on and off, demonstrating that the fusion process can be finely controlled. The fusion process is controllable by cycling the RF electromagnetic stimulation, on or off, within microseconds of the RF electromagnetic stimulation being applied or removed.

FIG. 3 is a spectrographic image (internal file name: Coaxial Reactor #4 WC 25 Milli 022611-A H2 Atinos FP He 492.193 nm) and shows acquisition 533. Cursor 0 reads 492.101 nanometers at a magnitude of 695 and Cursor 1 reads 492.196 nanometers. The figure is a good representation of two adjacent pixels separated by 0.095 nanometers both being stimulated by the helium spectral line at 492.193 nanometers.

As can be seen in the spectrometer pixel data, the actual fusion of common hydrogen was cycled on and off, demonstrating that the fusion process can be finely controlled. The fusion process is controllable by cycling the RF electromagnetic stimulation, on or off, within microseconds of the RF electromagnetic stimulation being applied or removed.

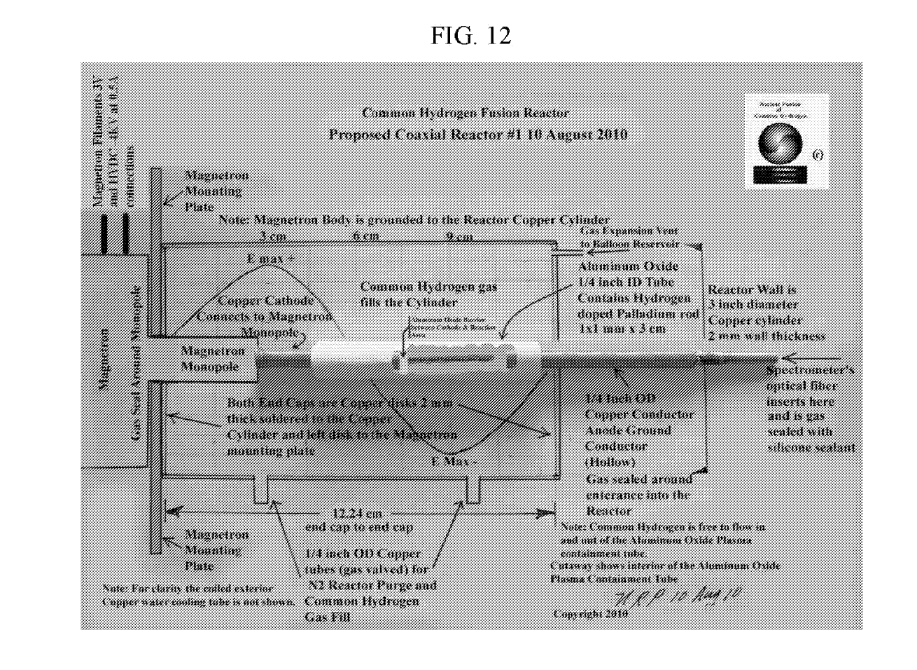

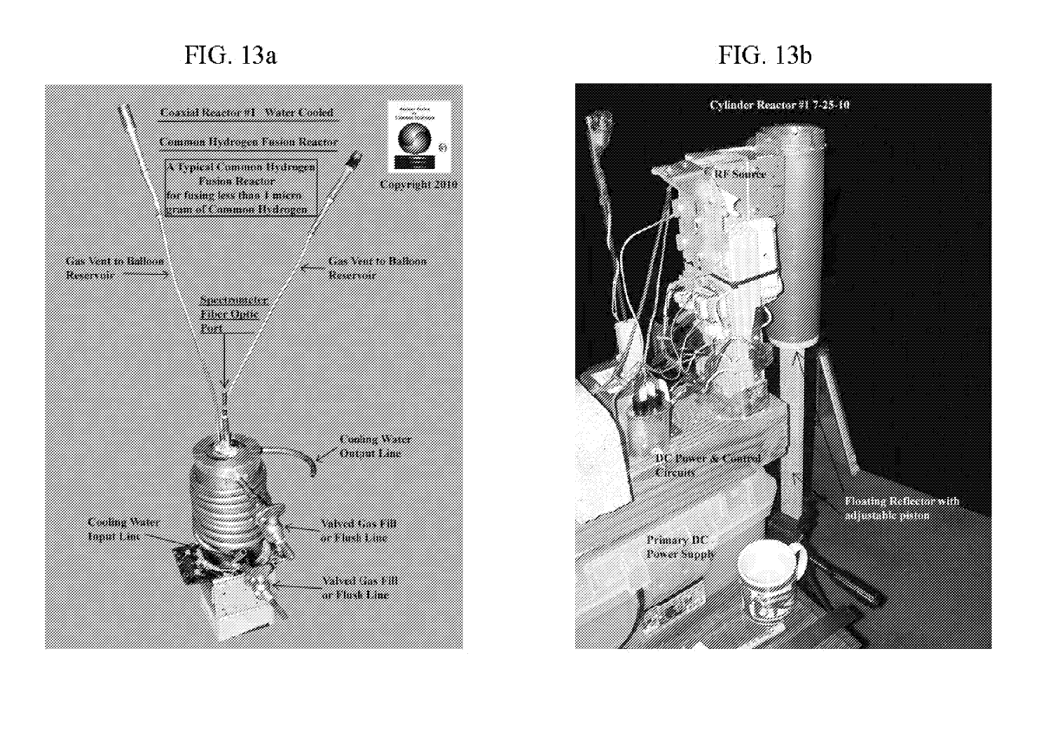

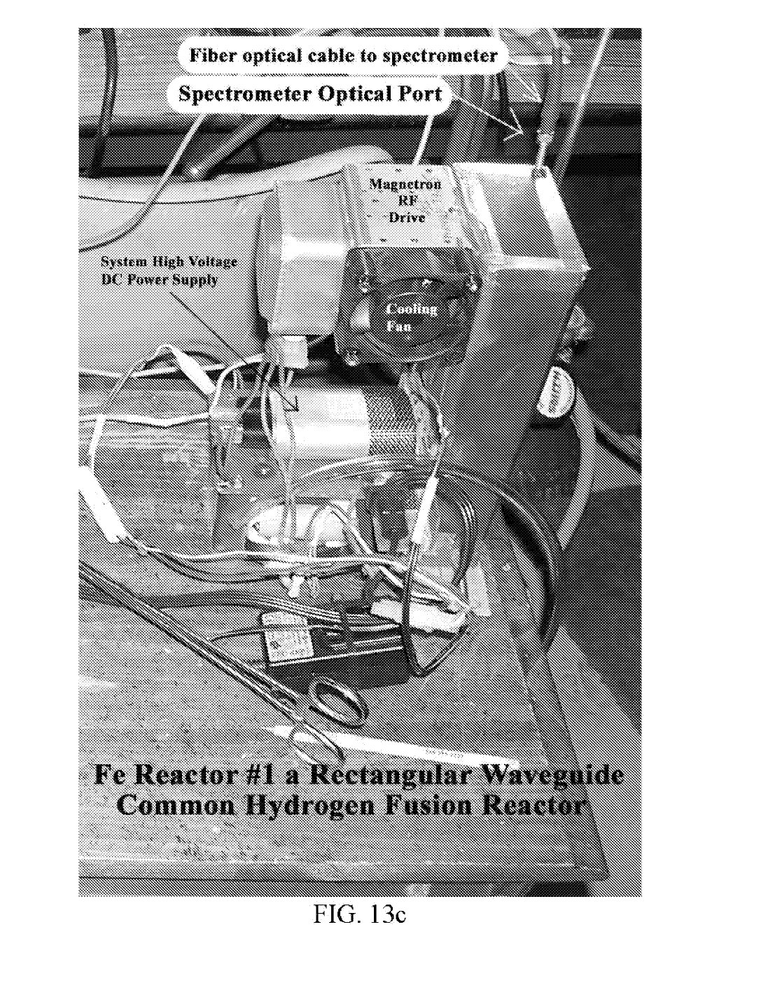

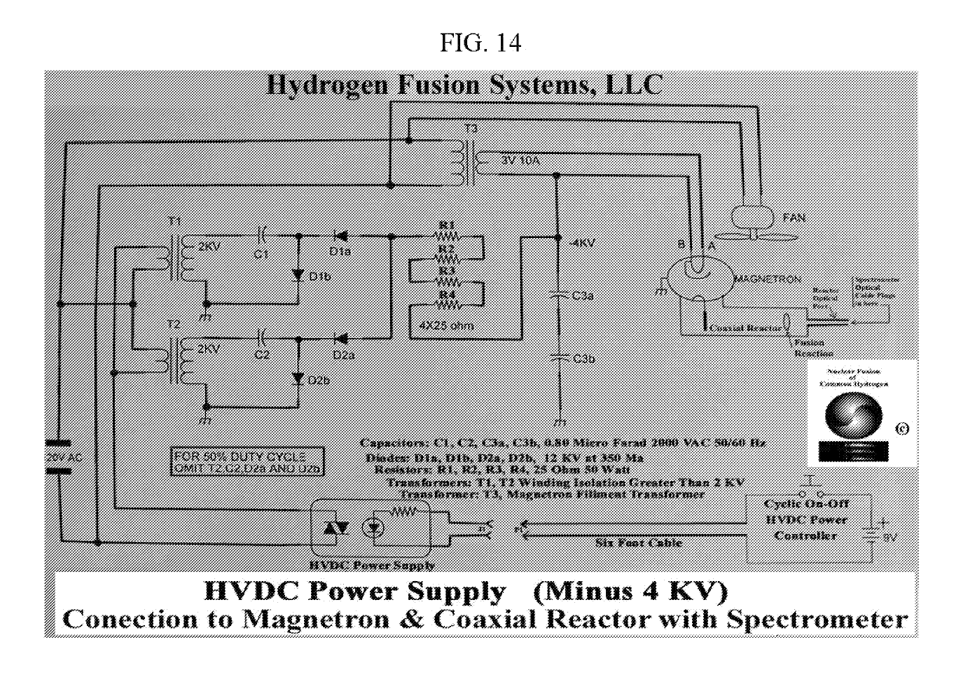

The type of coaxial reactor used to generate the data in FIGS. 1-3 can be seen in FIG. 12 and FIG. 13 (a).

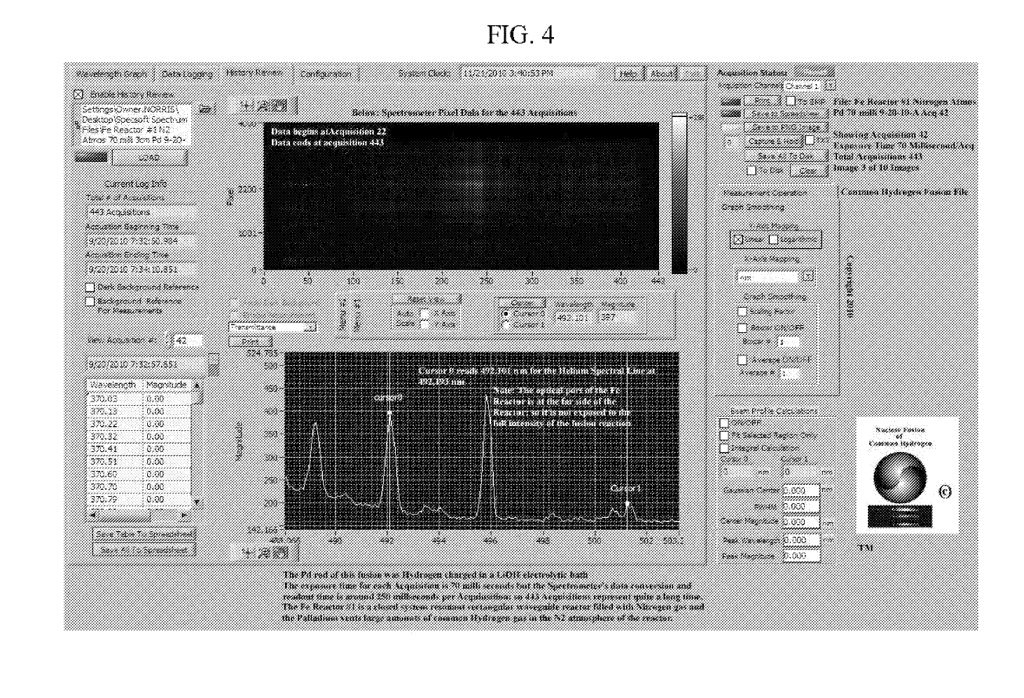

FIG. 4 is a spectrographic image (internal file name: Fe Reactor #1 Nitrogen Atmos Pd 70 Milli 9-20-10-A 492.101B&W) and shows acquisition 42. Cursor 0 reads 492.101 nanometers at a magnitude of 397. This is for the helium spectral line at 492.193 nanometers. There were 443 total acquisitions with the acquisition exposure time set at 70 milliseconds per acquisition. The reactor used to generate the data in FIG. 4 is a closed system resonant rectangular waveguide reactor, as can be seen in FIG. 13(c).

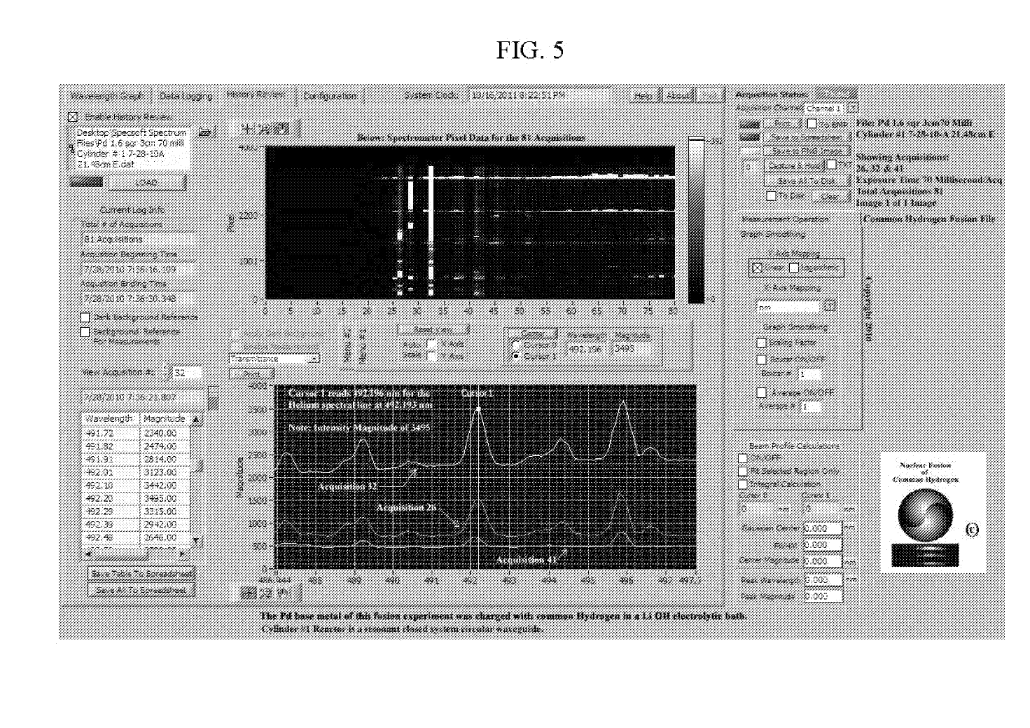

FIG. 5 is a spectrographic image (internal file name: Pd 1.6 sqr 3 cm 70 Milli Cylinder #1 7-28-10-A 21.48 cm E) and shows acquisitions 26, 32 and 41. Cursor 1 reads 492.196 nanometers at a magnitude of 3495 for the helium spectral line at 492.193 nanometers. The reactor used to generate the data in FIG. 5 is a resonant closed system circular waveguide reactor, as can be seen in FIG. 13(b).

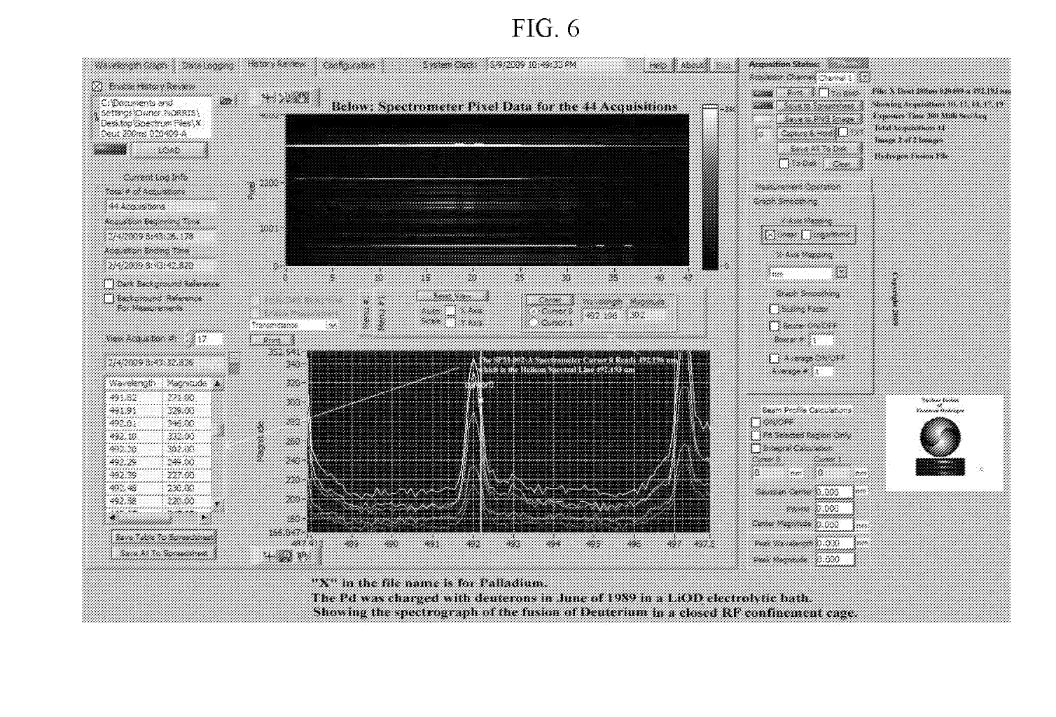

FIG. 6 is a spectrographic image (internal file name: X Deut 200 ms 020409-A 492.193 image 2 of 2) and shows acquisitions 10, 12, 14, 17 and 19. The “X” in the file name is for palladium. The palladium was loaded with deuterons in June of 1989. Cursor 0 reads 492.196 nanometers, but as can be seen the spectral peak is at 492.101 nanometers at a magnitude of 345, which is for the helium spectral line at 492.193 nanometers. This deuterium fusion was conducted in a resonant closed system RF confinement cage.

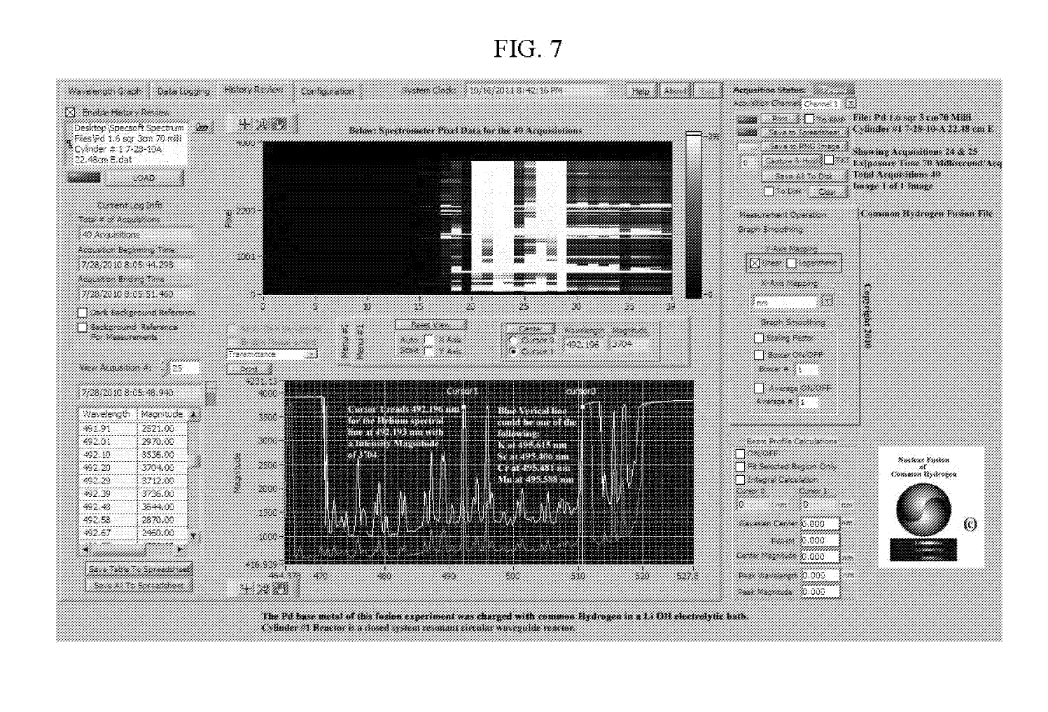

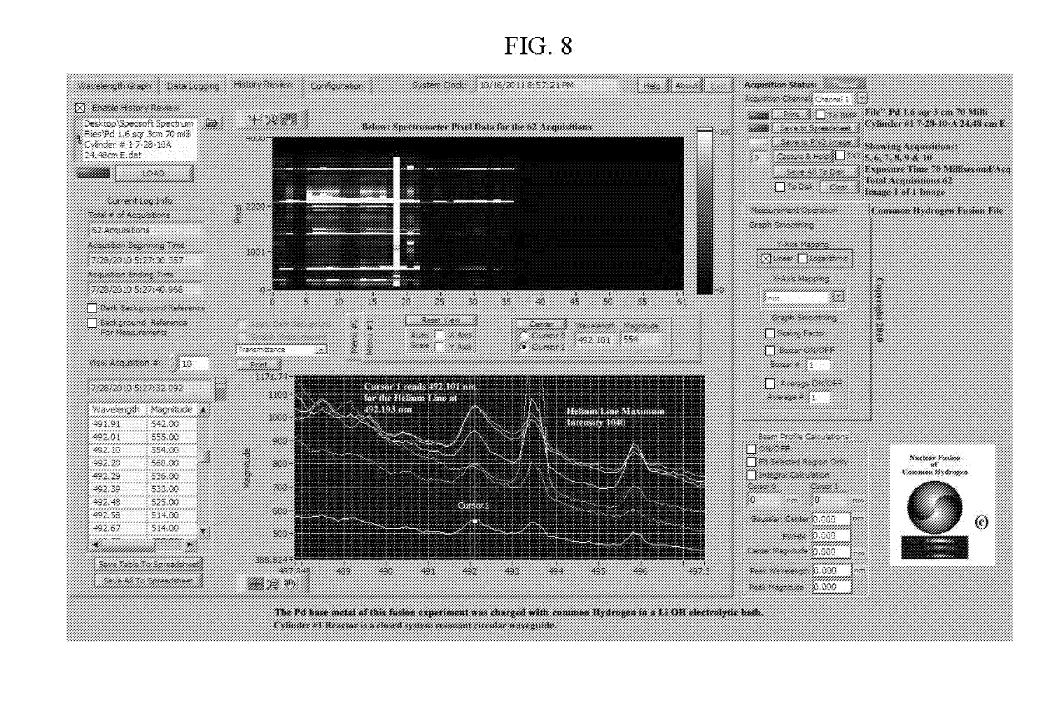

FIG. 7 is a spectrographic image (internal file name: Pd 1.6 sqr 3 cm 70 Milli Cylinder #1 7-28-10-A 22.48 cm E) and shows acquisitions 24 and 25. Cursor 1 reads 492.196 nanometers at a magnitude of 3704 for the helium spectral line at 492.193 nanometers. The spectrometer exposure time was set at 70 milliseconds per acquisition. The type of reactor used to generate the data in FIG. 7 is a closed system resonant circular waveguide reactor as seen in FIG. 13 (b).

FIG. 8 is a spectrographic image (internal file name: Pd 1.6 sqr 3 cm 70 Milli Cylinder #1 7-28-10-A 24.48 cm E) and shows acquisitions 5, 6, 7, 8, 9 and 10. Cursor 1 reads 492.101 nanometers at a maximum magnitude of 1040 for the helium spectral line at 492.193 nanometers. The exposure time for the spectrometer (SPM-002-A) was set at 70 milliseconds per acquisition. Sixty-two total acquisitions were captured.

FIG. 9 is a spectrographic image (internal file name: He 40 Milli 011709-A) and shows acquisitions 0, 1, 2, 3 and 4. The spectrographic image captures the helium reference lamp data for the spectral line at 492.193 nanometers in connection with calibrating the spectrometer (SPM-002-A). The exposure time was set at 40 milliseconds per acquisition.

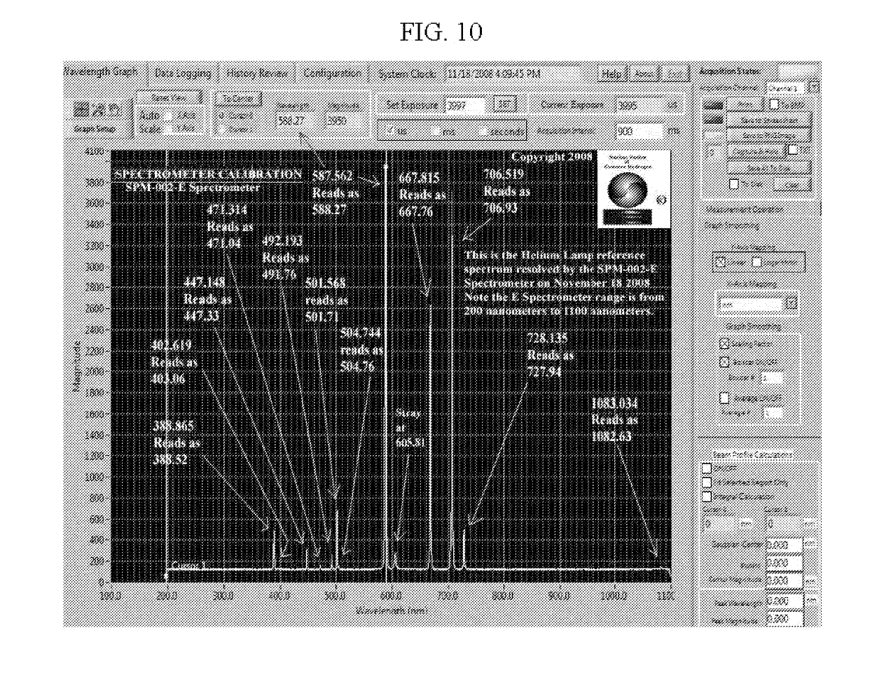

FIG. 10 is a spectrographic image for the calibration of the spectrometer (SPM-002-E) showing the full helium lamp spectrum in the range of 200 nanometers through 1100 nanometers.

FIG. 11 is a screen capture of the data from a digital Geiger counter (AW-SRAD) showing radiation data obtained on Thursday, Apr. 12, 2007 at 11:54:34 a.m. The radiation data was captured during a common hydrogen fusion to form helium. The average radiation was 12.25 micro Roentgen per hour, which is the normal background radiation for the laboratory.

FIG. 12 is drawing of a proposed version of common hydrogen fusion coaxial reactor #1, which was prepared on Aug. 10, 2010. This reactor is typical for coaxial fusion reactors 1, 2, 3, 4, 5, 6 and 7. It should be noted that, for clarity, the coiled exterior copper water cooling tube is not shown. This reactor, as built, is shown in FIG. 13(a) and is the reactor that was used to generate the spectrographic data for FIGS. 1-3. Note that, during the fusion process, the common hydrogen charged palladium rod vents approximately 69,120 cubic millimeters of common hydrogen gas into the coaxial reactor's interior volume.

FIGS. 13(a), 13(b) and 13(c) are various types of reactors built by the inventors for fusing common hydrogen to form helium.

FIG. 13(a) is a photographic image of a closed system resonant coaxial reactor (internal file name: Coaxial Reactor #1 Water Cooled). Coaxial Reactor #1 is typical of coaxial reactors 1, 2, 3, 4, 5, 6, and 7. These coaxial reactors are all copper metal reactors used for the fusion of less than one milligram of common hydrogen in experiments that test the validity of the (Peery Theory). This photographic image shows the coaxial reactor's exterior details and the copper water cooling tube.

FIG. 13(b) is a photographic image of a closed system resonant circular waveguide reactor (internal file name: Cylinder #1a Circular Waveguide Reactor). This is the reactor noted in many spectrographic images as “Pd 1.6 sqr 3 cm 70 Milli Cylinder #1 7-28-10-A.” FIG. 13(b) shows the electrically floating RF reflector mounted on an adjustable length piston assembly used for waveguide resonant tuning. Also shown is the DC power and control circuits and the primary DC power supply for delivering −4 KV of DC voltage. The spectrometer (SPM-002-A) optical port is located at the reactor's top central axis.

FIG. 13(c) is a photographic image of a closed system resonant rectangular waveguide reactor (internal file name: Fe Reactor #1a Rectangular Waveguide Reactor). FIG. 13(c) shows that the SPM-002-A spectrometer optical port is located at the extreme side corner of the reactor. Also shown are the magnetron (with magnetron cooling air fan), system high voltage power supply and the optical cable, which connects to the SPM-002-A spectrometer.

As described above, FIG. 14 illustrates a schematic diagram of an exemplary HVDC power supply for, among other things, supplying power to a source of microwave electromagnetic radiation (in this case, a magnetron) and for turning the fusion process on and off.

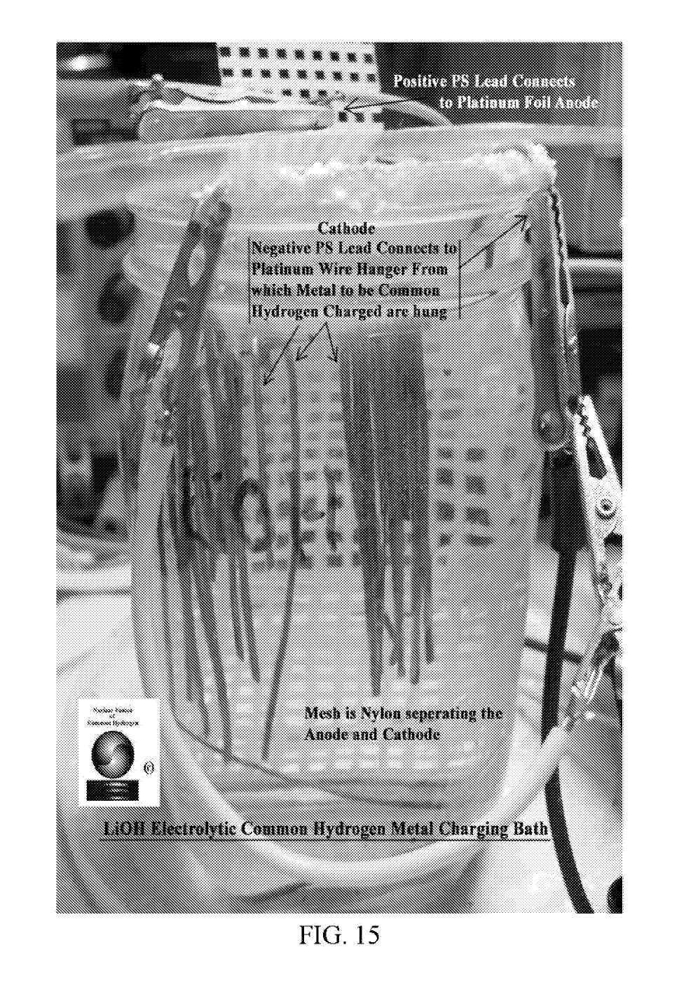

FIG. 15 is a photographic image showing palladium rods charging with common hydrogen in a distilled water and 5% lithium hydroxide (LiOH) electrolytic bath (internal file name: LiOH Electrolytic Common Hydrogen Charging Bath). The anode and cathode sections of the bath are separated by a nylon mesh.

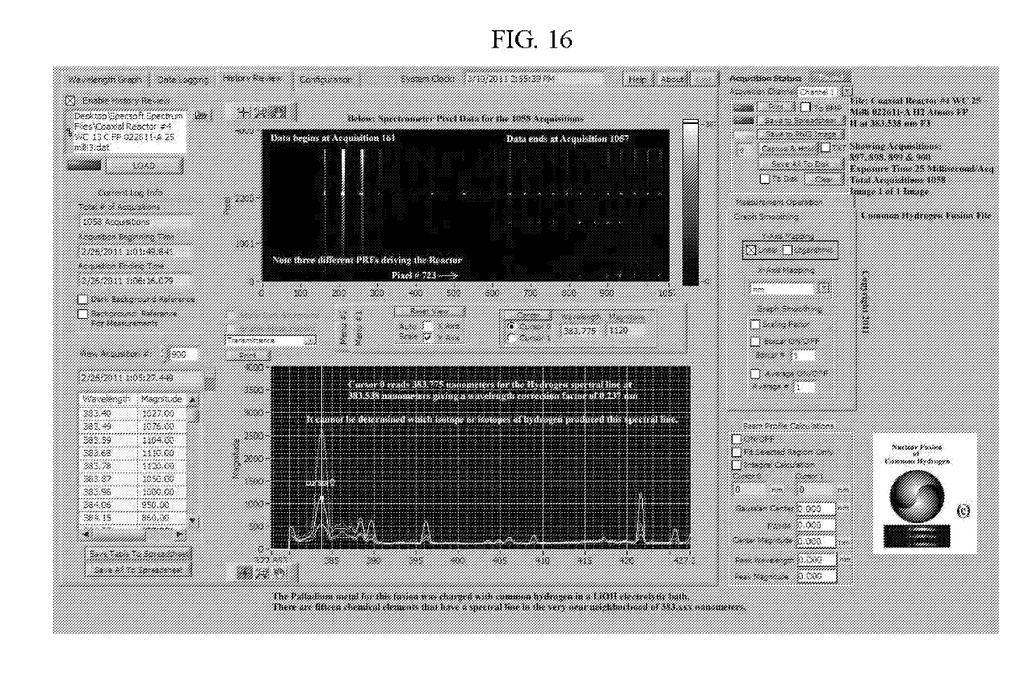

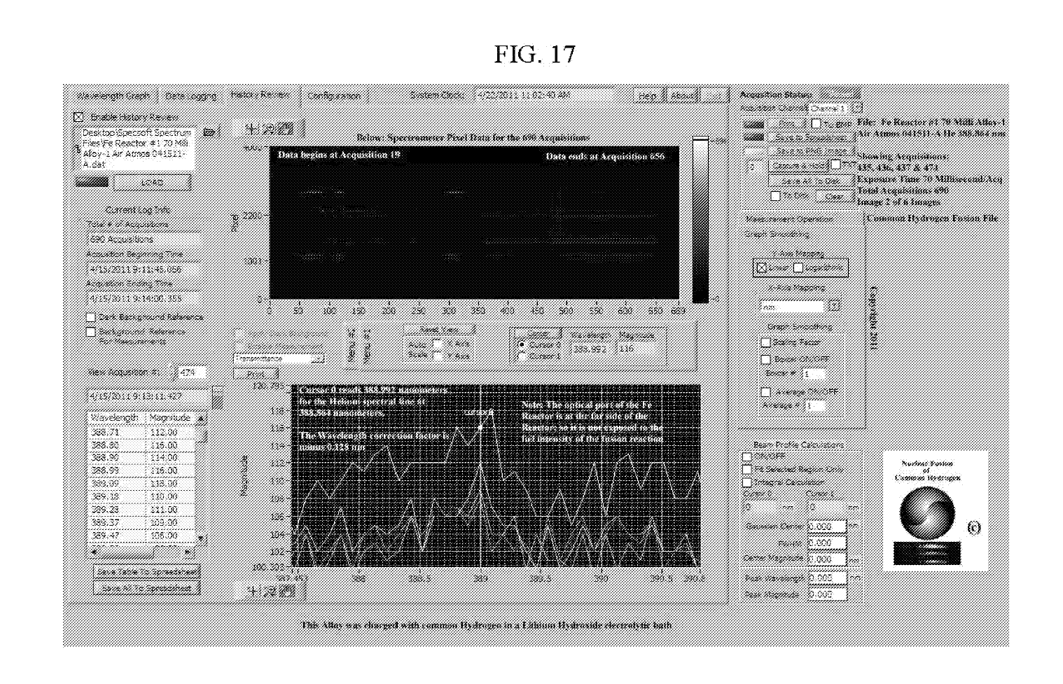

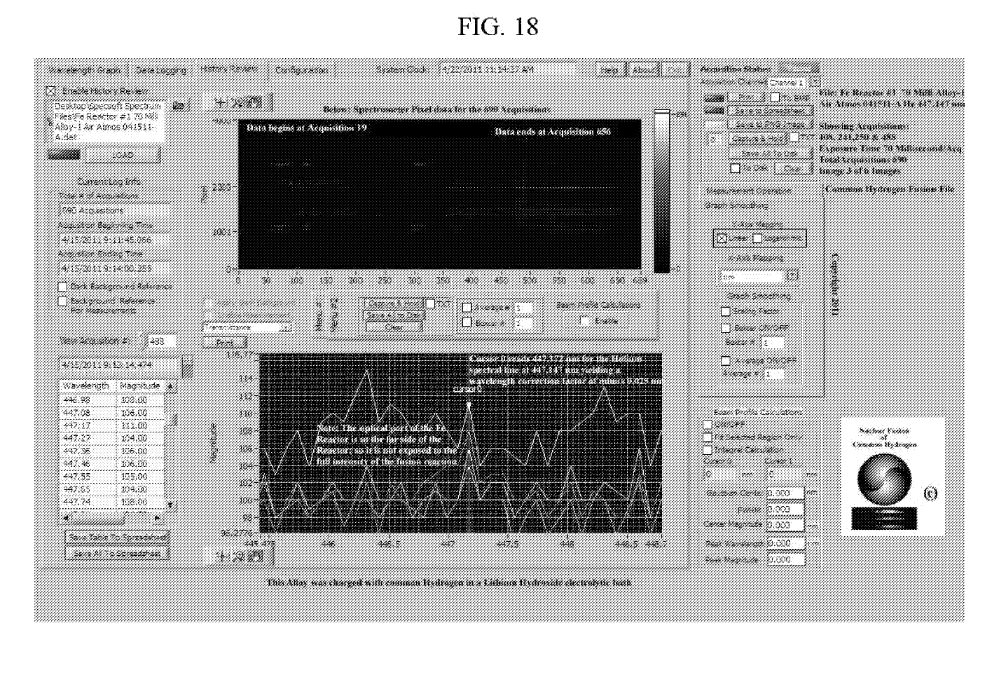

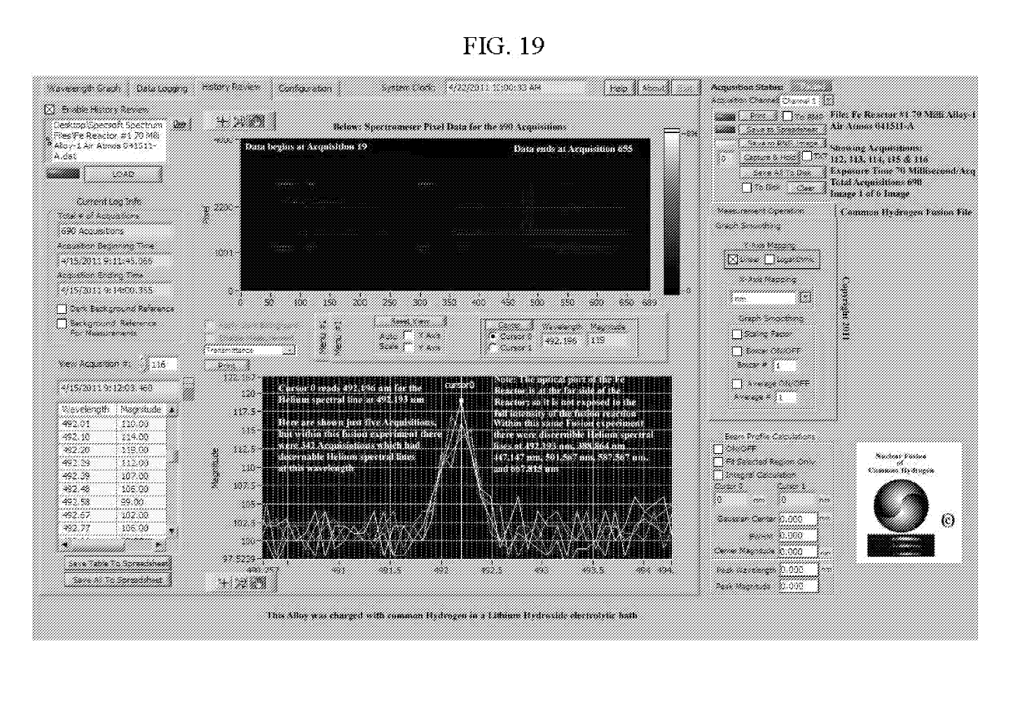

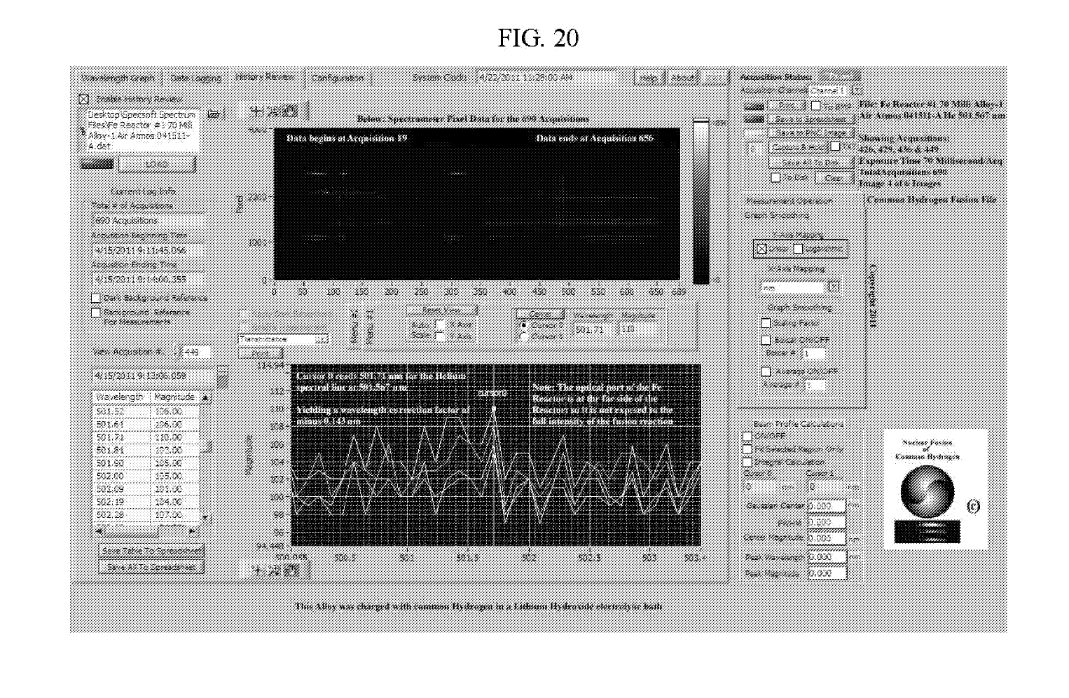

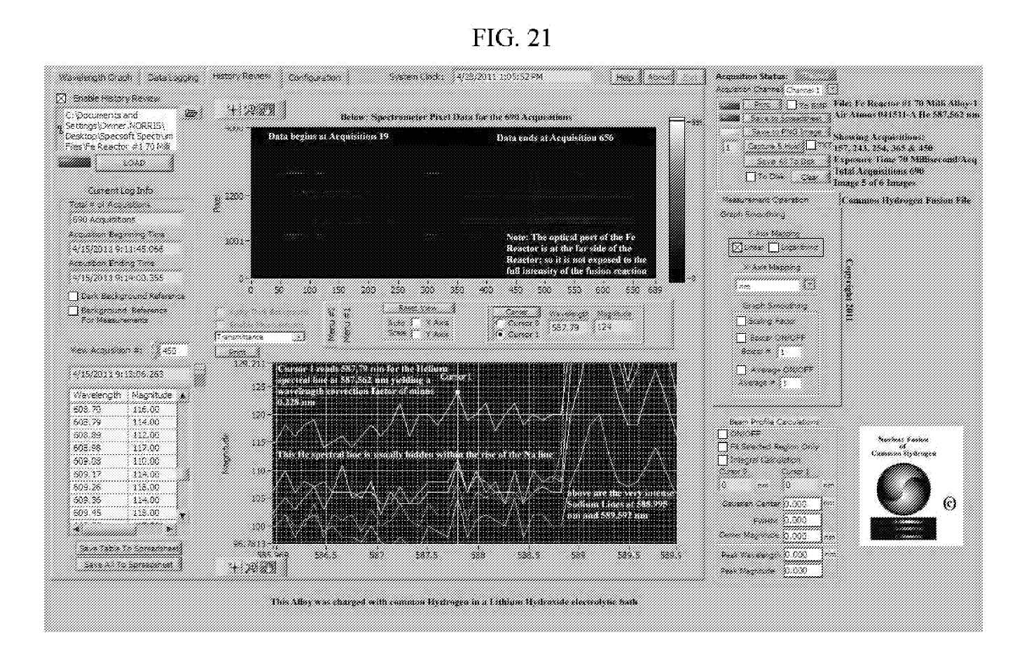

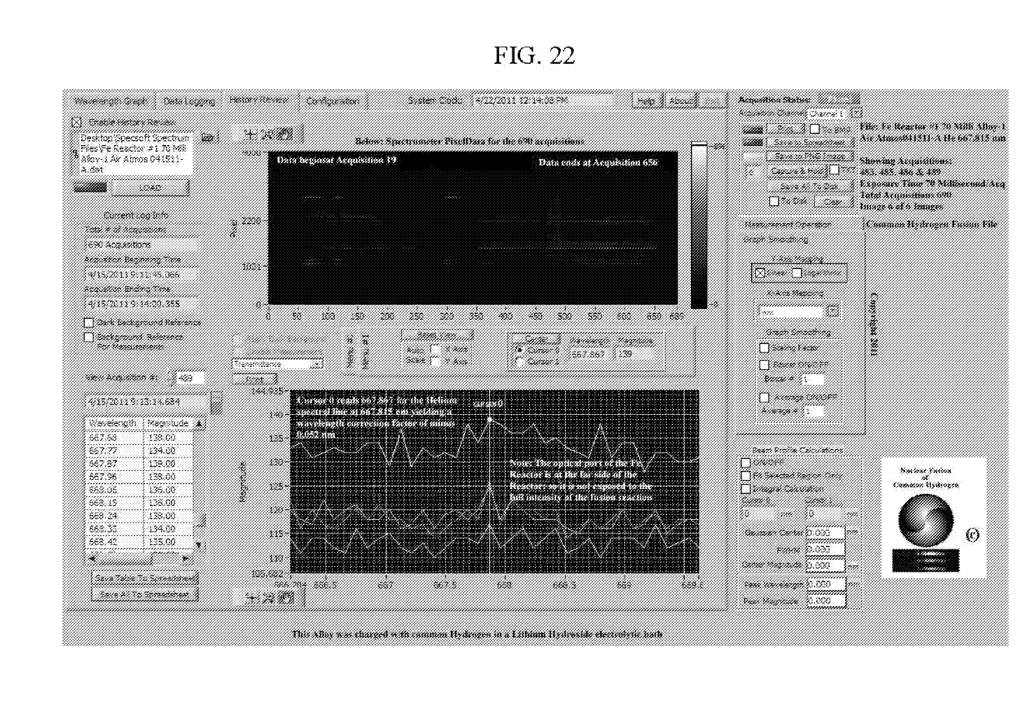

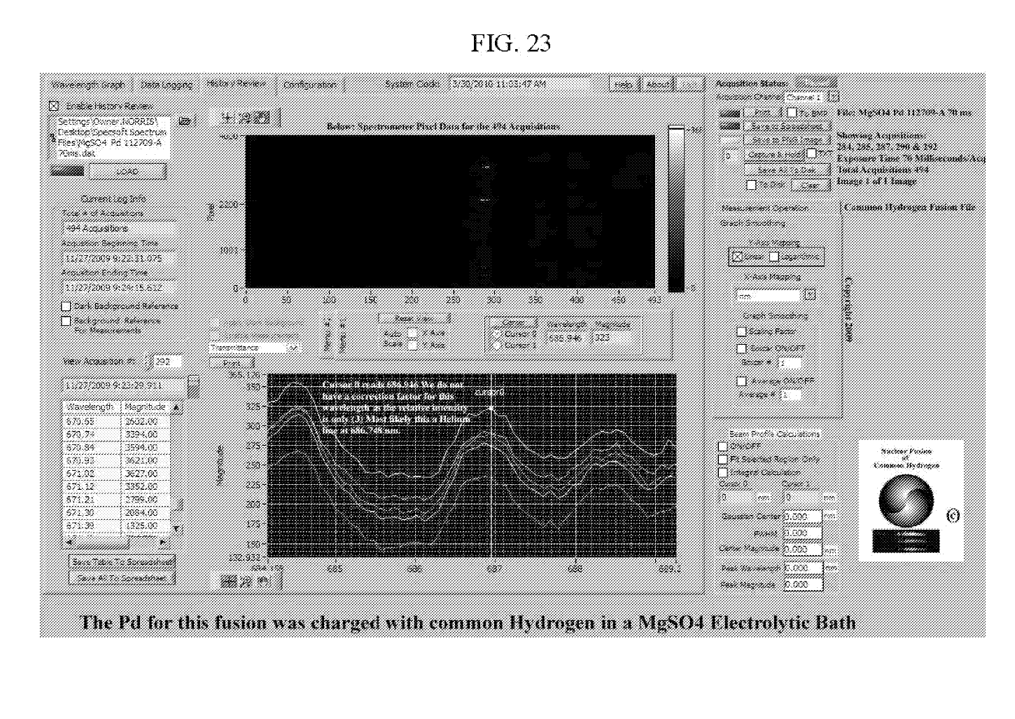

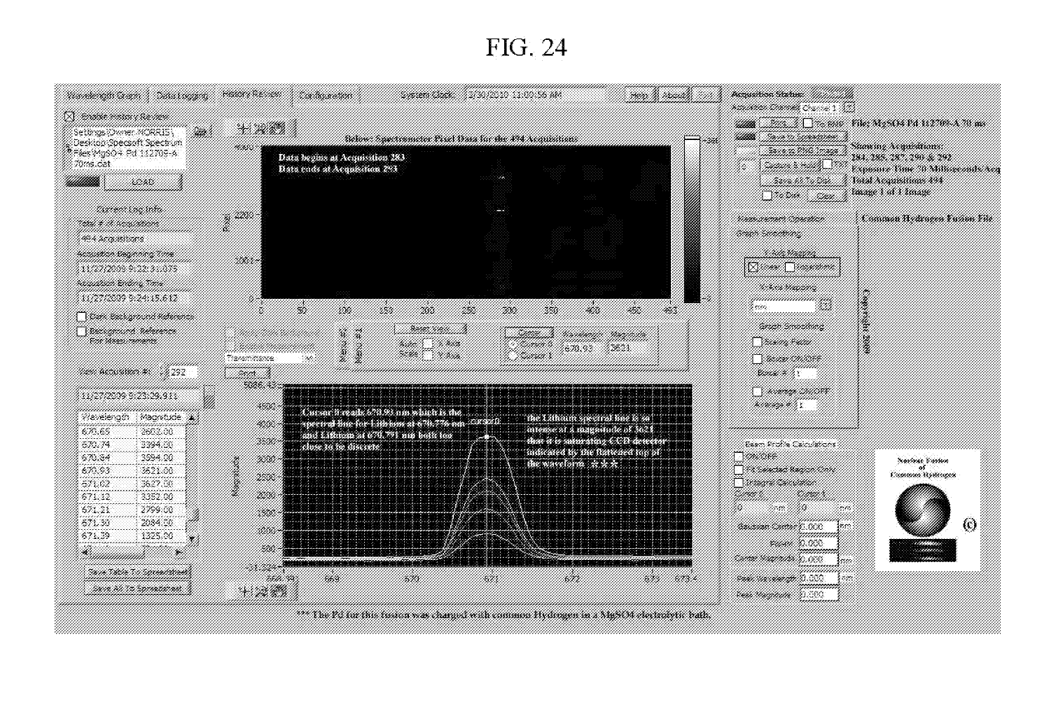

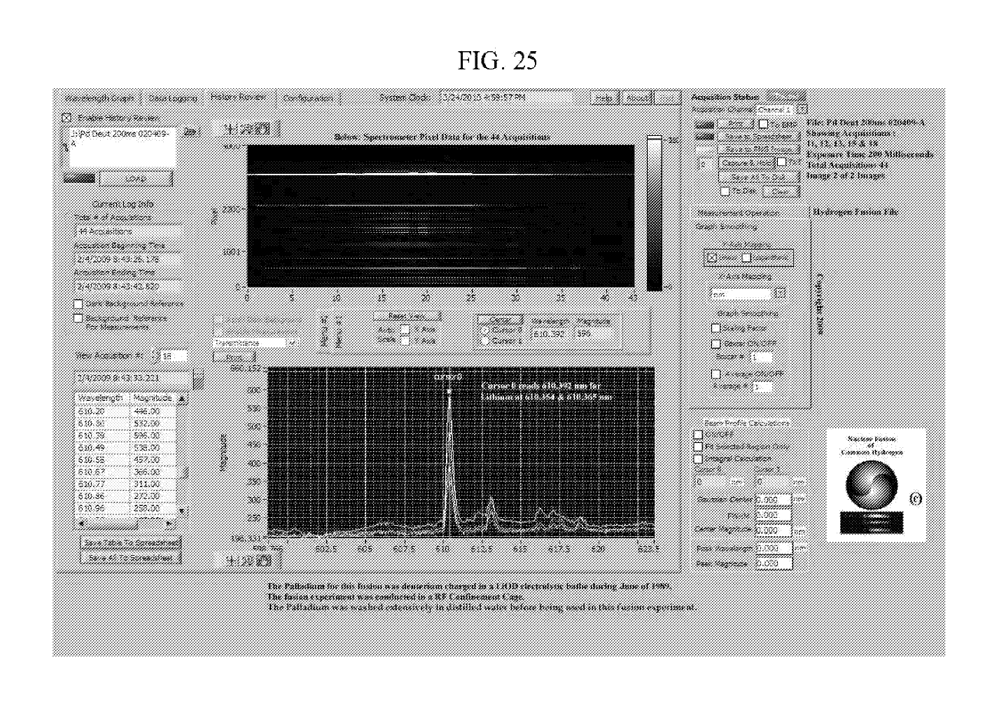

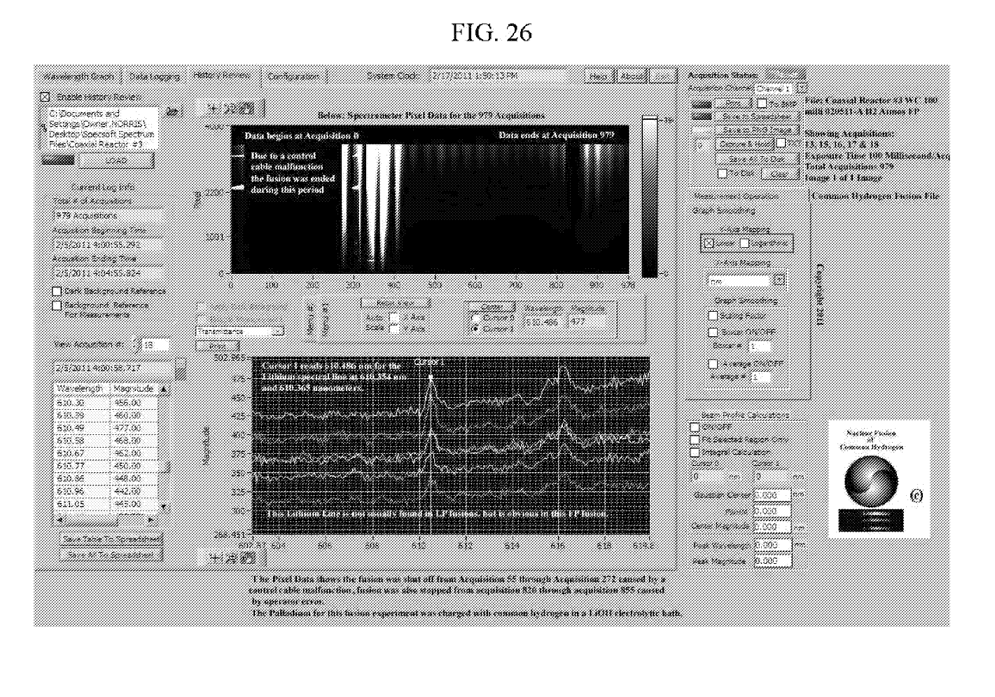

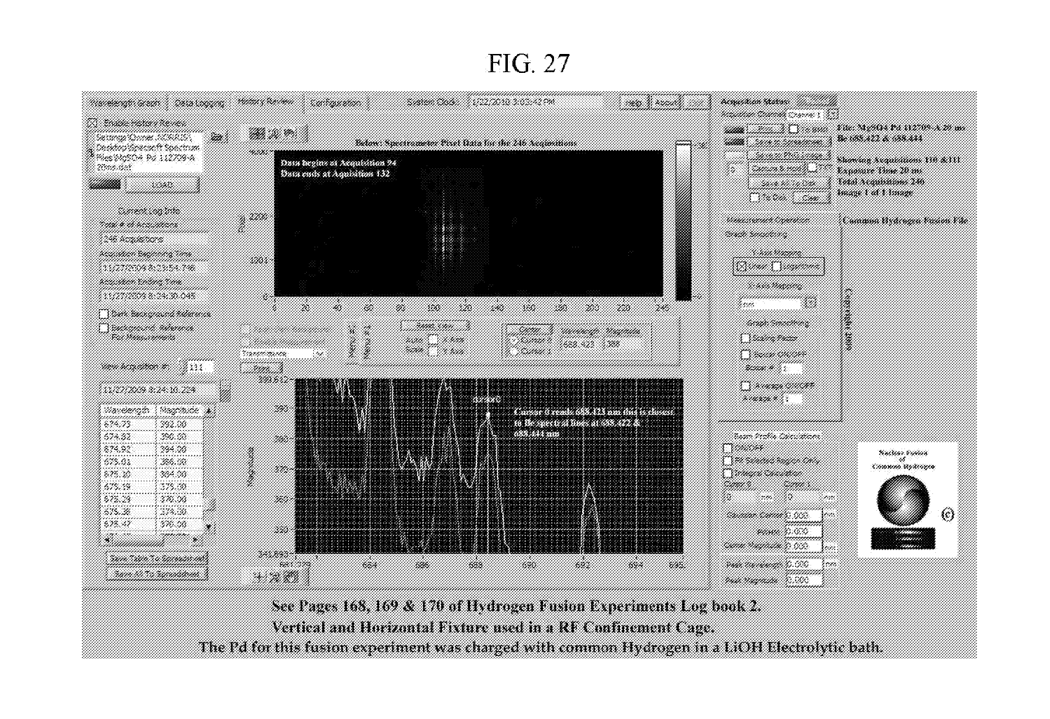

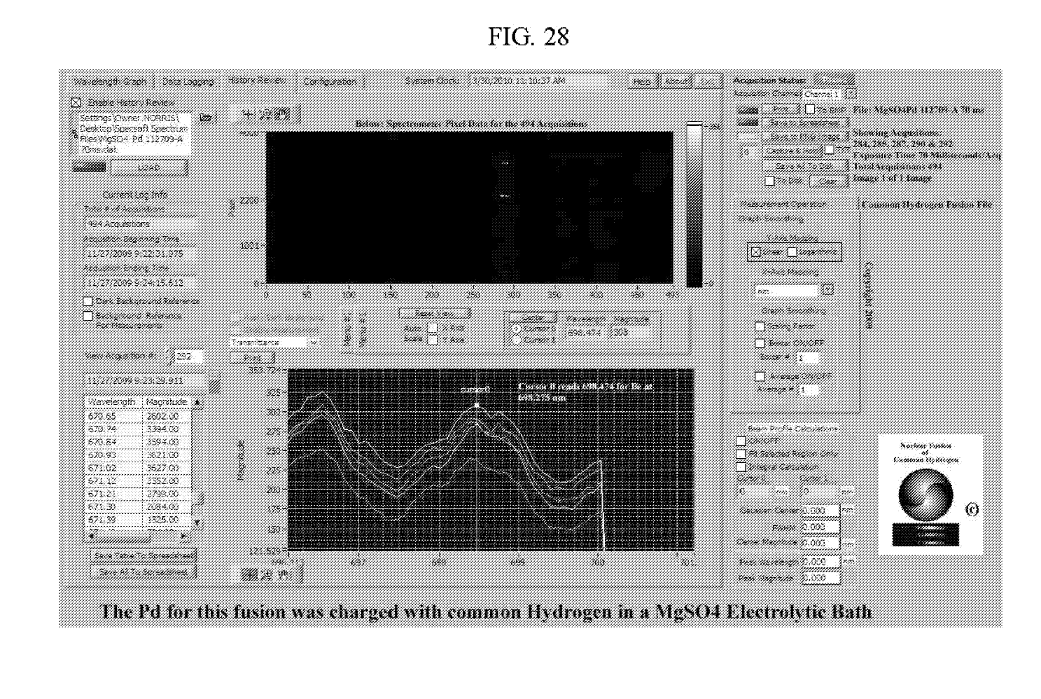

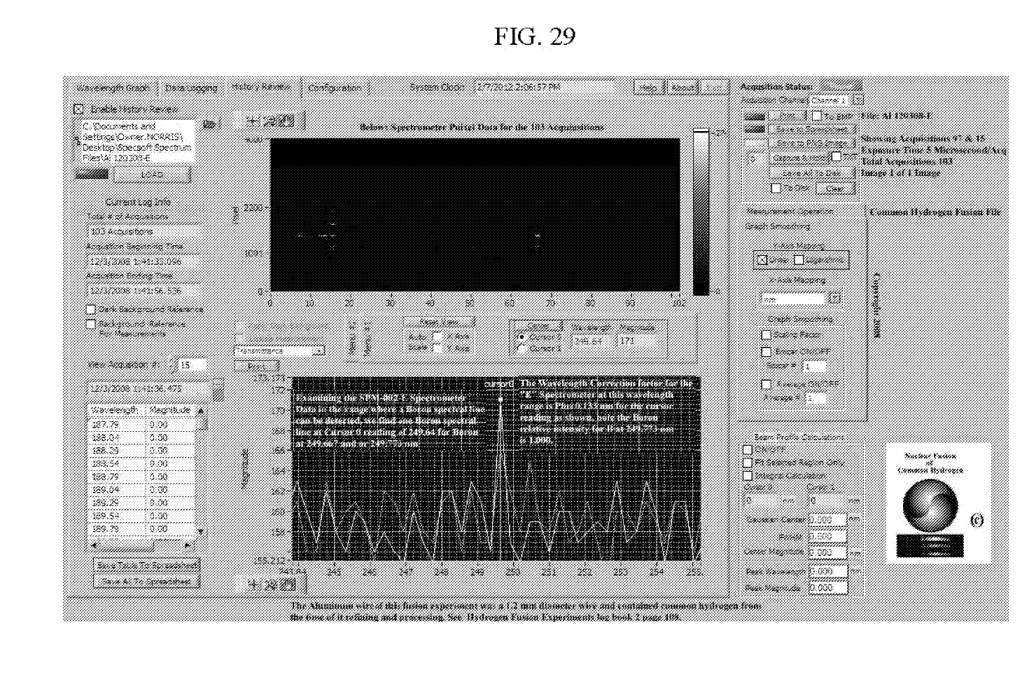

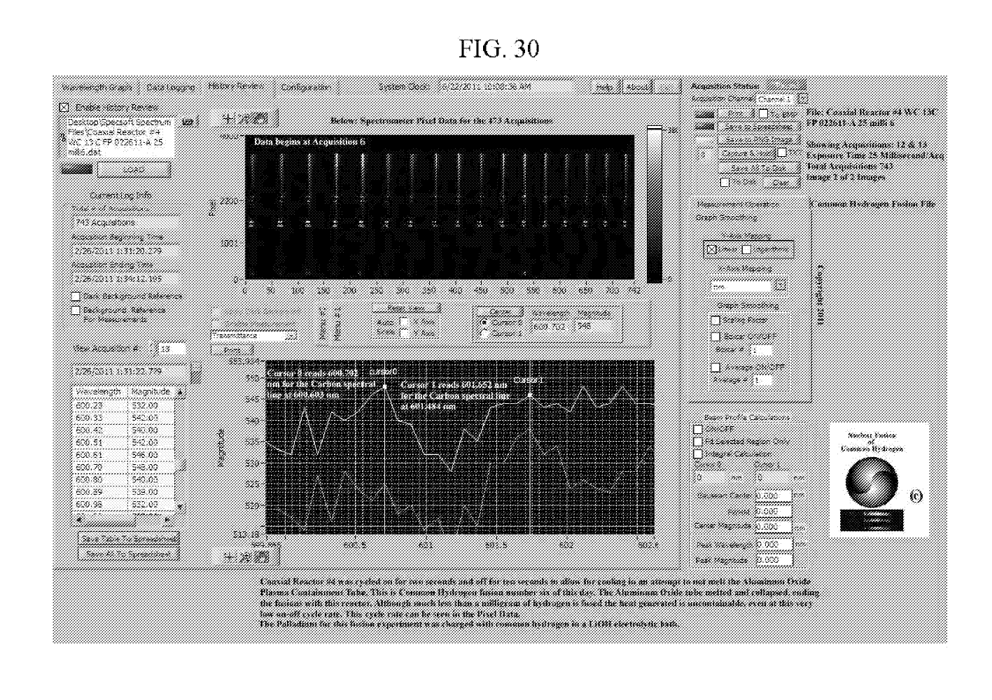

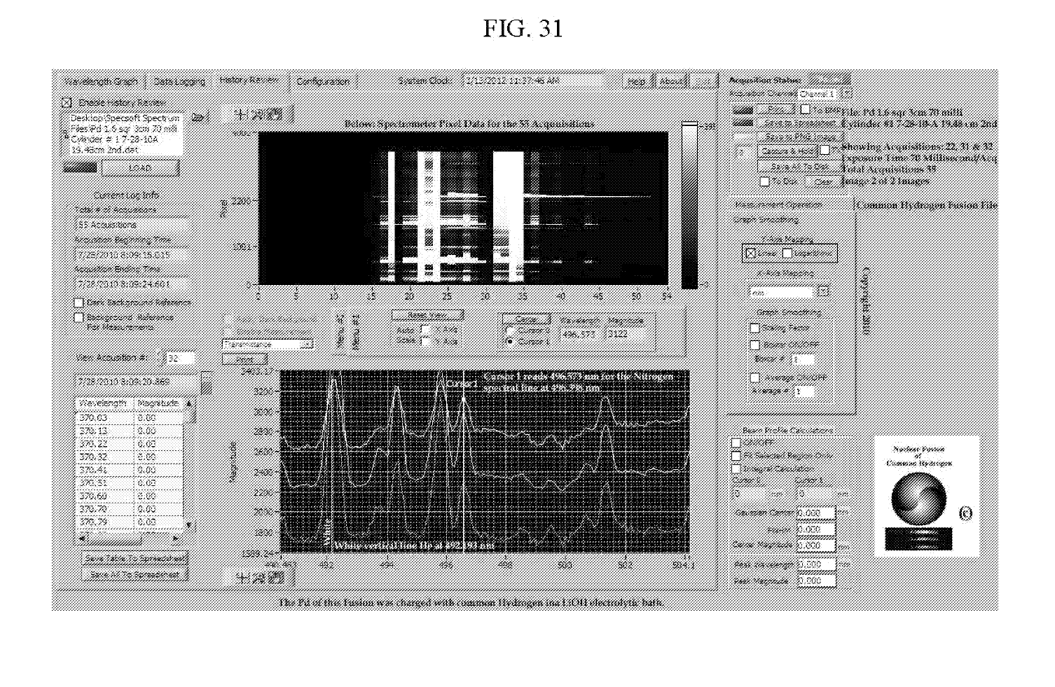

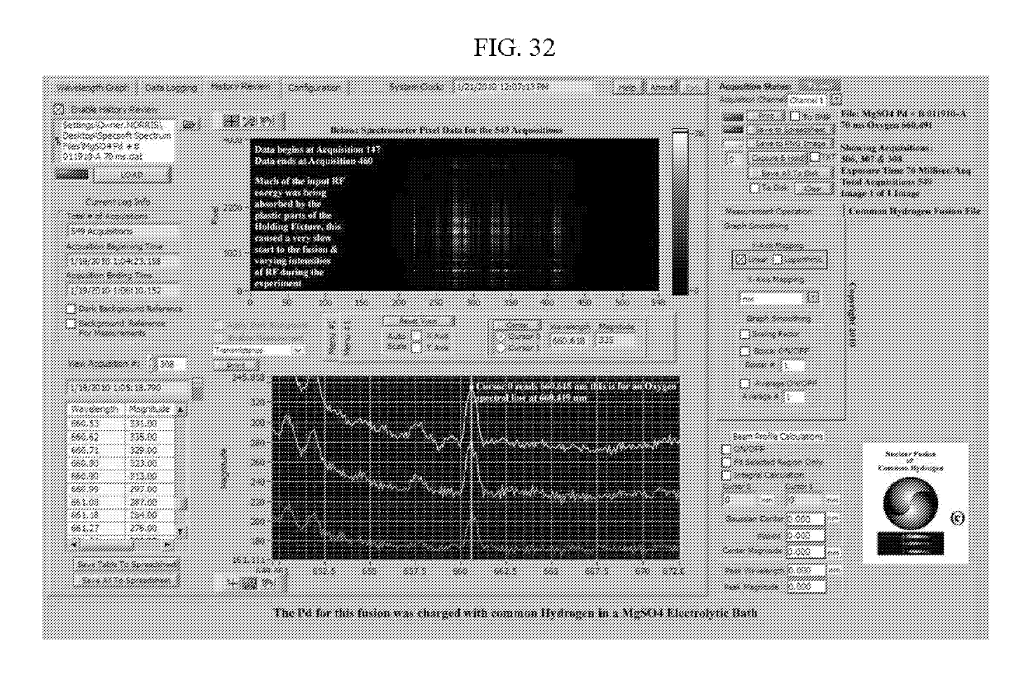

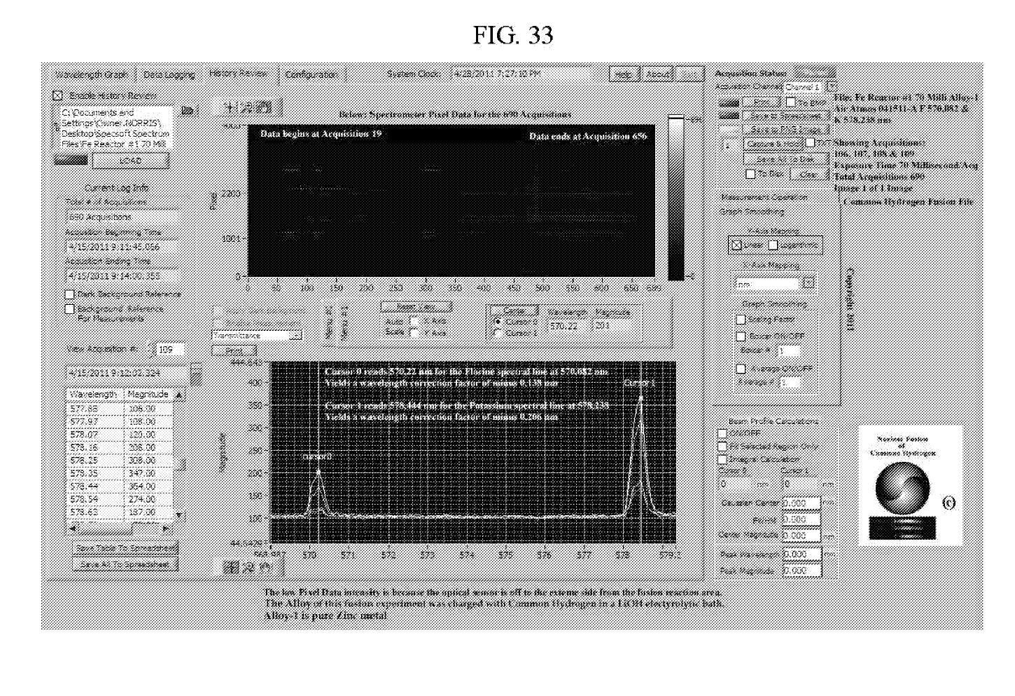

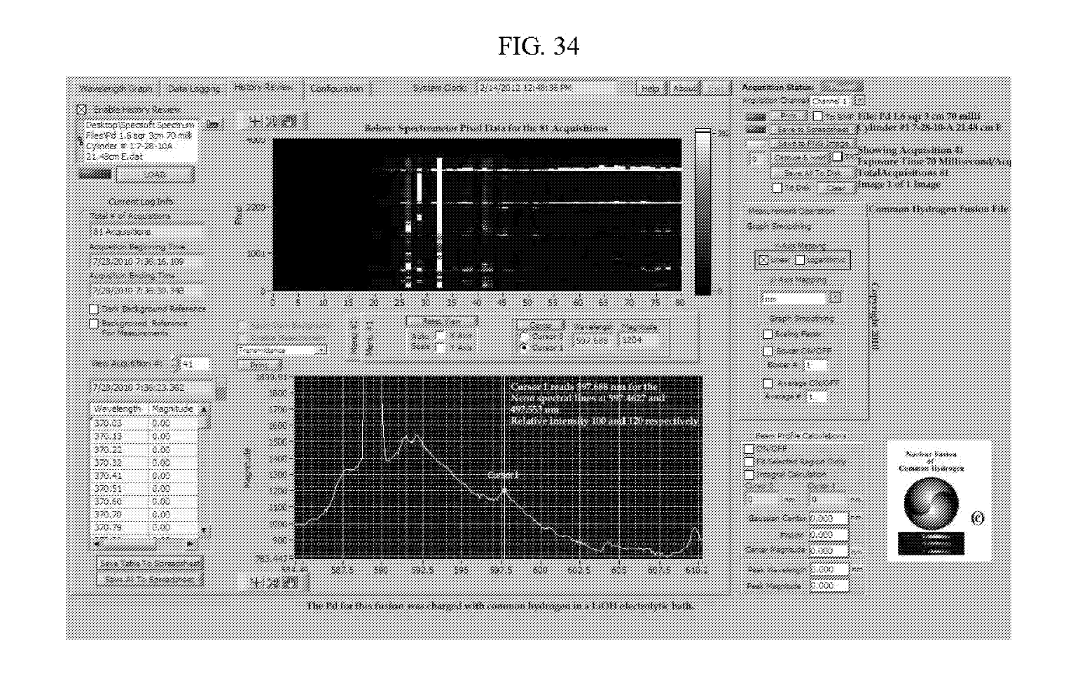

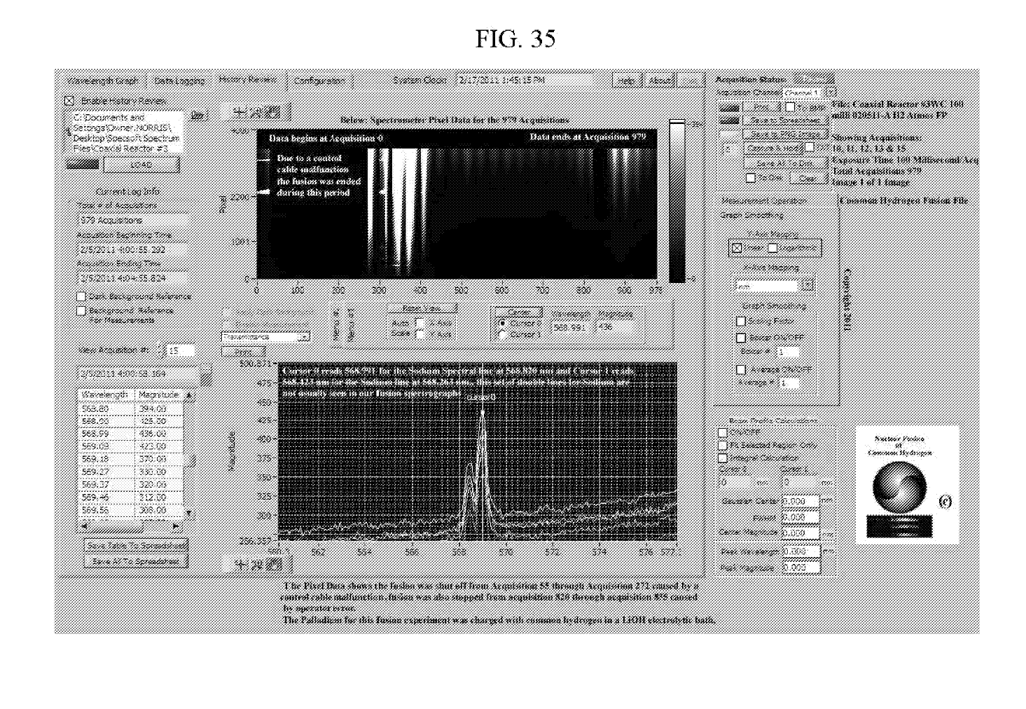

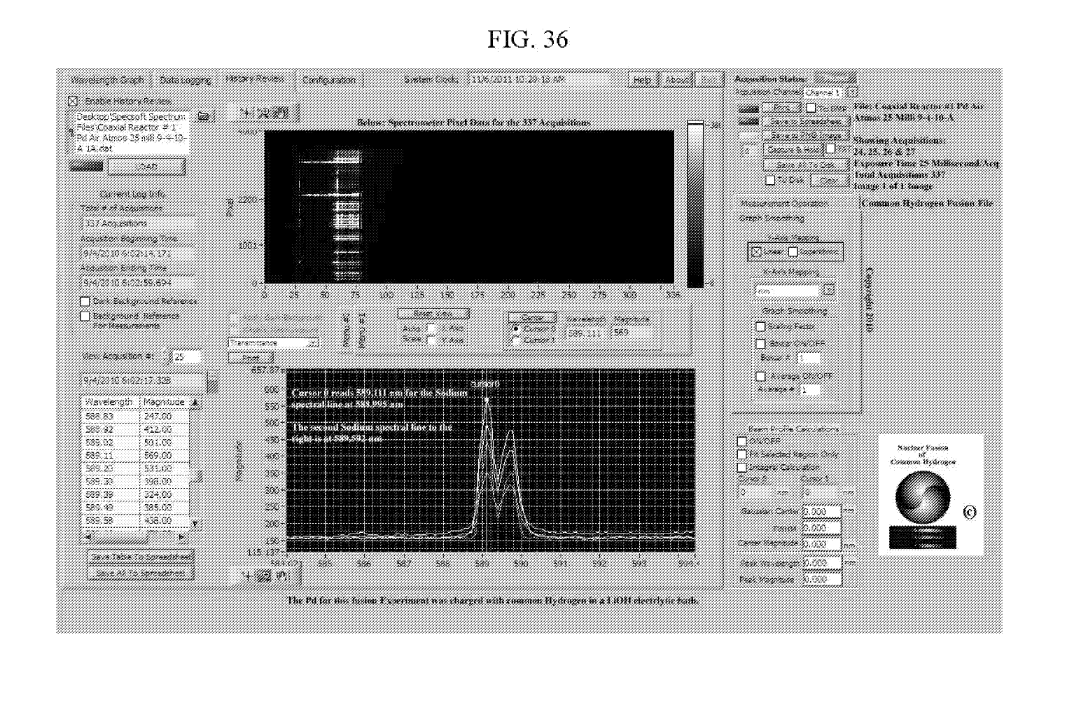

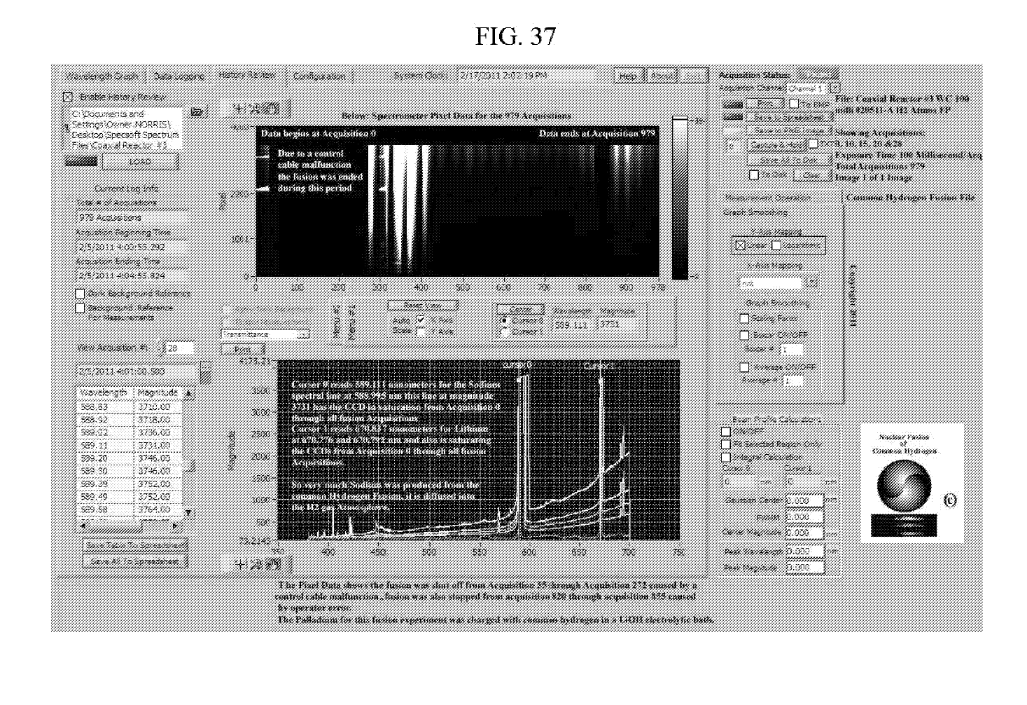

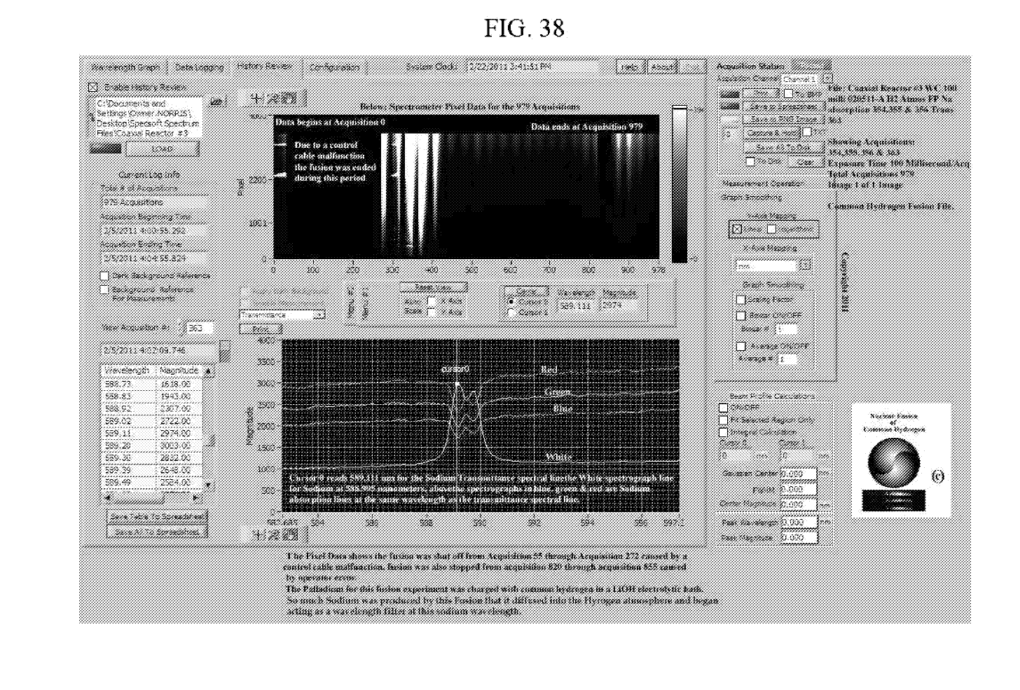

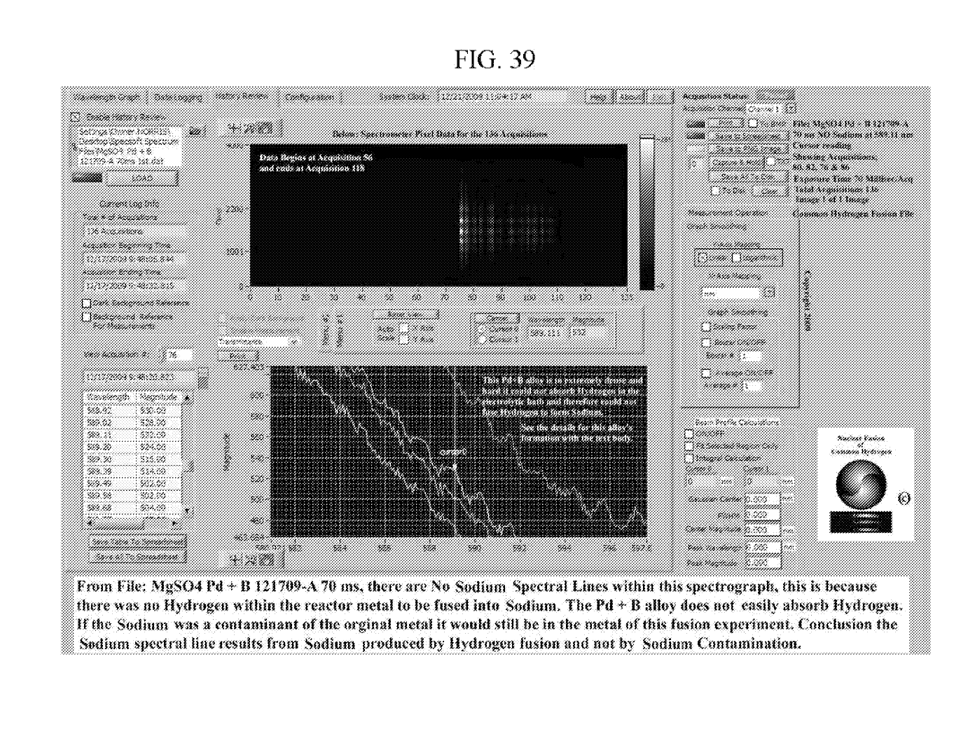

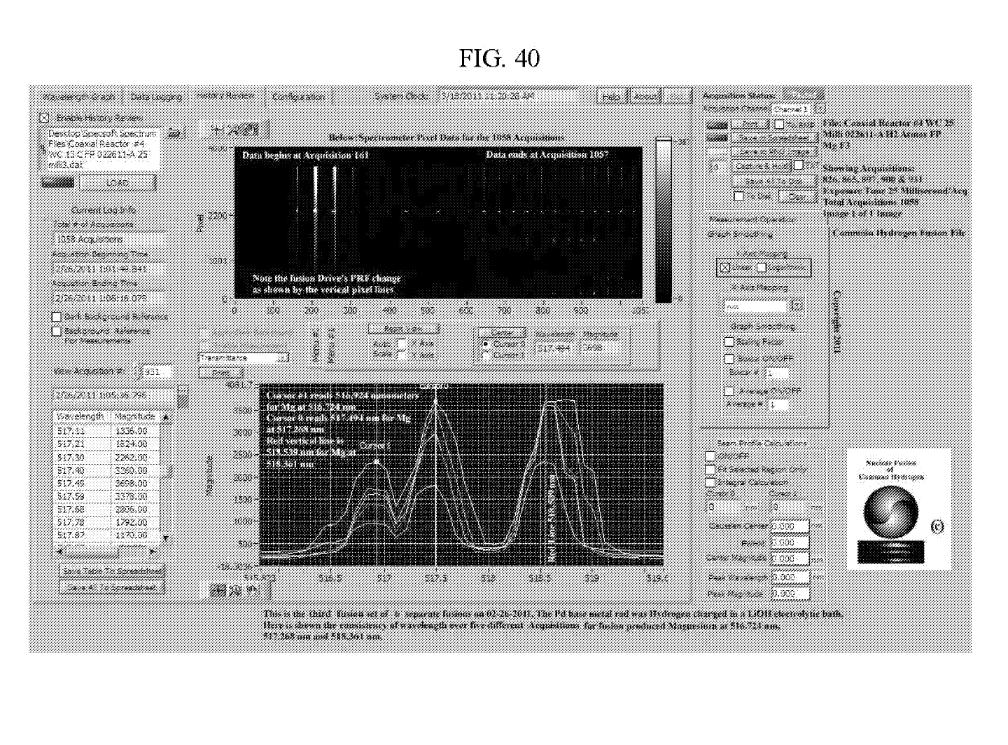

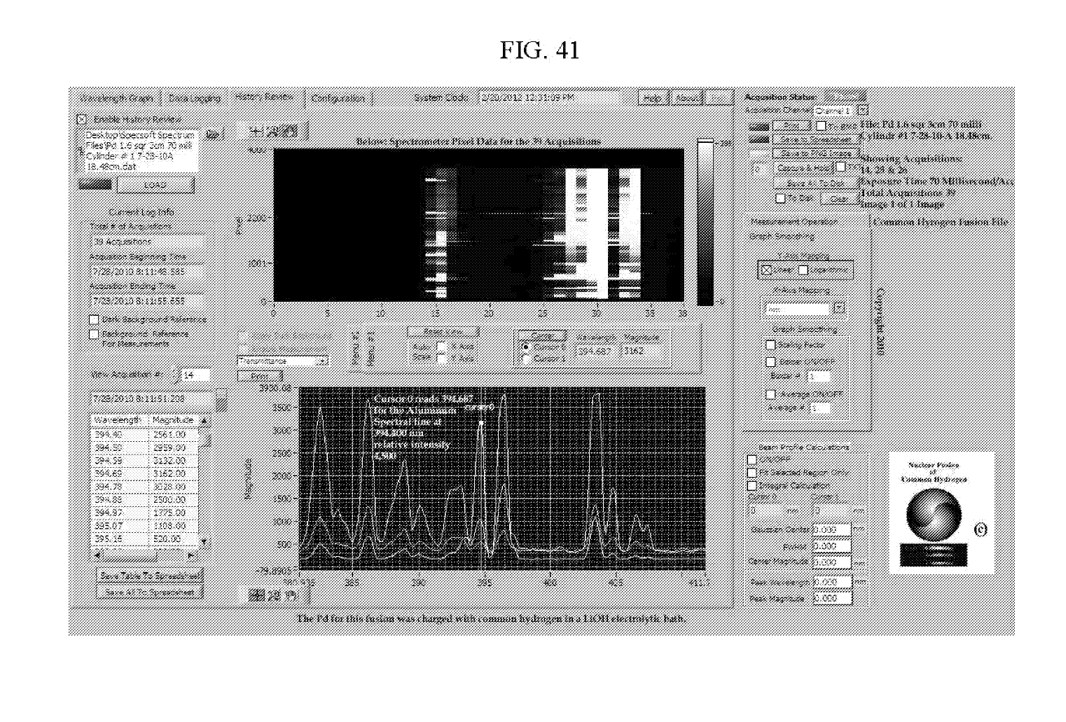

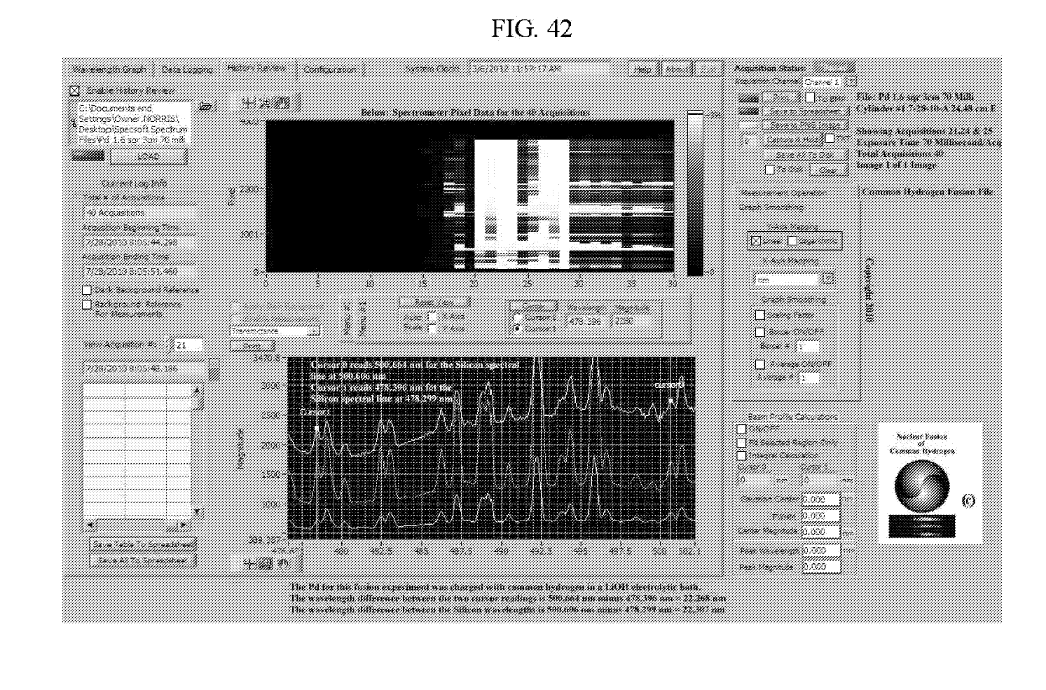

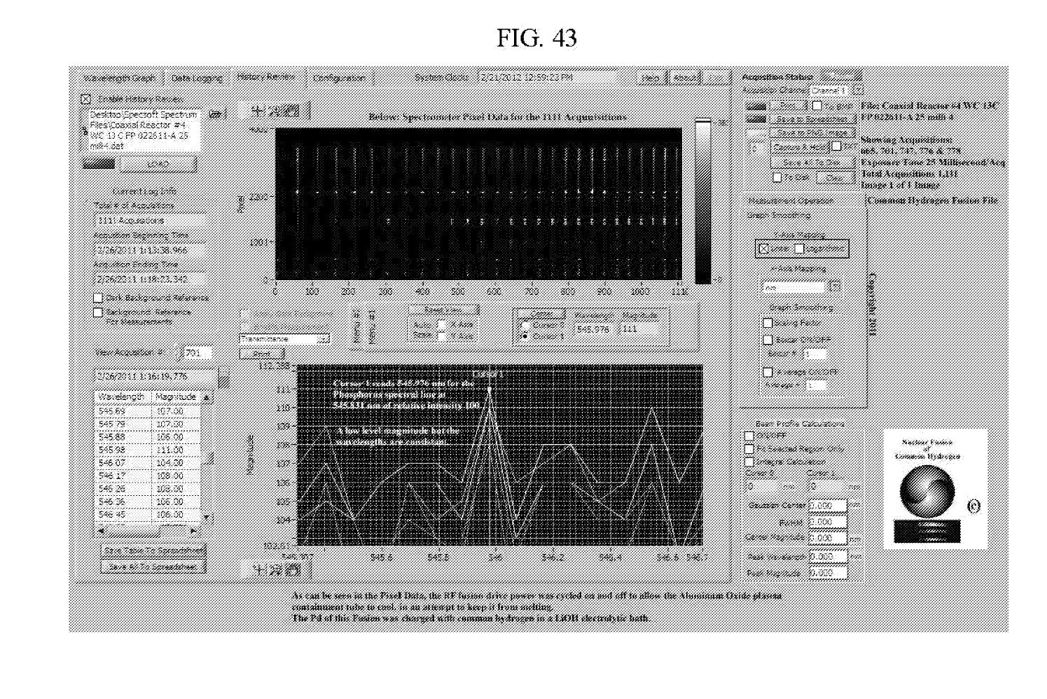

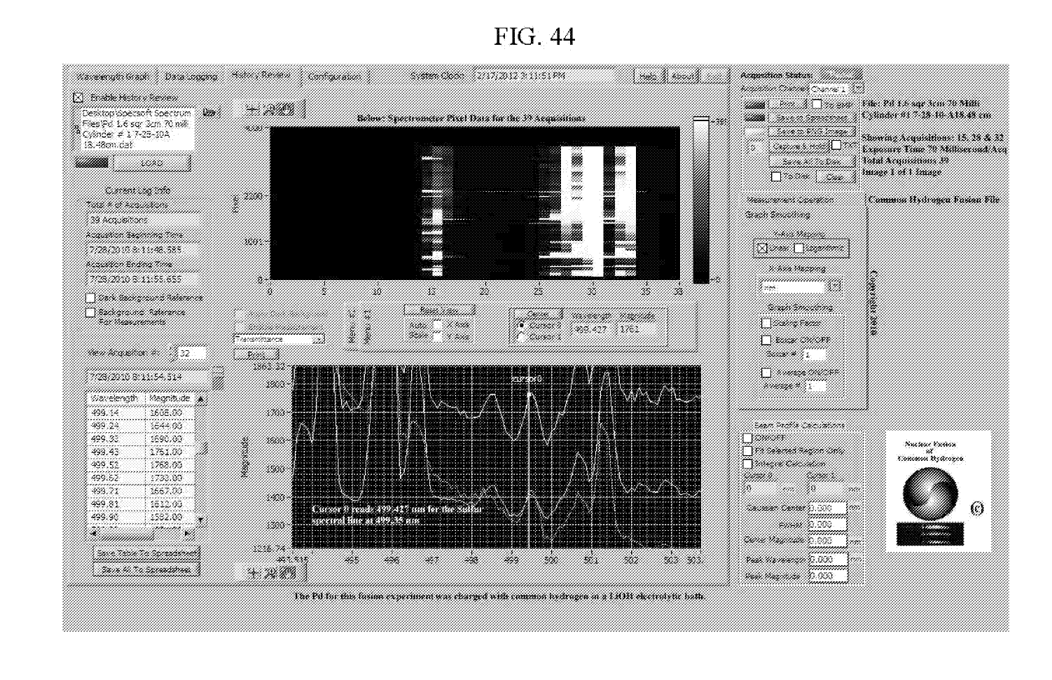

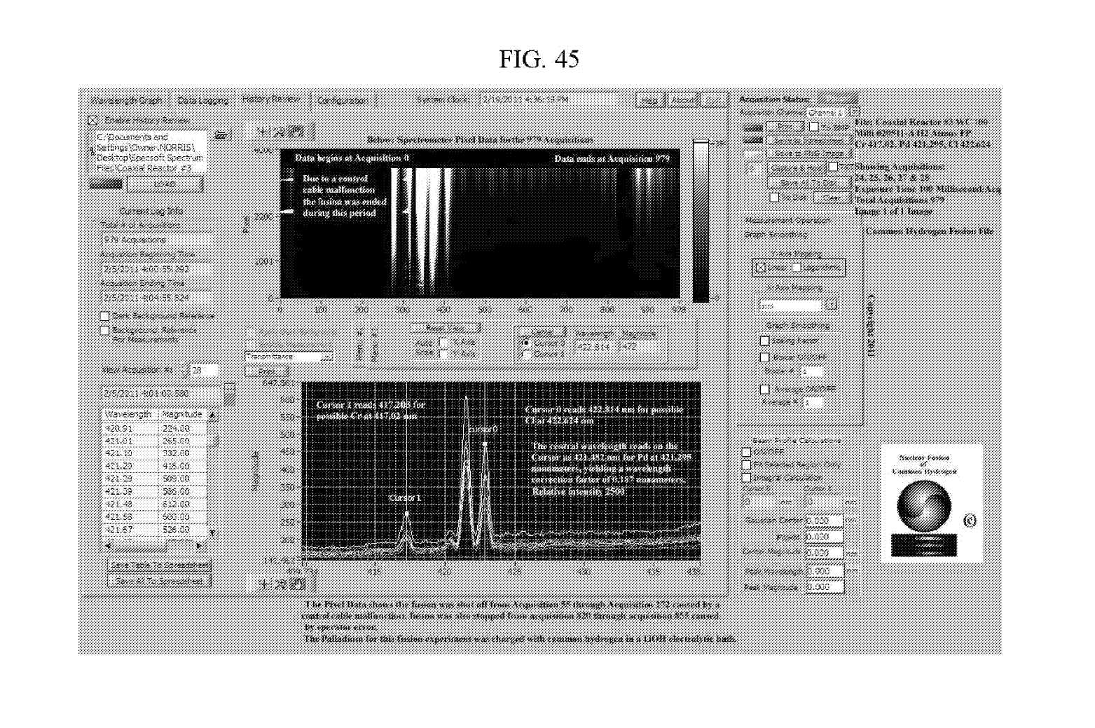

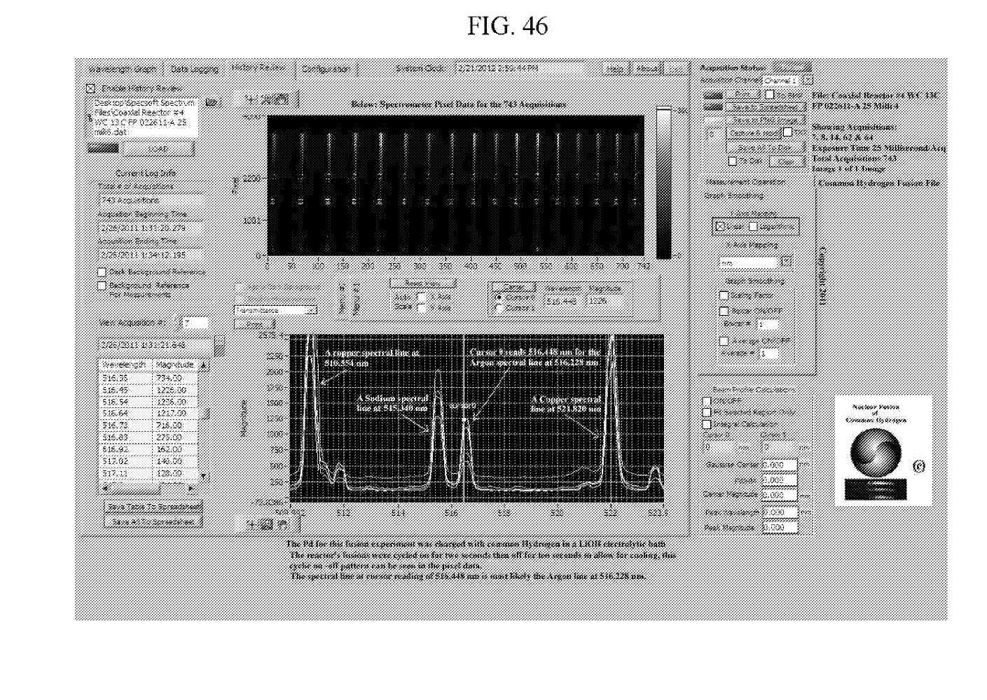

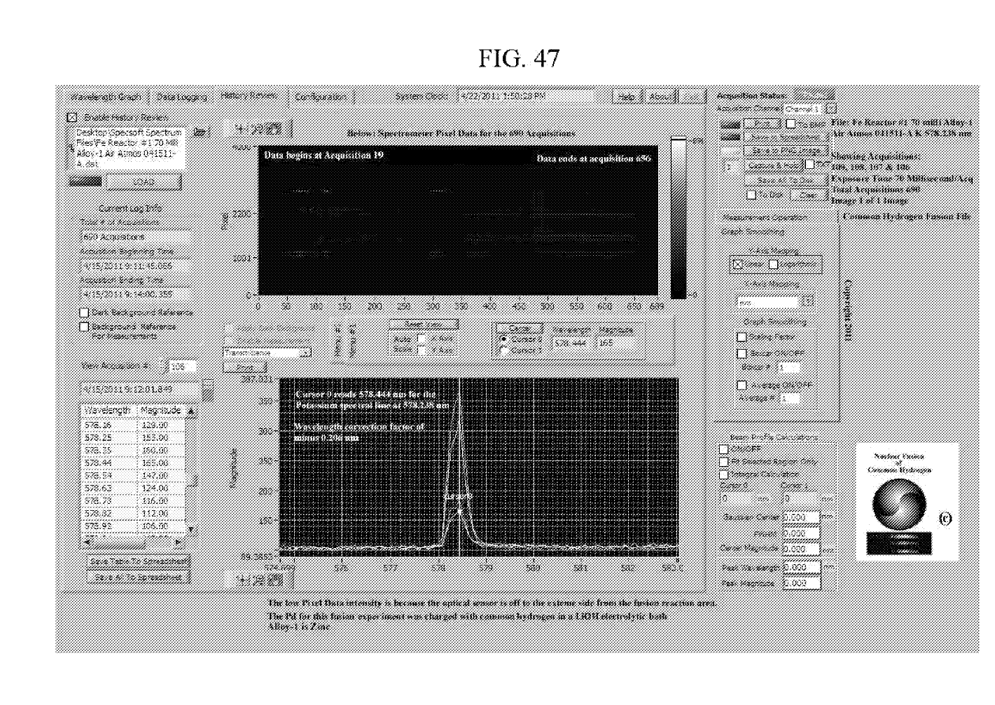

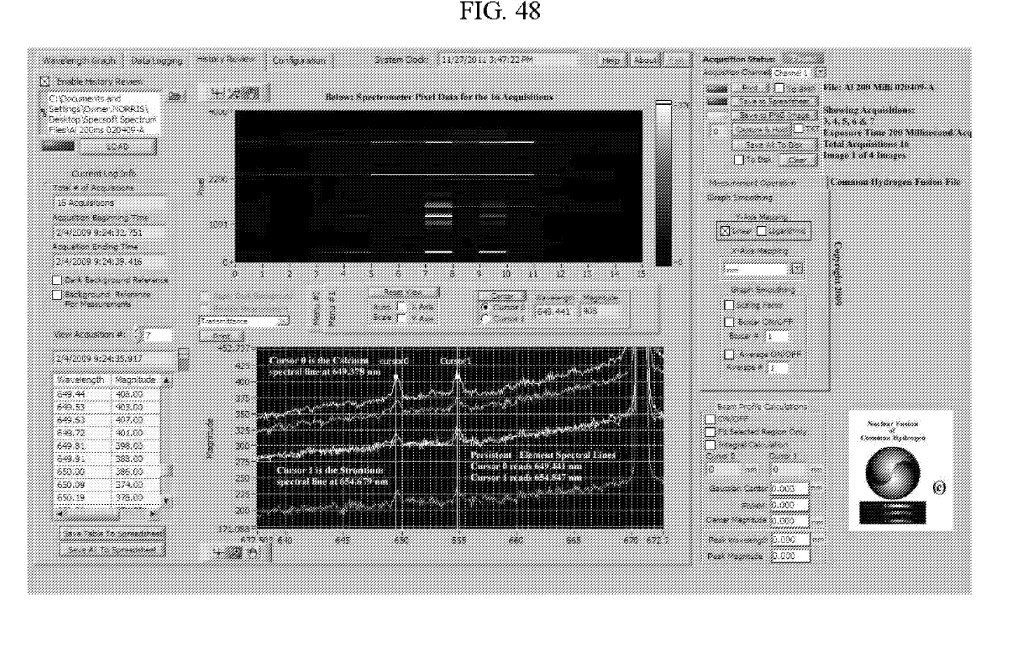

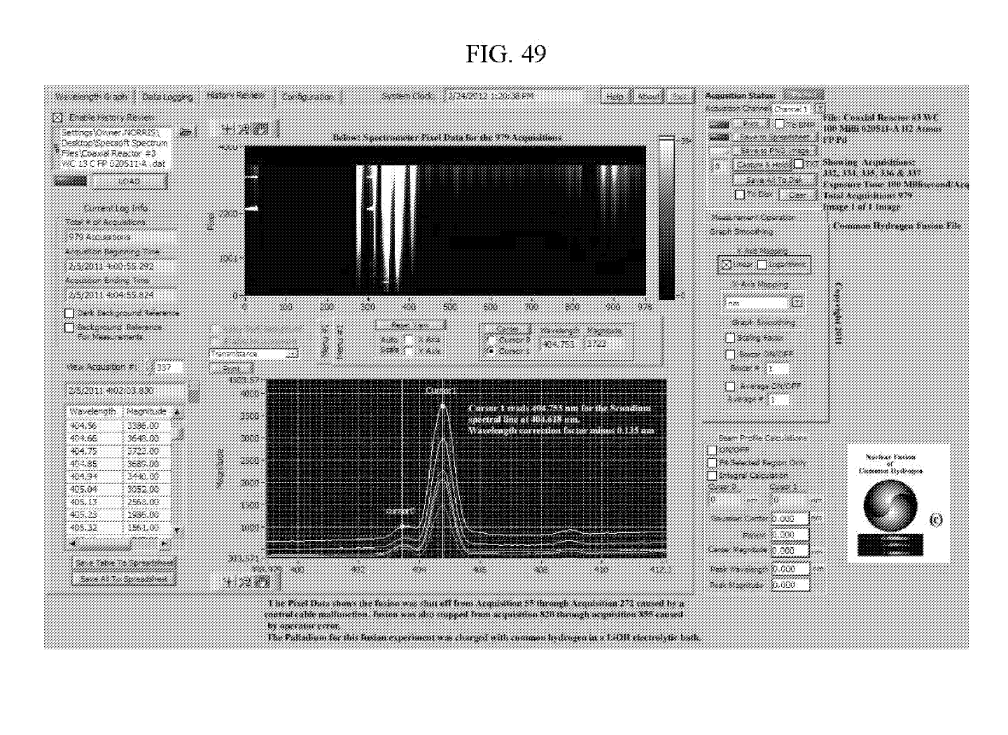

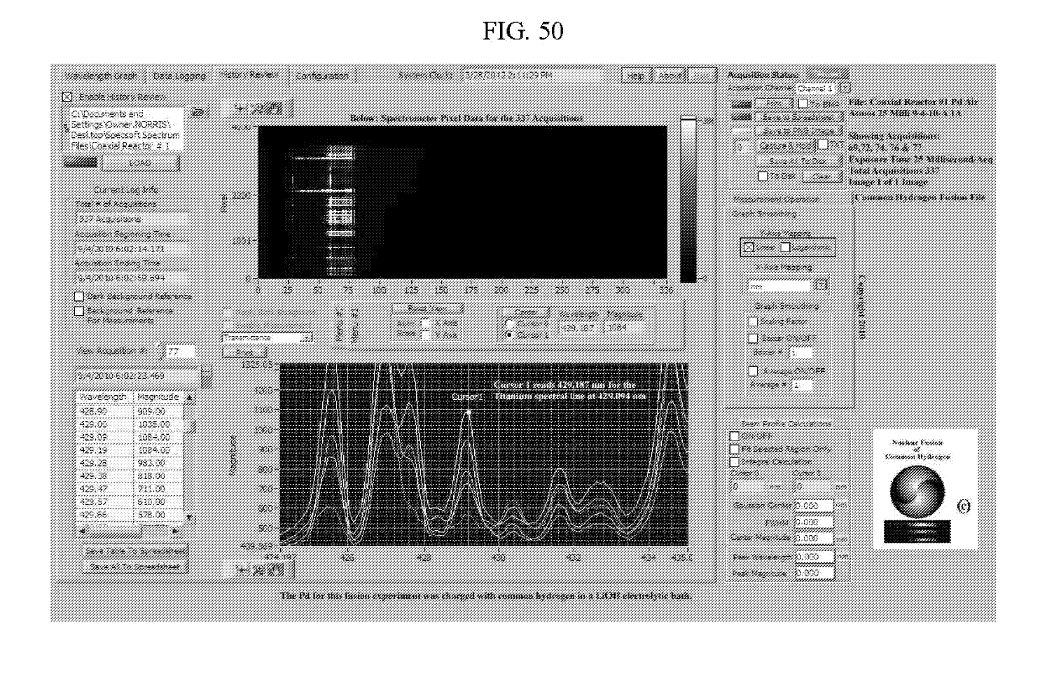

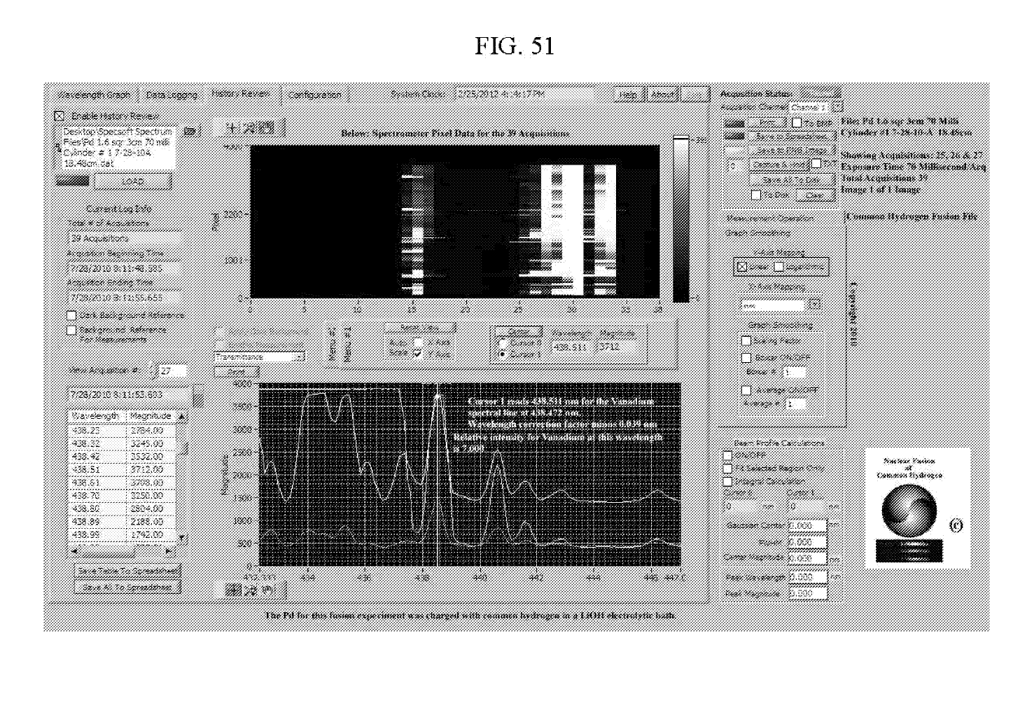

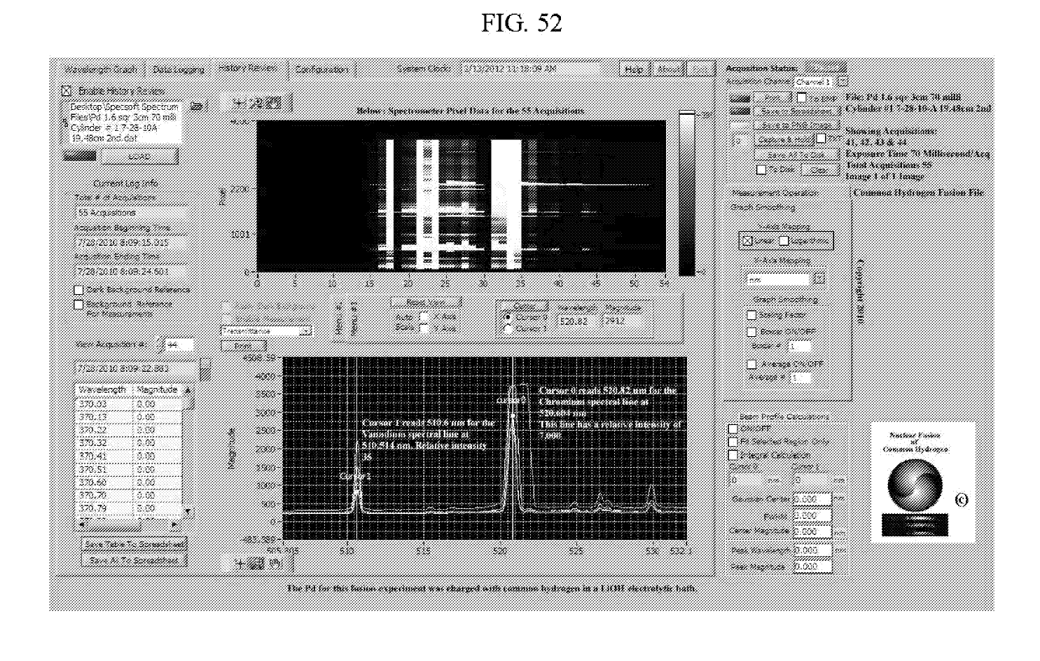

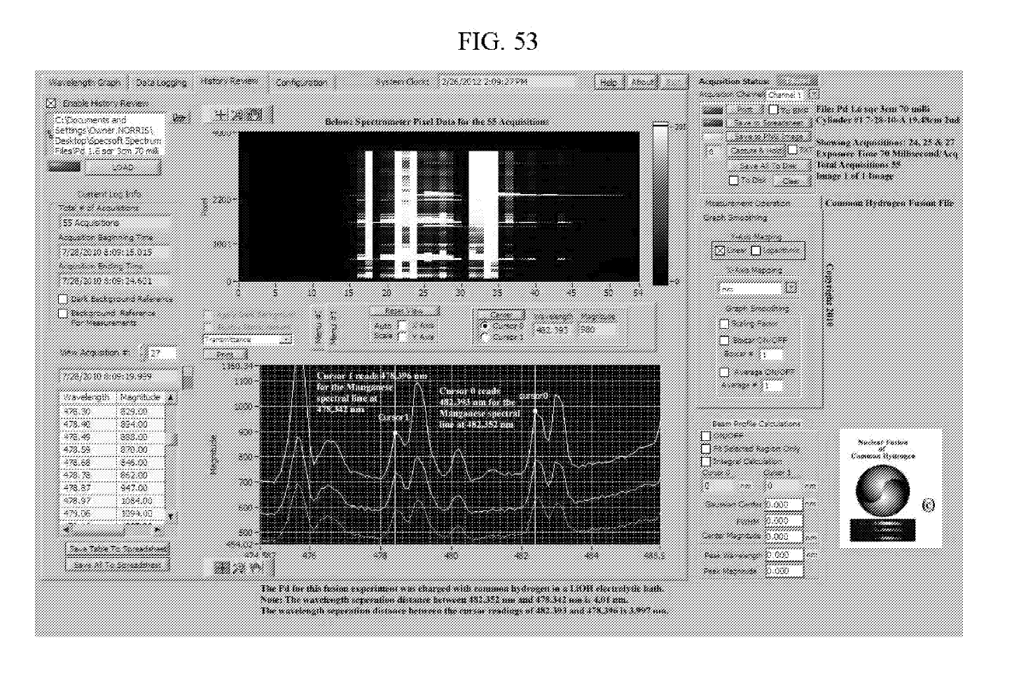

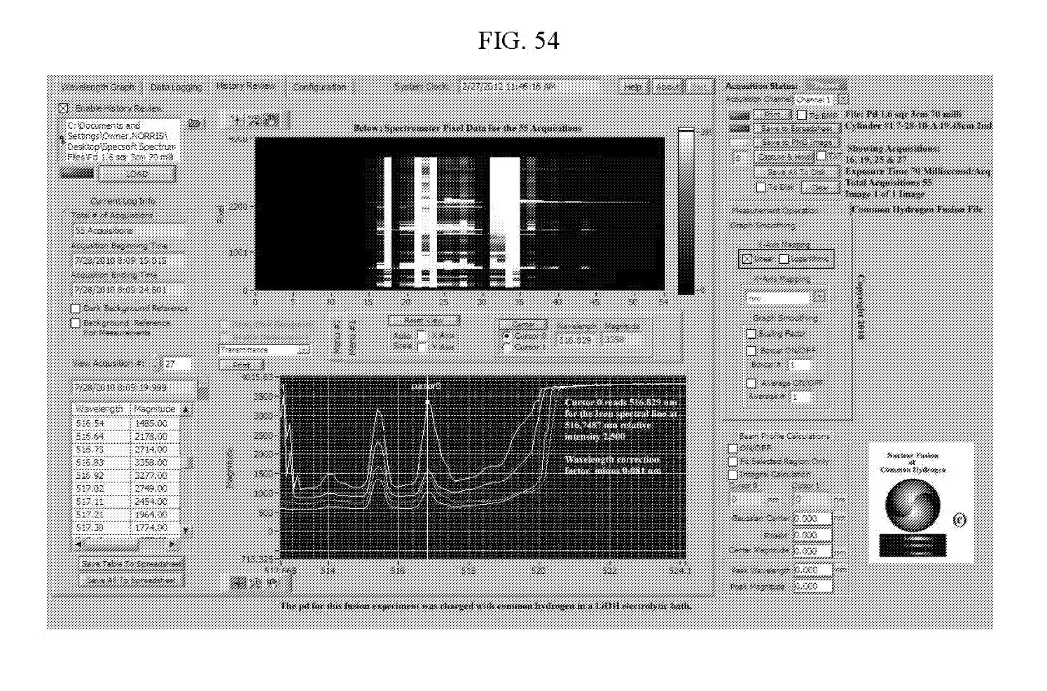

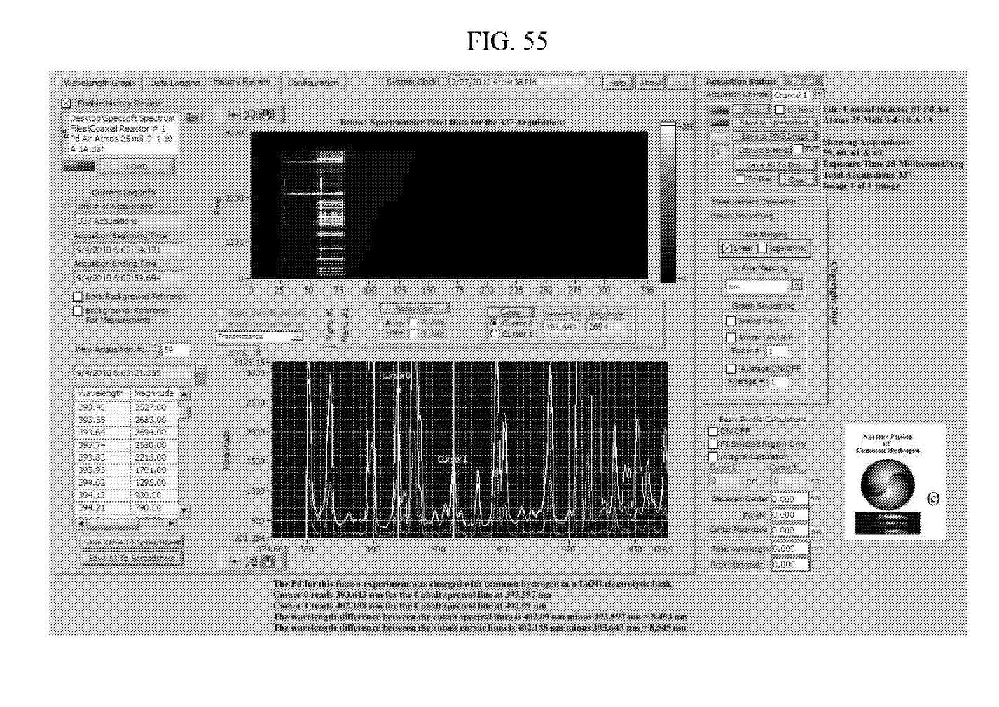

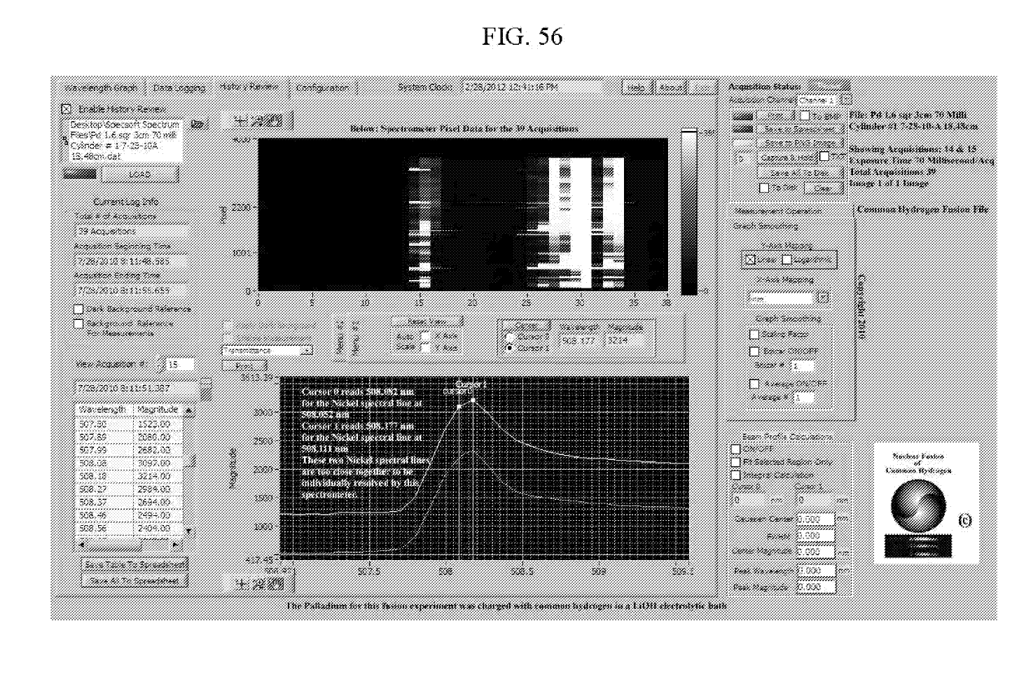

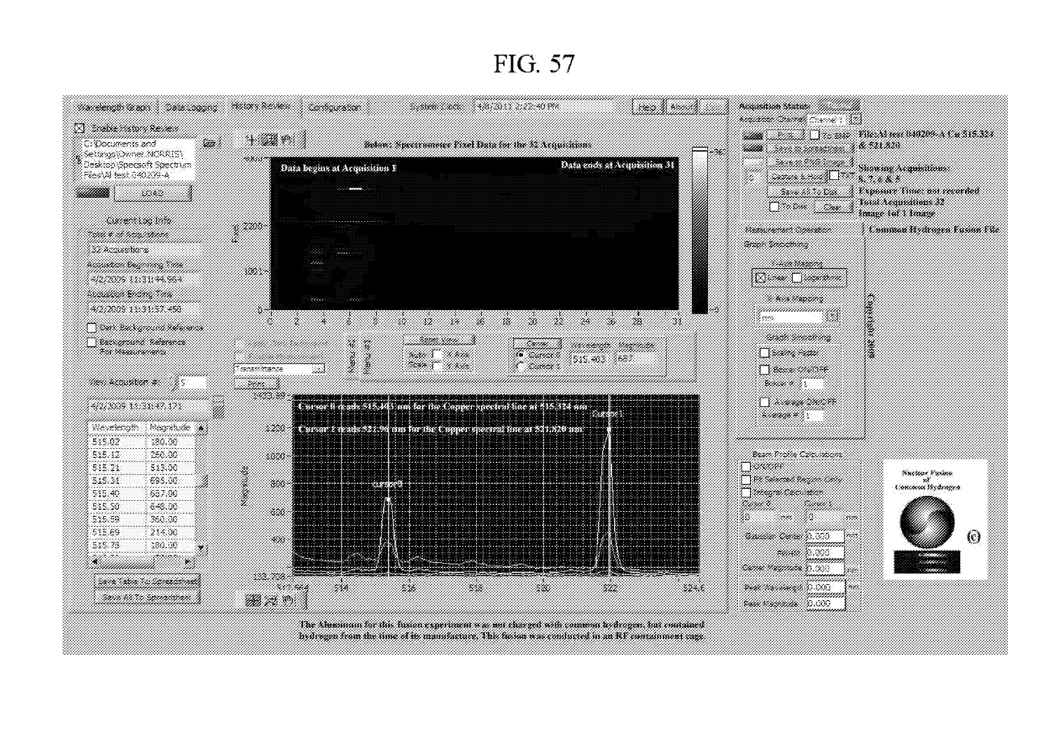

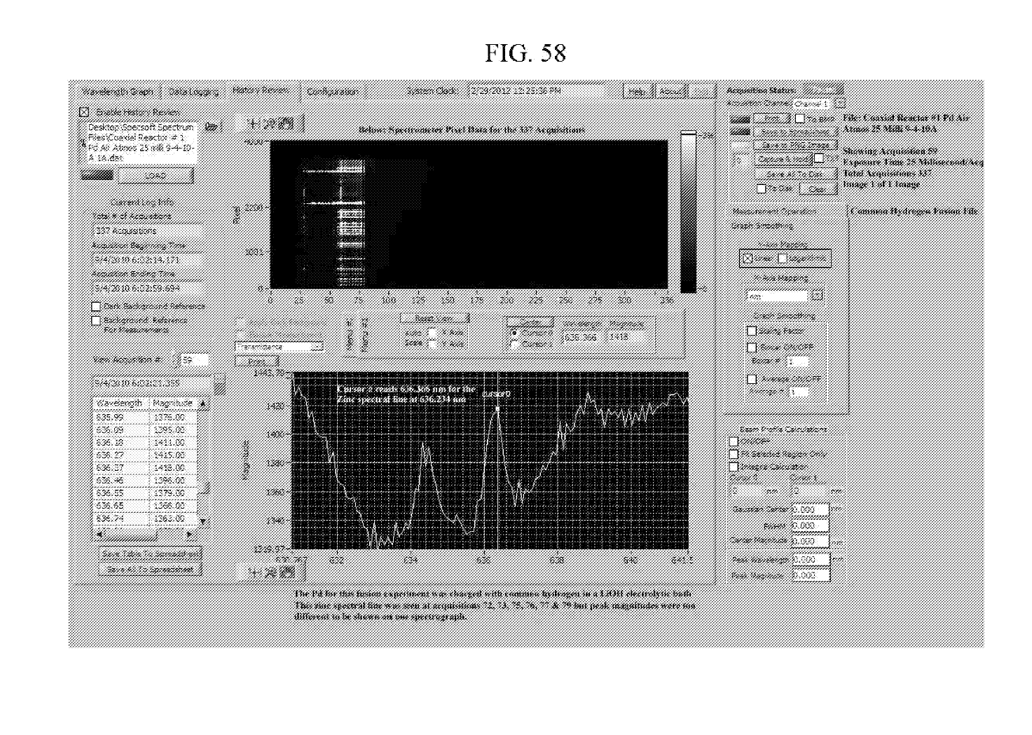

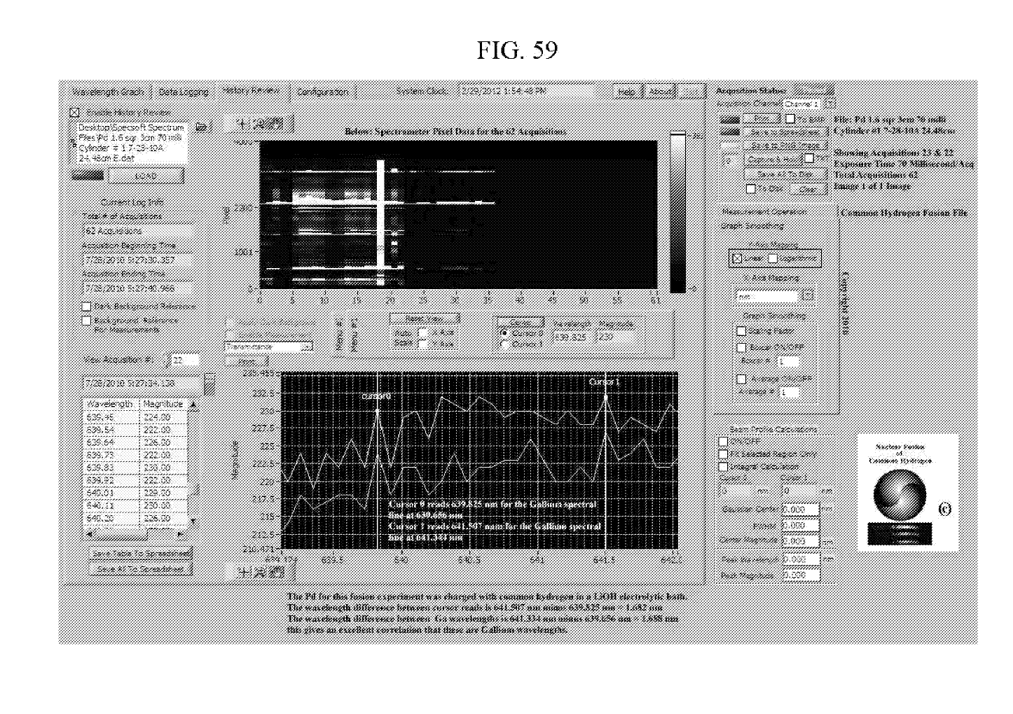

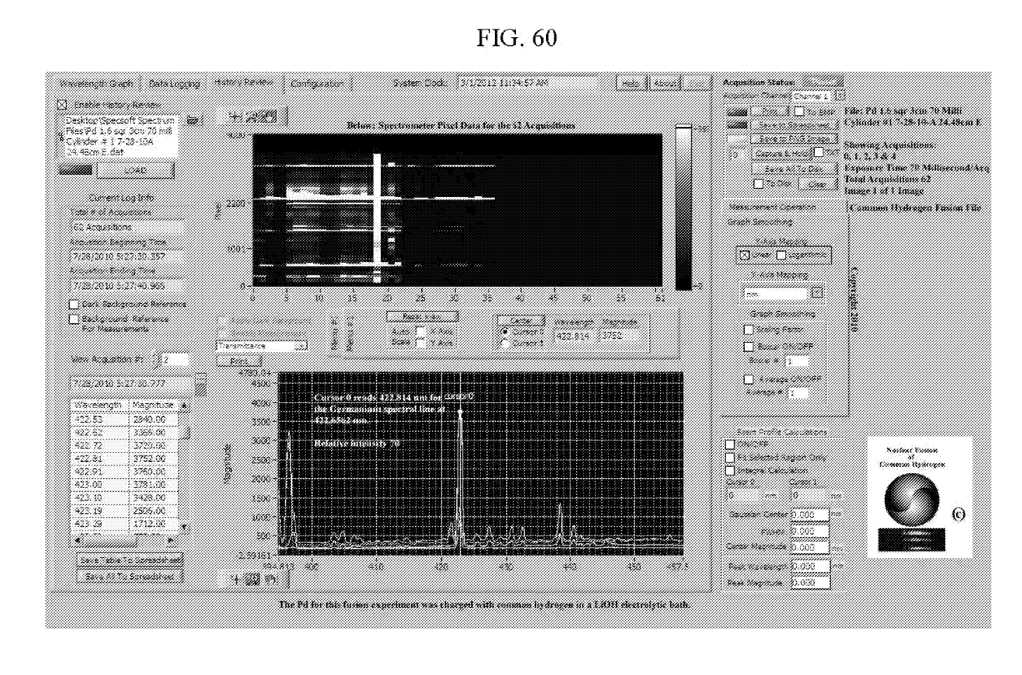

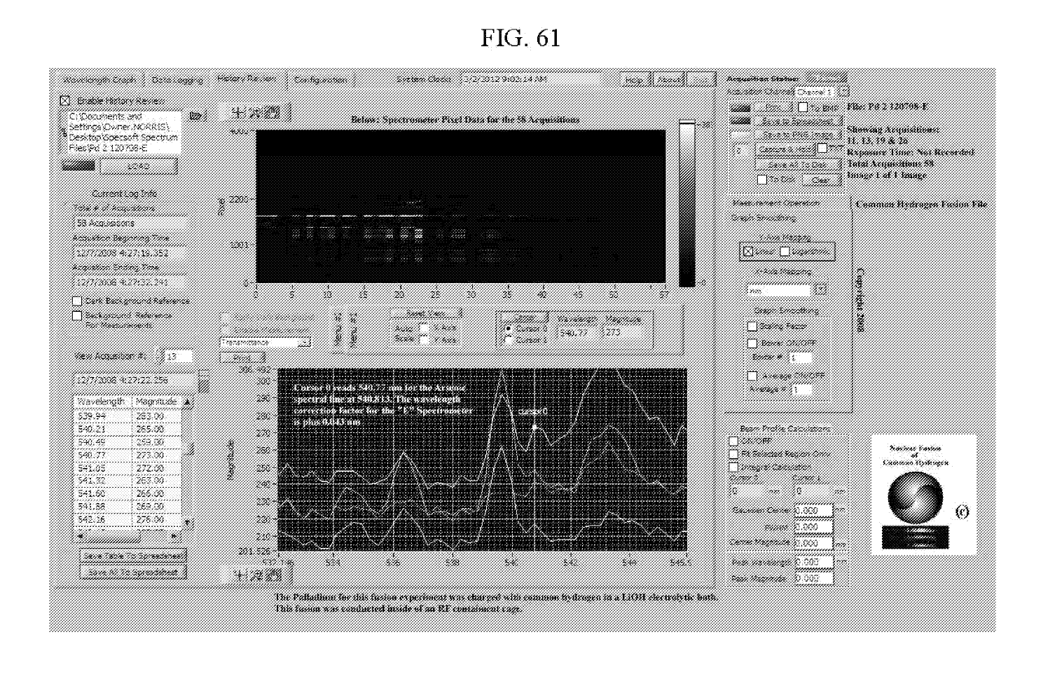

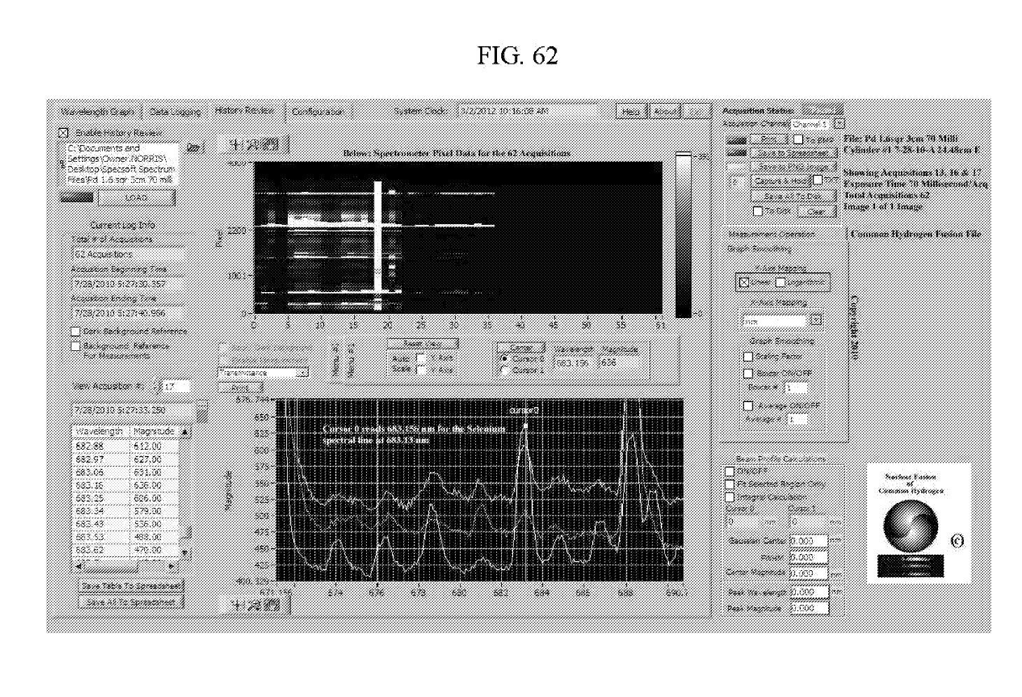

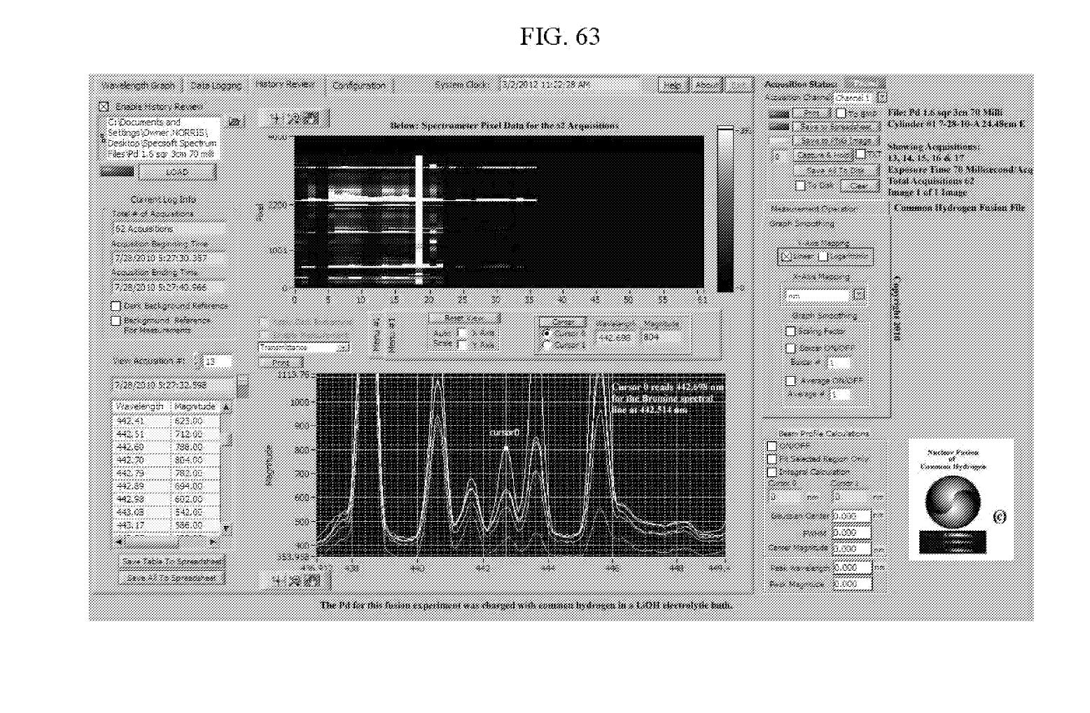

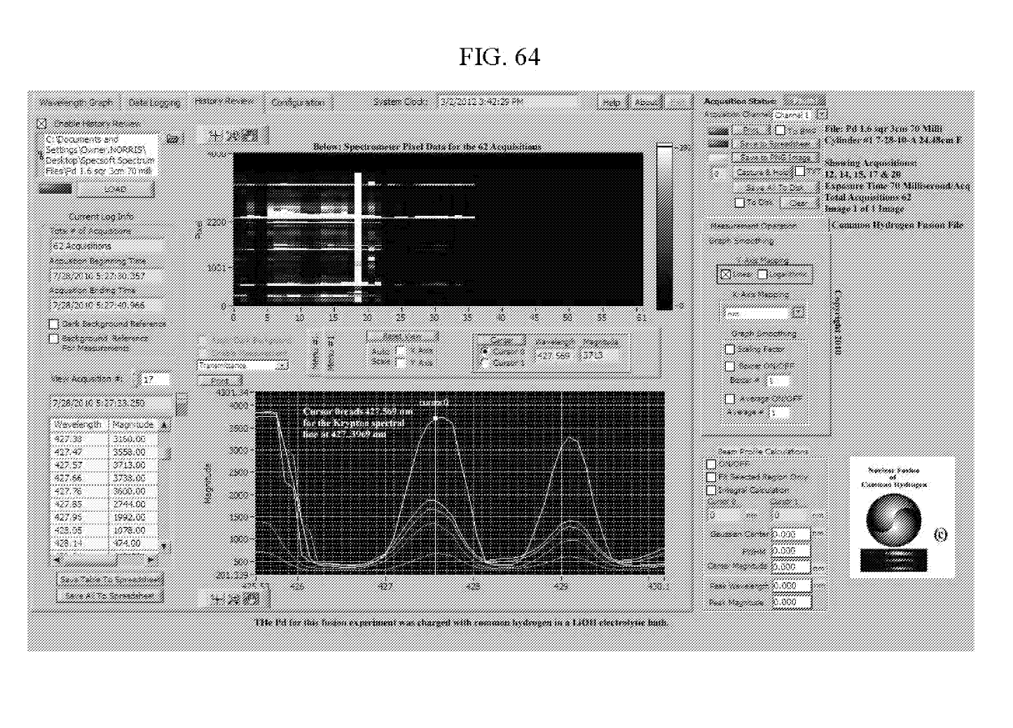

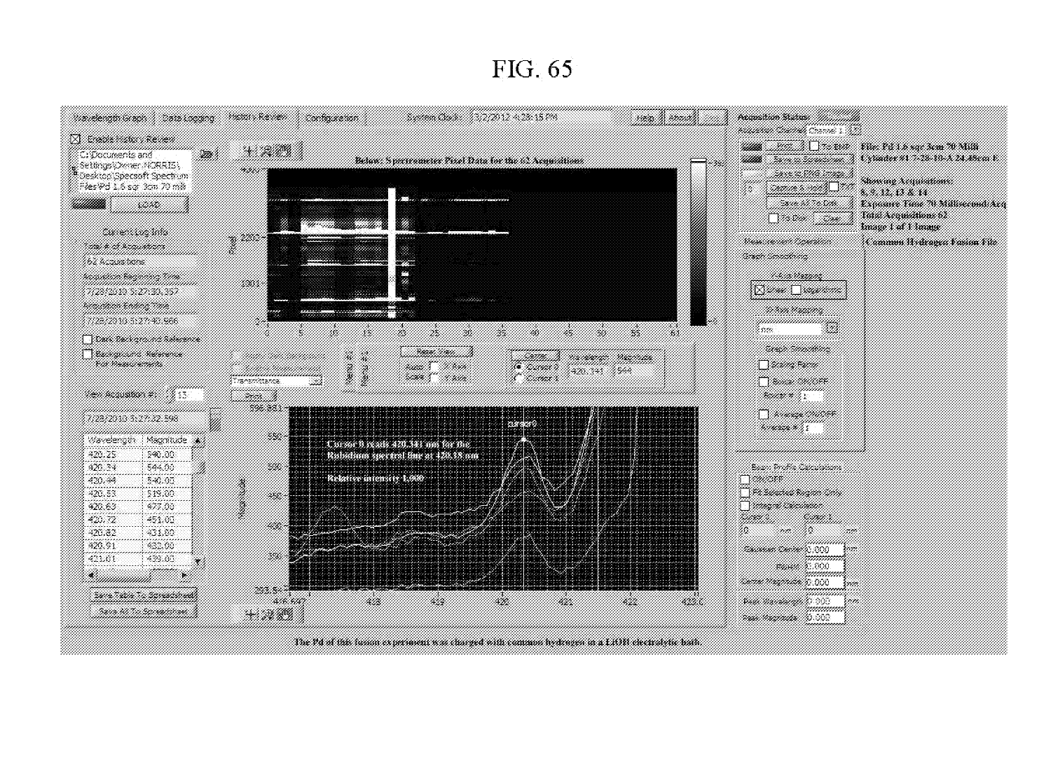

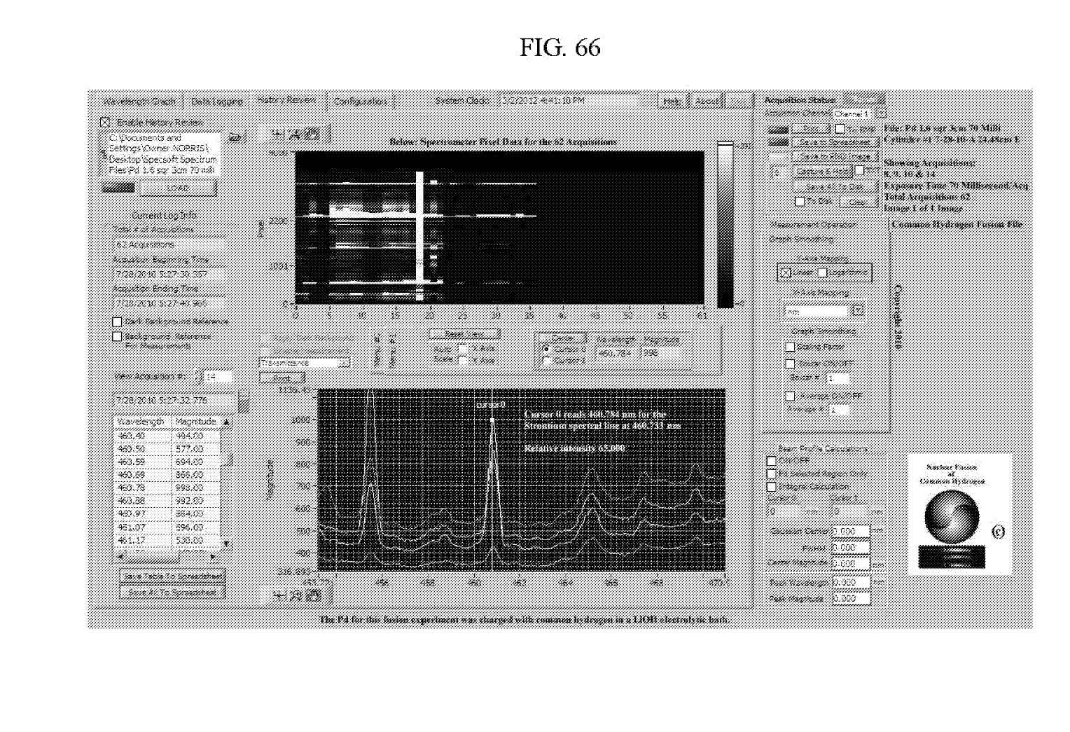

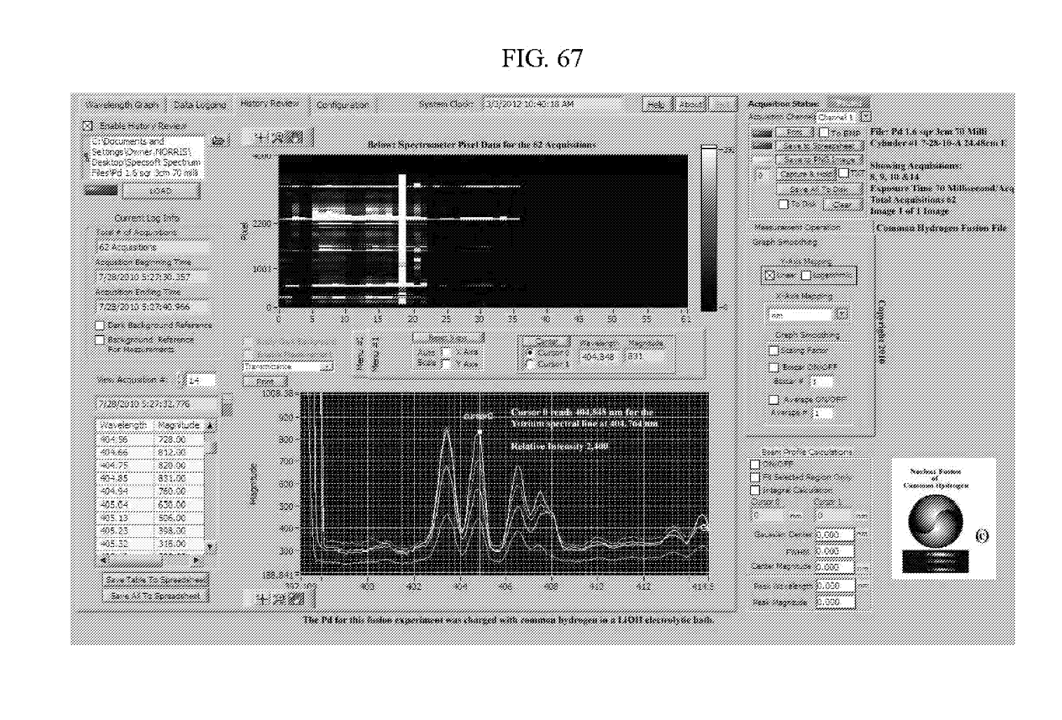

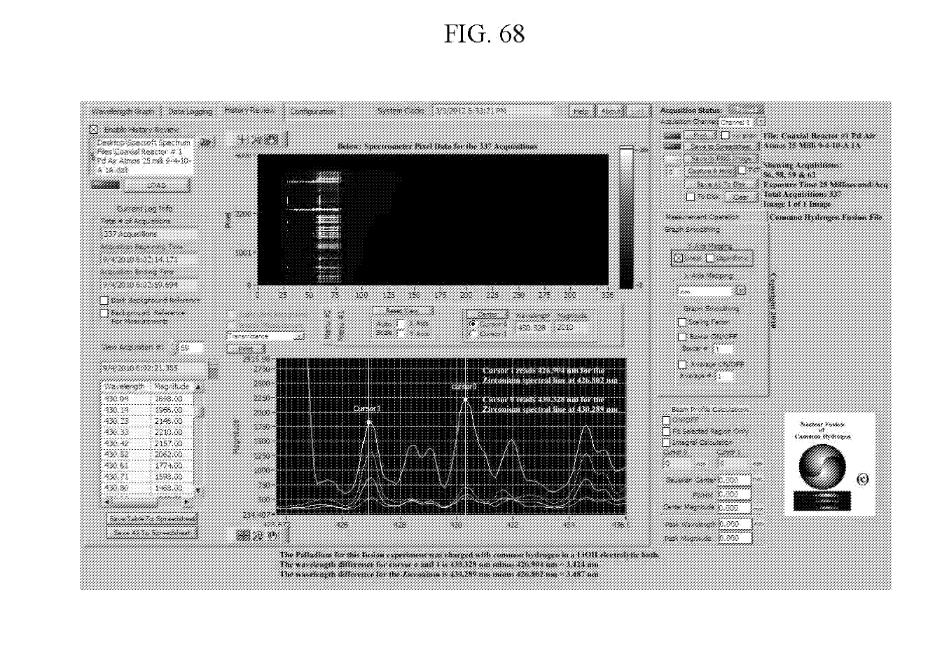

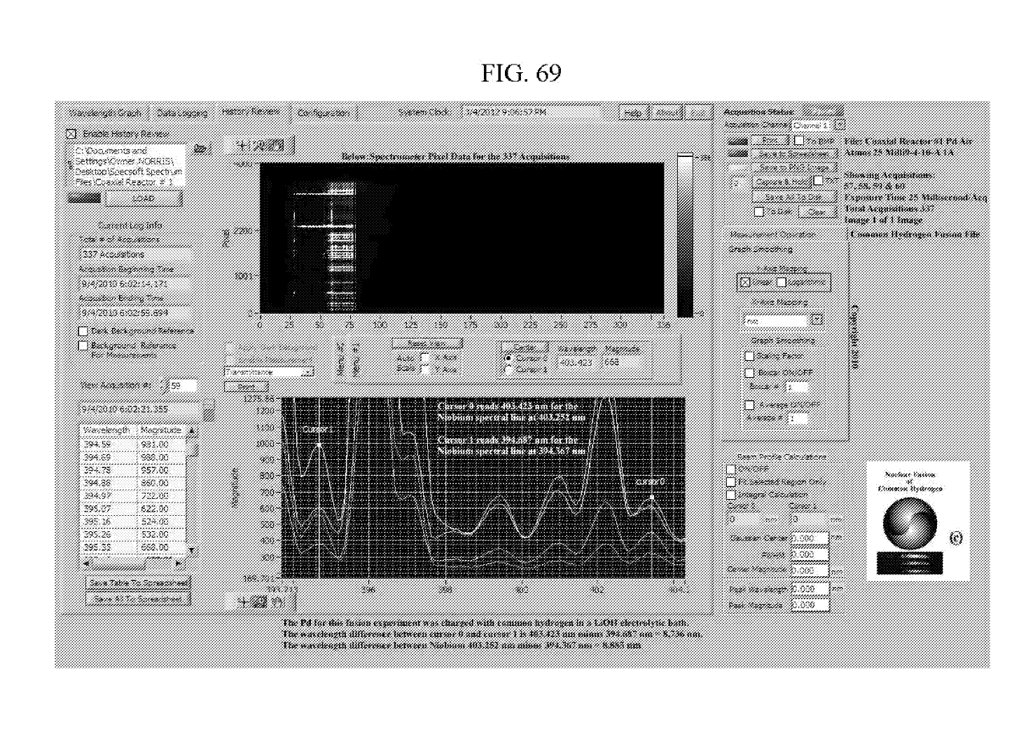

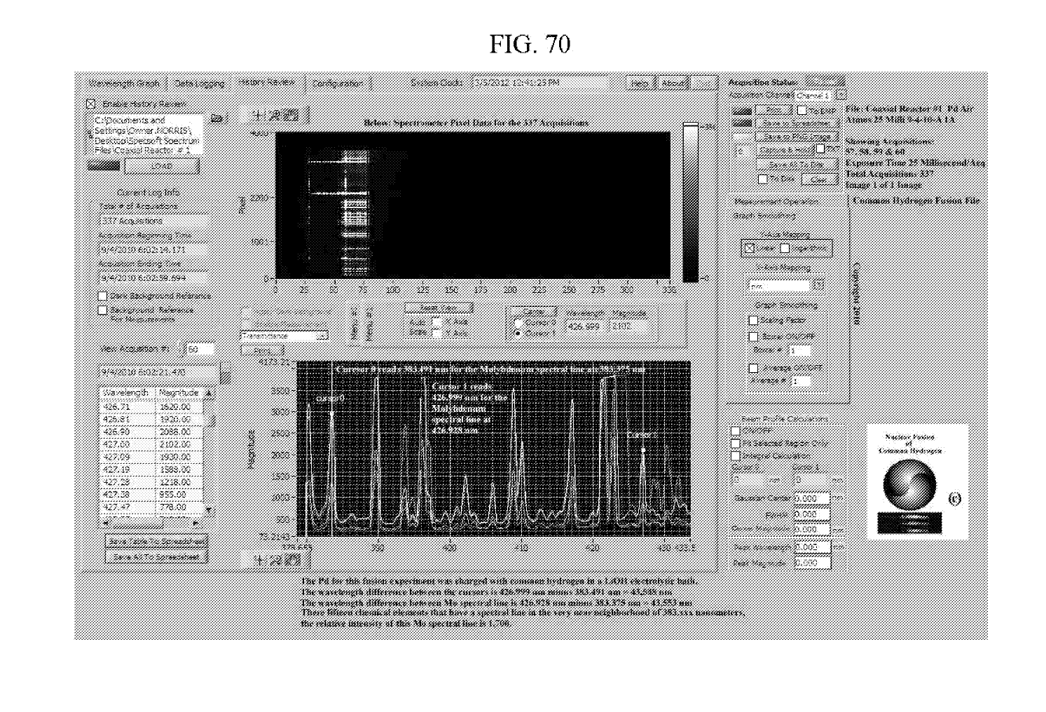

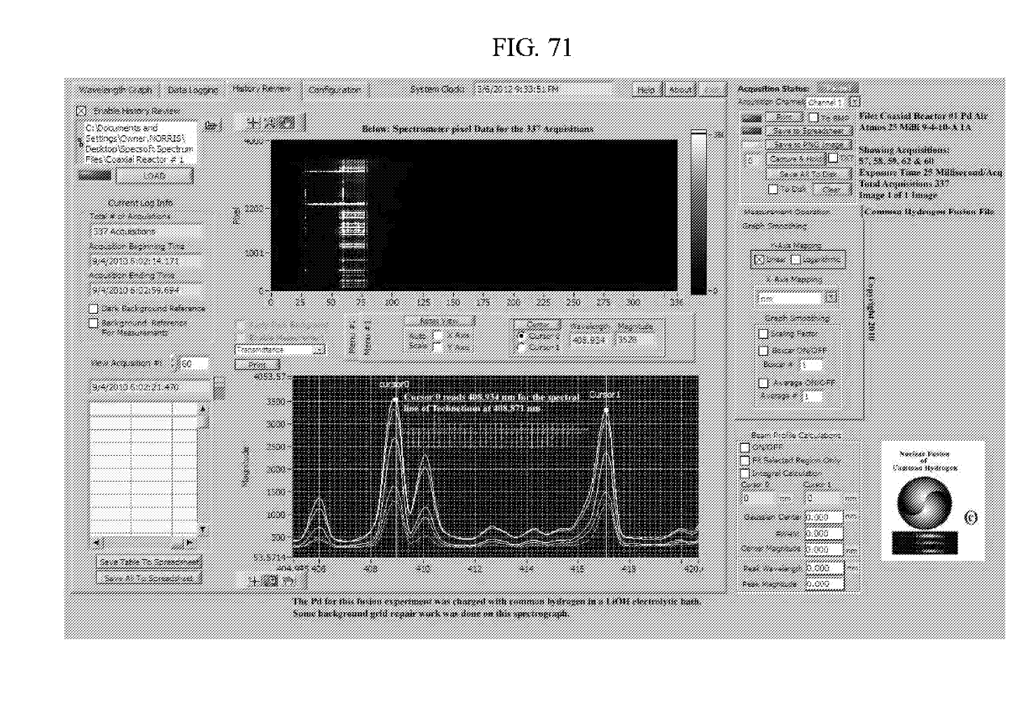

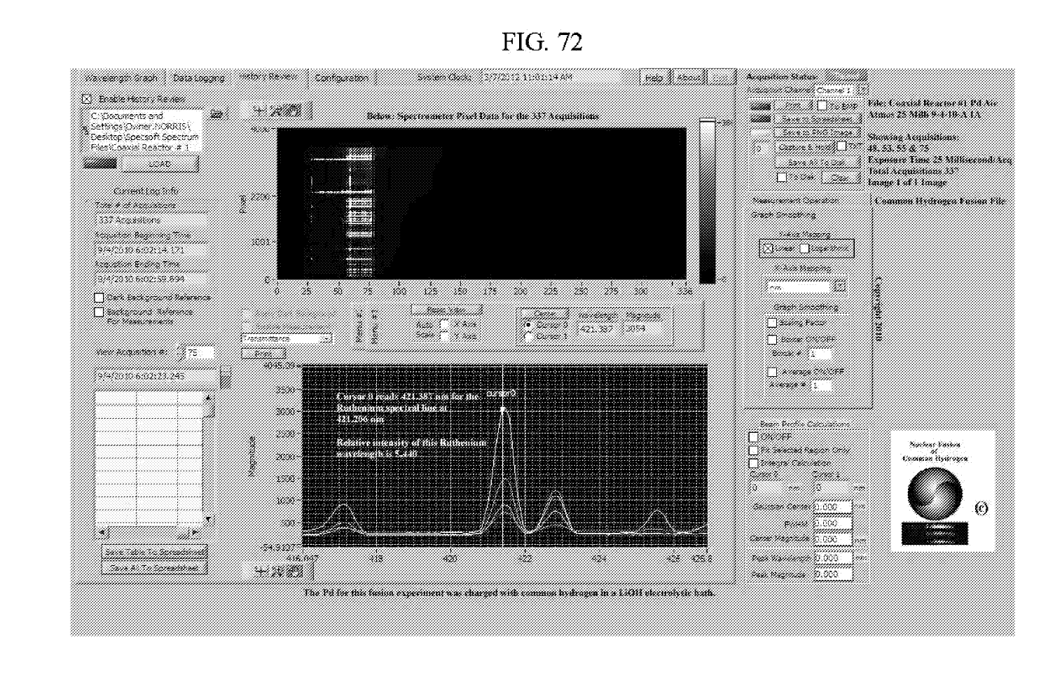

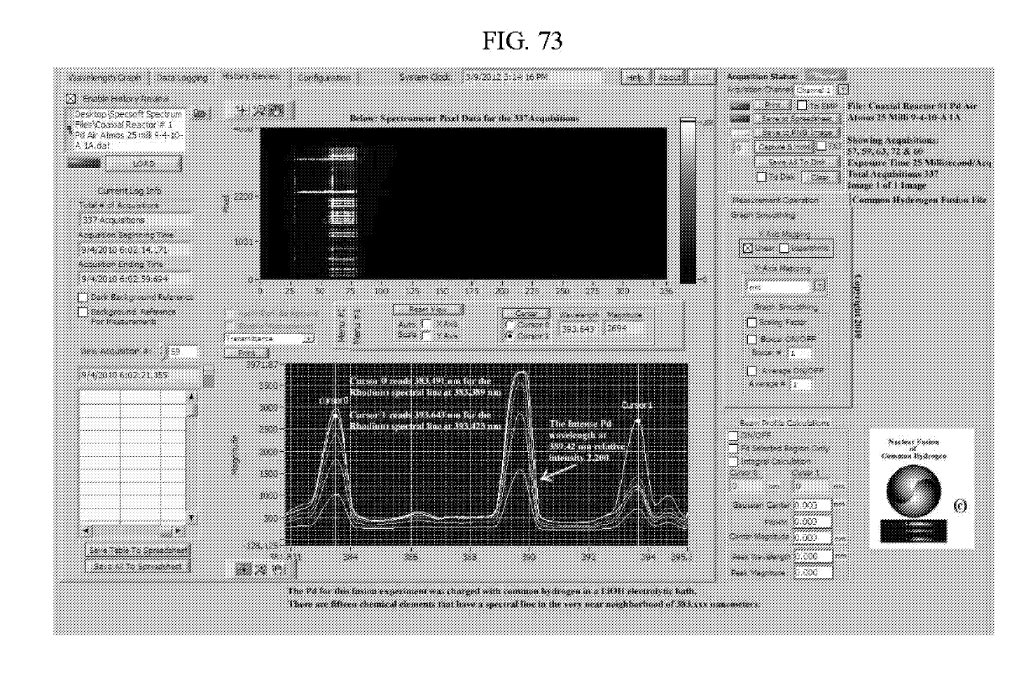

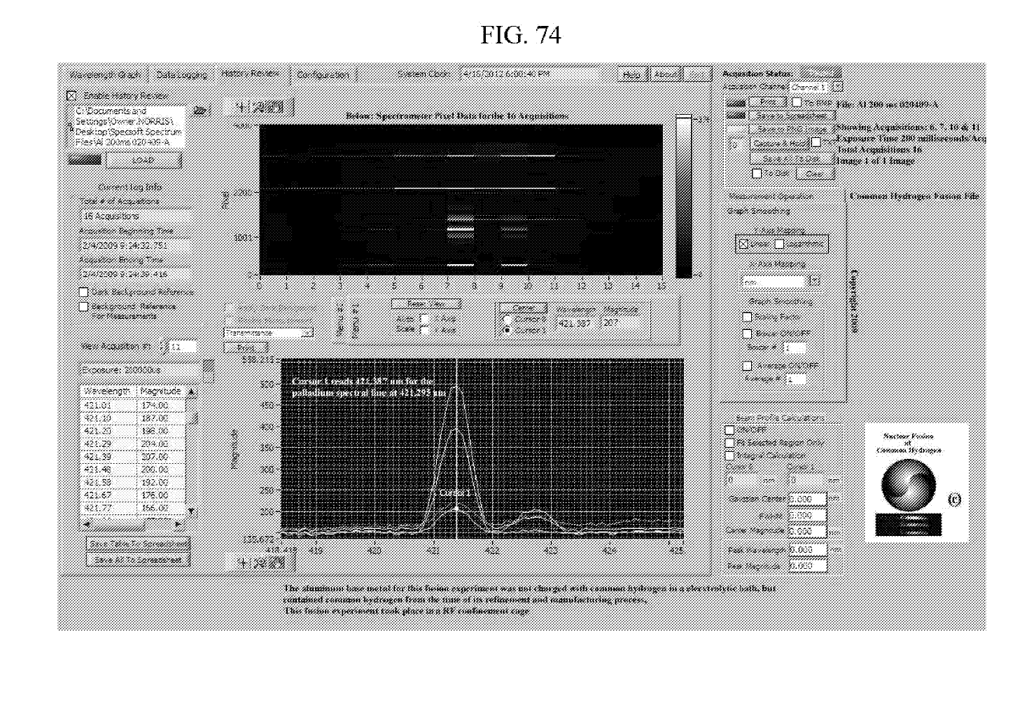

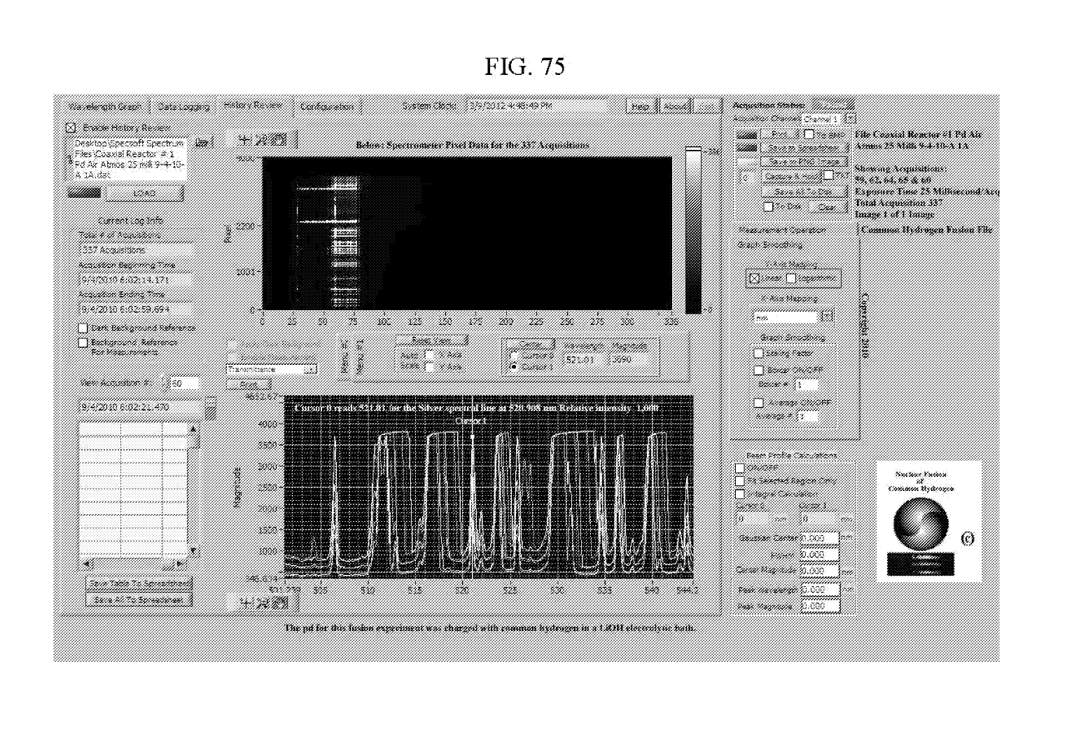

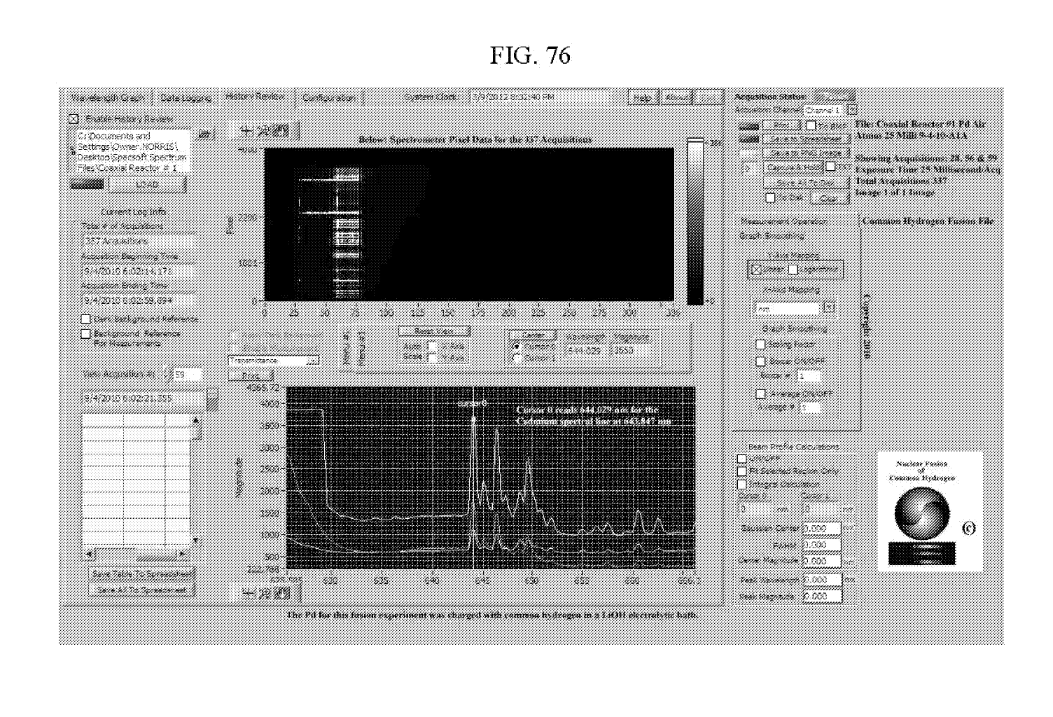

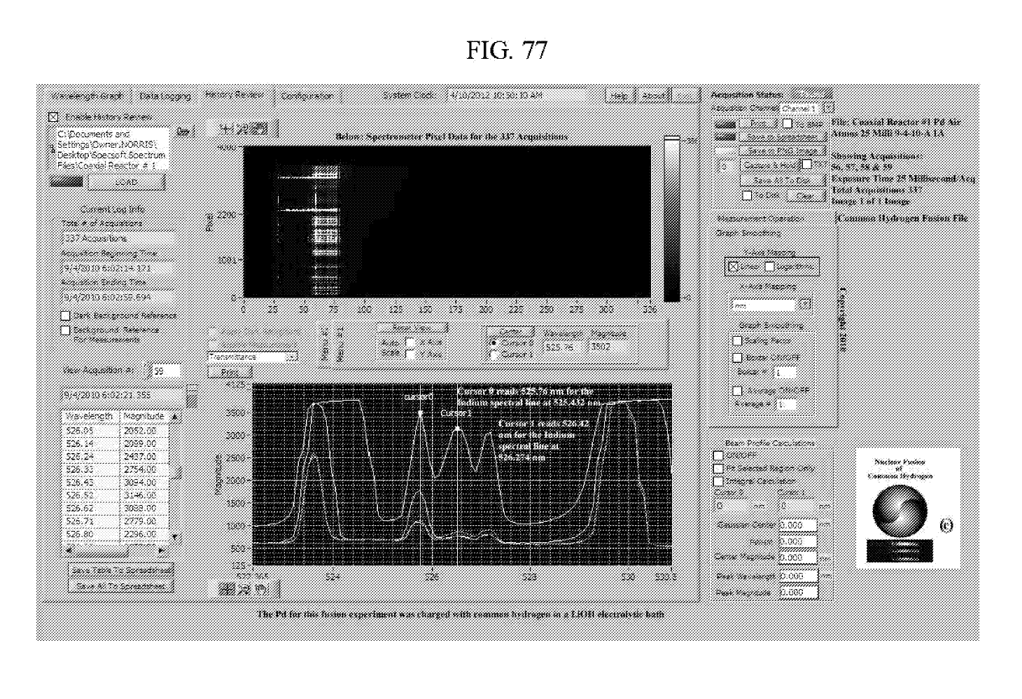

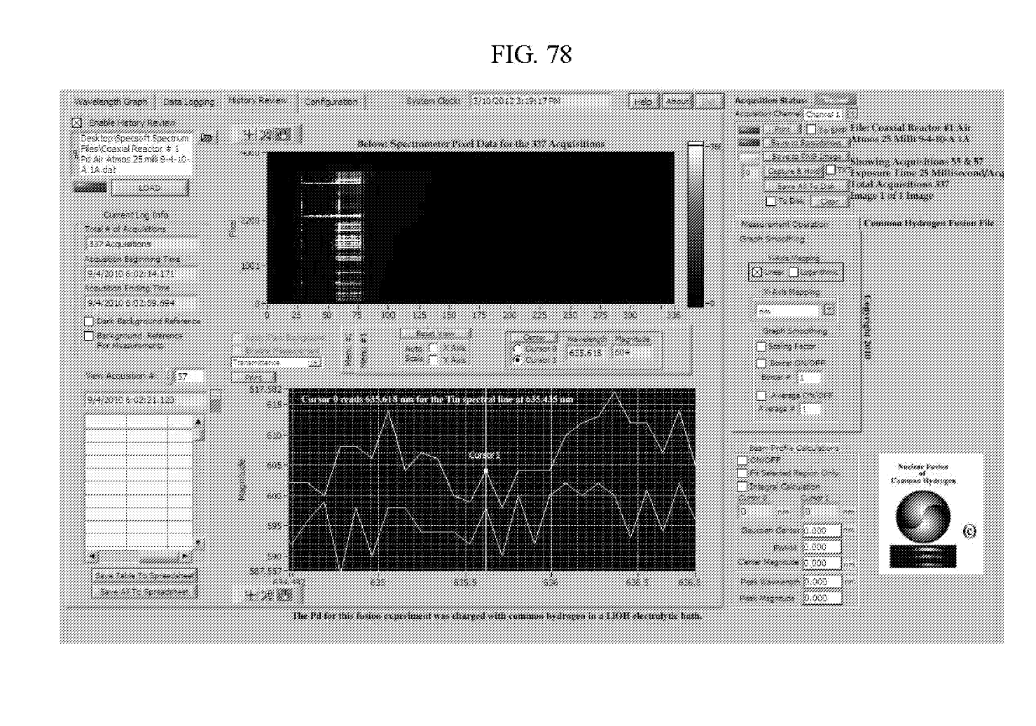

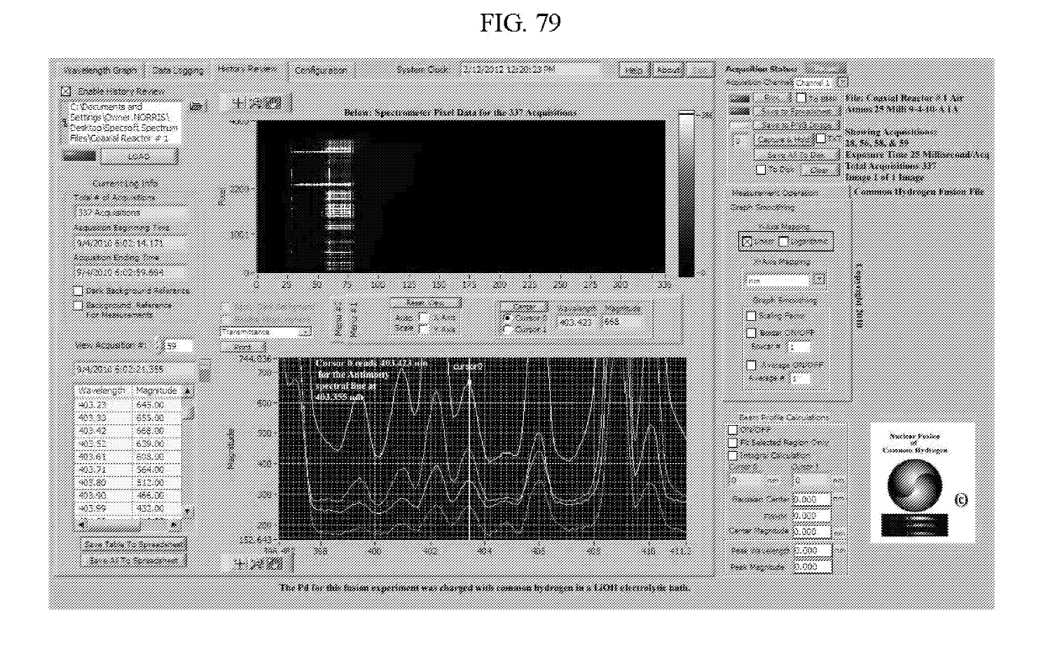

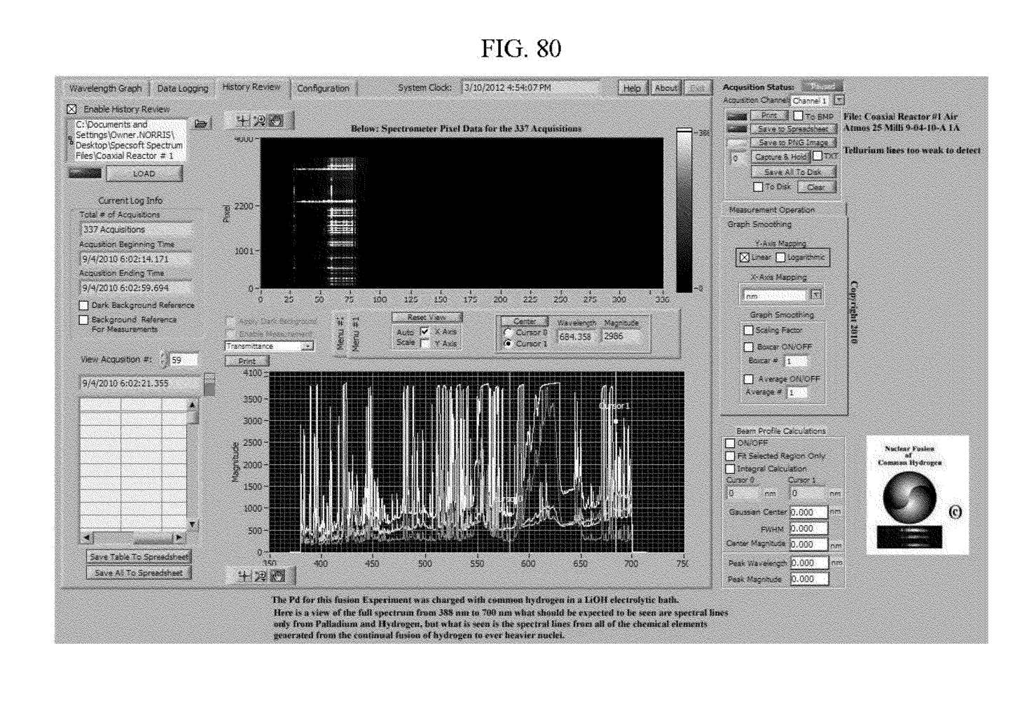

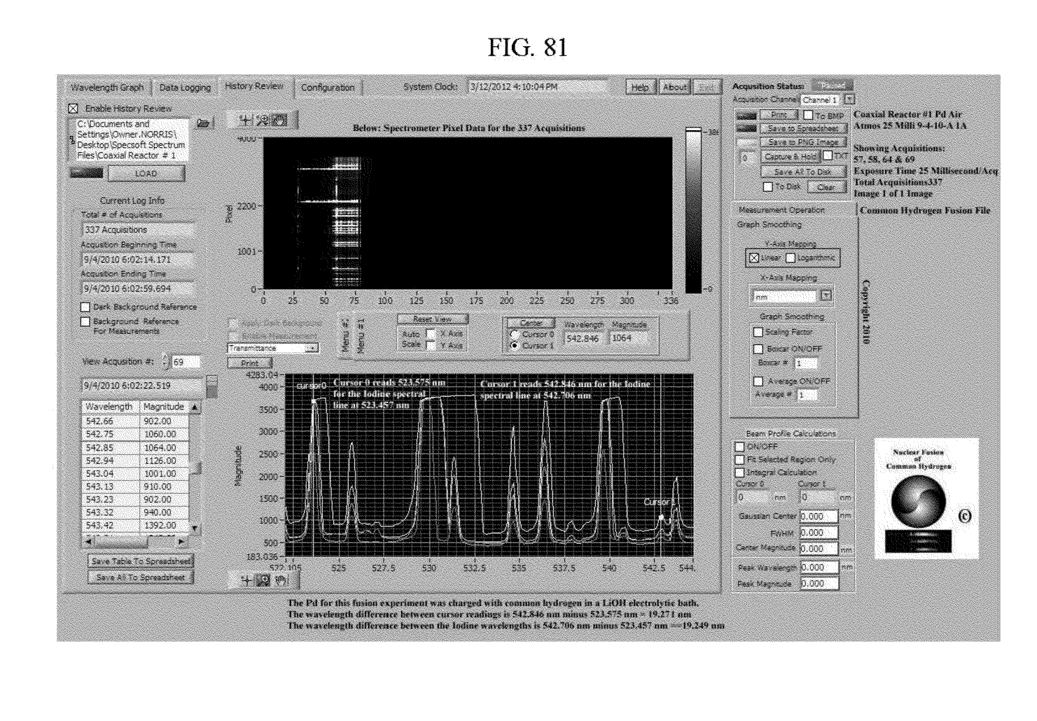

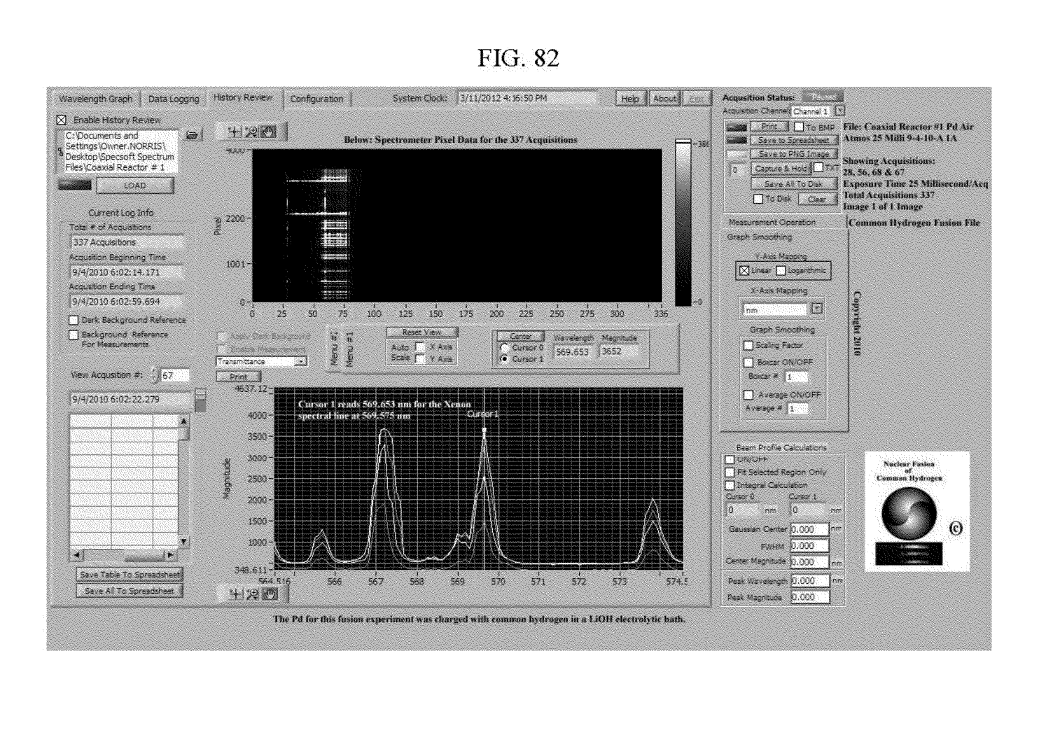

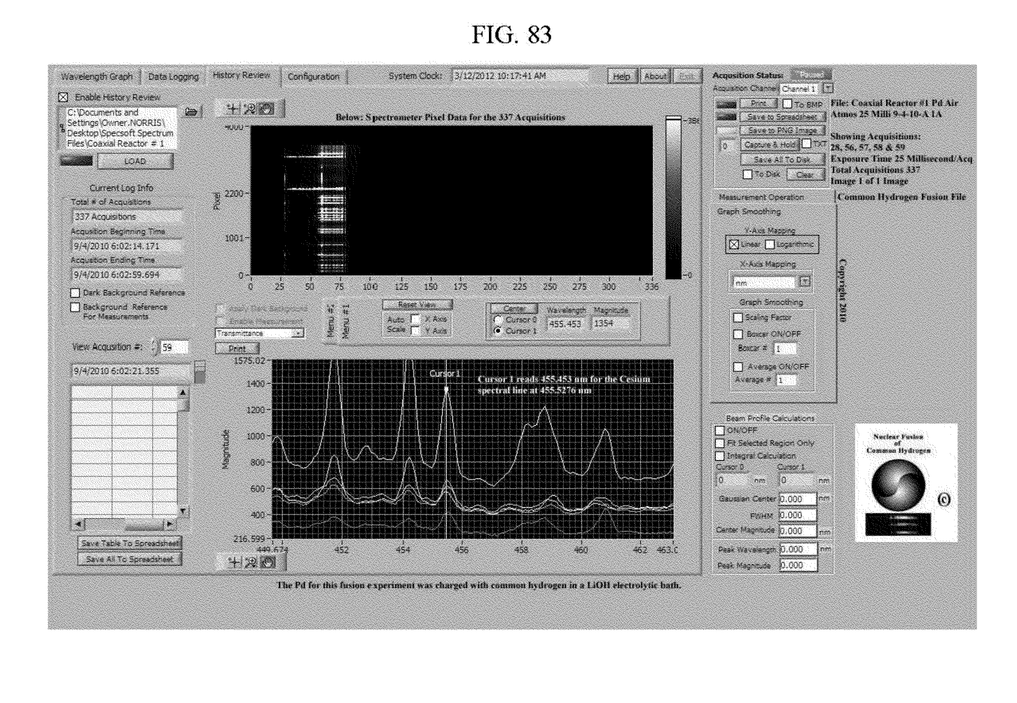

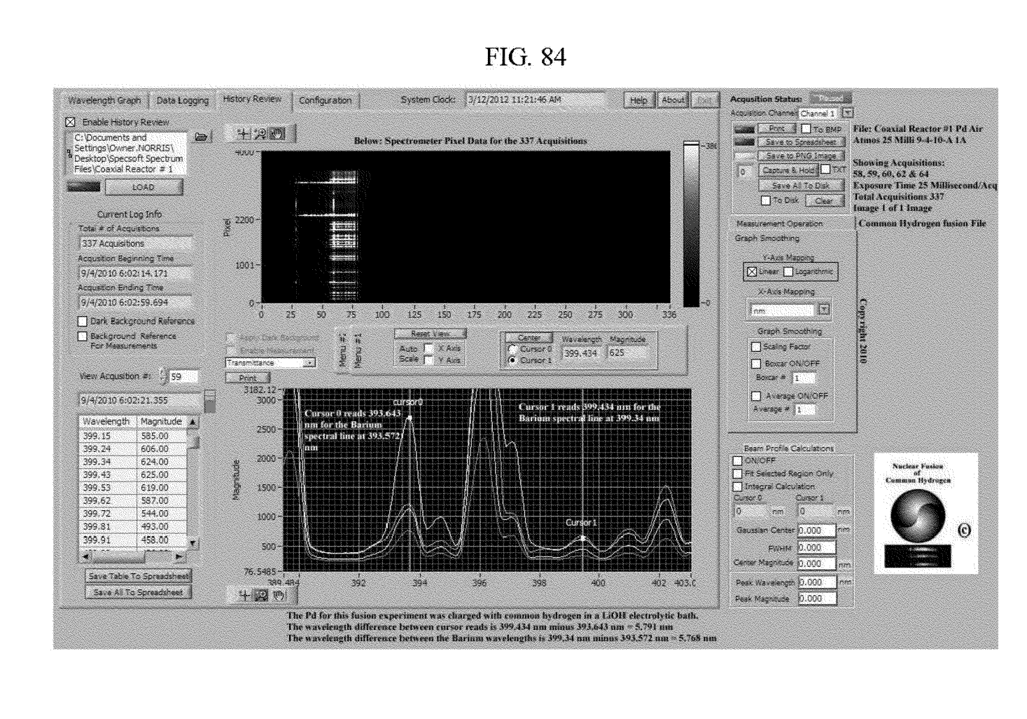

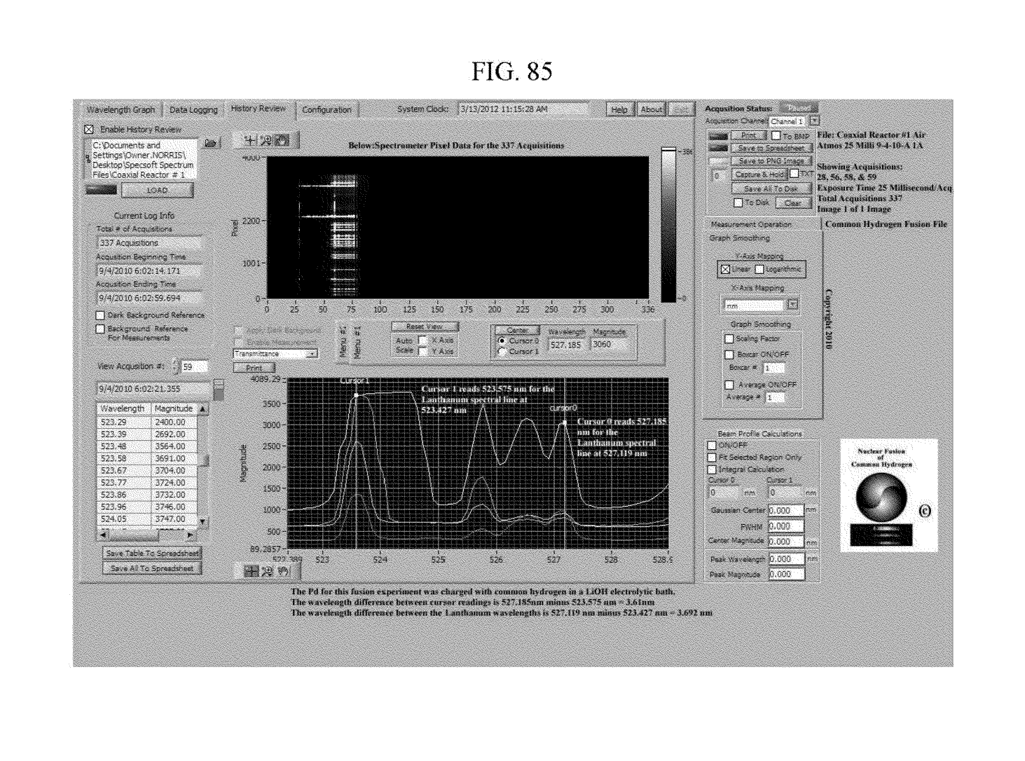

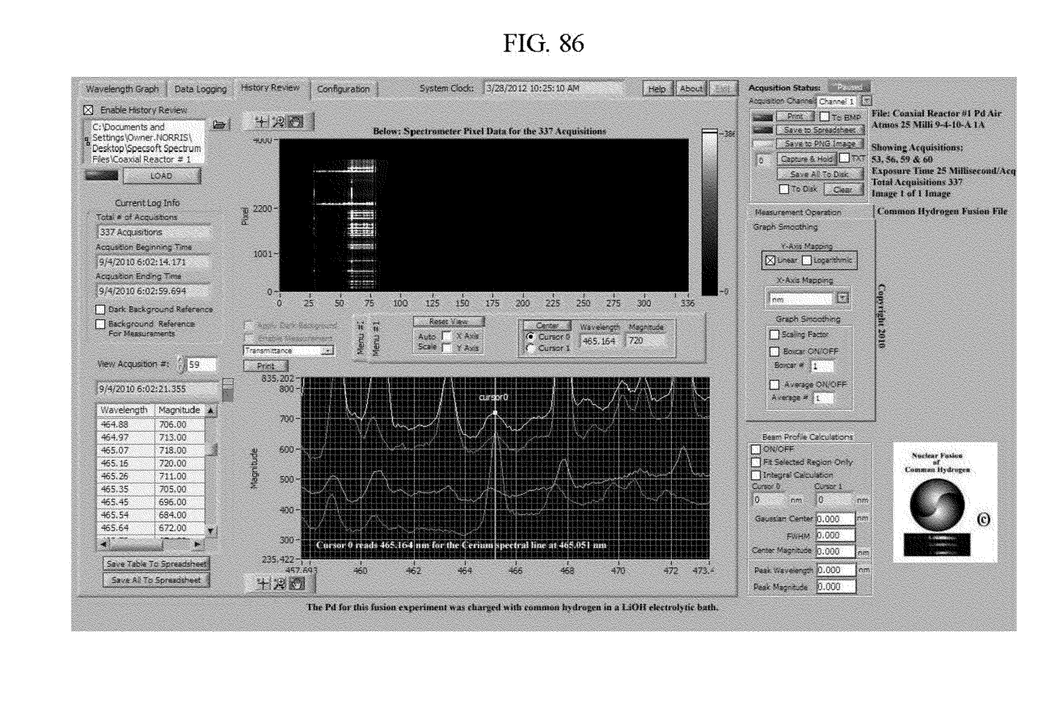

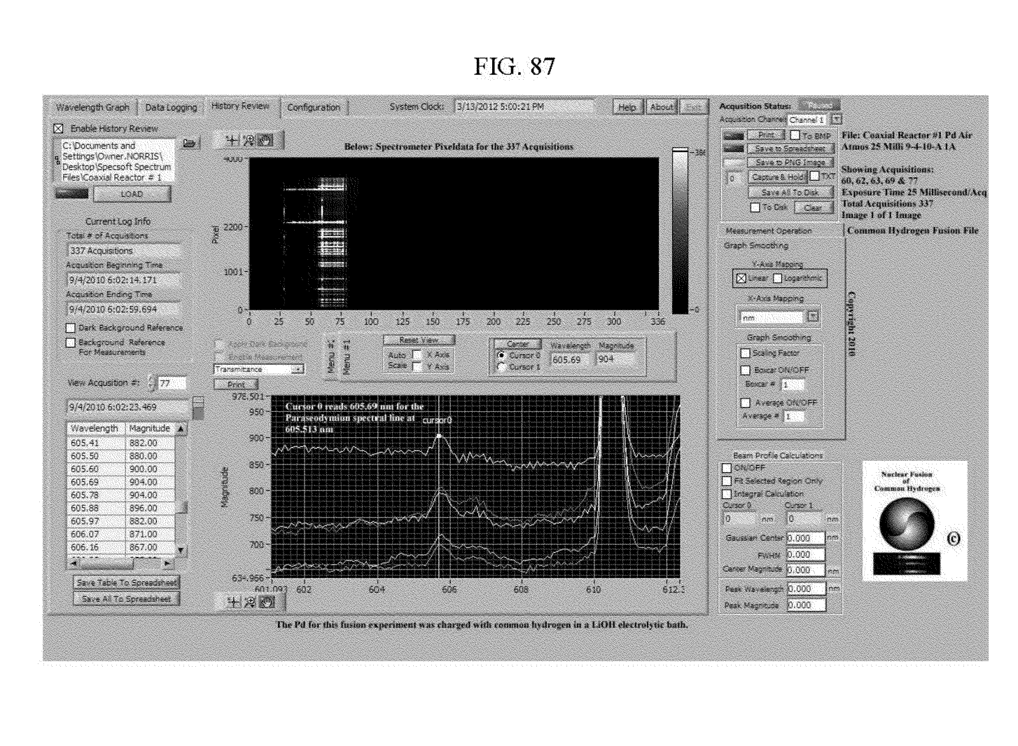

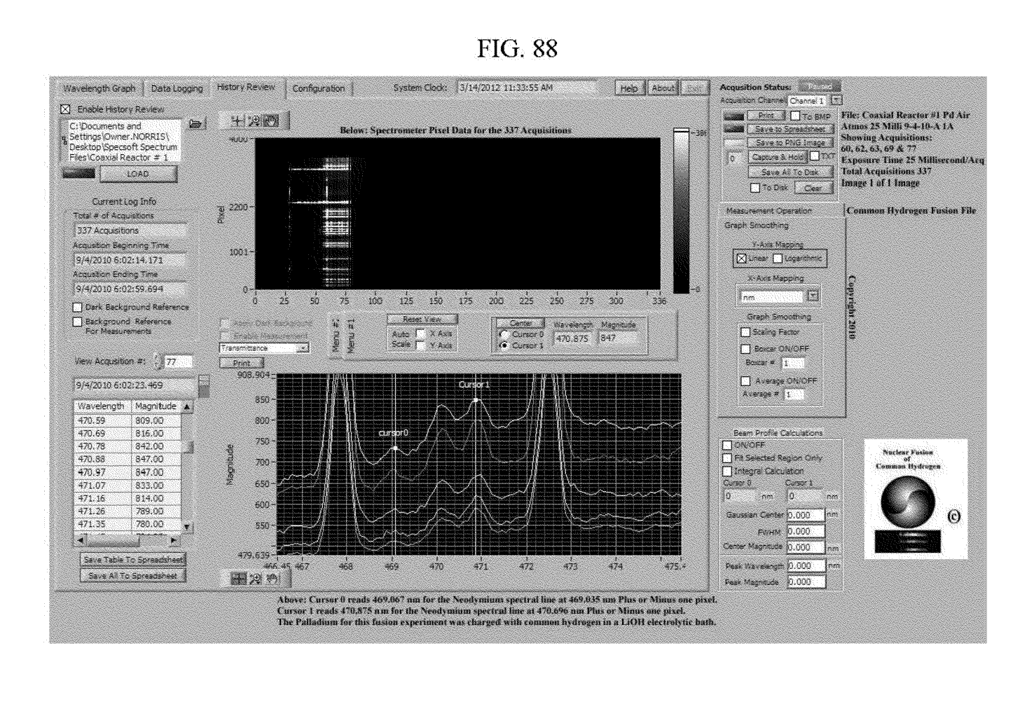

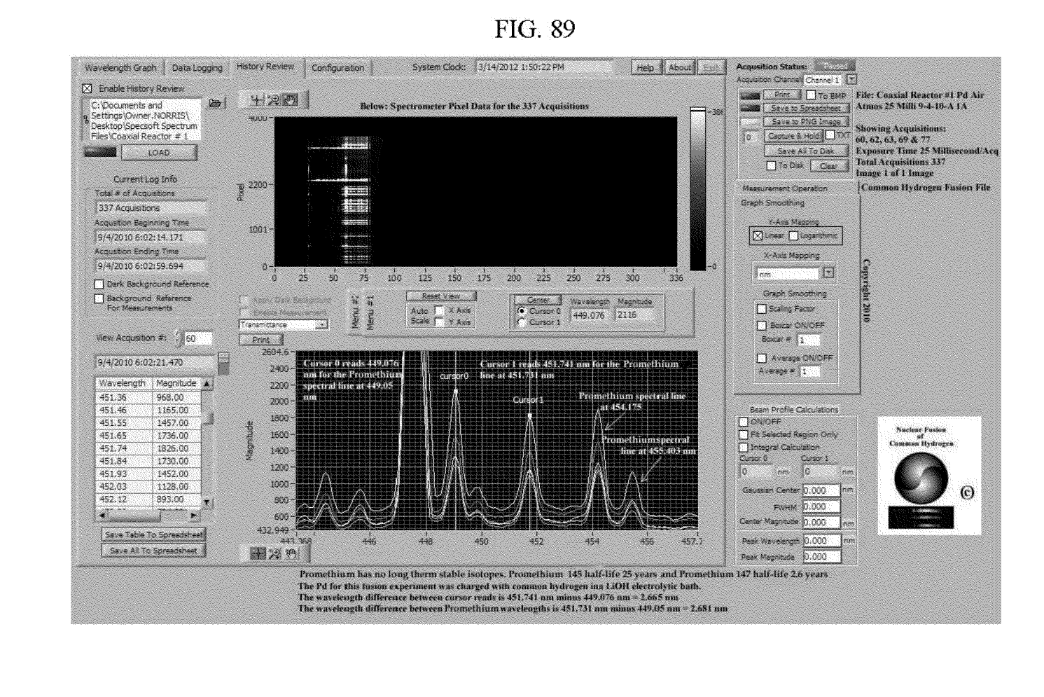

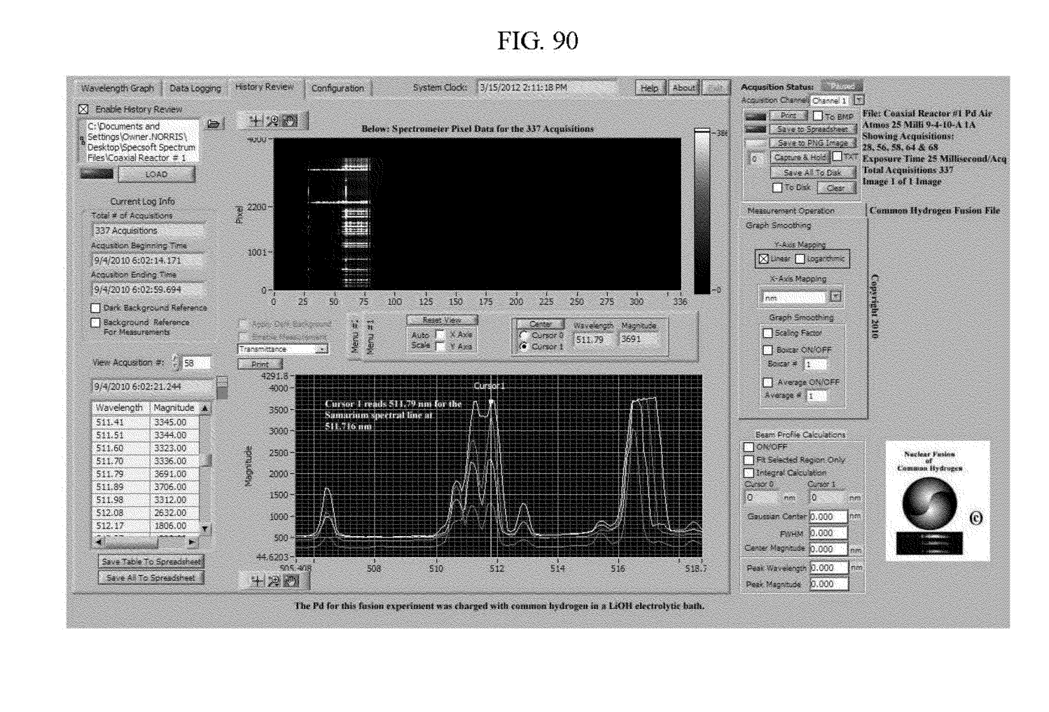

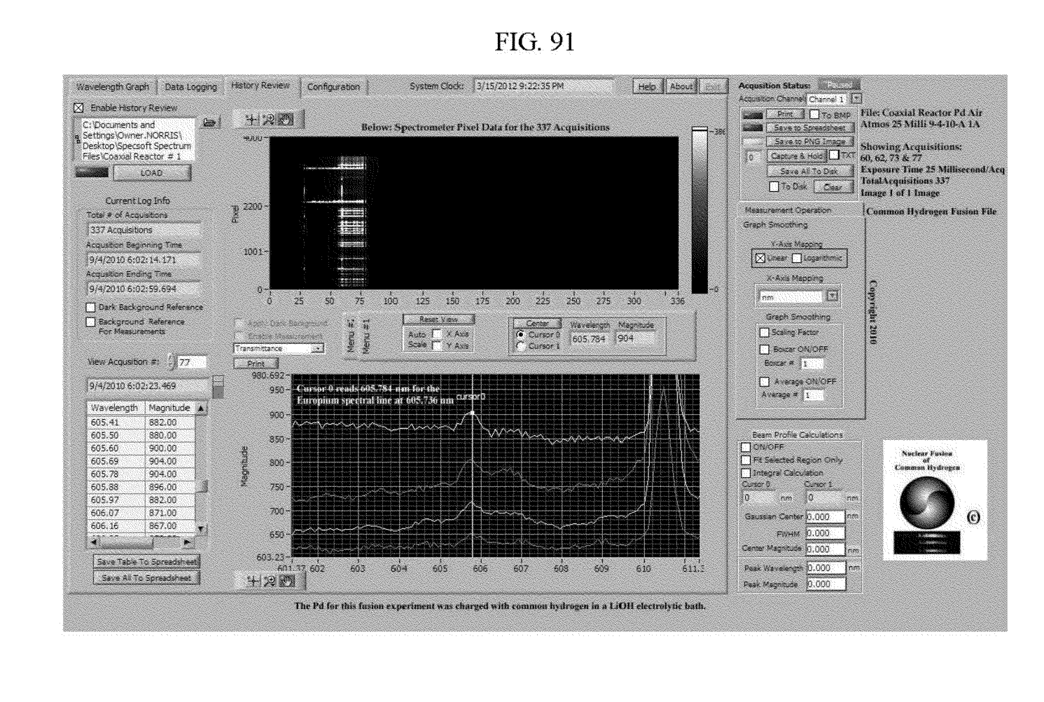

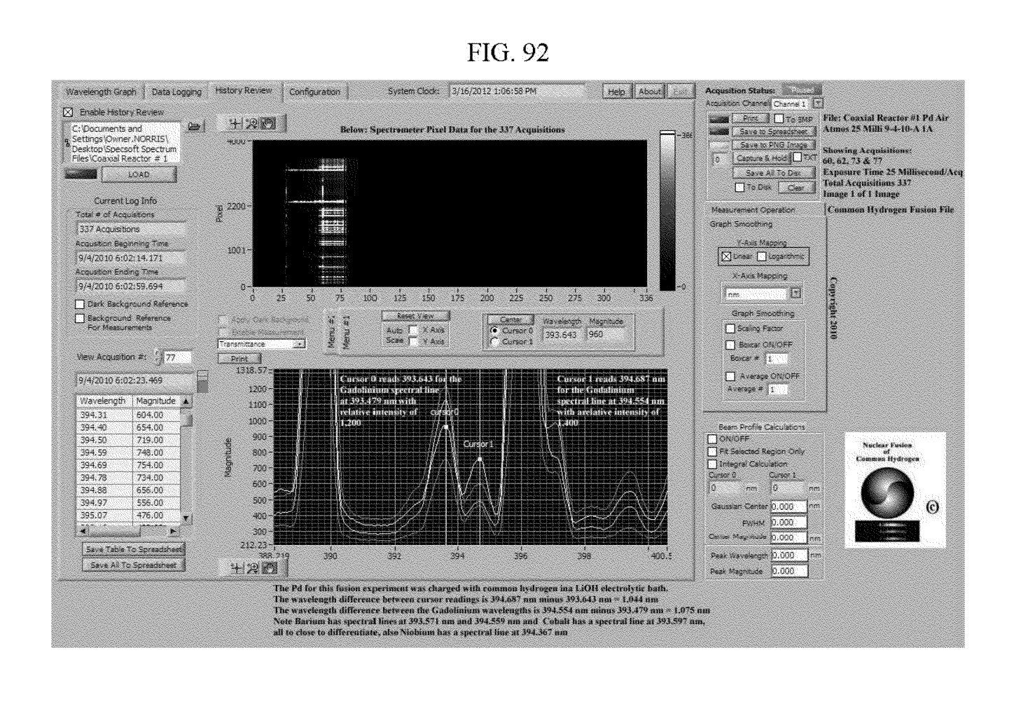

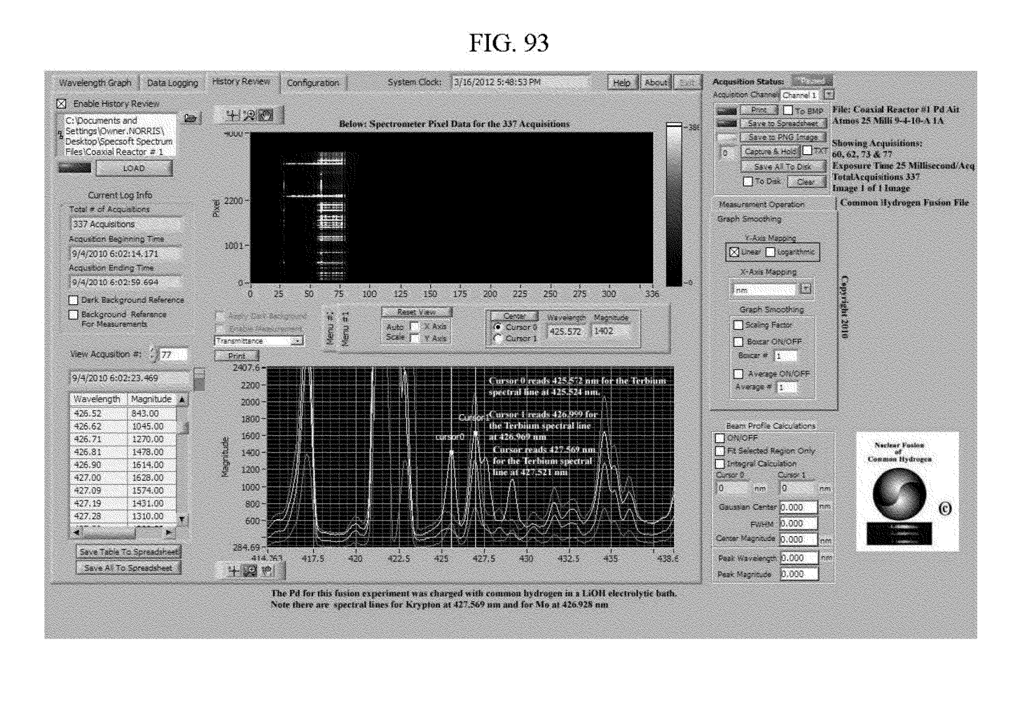

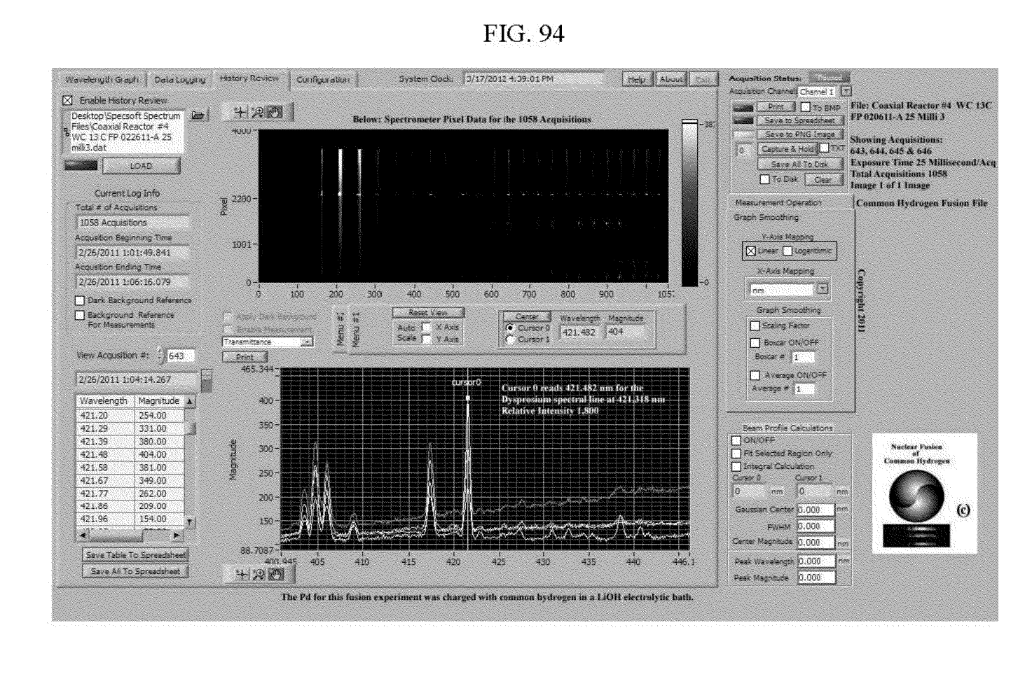

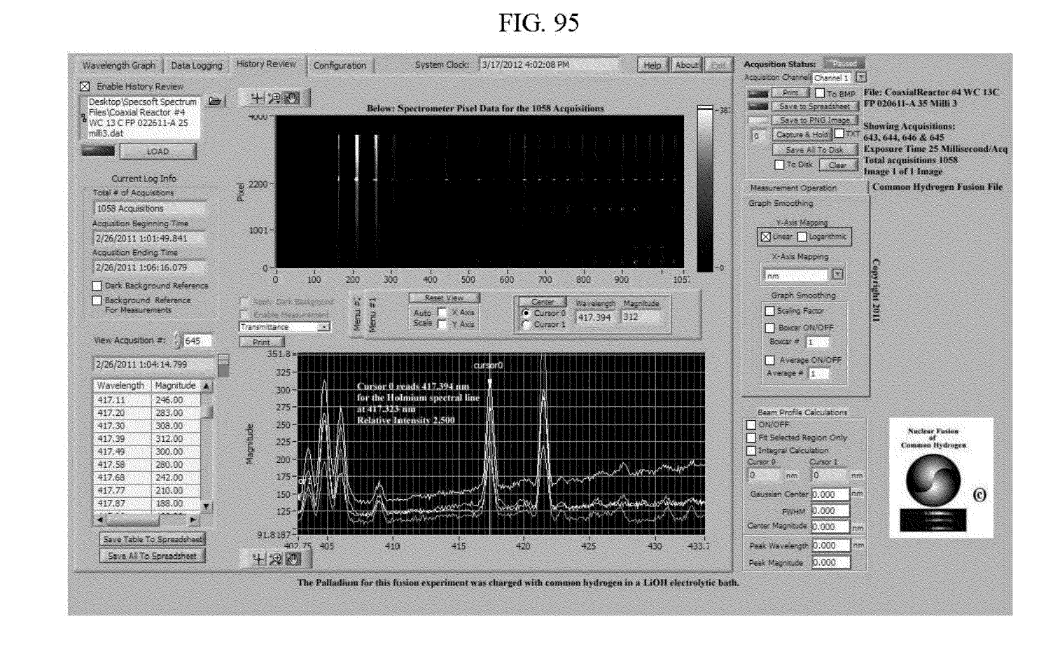

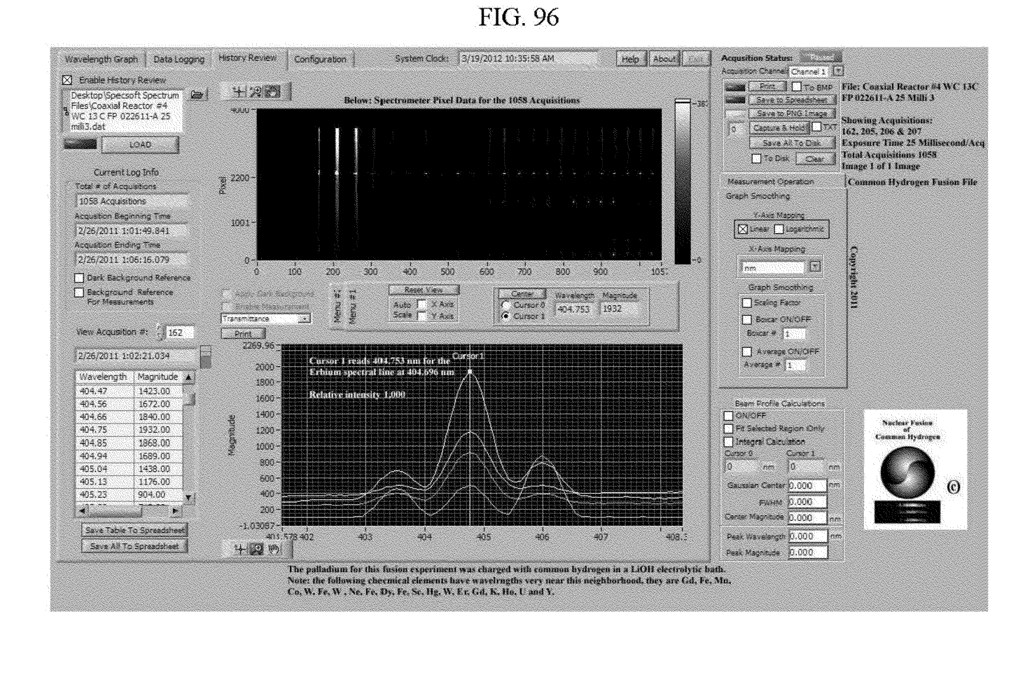

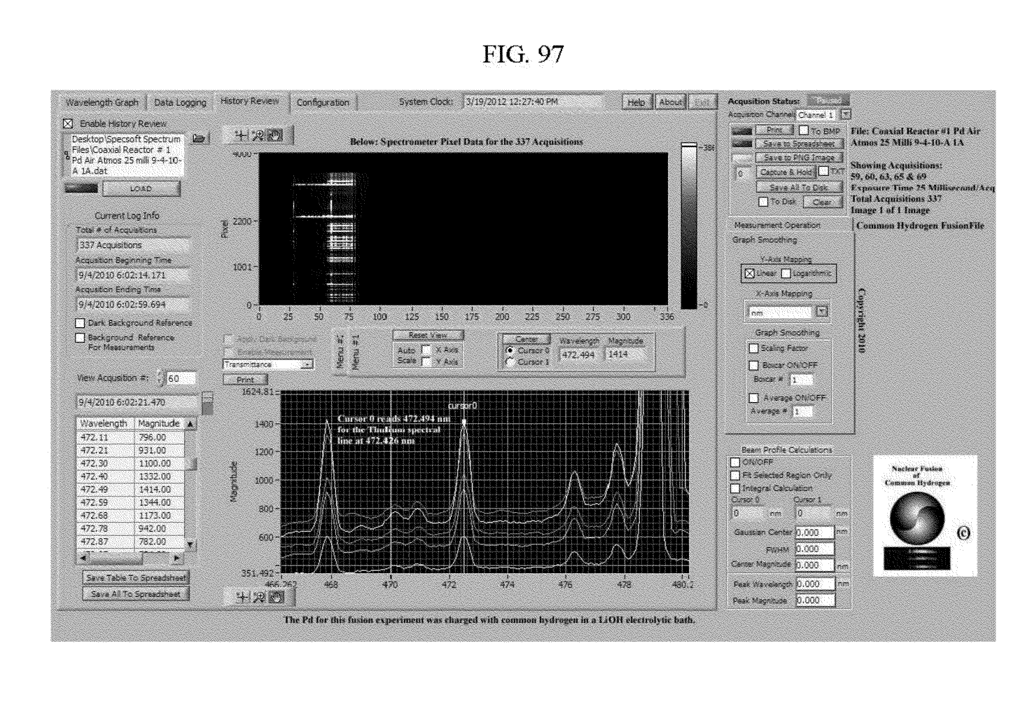

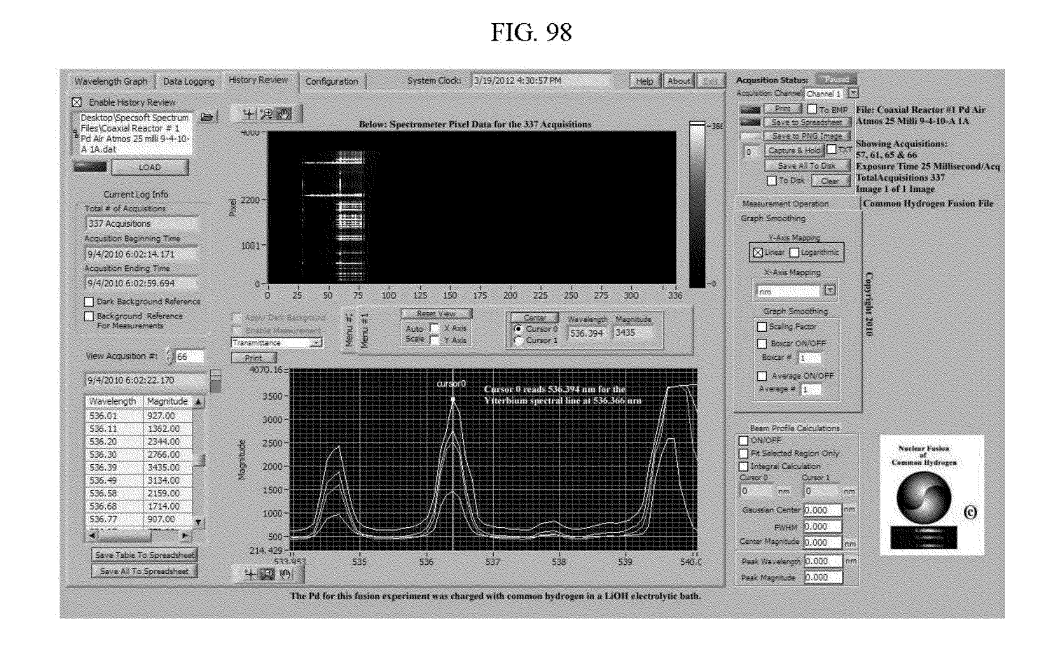

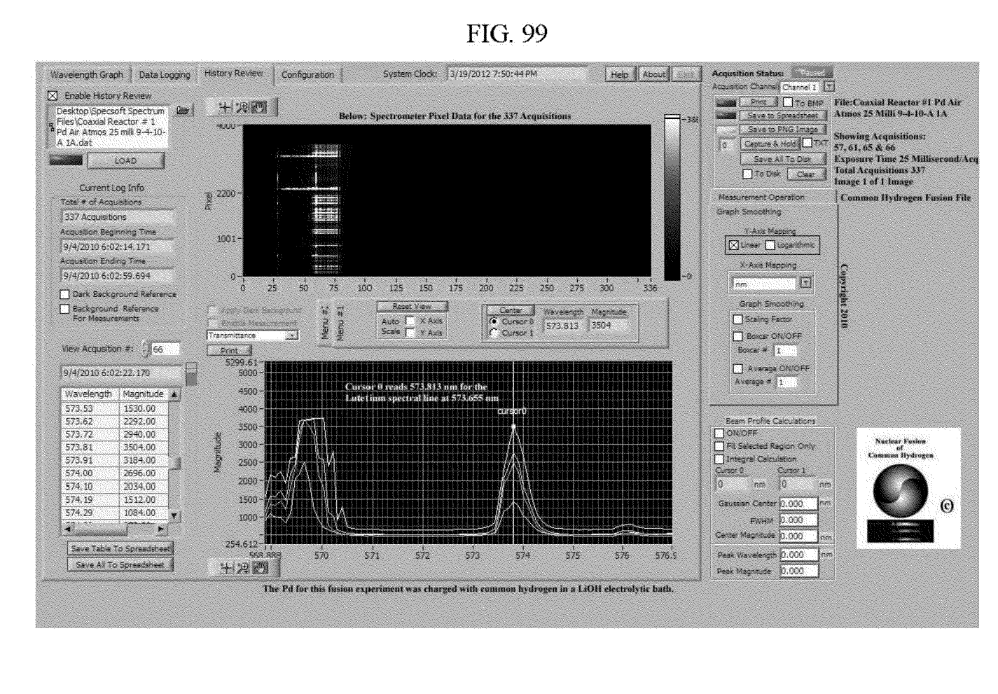

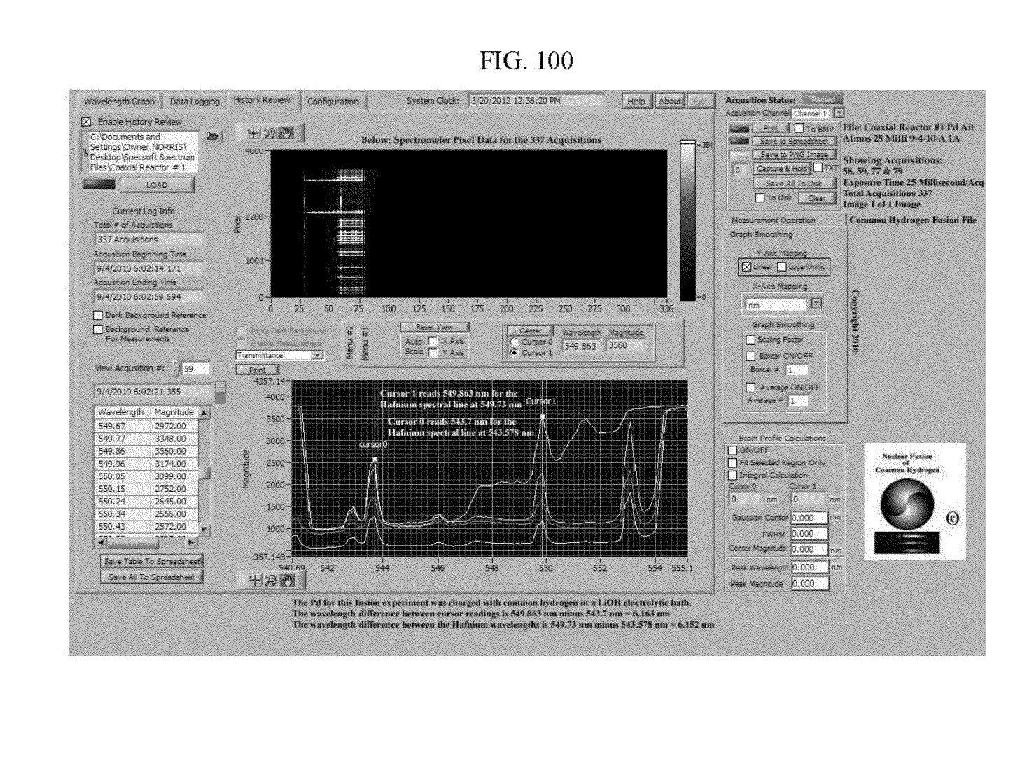

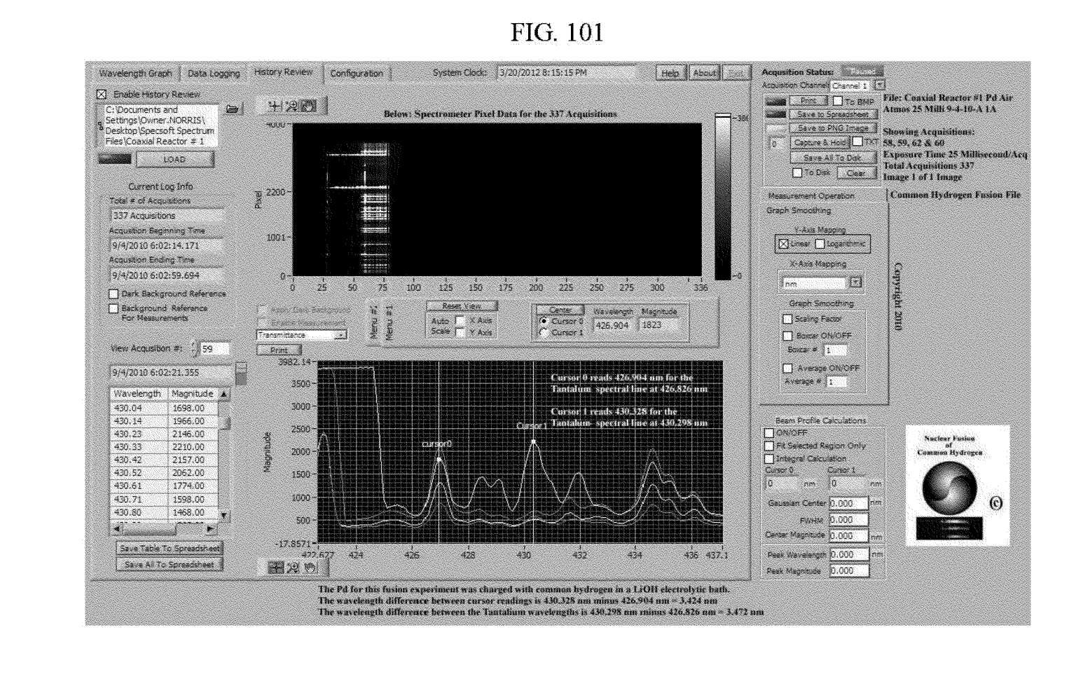

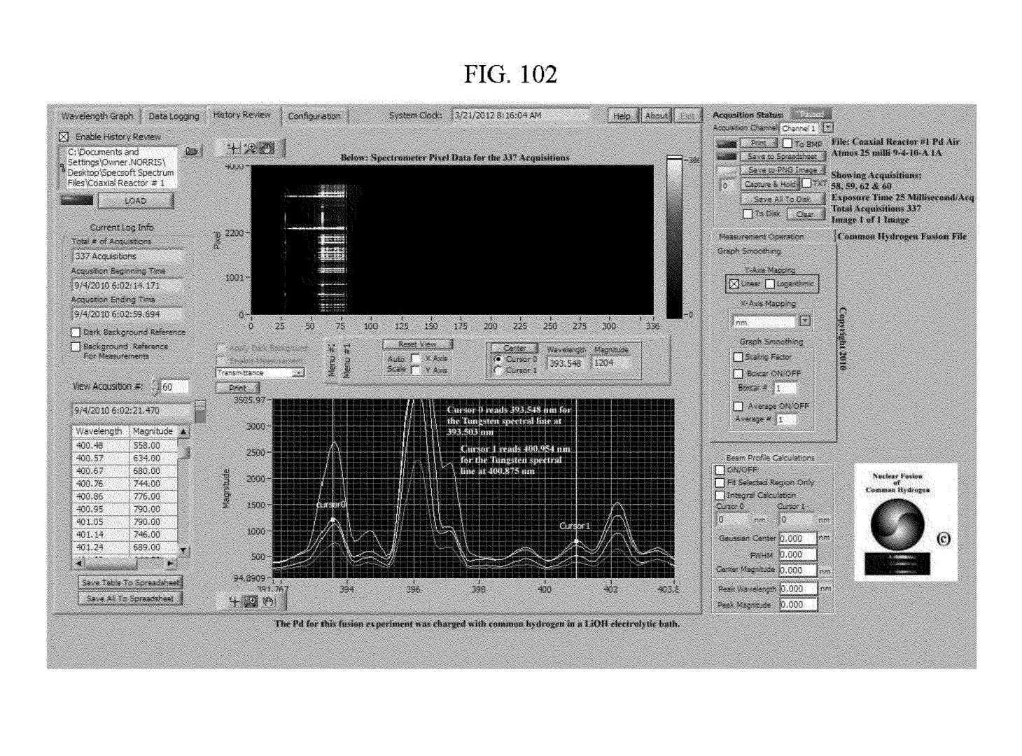

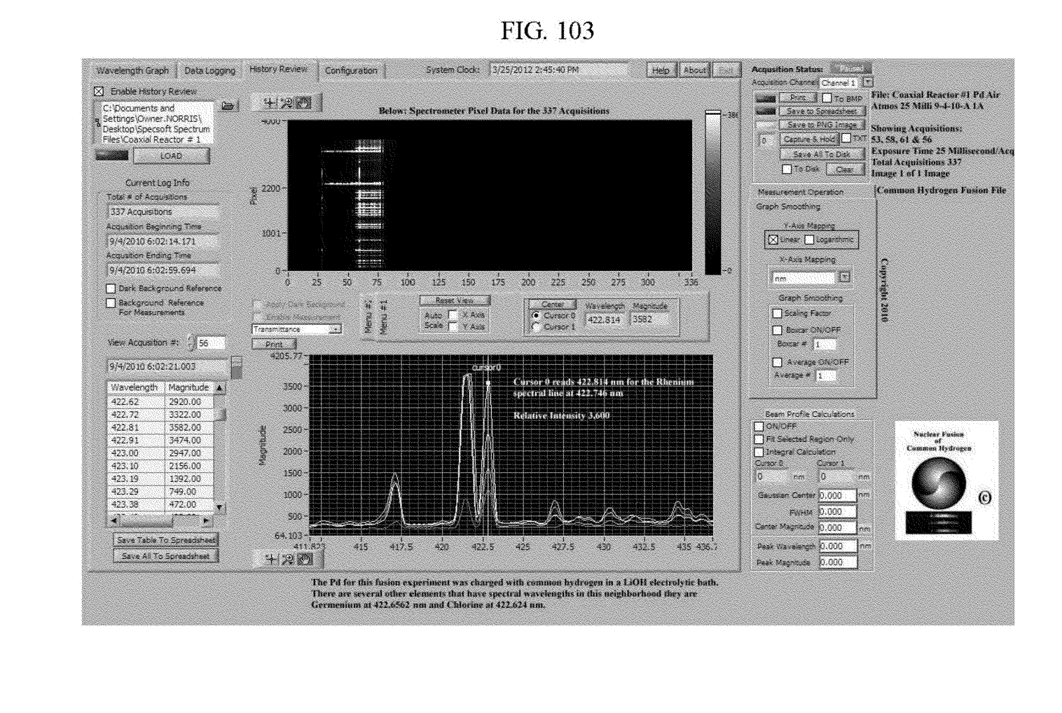

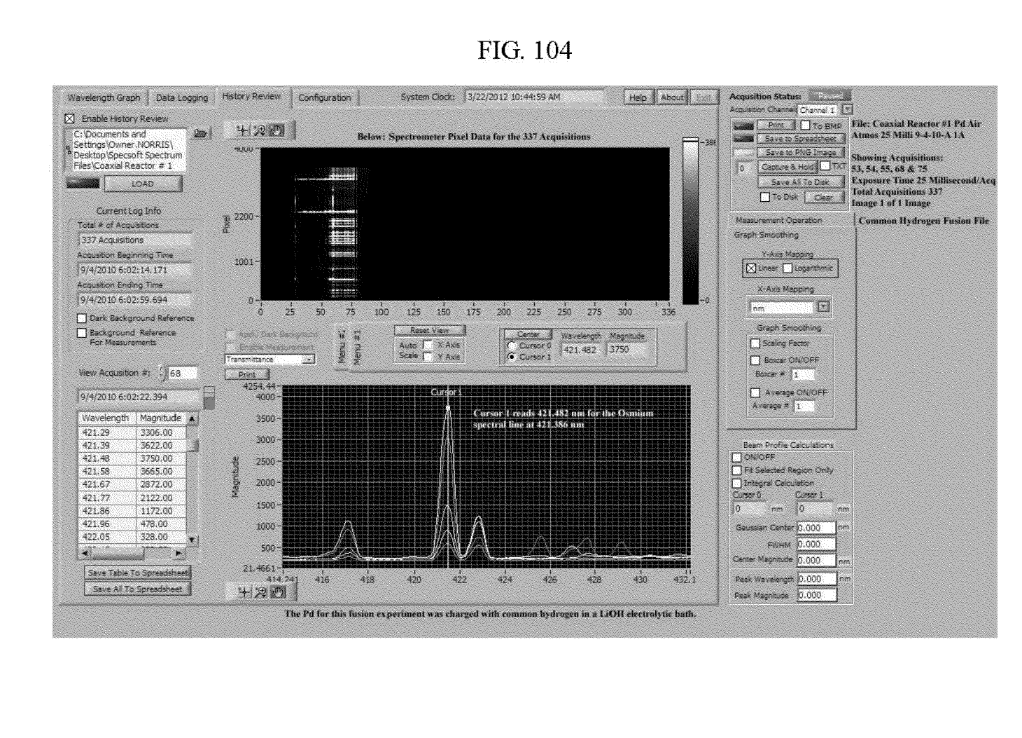

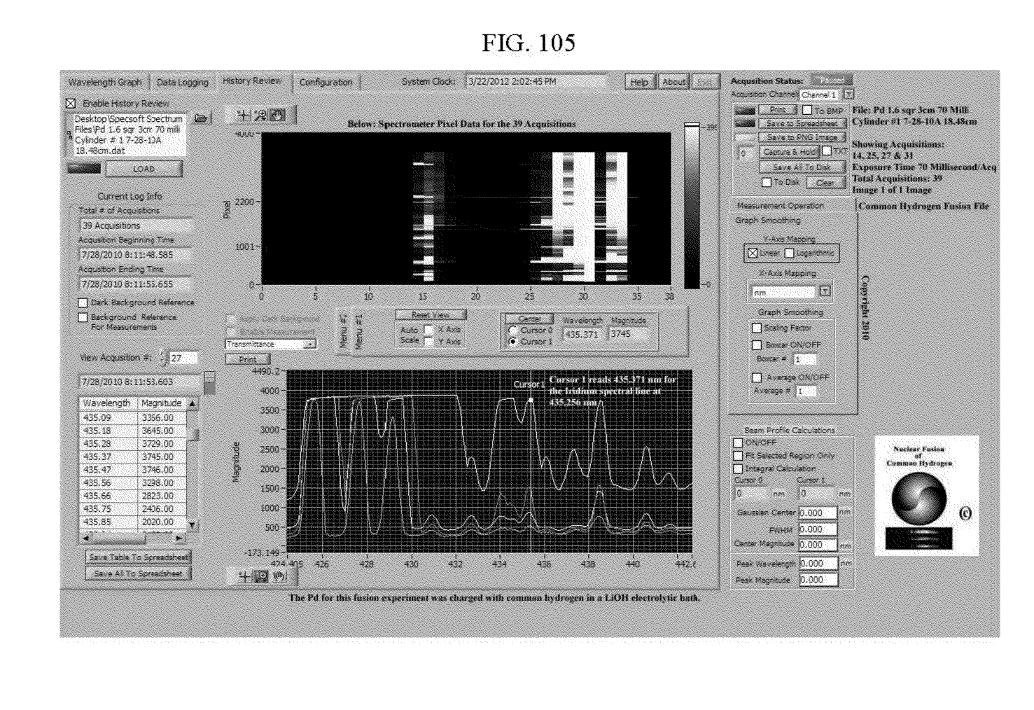

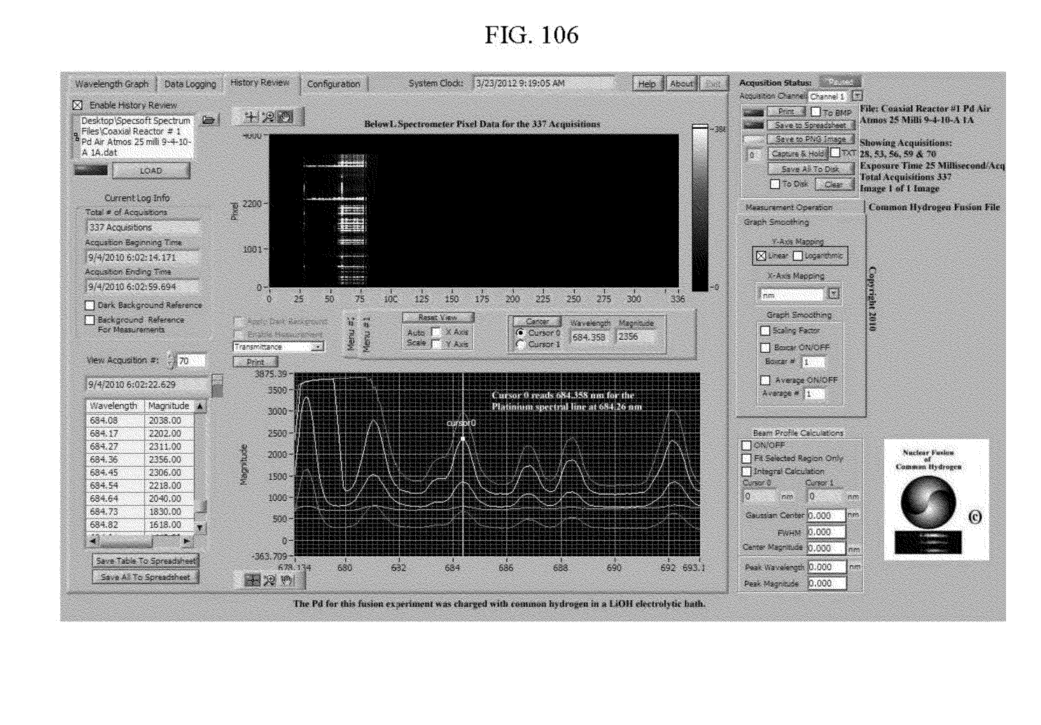

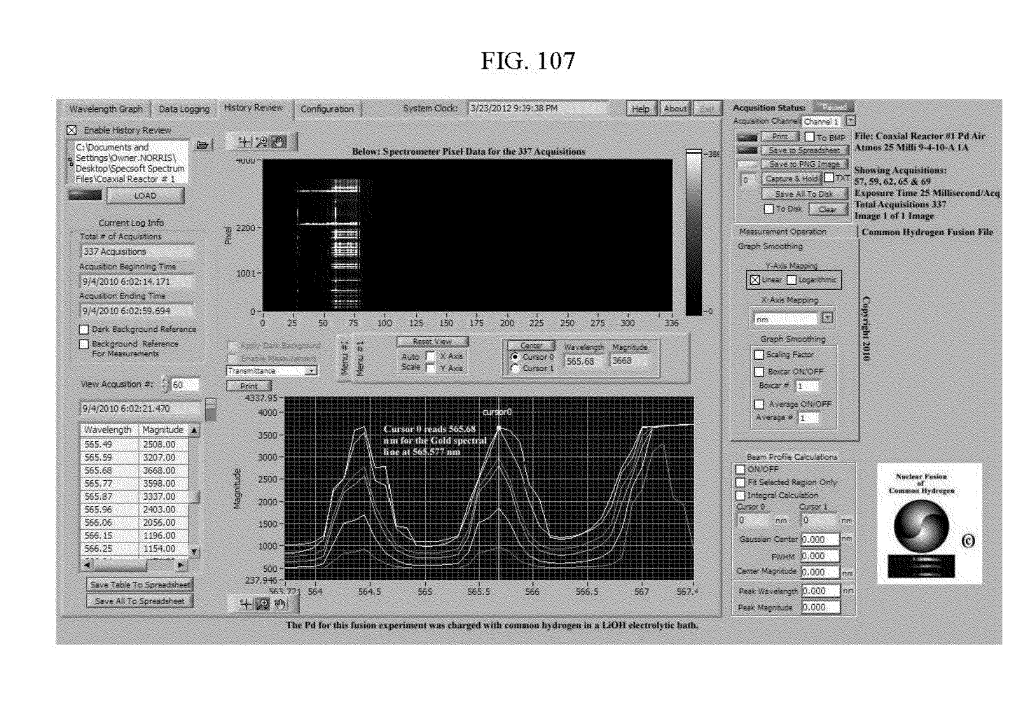

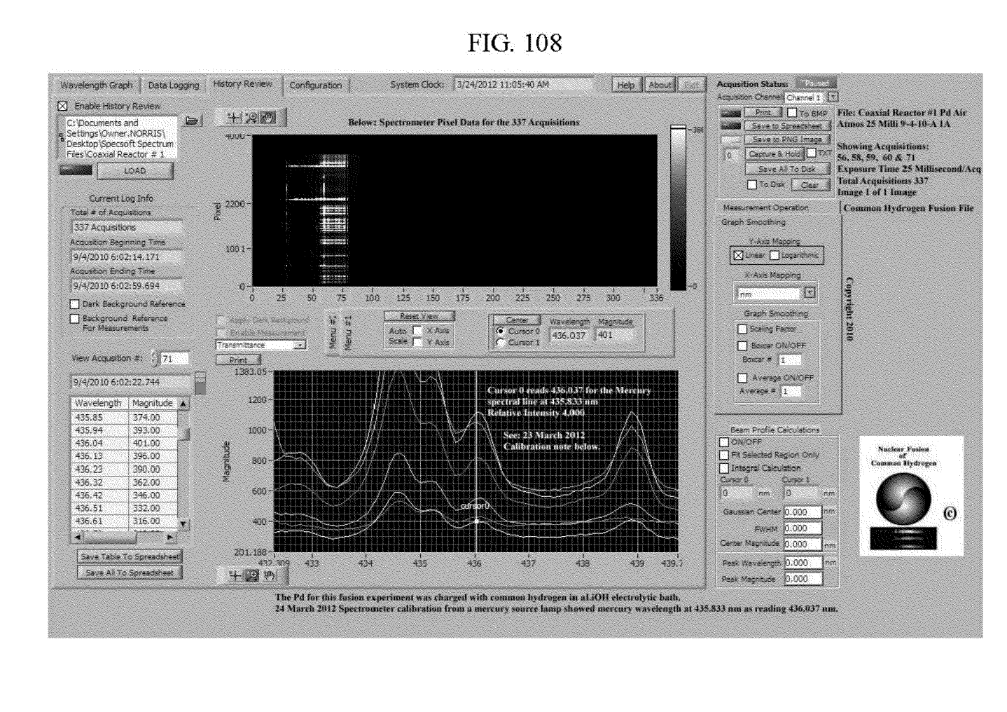

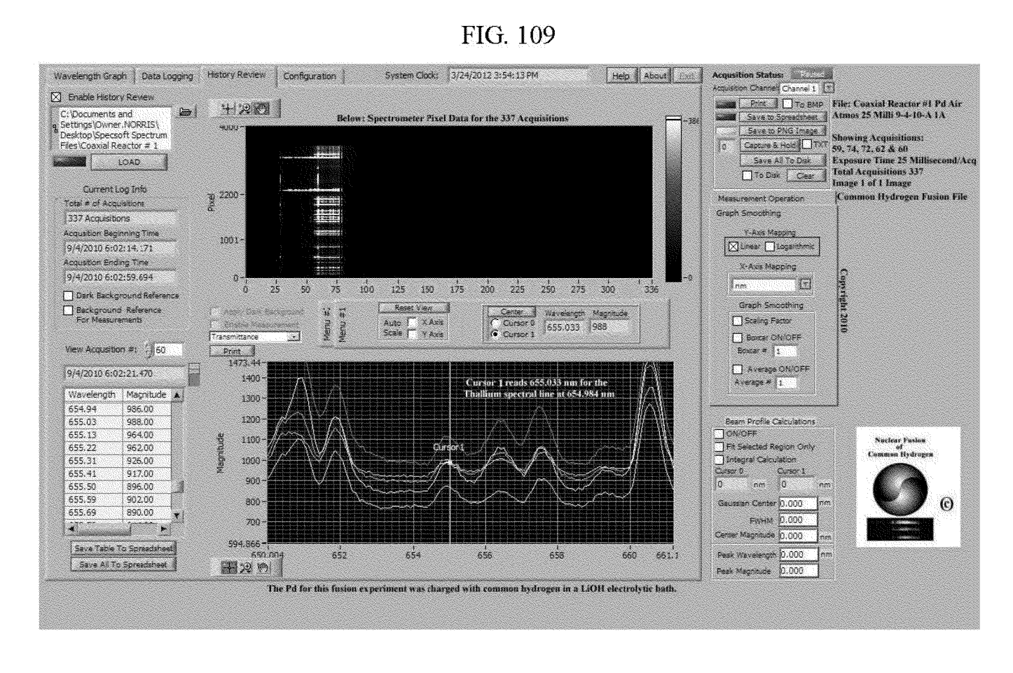

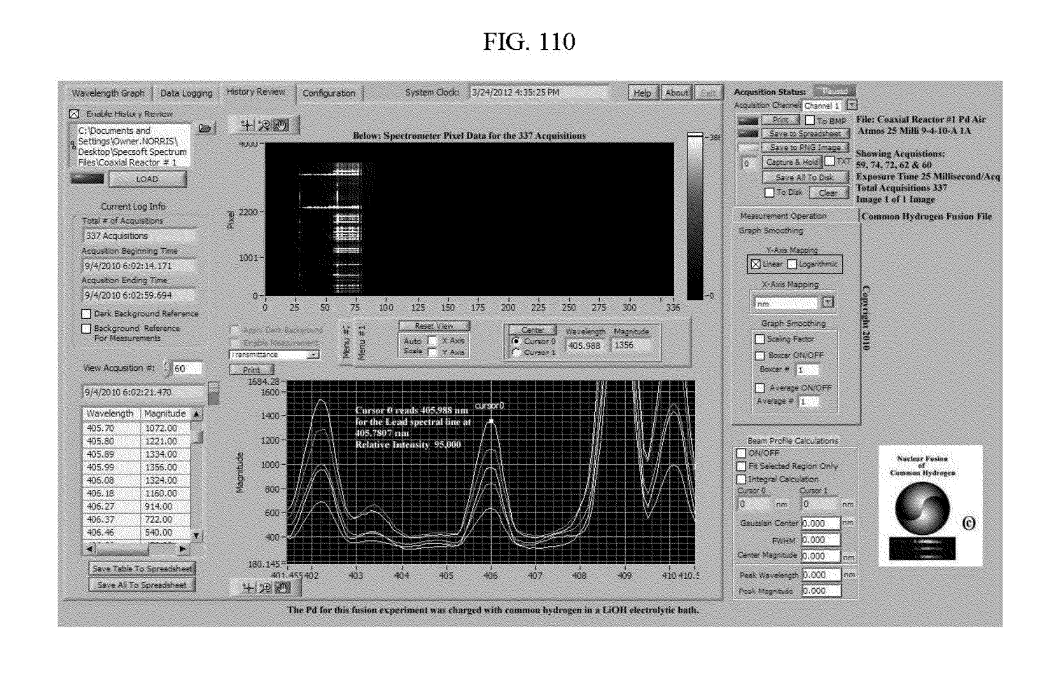

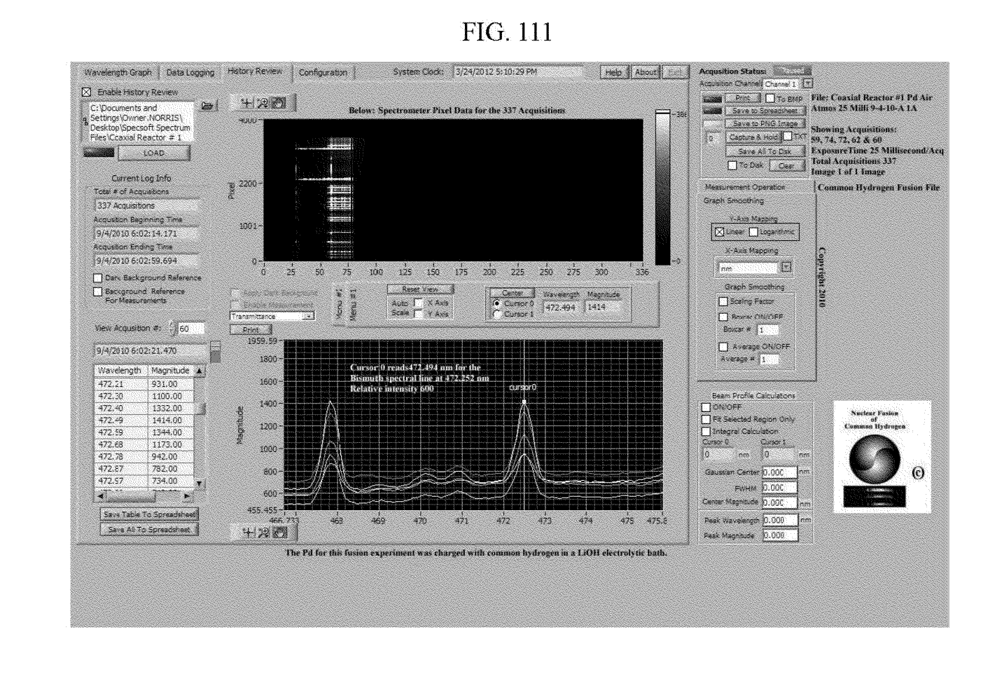

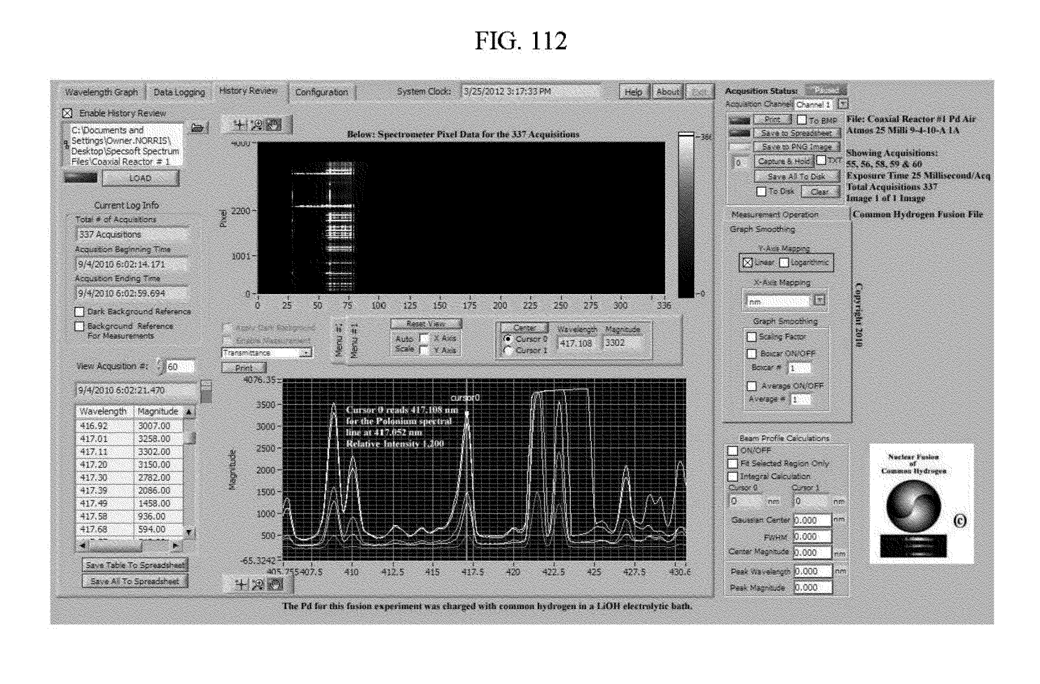

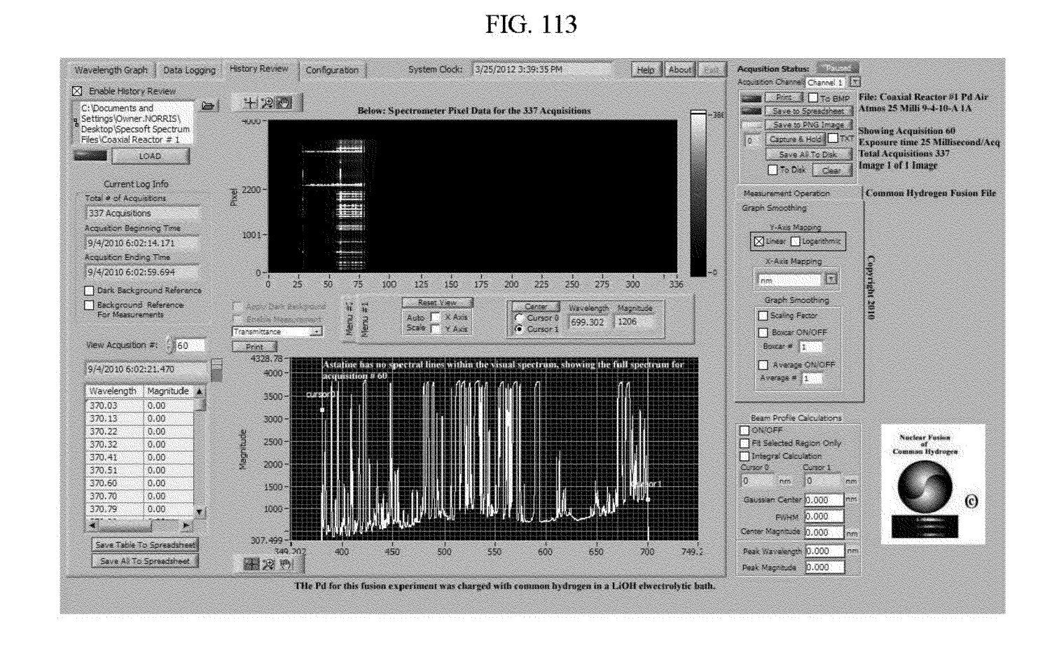

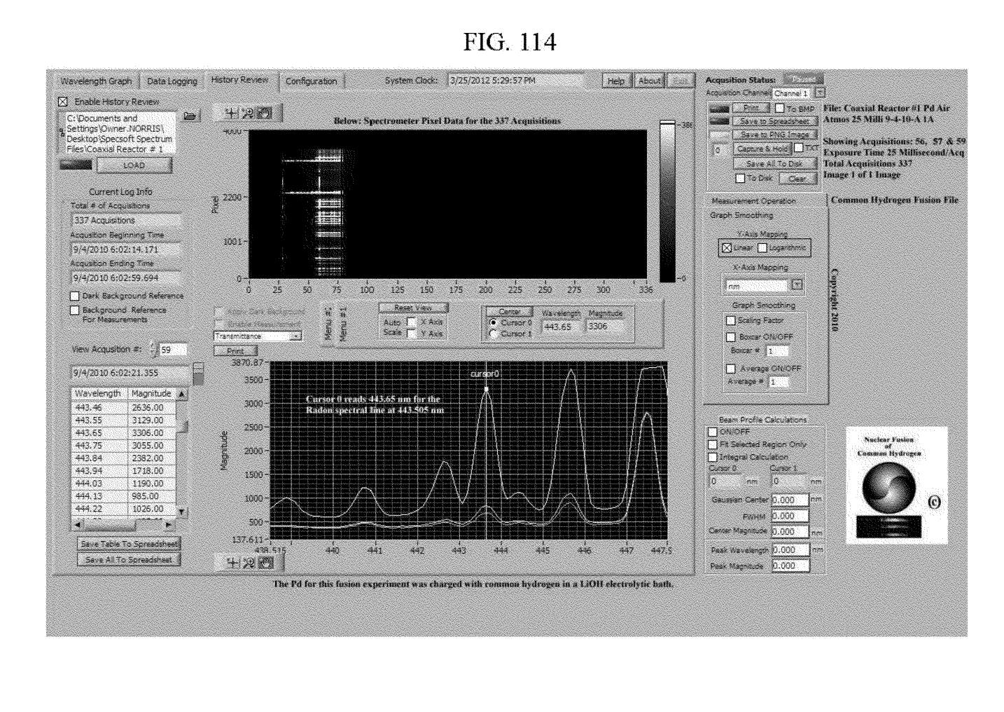

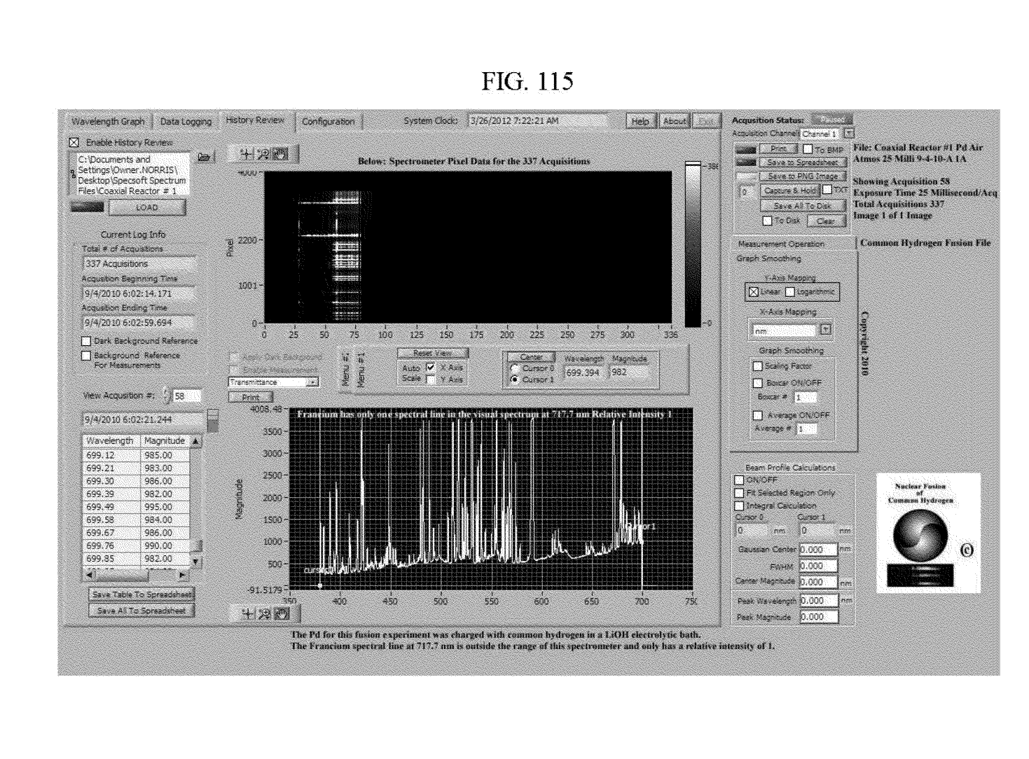

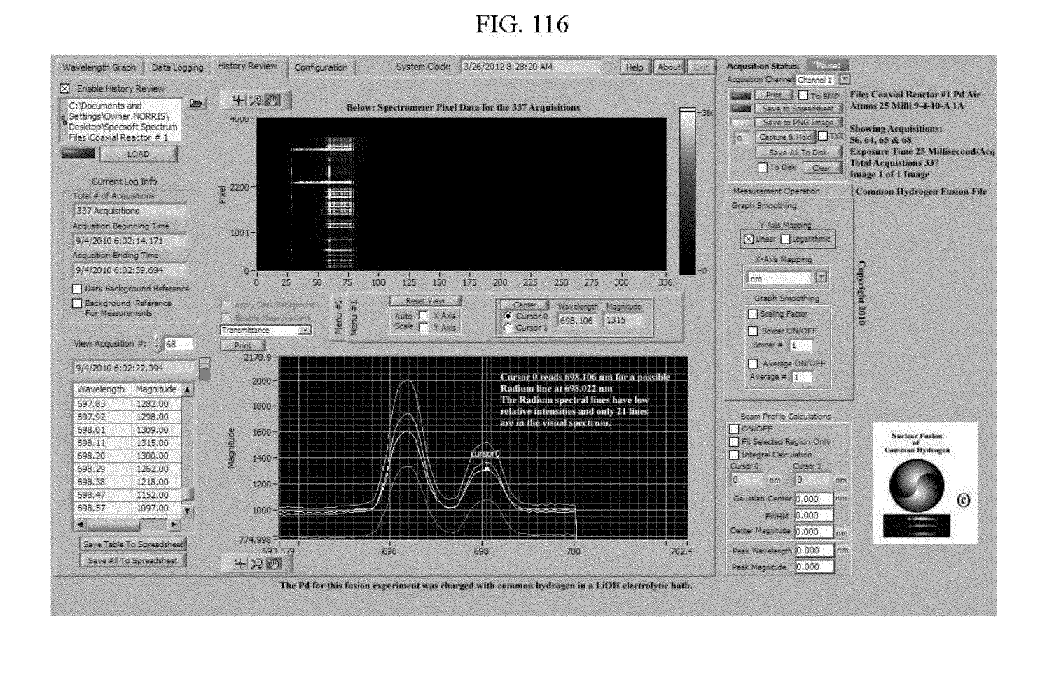

FIG. 16 is a spectrographic image (internal file name: Coaxial Reactor #4 WC 25 Milli 022611-A 112 Atmos FP) showing acquisitions 897, 898, 899 and 900. The spectrometer (SPM-002-A) exposure time was set at 25 millisecond per fusion acquisition. The palladium for this fusion experiment was charged with common hydrogen in a LiOH electrolytic bath. Shown is the hydrogen spectral line at 383.538 nm from the common hydrogen as it exits from the palladium metal and defuses into the common hydrogen atmosphere within the reactor. (Hydrogen, element atomic number 1)

FIG. 17 is a spectrographic image (internal file name: Fe Reactor #1 70 Milli Alloy-1 Air Atmos 041511-A He 388.864 nm) showing fusion acquisitions 408, 241, 250 and 488. The spectrometer (SPM-002-A) exposure time was set at 70 milliseconds per acquisition. Alloy-1 (aluminum) was charged with common hydrogen in a LiOH electrolytic bath. Shown is the fusion-produced Helium spectral line at 388.864 nm. (Helium, element atomic number 2)

FIG. 18 is a spectrographic image (internal file name: Fe Reactor #1 70 Milli Alloy-1 Air Atmos 041511-A He 447.147 nm) showing fusion acquisitions 435, 436, 437 and 474. The spectrometer (SPM-002-A) exposure time was set at 70 milliseconds per fusion acquisition. Alloy-1 (aluminum) was charged with common hydrogen in a LiOH electrolytic bath. Shown is the fusion-produced helium spectral line at 447.147 nm. (Helium, element atomic number 2)

FIG. 19 is a spectrographic image (internal file name: Fe Reactor #1 70 Milli Alloy-1Air Atmos 041511-A He 492.193 nm) showing fusion acquisitions 112, 113, 114, 115 and 116. This figure only shows five acquisitions, but within this fusion experiment, there were 342 acquisitions, which had discernible helium spectral lines at 492.193 nm, 388.864 nm, 447.147 nm, 501.567 nm, 587.567 nm and 667.815 nm. The spectrometer (SPM-002-A) exposure time was set at 70 milliseconds per fusion acquisition. Alloy-1 (aluminum) was charged with common hydrogen in a LiOH electrolytic bath. Shown is the fusion-produced helium spectral line at 492.193 nm, which is the helium spectral line most frequently seen in the common hydrogen fusion spectrographs. (Helium, element atomic number 2)

FIG. 20 is a spectrographic image (internal file name: Fe Reactor #1 70 Milli Alloy-1 Air Atmos 041511-A He 501.567 nm) showing fusion acquisitions 426, 429, 436 and 449. The spectrometer (SPM-002-A) exposure time was set at 70 milliseconds per acquisition. Alloy-1 (aluminum) was charged with common hydrogen in a LiOH electrolytic bath. Shown is the fusion-produced helium spectral line at 501.567 nm. (Helium, element atomic number 2)

FIG. 21 is a spectrographic image (internal file name: Fe Reactor #1 70 Milli Alloy-1 Air Atmos 041511-A He 587.563 nm) showing fusion acquisitions 157, 243, 254, 365 and 450. The Spectrometer (SPM-002-A) exposure time was set at 70 milliseconds per acquisition. Alloy-1 (aluminum) was charged with common hydrogen in a LiOH electrolytic bath. Shown is the fusion-produced helium spectral line at 587.562 nm. (Helium, element atomic number 2)

FIG. 22 is a spectrographic image (internal file name: Fe Reactor #1 70 Milli Alloy-1 Air Atmos 041511-A He 587.562 nm) showing fusion acquisitions 483, 485, 486 and 489. The spectrometer (SPM-002-A) exposure time was set at 70 milliseconds per acquisition. Alloy-1 (aluminum) was charged with common hydrogen in a LiOH electrolytic bath. Shown is the fusion-produced helium spectral line at 667.815 nm. (Helium, element atomic number 2)

FIG. 23 is a spectrographic image (internal file name: MgSO4 Pd 112709-A 70 ms.) showing fusion acquisitions 284, 285, 287, 290 and 292. The spectrometer (SPM-002-A) exposure time was set at 70 milliseconds per acquisition. The palladium of this fusion experiment was charged with common hydrogen in a magnesium sulfate electrolytic bath. Shown is the fusion-produced helium spectral line at 686.748 nm. (Helium, element atomic number 2)

FIG. 24 is a spectrographic image (internal file name: MgSO4 Pd 112709-A 70 Milli.) showing fusion acquisitions 284, 285, 287, 290 and 292. The spectrometer (SPM-002-A) exposure time was set at 70 milliseconds per acquisition. The palladium of this fusion was charged with common hydrogen in a magnesium sulfate electrolytic bath. This electrolyte was used to avoid lithium contamination from charging with common hydrogen in a LiOH electrolytic bath. Shown are the fusion-produced lithium spectral lines at 670.776 nm and 670.791 nm. Both lines are too close in wavelength to be individually resolved by the SPM-002-A spectrometer. (Lithium, element atomic number 3)

FIG. 25 is a spectrographic image (internal file name: Pd deut 200 ms 020409-A) showing fusion acquisitions 11, 12, 13, 15 and 18. This fusion reaction was conducted in an RF confinement cage. The spectrometer (SPM-002-A) exposure time was set at 200 milliseconds per acquisition. The palladium for this fusion experiment was charged with deuterons in June of 1989 in a LiOD electrolytic bath. Shown is the fusion-produced lithium spectral line at 610.352 nm. (Lithium, element atomic number 3)

FIG. 26 is a spectrographic image (internal file name: Coaxial Reactor #3 WC 100 Milli 020511-A H2 Atmos FP) showing fusion acquisitions 13, 15, 16, 17 and 18. The palladium for this fusion experiment was charged with common hydrogen in a LiOH electrolytic bath. The spectrometer (SPM-002-A) exposure time was set at 100 milliseconds per acquisition. Shown is the fusion-produced lithium spectral line at 610.354 nm produced from common hydrogen fusion, whereas the spectrograph of FIG. 25 shows lithium produced from the fusion of heavy hydrogen. (Lithium, element atomic number 3)

FIG. 27 is a spectrographic image (internal file name: MgSO4 Pd 112709-A 20 ms Be 688.422 & Be 688.444) showing fusion acquisitions 284, 285, 287, 290 and 292. The palladium for this fusion experiment was charged with common hydrogen in a Magnesium Sulfate electrolytic bath. The spectrometer (SPM-002-A) exposure time was set at 20 milliseconds per acquisition. Shown are the fusion-produced spectral lines for Be at 688.422 nm and 688.444 nm. Both lines are too close to be individually resolved by the spectrometer. (Beryllium, element atomic number 4)

FIG. 28 is a spectrographic image (internal file name: MgSO4 Pd 112709-A 70 ms) showing fusion acquisitions 284, 285, 287, 290 and 292. The palladium for this fusion experiment was charged with common hydrogen in a LiOH electrolytic bath. The spectrometer (SPM-002-A) exposure time was set at 70 milliseconds per acquisition. Shown is the fusion-produced spectral line for Be at 698.275 nm. (Beryllium, element atomic number 4)

FIG. 29 is a spectrographic image (internal file name: Al 120308-E) showing fusion acquisitions 92 and 15. The Aluminum for this fusion experiment contained the common hydrogen content acquired during its smelting and manufacturing process, and was not charged in an electrolytic bath because aluminum is too chemically active and will react with the electrolyte solution. The spectrometer (SPM-002-E) exposure time was set at 9,997 microseconds per fusion acquisition. Shown is the fusion-produced spectral line for boron at cursor 0 reading of 249.64 nm with a positive correction factor for the “E” spectrometer of plus 0.133 nm yielding the boron spectral line at 249.773 nm. (Boron, element atomic number 5)

FIG. 30 is a spectrographic image (internal file name: Coaxial Reactor #4 WC 13C FP 022611-A 25 Milli 6) showing fusion acquisitions 12 and 13. The palladium for this fusion experiment was charged common hydrogen in a LiOH electrolytic bath. The spectrometer (SPM-002-A) exposure time was set at 25 milliseconds per acquisition. Shown is the fusion-produced carbon spectral line at 600.603 nm. (Carbon, element atomic number 6)

FIG. 31 is a spectrographic image (internal file name: Pd 1.6 sqr 3 cm 70 milli Cylinder #1 7-28-10-A 19.48 cm 2nd) showing fusion acquisitions 22, 31 and 32. The palladium for this fusion experiment was charged with common hydrogen in a LiOH electrolytic bath. Cylinder #1 is a circular waveguide type fusion reactor. The spectrometer (SPM-002-A) exposure time was set at 70 Milliseconds per fusion acquisition. Shown is the fusion-produced nitrogen spectral line at 496.389 nm. (Nitrogen, element atomic number 7)

FIG. 32 is a spectrographic image (internal file name: MgSO4 Pd+B 011910-A 70 ms oxygen 660.491) showing fusion acquisitions 306, 307 and 308. The metal for this fusion experiment was a palladium-boron alloy with a very low hydrogen content. This fusion experiment was conducted in an RF containment cage. The fixture, which held the metal alloy, absorbed much of the RF energy causing a delay to the fusion's beginning, as can be seen in the pixel data. The palladium-boron alloy was charged with common hydrogen in a magnesium sulfate electrolytic bath, but this alloy absorbs very little common hydrogen as the boron occupies spaces in the Pd crystal matrix, which usually are available for common hydrogen storage. The spectrometer (SPM-002-A) exposure time was set at 70 milliseconds per fusion acquisition. Shown is the fusion-produced oxygen spectral line at 660.491 nm. (Oxygen, element atomic number 8)

FIG. 33 is a spectrographic image (internal file name: Fe Reactor #1 70 Milli Alloy-1 Air Atmos 041511-A F 570.082 & K 578.238 nm) showing acquisitions 106, 107, 108 and 109. The palladium for this fusion experiment was charged with common hydrogen in a LiOH electrolytic bath. The spectrometer (SPM-002-A) exposure time was set at 70 milliseconds per fusion acquisition. Shown is the fusion-produced fluorine spectral line at 570.082 nm and to such line's right is the spectral line of potassium at 578.238 nm. (Fluorine, element atomic number 9)

FIG. 34 is a spectrographic image (internal file name: Pd 1.6 sqr 3 cm 70 Milli Cylinder #1 7-28-10-A 21.48 cm E) showing acquisition 41. The palladium for this fusion experiment was charged with common hydrogen in a LiOH electrolytic bath. The spectrometer (SPM-002-A) exposure time was set at 70 milliseconds per acquisition. Shown are the fusion-produced neon spectral lines at 597.462 and 597.553 nm. The lines are too close to be individually resolved by the spectrometer. (Neon, element atomic number 10)

FIG. 35 is a spectrographic image (internal file name: Coaxial Reactor #3 WC 100 Milli 020511-A H2 Atmos FP) showing acquisitions 10, 11, 12, 13 and 15. The palladium for this fusion experiment was charged with common hydrogen in a LiOH electrolytic bath. The spectrometer (SPM-002-A) exposure time was set at 100 milliseconds per acquisition. Shown are the fusion-produced spectral lines at cursor 0 reading of 568.991 nm for the sodium spectral line at 568.820 nm and at cursor 1 reading 568.423 nm for the sodium spectral line at 568.263 nm. (Sodium, element atomic number 11).

FIG. 36 is a spectrographic image (internal file name: Coaxial Reactor #1 Pd Air Atmos 25 Milli 9-4-10-A) showing acquisitions 24, 25, 26 and 27. The palladium for this fusion experiment was charged with common hydrogen in a LiOH electrolytic bath. The spectrometer (SPM-002-A) exposure time was set at 25 milliseconds per acquisition. Cursor 0 reads 589.111 nm for the fusion-produced sodium spectral line at 588.995 nm, and the second spectral line to the right is the fusion-produced sodium spectral line at 589.592 nm. (Sodium, element atomic number 11)

FIG. 37 is a spectrographic image (internal file name: Coaxial Reactor #3 WC 100 Milli 0205110-A H2 Atmos FP) showing acquisitions 0, 10, 15, 20 and 28. The palladium for this fusion experiment was charged with common hydrogen in a LiOH electrolytic bath. The spectrometer (SPM-002-A) exposure time was set at 100 milliseconds per acquisition. Shown is the fusion-produced sodium spectral line at 589.995 nm at an intensity magnitude of 3731, which is saturating the CCD detectors from acquisition 0 through all of the fusion acquisitions. Also shown are the fusion-produced lithium spectral lines at 670.776 nm and 670.791 nm, which are also saturating the CCD detectors. So much sodium was produced from the common hydrogen fusion, the sodium was defused as a hot gas into the common hydrogen atmosphere of the reactor, causing a wavelength absorption phenomenon that can be seen in FIG. 38. (Sodium, element atomic number 11)

FIG. 38 is a spectrographic image (internal file number: Coaxial Reactor #3 WC 100 Milli 020511-A H2 Atmos FP Na absorption) showing acquisitions 354, 355, 356 and 363. The palladium for this fusion experiment was charged with common hydrogen in a LiOH electrolytic bath. The spectrometer (SPM-002-A) exposure time was set at 100 milliseconds per acquisition. Cursor 0 reads 589.111 for the fusion-produced sodium spectral line at 588.995 nm. So much sodium was produced from the fusion of common hydrogen, that the hot gaseous sodium was defused into the reactor's common hydrogen atmosphere and began acting as a wavelength filter, causing the inverse sodium absorption spectral lines that are clearly seen in the spectrographic image. (Sodium, element atomic number 11).

FIG. 39 is a spectrographic image (internal file number: MgSO4 Pd+B 121709-A 70 ms No Sodium at 589.11). The palladium-boron alloy for this fusion experiment was charged with common hydrogen in a magnesium sulfate electrolytic bath. The spectrometer (SPM-002-A) exposure time was set at 70 milliseconds per acquisition. The palladium-boron alloy does not readily absorb common hydrogen, as the boron occupies those spaces within the palladium atomic lattice where absorbed hydrogen is commonly stored, thus leaving no place for hydrogen to be stored. The question is: if the sodium seen in the fusion spectrographs is caused from sodium contamination in the palladium metal, then the same amount of sodium contamination should be contained in the palladium-boron alloy. Fusing the palladium-boron alloy, as seen in this spectrograph, produces no sodium spectral line. Therefore, it is the fusion of common hydrogen which produces the sodium spectral lines, not the contamination of sodium in the fusion's base metal. (Sodium, element atomic number 11).

FIG. 40 is a spectrographic image (internal file number: Coaxial Reactor #4 WC 25 Milli 022611-A H2 Atmos FP Mg F3) showing acquisitions 826, 865, 897, 900 and 931. The palladium for this fusion experiment was charged with common hydrogen in a LiOH electrolytic bath. The spectrometer (SPM-002-A) exposure time was set at 25 milliseconds per acquisition. Cursor 1 reads 516.924 nm for the fusion-produced magnesium spectral line at 516.724 nm, Cursor 0 reads 517.494 nm for the fusion-produced magnesium spectral line at 517.268 nm, and the red vertical line at cursor reading of 518.539 nm for the fusion-produced magnesium spectral line at 518.361 nm. (Magnesium, atomic number 12).

FIG. 41 is a spectrographic image (internal file name: Pd 1.6 sqr 3 cm 70 Milli Cylinder #1 7-28-10-A 18.48 cm) showing acquisitions 14, 25 and 26. The palladium for this fusion experiment was charged with common hydrogen in a LiOH electrolytic bath. The spectrometer (SPM-002-A) exposure time was set at 70 milliseconds per acquisition. Cylinder #1 is a circular waveguide reactor. Cursor 0 reads 394.687 nm for the fusion-produced aluminum spectral line at 394.687 nm. (Aluminum, atomic number 13)

FIG. 42 is a spectrographic image (internal file name: Pd 1.6 sqr 3 cm 70 Milli Cylinder #1 7-28-10-A 24.48 cm E) showing acquisitions 21, 24 and 25. The palladium for this fusion experiment was charged with common hydrogen in a LiOH electrolytic bath. The spectrometer (SPM-002-A) exposure time was set at 70 milliseconds per acquisition. Cylinder #1 is a circular waveguide reactor. Cursor 0 reads 500.664 nm for the fusion-produced silicon spectral line at 500.606 nm and cursor 1 reads 478.396 nm for the fusion-produced silicon spectral line at 478.299 nm. (Silicon, atomic number 14)

FIG. 43 is a spectrographic image (internal file name: Coaxial Reactor #4 WC 13C FP 022611-A 25 Milli 4) showing acquisitions 665, 701, 747, 776 and 778. The palladium for this fusion experiment was charged with common hydrogen in a LiOH electrolytic bath. The spectrometer (SPM-002-A) exposure time was set at 25 milliseconds per acquisition. Shown is the fusion-produced phosphorus spectral line at 545.831 nm. (Phosphorus, atomic number 15)

FIG. 44 is a spectrographic image (internal file name: Pd 1.6 sqr 3 cm 70 Milli Cylinder #1 7-28-10-A 18.48 cm) showing acquisitions 15, 28 and 32. The palladium for this fusion experiment was charged with common hydrogen in a LiOH electrolytic bath. The spectrometer (SPM-002-A) exposure time was set at 70 milliseconds per acquisition. Shown is the cursor 0 reading of 499.427 nm for the fusion-produced sulfur spectral line at 499.35 nm. (Sulfur, atomic number 16)

FIG. 45 is a spectrographic image (internal file name: Coaxial Reactor #3 WC 100 Milli 020511-A H2 Atmos FP Cr 417.02, Pd 421.295, Cl 422.624) showing acquisitions 24, 25, 26, 27 and 28. The palladium for this fusion experiment was charged with common hydrogen in a LiOH electrolytic bath. The spectrometer (SPM-002-A) exposure time was set at 100 milliseconds per acquisition. As shown in the figure, Cursor 0 reads 422.814 nm for the fusion-produced chlorine spectral line at 422.624 nm. Also shown is a Cursor 1 reading of 417.203 for the fusion-produced chromium spectral line at 417.02 nm. It should be noted that there is a central wavelength reading on Cursor 0 at 421.482 nm for palladium at 421.295 nm, which is not fusion produced, but is from the experiment's base metal. (Chlorine, atomic number 17)

FIG. 46 is a spectrographic image (internal file name: Coaxial Reactor #4 WC 13C FP 022611-A 25 Milli 4) showing acquisitions 7, 8, 14, 62 and 64. The palladium for this fusion experiment was charged with common hydrogen in a LiOH electrolytic bath.

The spectrometer (SPM-002-A) exposure time was set at 25 milliseconds per acquisition. Cursor 0 reads 516.448 nm for the fusion-produced argon spectral line at 516.228 nm. Also shown are spectral lines for copper at 510.554 nm and 521.820 nm, along with the spectral line for sodium at 515.340 nm. (Argon, atomic number 18)

FIG. 47 is a spectrographic image (internal file name: Fe Reactor #1 70 Milli Alloy-1 Air Atmos 041511-A K 578.238 nm) showing acquisitions 109, 108, 107 and 106. The Fe Reactor #1 is a rectangular waveguide reactor. The palladium for this fusion experiment was charged with common hydrogen in a LiOH electrolytic bath. The spectrometer (SPM-002-A) exposure time was set at 70 milliseconds per acquisition. Cursor 0 reads 578.444 nm for the fusion-produced potassium spectral line at 578.238 nm. (Potassium, atomic number 19)

FIG. 48 is a spectrographic image (internal file number: Al 200 Milli 020409-A) showing acquisitions 3, 4, 5, 6 and 7. This fusion experiment was conducted in a RF confinement cage. The aluminum base metal for this fusion experiment contained only its original common hydrogen content from the time of its refinement and manufacturing process. The spectrometer (SPM-002-A) exposure time was set at 200 milliseconds per acquisition. Cursor 0 reads 649.441 nm for the fusion-produced calcium spectral line at 649.378 nm. Also shown is a strontium spectral line at a cursor 1 reading of 654.847 nm for the strontium spectral line at 654.679 nm. (Calcium, atomic number 20)

FIG. 49 is a spectrographic image (internal file number: Coaxial Reactor #3 WC 100 Milli 020511-A H2 Atmos FP Pd) showing acquisitions 332, 334, 335, 336 and 337. The palladium for this fusion experiment was charged with common hydrogen in a LiOH electrolytic bath. The spectrometer (SPM-002-A) exposure time was set at 100 milliseconds per acquisition. Cursor 1 reads 404.753 nm for the fusion-produced scandium spectral line at 404.618 nm. (Scandium, atomic number 21)

FIG. 50 is a spectrographic image (internal file number: Coaxial Reactor #1 Pd Air Atmos 25 Milli 9-4-10-A 1A) showing acquisitions 69, 72, 74, 76 and 77. The palladium for this fusion experiment was charged with common hydrogen in a LiOH electrolytic bath. The spectrometer (SPM-002-A) exposure time was set at 25 milliseconds per acquisition. Cursor 1 reads 429.187 nm for the fusion-produced titanium spectral line at 429.094 nm. (Titanium, atomic number 22)

FIG. 51 is a spectrographic image (internal file name: Pd 1.6 sqr 3 cm 70 Milli Cylinder #1 7-28-10-A 18.48 cm) showing acquisitions 25, 26 and 27. Cylinder #1 is a circular waveguide reactor. The palladium for this fusion experiment was charged with common hydrogen in a LiOH electrolytic bath. The spectrometer (SPM-002-A) exposure was set at 70 milliseconds per acquisition. Cursor 1 reads 438.511 nm for the fusion-produced vanadium spectral line at 438.472 nm. The relative intensity of this spectral line is 7,000 and the spectral line is just entering the saturation range of the spectrometer's CCD detectors. (Vanadium, atomic number 23)

FIG. 52 is a spectrographic image (internal file name: Pd 1.6 sqr 3 cm 70 Milli Cylinder #1 7-28-10-A 19.48 cm 2nd) showing acquisitions 41, 42, 43 and 44. Cylinder #1 is a circular waveguide reactor. The palladium for this fusion experiment was charged with common hydrogen in a LiOH electrolytic bath. The spectrometer (SPM-002-A) exposure time was set at 70 milliseconds per acquisition. Cursor 0 reads 520.82 nm for the fusion-produced chromium spectral line at 520.604 nm. This line has a relative intensity of 7,000 and is showing saturation of the spectrometer's CCD detectors. Also shown is Cursor 1's reading at 510.6 nm for the fusion-produced vanadium spectral line at 510.514 nm. (Chromium, atomic number 24)

FIG. 53 is a spectrographic image (internal file name: Pd 1.6 sqr 3 cm 70 Milli Cylinder #1 7-28-10-A 19.48 cm 2nd) showing acquisitions 24, 25 and 27. Cylinder #1 is a circular waveguide reactor. The palladium for the fusion experiment was charged with common hydrogen in a LiOH electrolytic bath. The spectrometer (SPM-002-A) exposure time was set at 70 milliseconds per acquisition. Cursor 0 reads 482.393 nm for the fusion-produced manganese spectral line at 482.352 nm and Cursor 1 reads 478.396 nm for the fusion-produced manganese spectral line at 478.342 nm. (Manganese, atomic number 25)

FIG. 54 is a spectrographic image (internal file name: Pd 1.6 sqr 3 cm 70 Milli Cylinder #1 7-28-10-A 19.48 cm 2nd) showing acquisitions 16, 19, 25 and 27. Cylinder #1 is a circular waveguide reactor. The palladium for this fusion experiment was charged with common hydrogen in a LiOH electrolytic bath. The spectrometer (SPM-002-A) exposure time was set at 70 milliseconds per acquisition. Cursor 0 reads 516.829 nm for the fusion-produced iron spectral line at 516.7487 nm, which has a relative intensity of 2,500. (Iron, atomic number 26)

FIG. 55 is a spectrographic image (internal file name: Coaxial Reactor #1 Pd Air Atmos 25 Milli 9-4-10-A 1A) showing acquisitions 59, 60, 61 and 69. The palladium for this fusion experiment was charged with common hydrogen in a LiOH electrolytic bath. The spectrometer (SPM-002-A) exposure time was set at 25 milliseconds per acquisition. Cursor 0 reads 393.643 nm for the fusion-produced cobalt spectral line at 393.597 nm and cursor 1 reads 402.188 for the fusion-produced cobalt spectral line at 402.09 nm. (Cobalt, atomic number 27)

FIG. 56 is a spectrographic image (internal file name: Pd 1.6 sqr 3 cm 70 Milli Cylinder #1 7-28-10-A 18.48 cm) showing acquisitions 14 and 15. Cylinder #1 is a circular waveguide reactor. The palladium for this fusion experiment was charged with common hydrogen in a LiOH electrolytic bath. The spectrometer (SPM-002-A) exposure time was set at 70 milliseconds per acquisition. Cursor 0 reads 508.082 nm for the fusion-produced nickel spectral line at 508.052 nm and cursor 1 reads 508.177 nm for the fusion-produced nickel spectral line at 508.111 nm. These two spectral lines are too close to be individually resolved by the spectrometer. (Nickel, atomic number 28)

FIG. 57 is a spectrographic image (internal file number: Al test 040209-A cu 515.324 & 521.820) showing acquisitions 5, 6, 7 and 8. This fusion experiment was conducted in a RF confinement cage. The common hydrogen contained in the aluminum base metal was present from the original refining and manufacturing process. The spectrometer (SPM-002-A) exposure time was set at 200,000 microseconds per acquisition. Cursor 0 reads 515.403 nm for the fusion-produced copper spectral line at 515.324 nm and cursor 1 reads 521.96 nm for the fusion-produced copper spectral line at 521.820 nm. (Copper, atomic number 29)

FIG. 58 is a spectrographic image (internal file number: Coaxial Reactor #1 Pd Air Atmos 25 Milli 9-4-10-A) showing acquisition 59. The palladium for this fusion experiment was charged with common hydrogen in a LiOH electrolytic bath. The spectrometer (SPM-002-A) exposure time was set at 25 milliseconds per acquisition. Cursor 0 reads 636.366 nm for the fusion-produced zinc spectral line at 636.234 nm. (Zinc, atomic number 30)

FIG. 59 is a spectrographic image (internal file name: Pd 1.6 sqr 3 cm 70 Milli Cylinder #1 7-28-10A 24.48 cm) showing acquisitions 23 and 22. Cylinder #1 is a circular waveguide reactor. The palladium for this fusion experiment was charged with common hydrogen in a LiOH electrolytic bath. The spectrometer (SPM-002-A) exposure time was set at 70 milliseconds per acquisition. Cursor 0 reads 639.825 nm for the fusion-produced gallium spectral line at 639.656 nm. Cursor 1 reads 641.507 for the fusion-produced gallium spectral line at 641.344 nm. (Gallium, atomic number 31)

FIG. 60 is a spectrographic image (internal file name: Pd 1.6 sqr 3 cm 70 Milli Cylinder #1 7-28-10-A 24.48 cm E) showing acquisitions 0, 1, 2, 3 and 4. Cylinder #1 is a circular waveguide reactor. The palladium for this fusion experiment was charged with common hydrogen in a LiOH electrolytic bath. The spectrometer (SPM-002-A) exposure time was set at 70 milliseconds per acquisition. Cursor 0 reads 422.814 nm for the fusion-produced germanium spectral line at 422.6562 nm. (Germanium, atomic number 32)

FIG. 61 is a spectrographic image (internal file name: Pd 2 120708-E) showing acquisitions 11, 13, 19 and 26. This fusion experiment was conducted in an RF confinement cage. The palladium for this fusion experiment was charged with common hydrogen in a LiOH electrolytic bath. The spectrometer (SPM-002-A) exposure time was set at 9,999 microseconds per acquisition. Cursor 0 reads 540.77 nm for the fusion-produced arsenic spectral line at 540.813 nm. The wavelength correction factor for the “E” spectrometer at this wavelength is plus 0.043 nm. (Arsenic, atomic number 33)

FIG. 62 is a spectrographic image (internal file name: Pd 1.6 sqr 3 cm 70 Milli Cylinder #1 7-28-10-A 24.48 cm E) showing acquisitions 13, 16 and 17. Cylinder #1 is a circular waveguide reactor. The palladium for this fusion experiment was charged with common hydrogen in a LiOH electrolytic bath. The spectrometer (SPM-002-A) exposure time was set at 70 milliseconds per acquisition. Cursor 0 reads 683.156 nm for the fusion-produced selenium spectral line at 683.13 nm. (Selenium, atomic number 34)

FIG. 63 is a spectrographic image (internal file name: Pd 1.6 sqr 3 cm 70 Milli Cylinder #1 7-28-10-A 24.48 cm E) showing acquisitions 13, 14, 15, 16 and 17. Cylinder #1 is a circular waveguide reactor. The palladium for this fusion experiment was charged with common hydrogen in a LiOH electrolytic bath. The spectrometer (SPM-002-A) exposure time was set at 70 milliseconds per acquisition. Cursor 0 reads 442.689 nm for the fusion-produced bromine spectral line at 442.514 nm. (Bromine, atomic number 35)

FIG. 64 is a spectrographic image (internal file name: Pd 1.6 sqr 3 cm 70 Milli Cylinder #1 7-28-10-A 24.48 cm E) showing acquisitions 12, 14, 15, 17 and 20. Cylinder #1 is a circular waveguide reactor. The palladium for this fusion experiment was charged with common hydrogen in a LiOH electrolytic bath. The spectrometer (SPM-002-A) exposure time was set at 70 milliseconds per acquisition. Cursor 0 reads 427.569 nm for the fusion-produced krypton spectral line at 427.3969 nm. (Krypton, atomic number 36)

FIG. 65 is a spectrographic image (internal file name: Pd 1.6 sqr 3 cm 70 Milli Cylinder #1 7-28-10-A 24.48 cm E) showing acquisitions 8, 9, 12, 13 and 14. Cylinder #1 is a circular waveguide reactor. The palladium for this fusion experiment was charged with common hydrogen in a LiOH electrolytic bath. The spectrometer (SPM-002-A) exposure time was set at 70 milliseconds per acquisition. Cursor 0 reads 420.341 nm for the fusion-produced rubidium spectral line at 420.18 nm, which has a relative intensity of 1,000. (Rubidium, atomic number 37)

FIG. 66 is a spectrographic image (internal file name: Pd 1.6 sqr 3 cm 70 Milli Cylinder #1 7-28-10-A 24.48 cm E) showing acquisitions 8, 9, 10 and 14. Cylinder #1 is a circular waveguide reactor. The palladium for this fusion experiment was charged with common hydrogen in a LiOH electrolytic bath. The spectrometer (SPM-002-A) exposure time was set at 70 milliseconds per acquisition. Cursor 0 reads 460.784 nm for the fusion-produced strontium spectral line at 460.733 nm, which has a relative intensity of 65,000. (Strontium, atomic number 38)

FIG. 67 is a spectrographic image (internal file name: Pd 1.6 sqr 3 cm 70 Milli Cylinder #1 7-28-10-A 24.48 cm E) showing acquisitions 6, 8, 9, 10 and 14. Cylinder #1 is a circular waveguide reactor. The palladium for this fusion experiment was charged with common hydrogen in a LiOH electrolytic bath. The spectrometer (SPM-002-A) exposure time was set at 70 milliseconds per acquisition. Cursor 0 reads 404.848 nm for the fusion-produced yttrium spectral line at 404.764 nm. This yttrium wavelength has a relative intensity of 2,400. (Yttrium, atomic number 39)

FIG. 68 is a spectrographic image (internal file name: Coaxial Reactor #1 Pd Air Atmos 25 Milli 9-4-10-A 1A) showing acquisitions 56, 58, 59 and 62. The palladium for this fusion experiment was charged with common hydrogen in a LiOH electrolytic bath. The spectrometer (SPM-002-A) exposure time was set at 25 milliseconds per acquisition. Cursor 0 reads 430.328 nm for the fusion-produced zirconium spectral line at 430.289 nm and cursor 1 reads 426.904 nm for the fusion-produced zirconium spectral line at 426.802 nm. (Zirconium, atomic number 40)

FIG. 69 is a spectrographic image (internal file name: Coaxial Reactor #1 Pd Air Atmos 25 Milli 9-4-10-A 1A) showing acquisitions 57, 58, 59 and 60. The palladium for this fusion experiment was charged with common hydrogen in a LiOH electrolytic bath. The spectrometer (SPM-002-A) exposure time was set at 25 milliseconds per acquisition. Cursor 0 reads 403.423 nm for the fusion-produced niobium spectral line at 403.252 nm and cursor 1 reads 394.687 for the fusion-produced niobium spectral line at 394.367 nm. (Niobium, atomic number 41)

FIG. 70 is a spectrographic image (internal file number: Coaxial Reactor #1 Pd Air Atmos 25 Milli 9-4-10-A 1A) showing acquisitions 57, 58, 59 and 60. The palladium for this fusion experiment was charged with common hydrogen in a LiOH electrolytic bath. The spectrometer (SPM-002-A) exposure time was set at 25 milliseconds per acquisition. Cursor 0 reads 383.491 nm for the fusion-produced molybdenum spectral line at 383.375 nm and cursor 1 reads 426.999 nm for the fusion-produced molybdenum spectral line at 426.928 nm. There are fifteen chemical elements that have a spectral line in the very near neighborhood of 383.3xx nanometers. The relative intensity of the line at this wavelength is 1,700. (Molybdenum, atomic number 42)

FIG. 71 is a spectrographic image (internal file number: Coaxial Reactor #1 Pd Air Atmos 25 Milli 9-4-10-A 1A) showing acquisitions 57, 58, 59, 62 and 60. The palladium for this fusion experiment was charged with common hydrogen in a LiOH electrolytic bath. The spectrometer (SPM-002-A) exposure time was set at 25 milliseconds per acquisition. Cursor 0 reads 408.934 nm for the fusion-produced technetium spectral line at 408.871 nm. Some background grid repair was done on the wavelength graph of this spectrographic image. It was done to remove incorrectly typed information. (Technetium, atomic number 43)

FIG. 72 is a spectrographic image (internal file name: Coaxial Reactor #1 Pd Air Atmos 25 Milli 9-4-10-A 1A) showing acquisitions 48, 53, 55 and 75. The palladium for this fusion experiment was charged with common hydrogen in a LiOH electrolytic bath. The spectrometer (SPM-002-A) exposure time was set at 25 milliseconds per acquisition. Cursor 0 reads 421.387 nm for the fusion-produced ruthenium spectral line at 421.206 nm. This spectral line has a relative intensity of 5,440. (Ruthenium, atomic number 44)

FIG. 73 is a spectrographic image (internal file name: Coaxial Reactor #1 Pd Air Atmos 25 Milli 9-4-10-A 1A) showing acquisitions 57, 59, 63, 72 and 73. The palladium for this fusion reaction was charged in a LiOH electrolytic bath. The spectrometer (SPM-002-A) exposure time was set at 25 milliseconds per acquisition. Cursor 0 reads 383.491 nm for the fusion-produced rhodium spectral line at 383.389 nm. Cursor 1 reads 393.643 nm for the fusion-produced rhodium spectral line at 393.423 nm. Central to the two rhodium wavelengths is a palladium line at 389.42 nm with a relative intensity of 2,200. The palladium line in this spectrograph is not necessarily produced from the common hydrogen fusion, but is most likely from the palladium base metal. (Rhodium, atomic number 45)

FIG. 74 is a spectrographic image (internal file name: Al 200 ms 020409-A) showing acquisitions 6, 7, 10 and 11. The aluminum base metal for this fusion experiment was not charged with common hydrogen, but contained common hydrogen from the time of its original smelting and its manufacturing process. Aluminum was chosen for this common hydrogen fusion experiment, so as to exclude palladium spectral lines that would have been produced when using palladium as the base metal. The spectrometer (SPM-002-A) exposure time was set at 200 milliseconds per acquisition. This fusion experiment was conducted in a RF confinement cage. Cursor 0 reads 421.387 nm for the fusion-produced palladium spectral line at 421.295 nm. This wavelength of palladium has a relative intensity of 2,500. (Palladium, atomic number 46)

FIG. 75 is a spectrographic image (internal file name: Coaxial Reactor #1 Pd Air Atmos 25 Milli 9-4-10-A 1A) showing acquisitions 59, 62, 64, 65 and 60. The palladium for this fusion experiment was charged with common hydrogen in a LiOH electrolytic bath. The spectrometer (SPM-002-A) exposure time was set at 25 milliseconds per acquisition. Cursor 0 reads 521.01 nm for the fusion-produced silver spectral line at 520.908 nm, which has a relative intensity of 1,000. (Silver, atomic number 47)

FIG. 76 is a spectrographic image (internal file name: Coaxial Reactor #1 Pd Air Atmos 25 Milli 9-4-10-A 1A) showing acquisitions 28, 56 and 59. The palladium for this fusion experiment was charged with common hydrogen in a LiOH electrolytic bath. The spectrometer (SPM-002-A) exposure time was set at 25 milliseconds per acquisition. Cursor 0 reads 644.295 nm for the fusion-produced cadmium spectral line at 643.847 nm. (Cadmium, atomic number 48)

FIG. 77 is a spectrographic image (internal file name: Coaxial Reactor #1 Pd Air Atmos 25 Milli 9-4-10-A 1A) showing acquisitions 56, 57, 58 and 59. The palladium for this fusion experiment was charged with common hydrogen in a LiOH electrolytic bath. The spectrometer (SPM-002-A) exposure time was set at 25 milliseconds per acquisition. Cursor 0 reads 525.76 nm for the fusion-produced indium spectral line at 525.432 nm. Cursor 1 reads 526.42 nm for the fusion-produced indium spectral line at 526.274 nm. (Indium, atomic number 49)

FIG. 78 is a spectrographic image (internal file name: Coaxial Reactor #1 Pd Air Atmos 25 Milli 9-4-10-A 1A). The palladium for this fusion experiment was charged with common hydrogen in a LiOH electrolytic bath. The spectrometer (SPM002-A) exposure time was set to 25 milliseconds per acquisition. Cursor 1 reads 635.618 nm for the fusion-produced tin spectral line at 635.274 nm. (Tin, atomic number 50)

FIG. 79 is a spectrographic image (internal file number: Coaxial Reactor #1 Pd Air Atmos 25 Milli 9-4-10-A 1A) showing acquisitions 28, 56, 58 and 59. The palladium for this fusion experiment was charged with common hydrogen in a LiOH electrolytic bath. The spectrometer (SPM-002-A) exposure time was set at 25 milliseconds per acquisition. Cursor 0 reads 403.423 nm for the fusion-produced antimony spectral line at 403.355 nm. (Antimony, atomic number 51)

FIG. 80 is a spectrographic image (internal file number: Coaxial Reactor #1 Pd Air Atmos 25 Milli 9-4-10-A 1A). The palladium for this fusion experiment was charged with common hydrogen in a LiOH electrolytic bath. The spectrometer (SPM-002-A) exposure time was set at 25 milliseconds per acquisition. Tellurium's spectral lines were all too weak to be detected. Shown is the full spectrum from 388 nm to 700 nm. What should be seen are the spectral lines of palladium and those of hydrogen, but what is seen are the spectral lines from all of the chemical elements generated from the continual fusions of hydrogen to form ever heavier nuclei. (Tellurium, atomic number 52)

FIG. 81 is a spectrographic image (internal file number: Coaxial Reactor #1 Pd Air Atmos 25 Milli 9-4-10-A 1A) showing acquisitions 57, 58, 64 and 69. The palladium for this fusion experiment was charged with common hydrogen in a LiOH electrolytic bath. The spectrometer (SPM-002A) exposure time was set at 25 milliseconds per acquisition. Cursor 0 reads 523.575 nm for the fusion-produced iodine spectral line at 523.475 nm. Cursor 1 reads 542.846 nm for the fusion-produced iodine spectral line at 542.706 nm. (Iodine, atomic number 53)

FIG. 82 is a spectrographic image (internal file number: Coaxial Reactor #1 Pd Air Atmos 25 Milli 9-4-10-A 1A) showing acquisitions 26, 56, 68 and 67. The palladium for this fusion experiment was charged with common hydrogen in a LiOH electrolytic bath. The spectrometer (SPM-002-A) exposure time was set at 25 milliseconds per acquisition. Cursor 1 reads 569.653 nm for the fusion-produced xenon spectral line at 569.575 nm. (Xenon, atomic number 54)

FIG. 83 is a spectrographic image (internal file name: Coaxial Reactor #1 Pd Air Atmos 25 Milli 9-4-10-A 1A) showing acquisitions 28, 56, 57, 58 and 59. The palladium for this fusion experiment was charged with common hydrogen in a LiOH electrolytic bath. The spectrometer (SPM-002-A) exposure time was set at 25 milliseconds per acquisition. Cursor 1 reads 455.453 nm for the fusion-produced cesium spectral line at 455.5276 nm. (Cesium, atomic number 55)

FIG. 84 is a spectrographic image (internal file number Coaxial Reactor #1 Pd Air Atmos 25 Milli 9-4-10-A 1A) showing acquisitions 58, 59, 60, 62 and 64. The palladium for this fusion experiment was charged with common hydrogen in a LiOH electrolytic bath. The spectrometer (SPM-002-A) exposure time was set at 25 milliseconds per acquisition. Cursor 0 reads 393.643 nm for the fusion-produced barium spectral line at 393.572 nm. Cursor 1 reads 399.434 nm for the fusion-produced barium spectral line at 399.34 nm. (Barium, atomic number 56)

FIG. 85 is a spectrographic image (internal file number: Coaxial Reactor #1 Pd Air Atmos 25 Milli 9-4-10-A 1A) showing acquisitions 28, 56, 58 and 59. The palladium for this fusion experiment was charged with common hydrogen in a LiOH electrolytic bath. The spectrometer (SPM-002-A) exposure time was set at 25 milliseconds per acquisition. Cursor 0 reads 527.185 nm for the fusion-produced lanthanum spectral line at 527.119 nm. Cursor 1 reads 523.575 nm for the fusion-produced lanthanum spectral line at 523.427 nm. (Lanthanum, atomic number 57)

FIG. 86 is a spectrographic image (internal file name: Coaxial Reactor #1 Pd Air Atmos 25 Milli 9-4-10-A 1A) showing acquisitions 53, 56, 59 and 60. The palladium for this fusion experiment was charged with common hydrogen in a LiOH electrolytic bath. The spectrometer (SPM-002-A) exposure time was set at 25 milliseconds per acquisition. Cursor 0 reads 465.164 nm for the fusion-produced cerium spectral line at 465.051 nm. (Cerium, atomic number 58)

FIG. 87 is a spectrographic image (internal file name: Coaxial Reactor #1 Pd Air Atmos 25 Milli 9-4-10-A 1A) showing acquisitions 60, 62, 63, 69 and 77. The palladium for this fusion experiment was charged with common hydrogen in a LiOH electrolytic bath. The spectrometer (SPM-002-A) exposure time was set at 25 milliseconds per acquisition. Cursor 0 reads 605.69 nm for the fusion-produced praseodymium spectral line at 605. 513 nm. (Praseodymium, atomic number 59)

FIG. 88 is a spectrographic image (internal file name: Coaxial Reactor #1 Pd Air Atmos 25 Milli 9-4-10-A 1A) showing acquisitions 60, 62, 63, 69 and 77. The palladium for this fusion was charged with common hydrogen in a LiOH electrolytic bath. The spectrometer (SPM-002-A) exposure time was set at 25 milliseconds per acquisition. Cursor 0 reads 469.067 nm for the fusion-produced neodymium spectral line at 469.035 nm. Cursor 1 reads 470.875 nm for the fusion-produced neodymium spectral line at 470.696 nm. (Neodymium, atomic number 60)

FIG. 89 is a spectrographic image (internal file name: Coaxial Reactor #1 Pd Air Atmos 25 Milli 9-4-10-A) showing acquisitions 60, 62, 63, 69 and 77. The palladium for this fusion experiment was charged with common hydrogen in a LiOH electrolytic bath. The spectrometer (SPM-002-A) exposure time was set at 25 milliseconds per acquisition. Cursor 0 reads 449.076 nm for the fusion-produced promethium spectral line at 449.05 nm. Cursor 1 reads 451.741 nm for the fusion-produced promethium spectral line at 451.731 nm. A third fusion-produced spectral line of promethium is seen at 454.175 nm. A fourth fusion-produced spectral line of promethium is seen at 455.403 nm. Promethium has no long term stable isotopes. Promethium 145 has a half-life of 25 years and promethium 147 has a half-life of 2.6 years. (Promethium, atomic number 61)

FIG. 90 is a spectrographic image (internal file name: Coaxial Reactor #1 Pd Air Atmos 25 Milli 9-4-10-A 1A) showing acquisitions 28, 56, 58, 64 and 68. The palladium for this fusion experiment was charged with common hydrogen in a LiOH electrolytic bath. The spectrometer (SPM-002-A) exposure time was set at 25 milliseconds per acquisition. Cursor 1 reads 511.79 for the fusion-produced samarium spectral line at 511.716 nm. (Samarium, atomic number 62)

FIG. 91 is a spectrographic image (internal file name: Coaxial Reactor #1 Pd Air Atmos 25 Milli 9-4-10-A 1A) showing acquisitions 60, 62, 73 and 77. The palladium for this fusion experiment was charged with common hydrogen in a LiOH electrolytic bath. The spectrometer (SPM-002-A) exposure time was set at 25 milliseconds per acquisition. Cursor 0 reads 605.784 nm for the fusion-produced europium spectral line at 605.736 nm. (Europium, atomic number 63)

FIG. 92 is a spectrographic image (internal file name: Coaxial Reactor #1 Pd Air Atmos 25 Milli 9-4-10-A 1A) showing acquisitions 60, 62 73 and 77. The palladium for this fusion experiment was charged with common hydrogen in a LiOH electrolytic bath. The spectrometer (SPM-002-A) exposure time was set at 15 milliseconds per acquisition. Cursor 0 reads 393.643 nm for the fusion-produced gadolinium spectral line at 393.479 nm. Cursor 1 reads 394.687 nm for the fusion-produced gadolinium spectral line at 394.554 nm. Note: barium has spectral lines at 393.571 nm and 394.559 nm, cobalt has a spectral line at 393.597 nm and niobium has a spectral line at 394.367 nm, all too close to be individually resolved. (Gadolinium, atomic number 64)

FIG. 93 is a spectrographic image (internal file name: Coaxial reactor #1 Pd Air Atmos 25 Milli 9-4-10-A 1A) showing acquisitions 60, 62, 73 and 77. The palladium for this fusion experiment was charged with common hydrogen in a LiOH electrolytic bath. The spectrometer (SPM-002-A) exposure time was set at 25 milliseconds per acquisition. Cursor 0 reads 425.572 nm for the fusion-produced terbium spectral line at 425.524 nm. Cursor 1 reads 426.999 nm for the fusion-produced terbium spectral line at 426.969 nm. A cursor reading at 427.569 is for the fusion-produced terbium spectral line at 427.521 nm. Note: there are spectral lines for krypton at 427.569 nm and for Molybdenum at 426.928 nm, all too close to be individually resolved by the SPM-002-A spectrometer. (Terbium, atomic number 65)

FIG. 94 is a spectrographic image (internal file name: Coaxial Reactor #4 WC 13C FP 022611-A 25 Milli 3) showing acquisitions 643, 644, 645 and 646. The palladium for this fusion experiment was charged with common hydrogen in a LiOH electrolytic bath. The spectrometer (SPM-002-A) exposure time was set at 25 milliseconds per acquisition. Cursor 0 reads 421.482 nm for the fusion-produced dysprosium spectral line at 421.318 nm, which has a relative intensity of 1,800. (Dysprosium, atomic number 66)

FIG. 95 is a spectrographic image (internal file name: Coaxial Reactor #4 WC 13C FP 022611-A 25 Milli 3) showing acquisitions 643, 644, 646 and 645. The palladium for this fusion experiment was charged with common hydrogen in a LiOH electrolytic bath. The spectrometer (SPM-002-A) exposure time was set at 25 milliseconds per acquisition. Cursor 0 reads 417.394 nm for the fusion-produced holmium spectral line at 417.323 nm, which has a relative intensity of 2,500. (Holmium, atomic number 67)

FIG. 96 is a spectrographic image (internal file name: Coaxial Reactor #4 WC 13C FP 022611-A 25 Milli 3) showing acquisitions 59, 60, 63, 65 and 69. The palladium for this fusion experiment was charged with common hydrogen in a LiOH electrolytic bath. The spectrometer (SPM-002-A) exposure time was set at 25 milliseconds per acquisition. Cursor 1 reads 404.753 nm for the fusion-produced erbium spectral line at 404.693 nm, which has a relative intensity of 1,000. (Erbium, atomic number 68)

FIG. 97 is a spectrographic image (internal file name: Coaxial reactor #1 Pd Air Atmos 25 Milli 9-4-10-A 1A) showing acquisitions 59, 60, 63, 65 and 69. The palladium for this fusion experiment was charged with common hydrogen in a LiOH electrolytic bath. The spectrometer (SPM-002-A) exposure time was set at 25 milliseconds per acquisition. Cursor 0 reads 472.494 nm for the fusion-produced thulium spectral line at 472.426 nm. (Thulium, atomic number 69)

FIG. 98 is a spectrographic image (internal file name: Coaxial Reactor #1 Pd Air Atmos 25 Milli 9-4-10-A 1A) showing acquisitions 57, 61, 65 and 66. The palladium for this fusion experiment was charged with common hydrogen in a LiOH electrolytic bath. The spectrometer (SPM-002-A) exposure time was set at 25 milliseconds per acquisition. Cursor 0 reads 536.394 nm for the fusion-produced ytterbium spectral line at 536.366 nm. (Ytterbium, atomic number 70)

FIG. 99 is a spectrographic image (internal file name: Coaxial Reactor #1 Pd Air Atmos 25 Milli 9-4-10-A 1A) showing acquisitions 57, 61, 65 and 66. The palladium for this fusion experiment was charged with common hydrogen in a LiOH electrolytic bath. The spectrometer (SPM-002-A) exposure time was set at 25 milliseconds per acquisition. Cursor 0 reads 573.813 nm for the fusion-produced lutetium spectral line at 573.655 nm. (Lutetium, atomic number 71)

FIG. 100 is a spectrographic image (internal file name: Coaxial Reactor #1 Pd Air Atmos 25 Milli 9-4-10-A 1A) showing acquisitions 58, 59, 77 and 79. The palladium for this fusion experiment was charged with common hydrogen in a LiOH electrolytic bath. The spectrometer (SPM-002-A) exposure time was set at 25 milliseconds per acquisition. Cursor 0 reads 543.7 nm for the fusion-produced hafnium spectral line at 543.578 nm. Cursor 1 reads 549.866 nm for the fusion-produced hafnium spectral line at 549.73 nm. (Hafnium, atomic number 72)

FIG. 101 is a spectrographic image (internal file name: Coaxial Reactor #1 Pd Air Atmos 25 Milli 9-4-10-A 1A) showing acquisitions 58, 59, 62 and 60. The palladium for this fusion experiment was charged with common hydrogen in a LiOH electrolytic bath. The spectrometer (SPM-002-A) exposure time was set at 25 milliseconds per acquisition. Cursor 0 reads 426.904 nm for the fusion-produced tantalum spectral line at 426.826 nm. Cursor 1 reads 430.328 nm for the fusion-produced tantalum spectral line at 430.298 nm. (Tantalum, atomic number 73)

FIG. 102 is a spectrographic image (internal file name: Coaxial Reactor #1 Pd Air Atmos 25 Milli 9-4-10-A 1A) showing acquisitions 58, 59, 62 and 60. The palladium for this fusion experiment was charged with common hydrogen in a LiOH electrolytic bath. The spectrometer (SPM-002-A) exposure time was set at 25 milliseconds per acquisition. Cursor 0 reads 393.548 nm for the fusion-produced tungsten spectral line at 393.503 nm. Cursor 1 reads 400.954 nm for the fusion-produced tungsten spectral line at 400.875 nm. (Tungsten, atomic number 74)

FIG. 103 is a spectrographic image (internal file name: Coaxial Reactor #1 Pd Air Atmos 25 Milli 9-4-10-A 1A) showing acquisitions 53, 58, 61 and 56. The palladium for this fusion experiment was charged with common hydrogen in a LiOH electrolytic bath. The spectrometer (SPM-002-A) exposure time was set at 25 milliseconds per acquisition. Cursor 0 reads 422.841 nm for the fusion-produced rhenium spectral line at 422.746 nm, which has a relative intensity of 3,600. (Rhenium, atomic number 75)

FIG. 104 is a spectrographic image (internal file name: Coaxial Reactor #1 Pd Air Atmos 25 Milli 9-4-10-A 1A) showing acquisitions 53, 54, 55, 68 and 75. The palladium for this fusion experiment was charged with common hydrogen in a LiOH electrolytic bath. The spectrometer (SPM-002-A) exposure time was set at 25 milliseconds per acquisition. Cursor 1 reads 421.482 nm for the fusion-produced osmium spectral line at 421.386 nm. (Osmium, atomic number 76)

FIG. 105 is a spectrographic image (internal file name: Pd 1.6 sqr 3 cm 70 Milli Cylinder #1 7-28-10-A 18.48 cm) showing acquisitions 14, 25, 27 and 31. The palladium for this fusion experiment was charged with common hydrogen in a LiOH electrolytic bath. The spectrometer (SPM-002-A) exposure time was set at 25 milliseconds per acquisition. Cursor 1 reads 435.371 nm for the fusion-produced iridium spectral line at 435.256 nm. (Iridium, atomic number 77)

FIG. 106 is a spectrographic image (internal file name: Coaxial Reactor #1 Pd Air Atmos 25 Milli 9-4-10-A 1A) showing acquisitions 28, 53, 56, 59 and 70. The palladium for this fusion experiment was charged with common hydrogen in a LiOH electrolytic bath. The spectrometer (SPM-002-A) exposure time was set at 25 milliseconds per acquisition. Cursor 0 reads 684.358 for the fusion-produced platinum spectral line at 684.26 nm. (Platinum, atomic number 78)

FIG. 107 is a spectrographic image (internal file name: Coaxial Reactor #1 Pd Air Atmos 25 Milli 9-4-10-A 1A) showing acquisitions 57, 59, 62, 65 and 69. The palladium for this fusion experiment was charged with common hydrogen in a LiOH electrolytic bath. The spectrometer (SPM-002-A) exposure time was set at 25 milliseconds per acquisition. Cursor 0 reads 565.68 nm for the fusion-produced gold spectral line at 565.577 nm. (Gold, atomic number 79)

FIG. 108 is a spectrographic image (internal file name: Coaxial Reactor #1Pd Air Atmos 25 Milli 9-4-10-A 1A) showing acquisitions 56, 58, 59, 60 and 71. The palladium for this fusion experiment was charged with common hydrogen in a LiOH electrolytic bath. The spectrometer (SPM-002-A) exposure time was set at 25 milliseconds per acquisition. Cursor 0 reads 436.037 nm for the fusion-produced mercury spectral line at 435.833 nm at a relative intensity 4,000.24. On March 2012, a mercury lamp spectrometer calibration showed the mercury spectral line at 435.883 nm, as reading on the spectrometer as 436.037 nm. (Mercury, atomic number 80)

FIG. 109 is a spectrographic image (internal file name: Coaxial Reactor #1 Pd Air Atmos 25 Milli 9-4-10-A 1A) showing acquisitions 59, 74, 72, 62 and 60. The palladium for this fusion experiment was charged with common hydrogen in a LiOH electrolytic bath. The spectrometer (SPM-002-A) exposure time was set at 25 milliseconds per acquisition. Cursor 1 reads 655.033 nm for the fusion-produced thallium spectral line at 654.984 nm. (Thallium, atomic number 81)

FIG. 110 is a spectrographic image (internal file name: Coaxial Reactor #1 Pd Air Atmos 25 Milli 9-4-10-A 1A) showing acquisitions 59, 74, 72, 62 and 60. The palladium for this fusion experiment was charged with common hydrogen in a LiOH electrolytic bath. The spectrometer (SPM-002-A) exposure time was set at 25 milliseconds per acquisition. Cursor 0 reads 405.988 nm for the fusion-produced lead spectral line at 405.7807 nm. (Lead, atomic number 82)

FIG. 111 is a spectrographic image (internal file name: Coaxial Reactor #1 Pd Air Atmos 25 Milli 9-4-10-A 1A) showing acquisitions 59, 74, 72, 62 and 60. The palladium for this fusion experiment was charged with common hydrogen in a LiOH electrolytic bath. The spectrometer (SPM-002-A) exposure time was set at 25 milliseconds per acquisition. Cursor 0 reads 472.494 nm for the fusion-produced bismuth spectral line at 472.252 nm. (Bismuth, atomic number 83)

FIG. 112 is a spectrographic image (internal file name: Coaxial Reactor #1 Pd Air Atmos 25 Milli 9-4-10-A 1A) showing acquisitions 55, 56, 58, 59 and 60. The palladium for this fusion experiment was charged with common hydrogen in a LiOH electrolytic bath. The spectrometer (SPM-002-A) exposure time was set at 25 milliseconds per acquisition. Cursor 0 reads 417.108 nm for the fusion-produced polonium spectral line at 417.052 nm. (Polonium, atomic number 84)

FIG. 113 is a spectrographic image (internal file name: Coaxial Reactor #1 Pd Air Atmos 25 Milli 9-4-10-A 1A) showing acquisition 60, as a full spectrum from 388 nm to 700 nm. The palladium for this fusion experiment was charged with common hydrogen in a LiOH electrolytic bath. The spectrometer (SPM-002-A) exposure time was set at 25 milliseconds per acquisition. The chemical element astatine has no spectral lines within the visual spectrum from 388 nm to 700 nm. (Astatine, atomic number 85)

FIG. 114 is a spectrographic image (internal file name: Coaxial Reactor #1 Pd Air Atmos 25 Milli 9-4-10-A 1A) showing acquisitions 56, 57 and 69. The palladium for this fusion experiment was charged with common hydrogen in a LiOH electrolytic bath. The spectrometer (SPM-002-A) exposure time was set at 25 milliseconds per acquisition. Cursor 0 reads 443.65 for the fusion-produced radon spectral line at 443.505 nm. (Radon, atomic number 86)

FIG. 115 is a spectrographic image (internal file name: Coaxial Reactor #1 Pd Air Atmos 25 Milli 9-4-10-A 1A) showing Acquisition 58, as a full spectrum from 388 lam to 700 nm. The palladium for this fusion experiment was charged with common hydrogen in a LiOH electrolytic bath. The spectrometer (SPM-002-A) exposure time was set at 25 milliseconds per acquisition. The only francium spectral line at 717.7 nm is beyond the bandwidth of the spectrometer and has a relative intensity of just “1.” Therefore, this francium spectral line was not detected. (Francium, atomic number 87)

FIG. 116 is a spectrographic image (internal file name: Coaxial Reactor #1 Pd Air Atmos 25 Milli 9-4-10-A 1A) showing acquisitions 56, 64, 65 and 68. The palladium for this fusion experiment was charged with common hydrogen in a LiOH electrolytic bath. The spectrometer (SPM-002-A) exposure time was set at 25 milliseconds per acquisition. Cursor 0 reads 698.106 nm for the fusion-produced radium spectral line at 698.032 nm. All radium spectral lines have very low relative intensities and only 21 of radium's spectral lines are within the visual spectrum. (Radium, atomic number 88)

FIG. 117 is a spectrographic image (internal file name: Coaxial Reactor #1 Pd Air Atmos 25 Milli 9-4-10-A 1A) showing acquisition 60, as a full spectrum from 388 nm to 700 nm. The palladium for this fusion was charged with common hydrogen in a LiOH electrolytic bath. The spectrometer (SPM-002-A) exposure time was set at 25 milliseconds per acquisition. The spectral lines of actinium have relative intensities that are low and, therefore, were not detected. (Actinium, atomic number 89)

FIG. 118 is a spectrographic image (internal file name: Coaxial Reactor #1 Pd Air Atmos 25 Milli 9-4-10-A 1A) showing acquisitions 56, 58, 59, 62 and 60. The palladium for this fusion experiment was charged with common hydrogen in a LiOH electrolytic bath. The spectrometer (SPM-002-A) exposure time was set at 25 milliseconds per acquisition. Cursor 0 reads 400.954 nm for the fusion-produced thorium spectral line at 400.821 nm. (Thorium, atomic number 90)

FIG. 119 is a spectrographic image (internal file name: Coaxial Reactor #1 Pd Air Atmos 25 Milli 9-4-10-A 1A) showing acquisitions 56, 57, 58 and 61. The palladium for this fusion experiment was charged with common hydrogen in a LiOH electrolytic bath. The spectrometer (SPM-002-A) exposure time was set at 25 milliseconds per acquisition. Cursor 0 reads 616.311 nm for the fusion-produced protactinium spectral line at 616.256 nm. This spectral line has a relative intensity of 3,000. (Protactinium, atomic number 91)

FIG. 120 is a spectrographic image (internal file name: Coaxial Reactor #1 Pd Air Atmos 25 Milli 9-4-10-A 1A) showing acquisitions 62, 66, 69, 73 and 60. The palladium for this fusion experiment was charged with common hydrogen in a LiOH electrolytic bath. The spectrometer (SPM-002-A) exposure time was set at 25 milliseconds per acquisition. Cursor 0 reads 463.355 nm for the fusion-produced uranium spectral line at 463.162 nm. (Uranium, atomic number 92)

FIG. 121 is a spectrographic image (internal file name: Coaxial Reactor #1 Pd Air Atmos 25 Milli 9-4-10-A 1A) showing acquisitions 56, 58, 62, 72 and 77. The palladium for this fusion experiment was charged with common hydrogen in a LiOH electrolytic bath. The spectrometer (SPM-002-A) exposure time was set at 25 milliseconds per acquisition. Cursor 0 reads 560.284 nm for the fusion-produced neptunium spectral line at 560.17 nm. (Neptunium atomic number 93)

FIG. 122 is a spectrographic image (internal file name: Coaxial Reactor #1 Pd Air Atmos 25 Milli 9-4-10-A 1A) showing acquisitions 69, 72, 74, 76 and 77. The palladium for this fusion experiment was charged with common hydrogen in a LiOH electrolytic bath. The spectrometer (SPM-002-A) exposure time was set at 25 milliseconds per acquisition. Cursor 0 reads 389.657 nm for the fusion-produced plutonium spectral line at 389.589 nm, which has a relative intensity of 10,000. (Plutonium, atomic number 94)

FIG. 123 is a spectrographic image (internal file name: Coaxial Reactor #1 Pd Air Atmos 25 Milli 9-4-10-A 1A) showing acquisitions 69, 72, 74, 76 and 77. The palladium for this fusion experiment was charged with common hydrogen in a LiOH electrolytic bath. The spectrometer (SPM-002-A) exposure time was set at 25 milliseconds per acquisition. Cursor 0 reads 499.142 nm for the fusion-produced americium spectral line at 499.079 nm. (Americium, atomic number 95)

FIG. 124 is a spectrographic image (internal file name: Coaxial Reactor #1 Pd Air Atmos 25 Milli 9-4-10-A 1A) showing acquisitions 58, 59, 62, 72 and 76. The palladium for this fusion experiment was charged with common hydrogen in a LiOH electrolytic bath. The spectrometer (SPM-002-A) exposure time was set at 25 milliseconds per acquisition. Cursor 0 reads 666.381 nm for the fusion-produced curium spectral line at 666.326 nm. Cursor 1 reads 668.795 nm for the fusion-produced curium spectral line at 668.687 nm. (Curium, atomic number 96)

FIG. 125 is a spectrographic image (internal file name: Coaxial Reactor #1 Pd Air Atmos 25 Milli 9-4-10-A 1A) showing acquisitions 28, 56, 58 and 59. The palladium for this fusion experiment was charged with common hydrogen in a LiOH electrolytic bath. The spectrometer (SPM-002-A) exposure time was set at 25 milliseconds per acquisition. Cursor 1 reads 565.68 nm for the fusion-produced berkelium spectral line at 565.654 nm, which has a relative intensity 10,000. (Berkelium, atomic number 97)

FIG. 126 is a spectrographic image (internal file name: Coaxial Reactor #1 Pd Air Atmos 25 Milli 9-4-10-A 1A) showing acquisitions 56, 58, 59, 60 and 62. The palladium for this fusion experiment was charged with common hydrogen in a LiOH electrolytic bath. The spectrometer (SPM-002-A) exposure time was set at 25 milliseconds per acquisition. Cursor 0 reads 410.074 nm for the fusion-produced californium spectral line at 409.912 nm, which has a relative intensity 10,000. (Californium, atomic number 98)

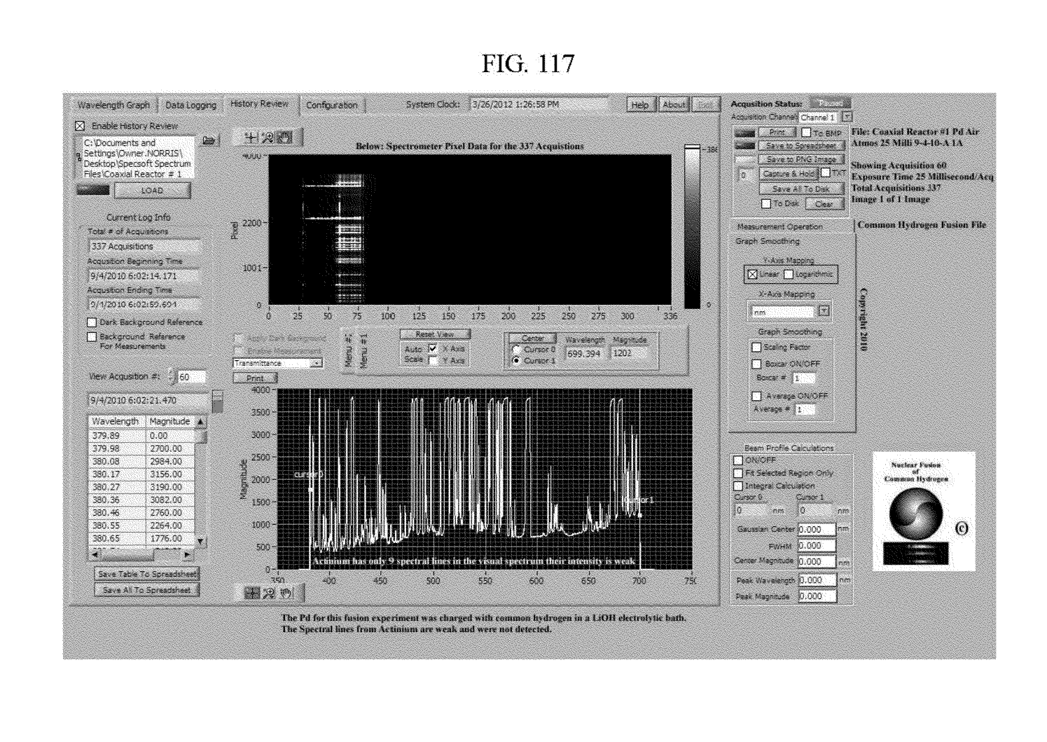

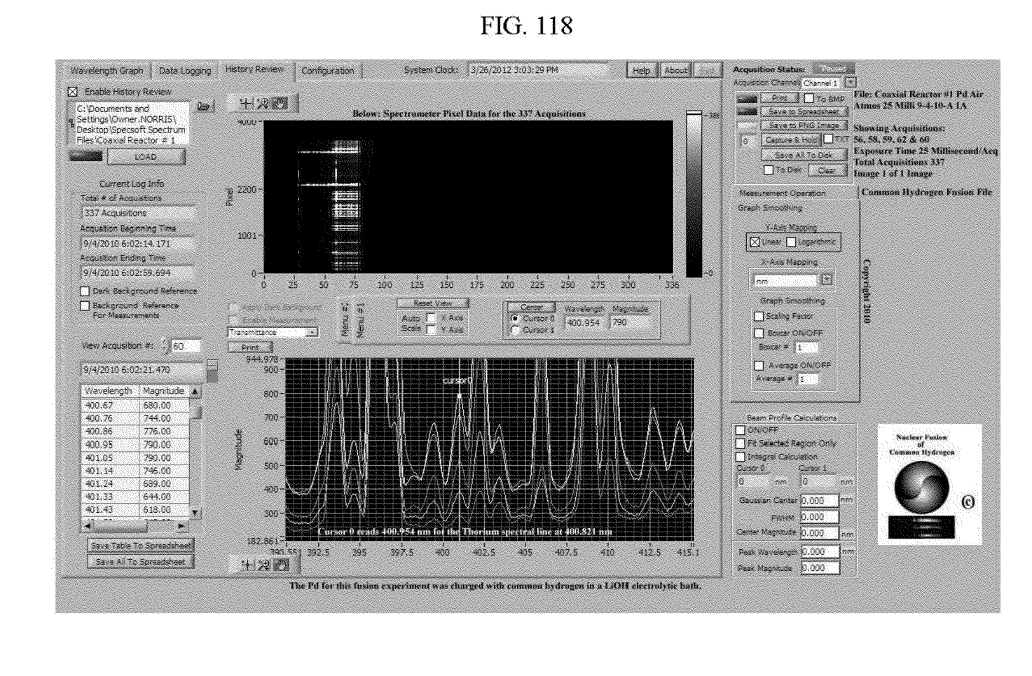

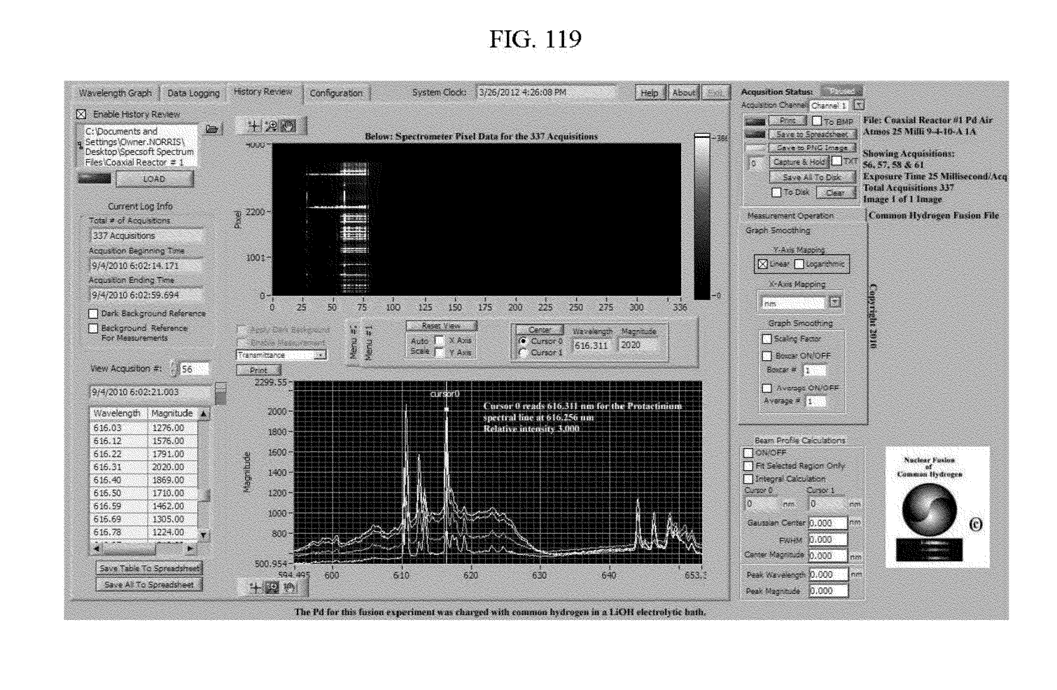

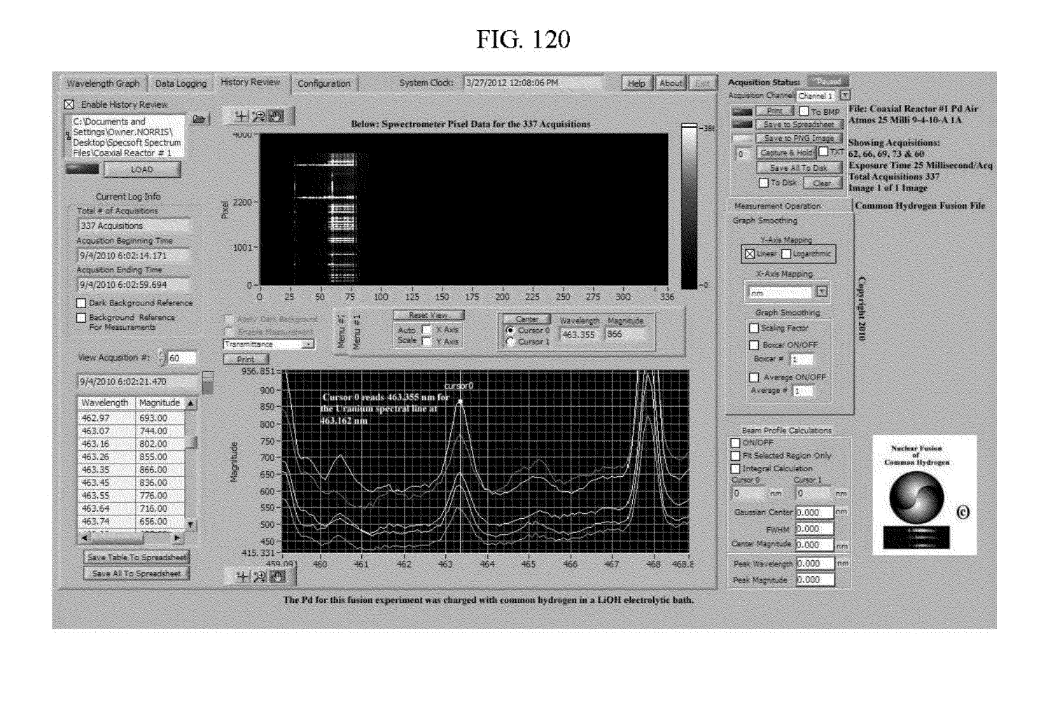

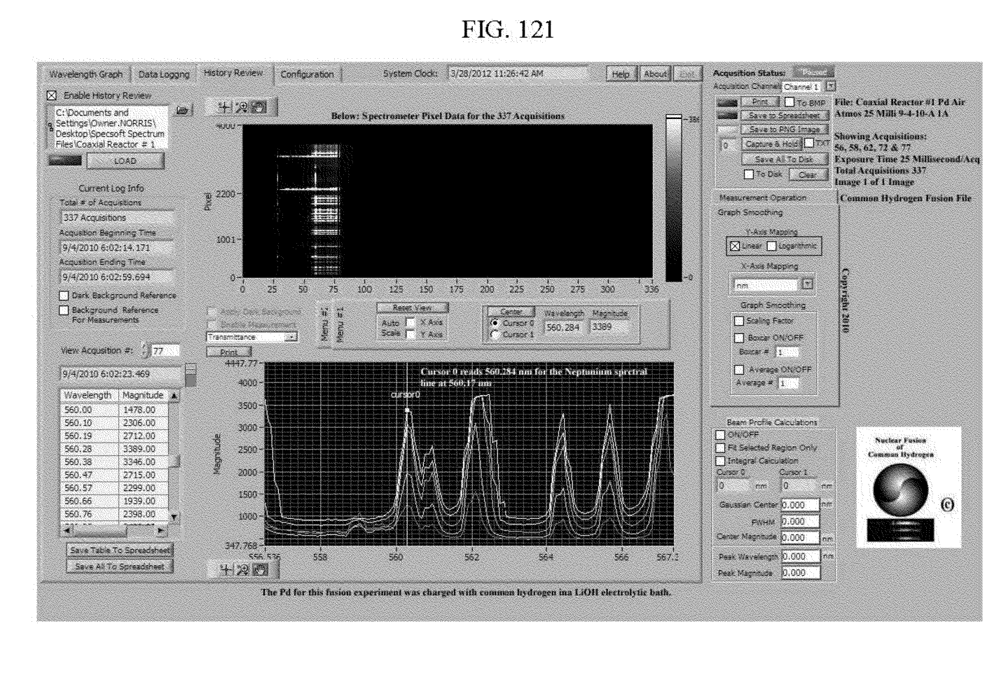

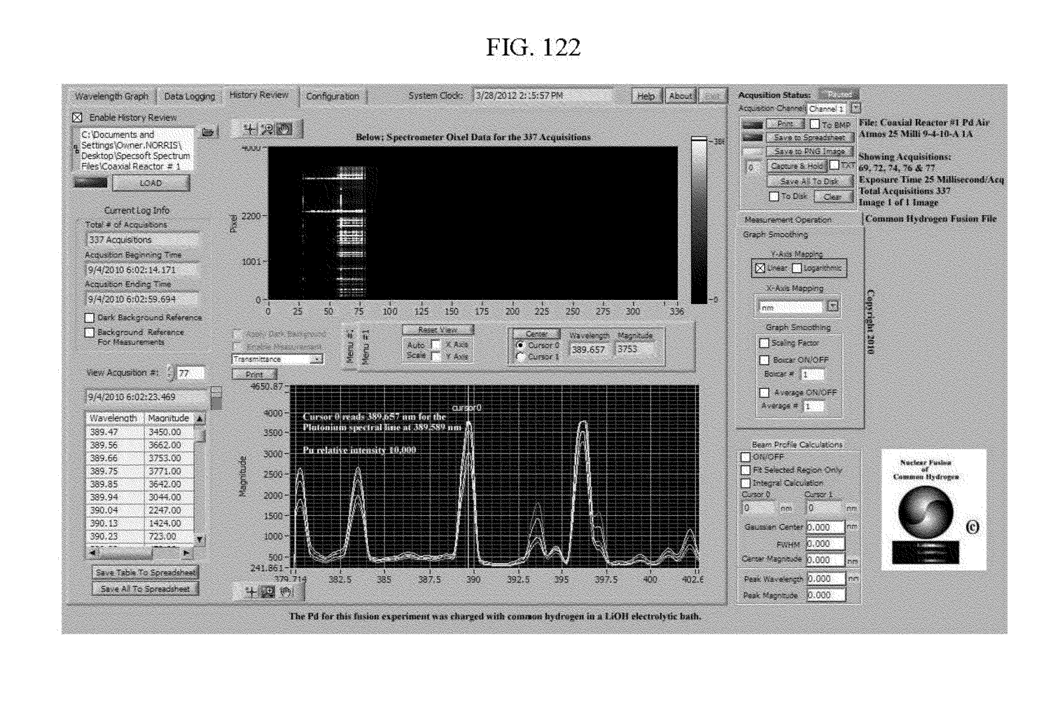

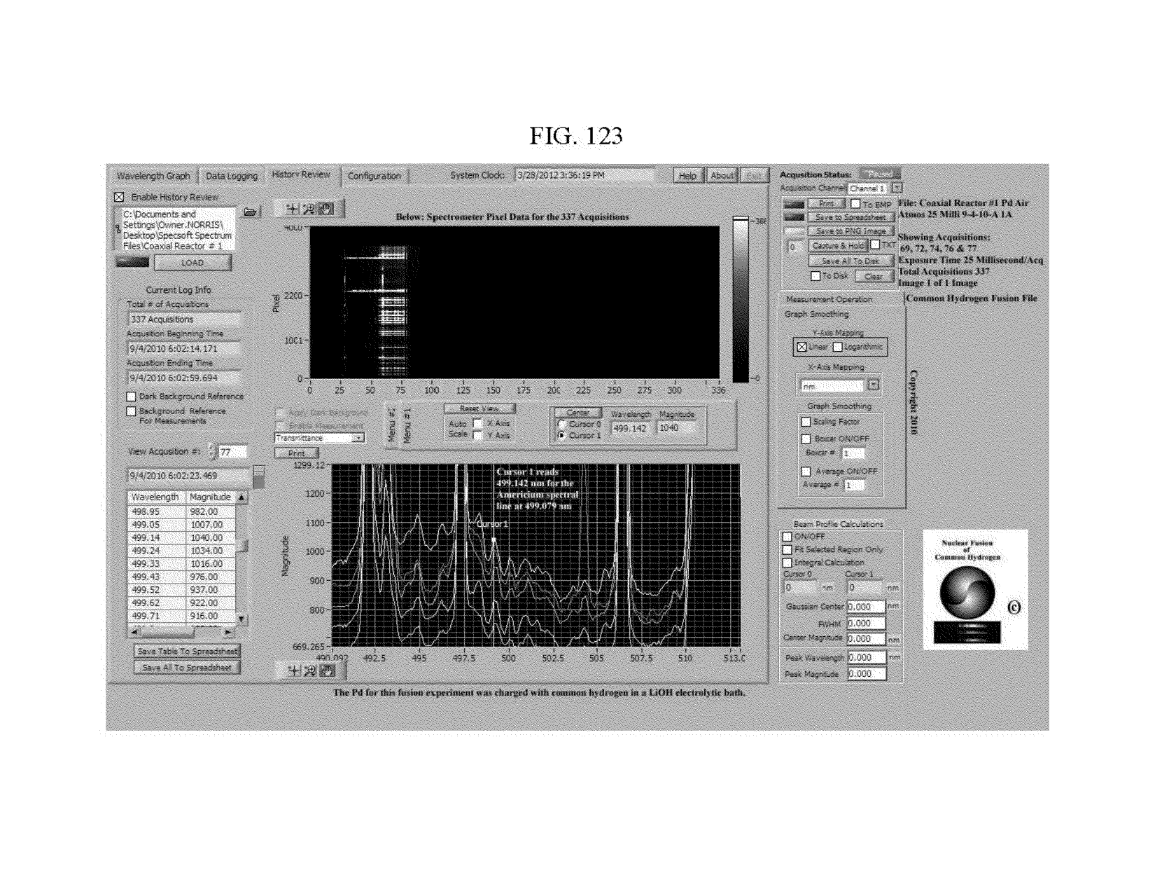

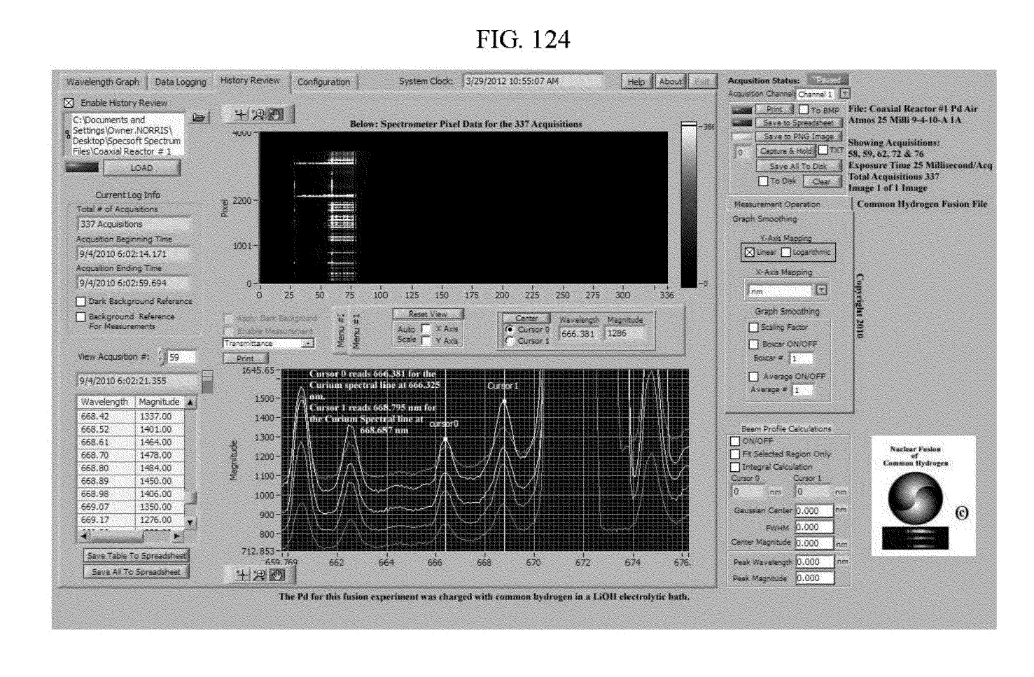

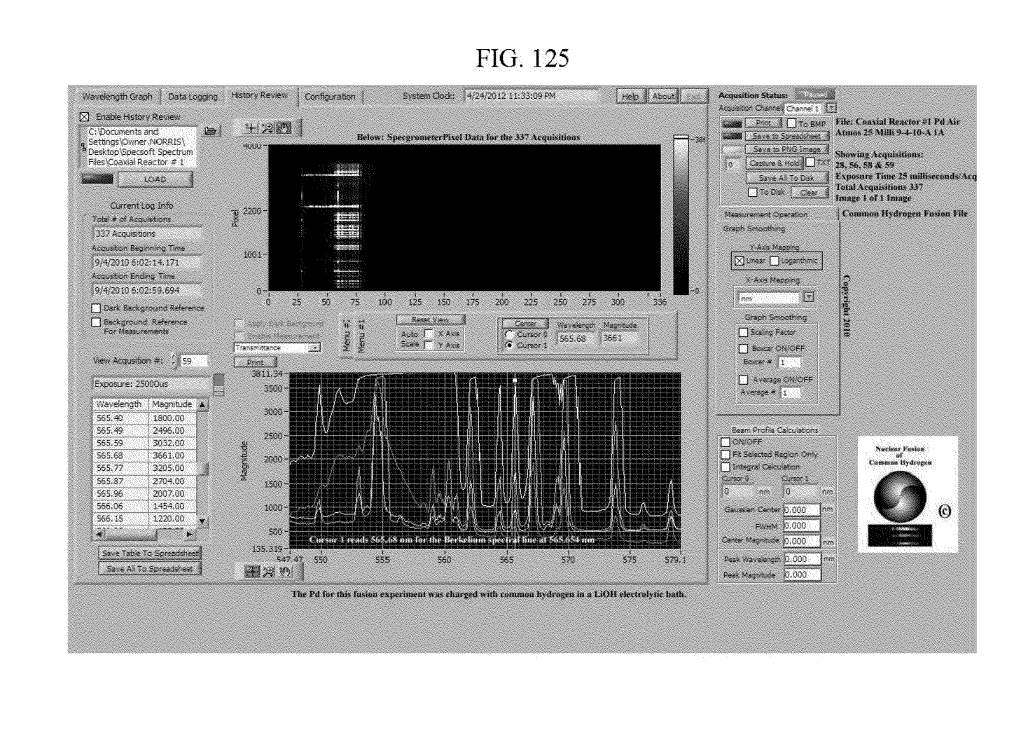

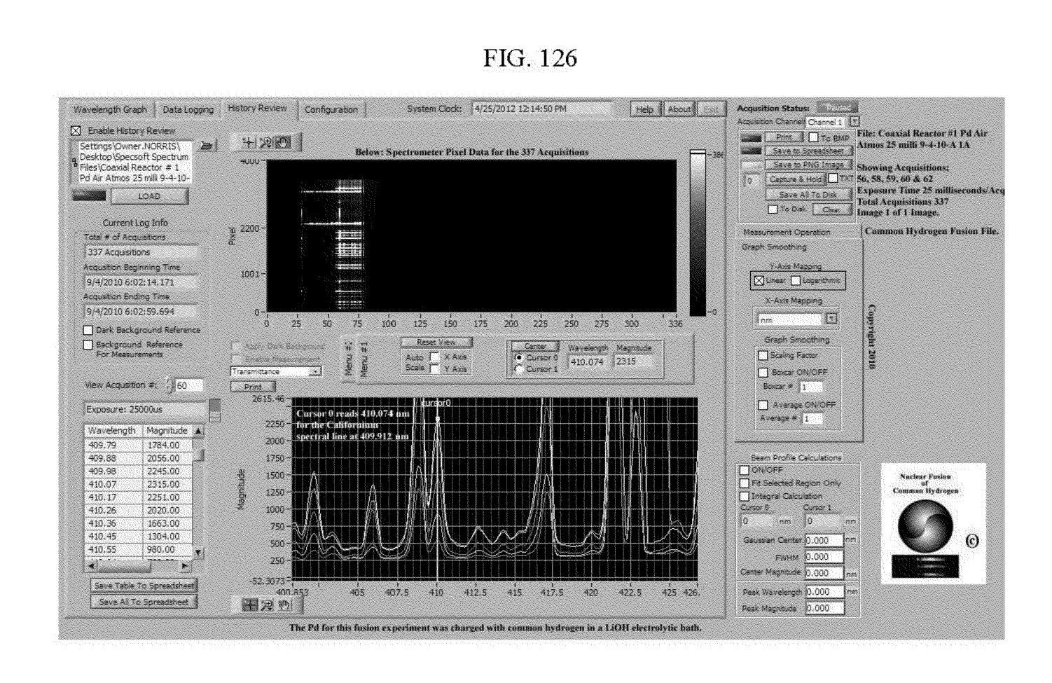

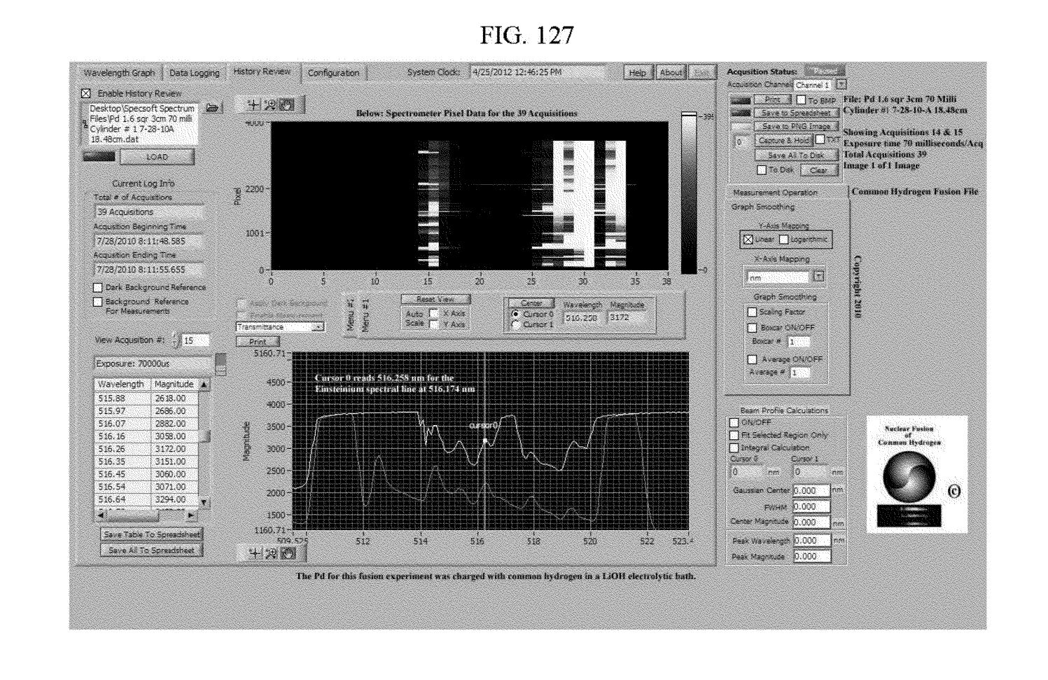

FIG. 127 is a spectrographic image (internal file name: Pd 1.6 sqr 3 cm 70 Milli Cylinder #1 7-28-10-A 18.48 cm) showing acquisitions 14 and 15. The palladium for this fusion experiment was charged with common hydrogen in a LiOH electrolytic bath. The spectrometer (SPM-002-A) exposure time was set at 70 milliseconds per acquisition. Cursor 0 reads 516.258 nm for the fusion-produced einsteinium spectral line at 516.174 nm, which has a relative intensity 10,000. Note: Chemical elements atomic numbers 100 to and including atomic number 118 do not exist in nature, they are man-made, and have no stable isotopes and exceedingly short half-lives, and are therefore not shown as no spectral data is available. (Einsteinium, atomic number 99)

FIG. 128 is entitled “Common Hydrogen Fusion and Chemical Element production vs. RF 2.45 GHz Wavelength Timing” (internal file name: Hydrogen Fusion vs. Time 19 Apr. 2012). FIG. 128 illustrates ten RF wavelengths and the chemical elements which are produced from common hydrogen fusions during each of the ten wavelength periods. Each period has a length of time of 41.6 nanoseconds. After 118 periods, all 118 chemical elements of the Periodic Table have been created. Accordingly, all 118 chemical elements of the Periodic Table are created within approximately 4.909 microseconds.

The following numbered paragraphs set forth an incomplete list of the discoveries believed to have been made by the inventors.

1. Within a proton and electron dense and dynamic electromagnetic driven environment of molten metal, a virtual Neutron is formed when a proton captures an electron, and for a short time, the proton's and the electron's electric charges are neutralized resulting in a particle that is a virtual neutron having a rest mass energy of 938.722 MeV. Reference: Electron Capture as a means of chemical element transmutations shown in tables listing all of the transmutations of chemical elements by means of nuclear Electron Capture.

2. Within a proton and electron dense and dynamic electromagnetic driven Special Environment of molten metal, a particle the inventors have named “Light Negatron (Y)” is formed when a virtual neutron (as described in paragraph 1), absorbs an electron to become a negatively charged virtual neutron or Light Negatron of rest mass energy of 939.233 MeV. The virtual neutron has no natural resistance to absorbing an electron to become a Light Negatron as it is without any repulsive charge. The Light Negatron particles are formed from virtual neutrons within nanoseconds of the virtual neutron's formation, thus within nanoseconds most all virtual neutrons are transformed into Light Negatrons. Negatrons formed from virtual neutrons and electrons are called “Light Negatrons.” Note: 931.494 MeV was used as the conversion factor from (uamu) unified atomic mass units (Daltons) to rest mass energy in MeV.

3. The virtual neutron of paragraph 1 is an active nuclear particle for the fusion with any nearby bare nucleus as it is without charge and is, therefore, not forcefully repealed from entering into a natural fusion. However, because of the very high electron density within the volume surrounding the virtual neutron, the virtual neutron is within nanoseconds converted into a Light Negatron by means of capturing an electron.

4. The Light Negatron of paragraphs 2 and 3 is an extremely active nuclear particle for fusion with any positively charged bare nucleus, as it is attracted to every nearby positively charged bare nucleus by the very powerful inverse attractive force of the coulomb barrier.

5. When a natural Neutron, rest mass energy of 939.505 MeV, exists within the electromagnetically driven Special Dynamic Material Environment of molten metal, the Neutron is without charge and is therefore not forcefully repealed from entering into a natural fusion with an electron, and because of the exceedingly high electron density within the molten metal volume surrounding the Neutron, the Neutron is within nanoseconds converted into a Heavy Negatron (Y#) rest mass energy 940.016 MeV by means of capturing an electron.

6. The formation of virtual Neutrons and Light and Heavy Negatrons is initiated and completed within a proton and electron dense Special Dynamic Material Environment of molten metal by means of irradiating the molten metal environment with a 2.45 Gigahertz Electromagnetic RF frequency with 400 watts or greater average RF power, or by irradiating Special Dynamic Material Environment with integral harmonics of the frequencies of 2.45 gigahertz which have 400 watts or greater RF average power.

7. The Electromagnetic irradiation of the proton and electron dense molten metal environment causes the protons and electrons at the surface and near surface of the molten metal environment to begin oscillating in synchronization with the powerful voltage and current oscillations induced by the irradiating electromagnetic radiation. In particular, the proton and electron oscillations are synchronized but, due to their different electric charges, each proton and electron is oscillating 180 degrees out of phase with their oppositely charged particles. These out of phase oscillations substantially increase the probability, to a near certainty, of the particles impacting and fusing to produce virtual Neutrons and Light and Heavy Negatrons.

8. Within a Proton and electron dense and dynamic electromagnetically driven environment of molten metal, it is imperative that the proton and electron dense dynamic electromagnetically driven environment is composed of molten metal, as the electron capture and other synchronous fusions cannot take place in a crystal lattice or non-crystalline solid where the particles are locked by electrostatic forces into relatively fixed positions within the crystal lattice or non-crystalline solid. It is the free motions within the molten metal that allows the synchronous oscillations of all the particles that allows the freedom of motion for the various fusions to take place.

9. The protons and electrons, within the Special Dynamic Material Environment of molten metal that is being irradiated with RF electromagnetic radiation, resonate in synchrony with those electrons of the RF device, which originally produced the RF electromagnetic radiation.

10. Negatrons do not react with the nucleus of any atom that has an established atomic electron structure, and do not react chemically with any atom that has an established atomic electron structure, as the Negatron's negative charge cannot penetrate the atom's electron's negative screening barrier. Therefore, the Negatrons cannot react with the molten metal used for the Special Dynamic Material Environment of the fusion process, or with any metal or nonmetal physical parts which make up the fusion reactor or its container. The established atomic electronic barrier protects the physical parts of the reactor from being destroyed by the Negatrons not being able to react either chemically or by nuclear reactions with the physical structures of the reactor.

11. Scalability: The common hydrogen fusion reactors which nuclear fuse hydrogen to form helium (and heavier chemical elements) are more scalable than any other type of fusion reactor and can range in size from less than two cubic feet to many thousands of square meters.

12. Precise on-off control of the common hydrogen fusion process can be obtained by means of cycling on or off the fusion's electromagnetic RF drive power.

13. Precise control of the magnitude and average excess power generated by the common hydrogen fusion reactor is accomplished by the periodic on-off cycling of the RF electromagnetic drive power.

14. Within these paragraphs, the term “metal” can be replaced with the term “metal alloy” and the logical intent of the paragraph remains true.

15. A metal or metal alloy used as the special dynamic material environment for the fusion of common hydrogen to form helium (and other heavier chemical elements), must be a metal or metal alloy that is both electrically conductive and can form hydrides, such as aluminum, titanium, nickel, iron, zinc, palladium, potassium, sodium, lithium, palladium-boron alloys and other metal alloys that are electrically conductive and can form metal hydrides.

16. The metal or metal alloy used as the Special Dynamic Material Environment can be brought to a molten condition by means of the induction and resonance at the 2.45 Gigahertz RF irradiating frequency, or by any means which can produce the melt heat of the metal or metal alloy, such as frequencies produced by RF induction melt furnaces, direct electrical heating or by chemical means.

17. The amount of electromagnetic energy at 2.45 Gigahertz or integral harmonics of that frequency, which induced voltages and currents into the metal of the Special Dynamic Material Environment is directly proportional to the average power of the RF energy at that frequency or integral harmonic multiples of the frequency, which is irradiating the Special Dynamic Material Environment. The physical size of the Special Dynamic Material Environment which accommodate the maximum energy transfers to the Special Dynamic Material Environment are at integral multiples of a quarter wavelength of the RF irradiating electromagnetic frequency. Of course, when the size of the Special Dynamic Material Environment is less than integral multiples of the RF irradiating frequency's wavelength, less than maximum energy is induced in the Special Dynamic Material Environment and that energy is proportional to the fraction of the wavelength sustained, which is less than a quarter wavelength of the irradiating electromagnetic energy.

18. Electromagnetic RF radiation delivered into the common Hydrogen fusion reactor by means of irradiating elements such as a monopole, dipole, or waveguide, has as a specific electromagnetic polarization associated with it. Maximum electromagnetic energy can only be transferred from the irradiating RF energy to the Special Dynamic Material Environment of molten metal, when the major axis of the Special Dynamic Material Environment's molten metal is parallel to the direction of the electromagnetic RF polarization.

19. A metal or metal alloy used as the dynamic material environment for the fusion of common Hydrogen to form Helium and other heavier chemical elements, must be a metal or metal alloy that is both electrically conductive and can form metal hydrides by means of electrochemical deposition of Hydrogen within the metal or metal alloy, or by the direct means of common Hydrogen absorption from a common hydrogen rich atmosphere in which the metal or metal alloy is molten and in direct contact with the common Hydrogen rich atmosphere.

20. The fusion process, the “Peery Theory,” including electron capture and resonant particle fusion to form helium (and heavier nuclei) with the release of excess thermal energy (more energy than is supplied to the reactor to initiate and sustain the fusion reaction) from common hydrogen as the reactor's fusion fuel, wherein common hydrogen refers to the commonly most abundant form of hydrogen, which has but one proton in its nucleus and one electron in its atomic orbit.

21. The fusion process, the “Peery Theory,” including electron capture and resonant particle fusion to form Helium (and heavier nuclei) with the release of excess energy (more energy than is supplied to the reactor to initiate and sustain the fusion reaction), can use deuterium and or tritium, two of hydrogen's isotopes, as the reactor's fusion fuel.

22. The common hydrogen fusion reactor's atmosphere of common hydrogen can be replaced with a mixture of various percentages of common hydrogen mixed with deuterium or with common hydrogen mixed with an inert gas. These mixtures decrease the reactor's excess energy production.

23. A Light Negatron (Y) has two decay modes. Specifically, a Light Negatron (Y) may either eject one of its two absorbed electrons to become a Virtual Neutron (X) or it may eject two of its captured or absorbed electrons to become a proton.

24. A Heavy Negatron (Y#) decays by ejecting its absorbed electron to become a neutron.

25. A Virtual Neutron (X) decays by ejecting its absorbed electron to become a proton.

26. Within the common hydrogen fusion reactor's minimal cycle time of one irradiating electromagnetic RF wavelength, several sequential fusions to heavier nuclei periodically take place, producing nuclei that are several atomic weights heavier than the element that was the original target of Negatrons at the beginning of the fusion cycle. The cause of these multiple fusions is that many Negatrons that are nearby a target nucleus are so powerfully attracted to the nucleus that many Negatrons can fuse with the target nucleus, before the fusion cycle time has ended and before the next fusion cycle time has begun.

27. Common Hydrogen fusions would be suspected to stop, after the completion of reactions that have formed Helium-4, because He-4 is inactive to further absorbing Neutrons or Protons. This is because Helium-4 has a cross-section to thermal neutrons of Zero Barns. But, contrary to this, when the Helium-4 is formed in the fusion process, it is formed as a bare nucleus, an Alpha particle, more specifically, a positively charged Alpha particle. Therefore, further fusion reactions with the highly reactive Negatrons are possible within the molten metal of the “Special Dynamic Material Environment.”

28. The sequence of fusion reactions (or sequence of fusions) that that leads from 4₁¹H to ₂⁴He (listed above). It should be noted that the energy yields are approximate, as 931.494 MeV was used as the conversion factor from (uamu) unified atomic mass units (Daltons) to rest mass energy in MeV. The twelve reactions take place within the Special Dynamic Material Environment, while the environment's reactions are being stimulated and synchronized by electromagnetic radiation.

29. Nuclear fusion of common hydrogen to: (a) form all of the chemical elements in the Periodic Table; and, (b) produce excess energy.

30. Performing nuclear fusion (described in 29) by means of electron capture and resonant particle fusion within a Special Dynamic Material Environment, while excited by microwave electromagnetic radiation.

31. The fusion of common hydrogen to form all 118 of the known chemical elements, including those transuranic chemical elements atomic numbers 99 to 118 which do not occur naturally, but can be produced artificially.

32. The “ash” from the fusion of common hydrogen is a collection of all of the elements of the Periodic Table. Thus, the ash is extremely valuable. Chemical elements that are not abundantly available within the earth's crust can be extracted from the ash. Likewise, the ash provides an alternative source of chemical elements that are not economically available.

33. The available excess thermal energy resulting from the fusion of common hydrogen to form all of the chemical elements greatly exceeds the available excess thermal energy produced from the fusion of common hydrogen to form helium or from any other energy source.

34. The process (described in 30) produces excess energy for elements beyond Iron. This is different than what is currently accepted. Physicists expect that any fusions beyond Iron require the insertion of energy for fusions to occur. In the present invention, the insertion energy is supplied by the electrostatic attraction between the Negatrons and the positively charged nuclei.

35. The process for fusing common hydrogen to form all of the chemical elements is exquisitely controllable. The excess thermal energy produced in a given time can be controlled by: (a) cycling on or off the RF energy which irradiates the Special Dynamic Material Environment; (b) controlling the intensity of the RF energy which at any time irradiates the Special Dynamic Material Environment; (c) controlling the concentration of common hydrogen within the Special Dynamic Material Environment; and/or, (d) controlling the composition of the Special Dynamic Material Environment's atmosphere.

Several embodiments of the invention have been described. It should be understood that the concepts described in connection with one embodiment of the invention may be combined with the concepts described in connection with another embodiment (or other embodiments) of the invention.

While an effort has been made to describe some alternatives to the preferred embodiment, other alternatives will readily come to mind to those skilled in the art. Therefore, it should be understood that the invention may be embodied in other specific forms without departing from the spirit or central characteristics thereof. The present examples and embodiments, therefore, are to be considered in all respects as illustrative and not restrictive, and the invention is not intended to be limited to the details given herein.

What is claimed is:

1. A method comprising:
providing an electrically conductive molten metal, which is has been charged with common hydrogen; and,
irradiating the electrically conductive molten metal with an electromagnetic frequency that is 2.45 GHz or integer harmonics thereof, so as to cause hydrogen to fuse into helium.

2. The method of claim 1, further comprising:
surrounding exposed portions of the molten metal hydride with a common hydrogen atmosphere.

3. A method comprising;
providing an electrically conductive molten metal alloy, which has been charged with common hydrogen; and,
irradiating the molten metal-alloy hydride with an electromagnetic frequency that is 2.45 GHz or integer harmonics thereof, so as to cause hydrogen to fuse into helium.

4. A method comprising:
providing an electrically conductive metal, which is capable of forming a metal hydride;
surrounding exposed portions of the electrically conductive metal with a common hydrogen atmosphere;
melting the electrically conductive metal;
irradiating the electrically conductive molten metal with an electromagnetic frequency that is 2.45 GHz or integer harmonics thereof, so as to cause hydrogen to fuse into helium.
